(19) United States
(12) Patent Application Publication
(10) Pub. No.: US 2024/0324601 A1
(43) Pub. Date: Oct. 3, 2024

(54) COMPOSITIONS FOR PROMOTING PLANT HEALTH AND GROWTH

(71) Applicant: EverGROW Soil, LLC, Sheridan, WY (US)

(72) Inventors: Emil Adam Nowak, Bonners Ferry, ID (US); Debra Marie Nowak, Bonners Ferry, ID (US); Douglas Vincent Nowak, Bonners Ferry, ID (US)

(73) Assignee: EverGROW Soil, LLC, Sheridan, WY (US)

(21) Appl. No.: 18/587,681

(22) Filed: Feb. 26, 2024

Related U.S. Application Data
(60) Provisional application No. 63/487,140, filed on Feb. 27, 2023.

(51) Int. Cl. A01N 63/50; A01N 25/12; A01N 61/00; A01P 21/00; C05D 9/02; C05F 11/08

(52) U.S. Cl. CPC A01N 63/50; A01N 25/12; A01N 61/00; A01P 21/00; C05D 9/02; C05F 11/08

(57) ABSTRACT

The present disclosure describes a composition comprising a mixture of montmorillonite clay (MIMT) and an enzyme blend comprising plant growth-promoting fungi (PGPF) and/or plant growth-promoting rhizobacteria (PGPR). The composition is useful for promoting plant health and/or plant growth, and/or for improving the root health of a plant.

### CROSS REFERENCE TO RELATED APPLICATIONS

This application claims the benefit of U.S. Provisional Application No. 63/487,140 filed Feb. 27, 2023, which is incorporated herein by reference in its entirety.

### FIELD OF THE DISCLOSURE

The current disclosure discloses a composition for promoting plant health and growth comprising a mixture of montmorillonite clay (MMT) and an enzyme blend comprising plant growth-promoting fungi (PGPF) and/or plant growth-promoting rhizobacteria (PGPR).

### BACKGROUND OF THE DISCLOSURE

By 2050 the United Nations' Food and Agriculture Organization projects that total food production must increase by 70% to meet the needs of a growing population, a challenge that is exacerbated by numerous factors, including diminishing freshwater resources, increasing competition for arable land, rising energy prices, increasing input costs, and the likely need for crops to adapt to the pressures of a drier, hotter, and more extreme global climate.

Current agricultural practices are not well equipped to meet this growing demand for food production, while simultaneously balancing the environmental impacts that result from increased agricultural intensity.

To meet the above growing demand, plant growth products are needed that increase the nutrient intake of plants, produce more nutritious crops, and hydrate, oxygenate, and feed the soil. The present disclosure describes such a product.

### SUMMARY OF THE DISCLOSURE

This Summary is provided to introduce a selection of concepts in a simplified form that is further described below in the Detailed Description. This Summary is not intended to identify all key features or essential features of the claimed subject matter, nor is it intended to be used alone as an aid in determining the scope of the claimed subject matter.

The present disclosure describes a composition for promoting plant health and growth in a plant, the composition comprising a mixture of:
montmorillonite clay (MMT); and
an enzyme blend comprising plant growth-promoting fungi (PGPF) and/or plant growth-promoting rhizobacteria (PGPR).

The current disclosure also provides a method for promoting plant health, or plant growth, or for improving the root health of a plant, comprising administering an effective amount of the composition described herein.

### BRIEF DESCRIPTION OF THE FIGURES

The patent or application file contains at least one drawing executed in color. Copies of this patent or patent application publication with color drawing(s) will be provided by the Office upon request and payment of the necessary fee.

FIG. 1 shows a photograph of grass grown with and without a composition comprising MMT and PGPF comprising Aspergillus oryzae. The lush green grass was grown using the composition described herein, whereas the grass grown without the composition is outside the lush green grass.

FIG. 2 shows a photograph of a red bell pepper grown with and without a composition comprising MMT and PGPF comprising Aspergillus oryzae. The darker red peppers were grown using the composition whereas the orange peppers were grown without the present composition.

FIGS. 3-49 show radishes grown in MMT, PGPF-PGPR, Formula A, Formula B, or Soil test groups, taken weeks 1-9 after planting.

FIGS. 50-94 show carrots grown in MMT, PGPF-PGPR, Formula B, Formula A, or Soil test groups, taken weeks 1-9 after planting.

FIGS. 95-139 show beets grown in MMT, PGPF-PGPR, Formula B, Formula A, or Soil test groups, taken weeks 1-9 after planting.

FIGS. 140-184 show strawberries grown in MMT, PGPF-PGPR, Formula B, Formula A, or Soil test groups, taken weeks 1-9 after planting.

FIGS. 185-229 show bell peppers grown in MMT, PGPF-PGPR, Formula B, Formula A, or Soil test groups, taken weeks 1-9 after planting.

FIGS. 230-274 show tomatoes grown in MMT, PGPF-PGPR, Formula B, Formula A, or Soil test groups, taken weeks 1-9 after planting.

FIGS. 275-281 show radishes, carrots, beets, strawberries, bell peppers, and tomatoes grown in Formula B (OF) or Soil.

FIGS. 282-288 show radishes, carrots, beets, strawberries, bell peppers, and tomatoes grown in Formula B (OF) or MMT.

FIGS. 289-296 show radishes, carrots, beets, strawberries, bell peppers, and tomatoes grown in Formula B (OF) or PGPF-PGPR.

FIGS. 297-303 show radishes, carrots, beets, strawberries, bell peppers, and tomatoes grown in Formula B (OF) or Formula A (NF).

FIGS. 304-312 show strawberries grown in Formula B or Soil groups. The strawberries were picked on August 13.

FIGS. 313-321 show strawberries grown in Formula A, Formula B, or Soil groups. The strawberries were picked on August 18.

### DETAILED DESCRIPTION

The present disclosure discloses a composition for promoting plant health and growth in a plant, the composition comprising a mixture of:
montmorillonite clay (MMT); and
an enzyme blend comprising plant growth-promoting plant growth-promoting fungi (PGPF) and/or plant growth-promoting rhizobacteria (PGPR).

The enzyme blend further comprises vitamins, minerals, enzymes, and amino acids.

### Montmorillonite Clay (MMT)

MMT is a very soft phyllosilicate group of minerals that form when they precipitate from water solution as microscopic crystals, known as clay. MMT, a member of the smectite group, is a 2:1 clay, meaning that it has two tetrahedral sheets of silica sandwiching a central octahedral sheet of alumina. MMT is also known as “mineral rock dust”. Within the smectite grouping, there are several subdivisions, including nontronite, pyrophyllite, saponite, sauconite, bentonite, montmorillonite, and talc.

The individual crystals of MMT are not tightly bound hence water can intervene, causing the clay to swell, hence montmorillonite is a characteristic component of swelling soil. The water content of MMT is variable and it increases greatly in volume when it absorbs water. Chemically, it is hydrated sodium calcium aluminum magnesium silicate hydroxide (Na,Ca)_{0.33}(Al,Mg)₂(Si₄O₁₀)(OH)₂·nH₂O. Potassium, iron, and other cations are common substitutes, and the exact ratio of cations varies with the source. It often occurs intermixed with chlorite, muscovite, illite, cookeite, and kaolinite.

Both bentonite and MMT clay contain MMT crystals. However, there is a difference between bentonite and MMT in terms of their composition. Bentonite is a clay material consisting mainly of sodium montmorillonite, whereas MMT is a type of clay consisting mainly of either sodium or calcium montmorillonite mineral crystals.

These minerals in MMT are naturally chelated and documented to be high in humus lignite silts intermixed with highly fibrous organic matter. Besides the well-known colloidal properties of clays, it has an extra layer of organic matter chelated by fluvic acids. Plant developmental processes are controlled by internal signals that depend on the adequate supply of mineral nutrients by soil to the roots. Plants take up most mineral nutrients through the rhizosphere where soil microbes (rhizobacteria) are needed to keep soil healthy and fertile.

MMT is commercially available. In embodiments, the MMT is obtained from a quarry in Nevada and is sold by Window Peak Trace Minerals (http://www.montmorillonite.biz/).

In embodiments, the MMT comprises one or more of nitrogen (N), phosphorus (P), potassium K), calcium (Ca), magnesium (Mg), iron (Fe), oxygen (O₂), and additional trace minerals.

In embodiments, the MMT comprises:
N in the amount of 500 to 800, 500 to 750, 550 to 750, or 600 to 700, 625 to 675, 635 to 650, or 640 to 650 ppm;
P in the amount of 100 to 300, 100 to 275, 150 to 275, 150 to 250, or 175 to 225 ppm;
K in the amount of 25,000 to 35,000, 26,000 to 34,000, 27,000 to 33,000, or 28,000 to 32,000 ppm;
Ca in the amount of 16,000 to 24,000, 17,000 to 23,000, 18,000 to 21,000, or 18,000 to 22,000 ppm;
Mg in the amount of 4,000 to 8,000, 4500 to 7500, 5500 to 6500, or 5,000 to 7,000 ppm; Fe in the amount of 11,000 to 16,000, 12,500 to 14,500, 13,000 to 14,000, or 12,000-15,000 ppm; and
O₂ in the amount of 400,000 to 700,000, 450,000 to 650,000, 450,000 to 550,000, or 500,000-600,000 ppm.

In embodiments, the MMT comprises one or more of the elements listed in Table 1, and over 70 other ionic trace minerals derived from MMT.

TABLE 1

| | Average parts |
|---|---|
| Element | per million (PPM) |
| Nitrogen (N) | 646 |
| Phosphorus (P) | 196 |
| Potassium (K) | 30,185 |
| Calcium (Ca) | 20,425 |
| Magnesium (Mg) | 6,079 |
| Oxygen (O₂) | 550,000 |
| Iron (Fe) | 13,422 |

Trace minerals are nutrients that plant needs in very small amounts to thrive. Examples of trace minerals can include iron (Fe), manganese (Mn), copper (Cu), molybdenum (Mb), zinc (Zn), selenium (Se), chromium (Cr), iodine (I), and fluoride (F). Many of these trace minerals may be chelated. Chelation is the suspension of a mineral between two or more amino acids, or bonding to “small proteins”, peptides, or amino acids (“Chela” is Greek for “claw”). Chelation substances can include things like amino acids, ascorbic acid, and orotates, as well as hydrolyzed protein. Chelation improves the absorption of the mineral from the digestive tract. (www.chelatedtraceminerals.com/chelated_trace_minerals.html; www.chelatedtraceminerals.com/montmorillonite_minerals.html).

In embodiments, the MMT is micronized. Micronization of MMT makes it more accessible to the cells. In embodiments, it is micronized such that the average (mean) diameter of particle size of the micronized MMT is less than or equal to 100 micrometers (≤100 μm), for example, less than or equal to 80 micrometers (≤80 μm), less than or equal to 60 micrometers (≤60 μm), less than or equal to 50 micrometers (≤50 μm), less than or equal to 40 micrometers (≤40 μm), or less than or equal to 30 micrometers (≤30 μm). In preferred embodiments, the MMT is micronized, such that the average particle size is less than or equal to 40 micrometers (≤40 μm).

Particle sizes can also be expressed in terms of the particle size distribution (PSD) (e.g., D₁₀, D₅₀, and D₉₀ values). Particle size distribution may be affected by the hydration state of the particles. Illustratively, a wet particle size distribution may differ from a dry particle size distribution and corresponding possess different characteristic D₁₀, D₅₀, and D₉₀ values.

As would be understood by a person having ordinary skill in the art, particle sizes and particle size distributions of powders can be measured using various techniques known in the art, such as sieves, sedimentation, electrozone testing, and laser diffraction. Particle size distributions of solids can be expressed using values (e.g., D₁₀, D₅₀, and D₉₀ values) measured by laser diffraction.

As used herein, “D₅₀” refers to the median diameter of a particle size distribution.

As used herein, “D₁₀” refers to the particle diameter at which 10% of a population of particles possess a particle diameter of D₁₀ or less.

As used herein, “D₉₀” refers to the particle diameter at which 90% of a population of particles possess a particle diameter of D₉₀ or less.

In embodiments, the D₉₀ value of the MMT is 40 micrometers (40 μm).

### Enzyme Blend

The enzyme blend comprises PGPF and/or PGPR.

The enzyme blend further comprises one or more vitamins, minerals, enzymes, and amino acids. The enzyme blend can comprise natural or synthetic ingredients or a combination of natural or synthetic ingredients. For example, vitamins, minerals, enzymes, and amino acids can be obtained from a natural source or be synthetically synthesized. Moreover, the enzymes can be made recombinantly. In embodiments, the enzyme blend is a biofertilizer. In embodiments, the biofertilizer is a natural biofertilizer comprising natural ingredients.

### Minerals of the Enzyme Blend

The one or more minerals of the enzyme blend comprise zinc (Zn), magnesium (Mg), selenium (Se), copper (Cu), cobalt (Co), manganese (Mn), iron (Fe), iodine (I), phosphorus (P), sulfur(S), potassium (K), and sodium (Na).

In embodiments, the amount of each mineral in the enzyme blend in grams per kilogram of the enzyme blend is set forth below:
Zn in the amount of 7.0 to 11.0, 7.5 to 10.5, 8 to 10, 9 to 10, or 9.4 to 9.8 g;
Mg in the amount of 5.0 to 7.0, 5.5 to 6.5, or 5.8 to 6.2 g;
Selenium in the amount of 0.005 to 0.015, 0.006 to 0.014, 0.007 to 0.013, or 0.008 to 0.012 g;
Copper in the amount of 0.8 to 1.6, 0.9 to 1.5, 1.0 to 1.4, or 1.1 to 1.3 g;
Cobalt in the amount of 0.10 to 0.20, 0.12 to 0.18, or 0.13 to 0.17 g;
Manganese in the amount of 1.0 to 2.0, 1.2 to 1.8, or 1.3 to 1.7 g;
Iron in the amount of 1.0 to 2.0, 1.2 to 1.8, or 1.3 to 1.7 g;
Iodine in the amount of 0.25 to 0.40, 0.26 to 0.39, 0.28 to 0.37, or 0.31 to 0.35 g;
Phosphorus in the amount of 13.0 to 14.5, 13.2 to 14.3, 13.4 to 13.9, or 13.6 to 14.0 g;
Sulfur in the amount of 0.3 to 1.1, 0.4 to 1.0, or 0.5 to 0.9 g sulfur(S);
Potassium in the amount of 0.05 to 0.15, 0.07 to 0.13, or 0.08 to 0.12 g; and
Sodium in the amount of 0.002 to 0.010, 0.003 to 0.019, or 0.004 to 0.008 g.

In embodiments, the minerals of the enzyme blend include the following as set forth in Table 2.

TABLE 2

| | Weight in grams per |
|---|---|
| Element | kg of enzyme blend |
| Copper (Cu) | 1.2 |
| Cobalt (Co) | 0.15 |
| Manganese (Mn) | 1.5 |
| Magnesium (Mg) | 6.0 |
| Zinc (Zn) | 9.6 |
| Iron (Fe) | 1.5 |
| Iodine (I) | 0.33 |
| Phosphorus (P) | 13.8 |
| Sulfur (S) | 0.7 |
| Potassium (K) | 0.1 |
| Sodium (Na) | 0.006 |
| Selenium | 0.01 |

### Vitamins of Enzyme Blend

The one or more vitamins of the enzyme blend include vitamin A, vitamin D₃, and vitamin E.

In embodiments, the amount of the vitamins in the enzyme blend in international units (iu) per kilogram of the enzyme blend is set forth below:
Vitamin A in the amount of 650,000 to 710,000, 660,000 to 700,000, or 670,000 to 690,000 iu;
Vitamin D₃ in the amount of 80,000 to 115,000, 90,000 to 105,000, or 95,000 to 100,00 iu; and
Vitamin D₃ in the amount of 300 to 350, 310,000 to 340, or 315 to 335 iu.

In embodiments, the vitamins of the enzyme blend include the following as set forth in Table 3.

TABLE 3

| | Amount in international |
|---|---|
| Vitamin | units (iu) |
| Vitamin A | 680,000 |
| Vitamin D3 | 98,000 |
| Vitamin E | 325 |

### Amino Acids of Enzyme Blend

In embodiments, the one or more amino acids of the enzyme blend comprise glutamine (Gln), alanine (Ala), threonine (Thr), valine (Val), serine (Ser), proline (Pro), isoleucine (Ile), leucine (Ile), leucine (Leu), histidine (His), phenylalanine (Phe), glutamic acid (Glu), aspartic acid (Asp), cysteine (Cys), tyrosine (Tyr), and tryptophan (Trp).

In embodiments, the amounts of the amino acids of the enzyme blend per gram of the enzyme blend are set forth below:
Gln in the amount of 40.0 to 43.0, 40.5 to 42.5, 41.0 to 42.0, or 41.2 to 41.6 mg;
Ala in the amount of 44.5 to 47.0, 45.0 to 46.5, 45.2 to 46.0, or 45.4 to 45.8 mg;
Thr in the amount of 3.0 to 5.0, 3.5 to 4.5, 3.7 to 4.6, or 3.9 to 4.3 mg Thr;
Val in the amount of 2.8 to 4.0, 3.0 to 3.8, 3.2 to 3.6, or 3.3 to 3.5 mg;
Ser in the amount of 0.3 to 1.3, 0.5 to 1.1, 0.6 to 1.0, or 0.7 to 0.9 mg;
Pro in the amount of 0.3 to 1.3, 0.5 to 1.1, 0.6 to 1.0, or 0.7 to 0.9 mg;
Ile in the amount of 0.1 to 1.0, 0.3 to 0.9, 0.4 to 0.8, or 0.5 to 0.7 mg;
Leu in the amount of 14.5 to 16.0, 14.7 to 15.7, 14.9 to 15.5, 15.0 to 15.4, or 15.1 to 15.3 mg;
His in the amount of 0.1 to 0.5, or 0.2 to 0.4 mg;
Phe in the amount of 0.08 to 0.6, 0.09 to 0.5, or 0.1 to 0.3 mg;
Glu in the amount of 0.3 to 1.2, 0.5 to 1.1, 0.6 to 1.0, or 0.7 to 0.9 mg;
Asp in the amount of 0.2 to 1.4, 0.4 to 1.2, 0.6 to 1.0, 0.7 to 0.9 mg;
Cys in the amount of 0.2 to 1.2, 0.4 to 1.0, 0.5 to 0.9, or 0.6 to 0.8 mg;
Tyr in the amount of 1.0 to 2.0, 1.2 to 1.9, 1.3 to 2.0, 1.4 to 1.8, 1.5 to 1.7 mg; and
Trp in the amount of 0.005 to 0.015, 0.007 to 0.013, or 0.009 to 0.011 mg.

In embodiments, the amounts (in milligrams) of the amino acids of the enzyme blend per gram of the enzyme blend are set forth in Table 4.

TABLE 4

| | Weight in mg/g of |
|---|---|
| Amino acid | the enzyme blend |
| Glutamine (Gln) | 41.4 |
| Alanine (Ala) | 45.6 |
| Threonine (Thr) | 4.1 |
| Valine (Val) | 3.4 |
| Serine (Ser) | 0.8 |
| Proline (Pro) | 0.8 |
| Isoleucine (Ile) | 0.6 |
| Leucine (Leu) | 15.2 |
| Histidine (His) | 0.3 |
| Phenylalanine (Phe) | 0.2 |
| Glutamic Acid (Glu) | 0.8 |
| Aspartic Acid (Asp) | 0.8 |
| Cysteine (Cys) | 0.7 |
| Tyrosine (Tyr) | 1.6 |
| Tryptophan (Trp) | 0.01 |

### Enzymes of the Enzyme Blend

In embodiments, the one or more enzymes of the enzyme blend comprise cellulase, hemicellulase, and pectinase.

In embodiments, the amount of the enzymes of the enzyme blend (in international units; iu) per kilogram (kg) of the blend is set forth below:
Cellulase in the amount of 700 to 1300, 800 to 1200, 900 to 1100, or 980 to 1020 iu;
Hemicellulase in the amount of 700 to 1300, 800 to 1200, 900 to 1100, or 980 to 1020 iu; and
Pectinase in the amount of 700 to 1300, 800 to 1200, 900 to 1100, or 980-1020 iu.

In embodiments, the one or more enzymes of the enzyme blend comprise the following as set forth in Table 5.

TABLE 5

| | Amount in international units |
|---|---|
| Enzyme | (iu) per kg of enzyme blend |
| Cellulase | 1000 |
| Hemicellulase | 1000 |
| Pectinase | 1000 |

Cellulase is an enzyme that is capable of breaking down cellulosic material.

In embodiments, the cellulase enzyme is derived from organisms selected from the group consisting of Aspergillus niger, Aspergillus nidulans, and Aspergillus oryzae.

Pectinases are a group of enzymes that break down pectin, a polysaccharide found in plant cell walls. The reactions involved in the breakdown comprise hydrolysis, transelimination, and de-esterification reactions. The pectinase enzyme can be either natural or synthetic, with the former being preferred.

In embodiments, the pectinase enzyme is derived from organisms selected from the group consisting of Aspergillus Niger, Aspergillus awamori, Aspergillus oryzae, Penicillium expansum, Penicillium restrictum, Trichoderma viride, Mucor piriformis, Yarrowia lipolytica, Penicillium janthinellum, Tetracoccosporium sp., Penicillium chrysogenum, Saccharomyces fragilis, Saccharomyces thermantitonum, Torulopsis kefyr, Candida pseudotropicalis var, lactosa, Candida pseudotropicalis, Saccharomyces sp, Cryptococcus sp., Aureobasidium pullulans, Rhodotorula dairenensis, Kluyveromyces marxianus, Geotrichum klebahnii, Wickerhanomyces anomalus, Hanseniaspora sp., Saccharomyces cerevisiae, Rhodotorula dairenensis, Candida zemplinina, Metschnikowia sp., Aureobasidium pullulans, Cryptococcus saitoi, Pseudomonas fluorescens, Bacillus sp., Pseudomonas sp., Micrococcus sp., Bacillus licheniformis, and Brevibacillus borstelensis.

Hemicellulase is a type of enzyme that breaks down material typically associated with or attached to cellulose. The hemicellulases include xylanase, arabinoxylanase, beta-glucanase, beta-mannanase, pectinase, arabinase, pectin methylesterase, pectin lyase, and polygalacturonases.

In embodiments, the hemicellulase is derived from saprophytic microbes. In one embodiment, the saprophytic microbes comprise members of the Bacillus or Paenibacillus genera.

In embodiments, the enzymes of the enzyme blend can be from a natural source or can be made recombinantly or synthetically. In embodiments, the enzymes are from a natural source.

### PGPF of Enzyme Blend

Plant growth-promoting fungi (PGPF) are a group of rhizosphere fungi that can colonize plant roots and improve plant growth. The word “rhizosphere” refers to an area of soil near plant roots where the chemistry and microbiology are influenced by plant growth, respiration, and nutrient exchange. PGPF plays an important role in sustainable agriculture as it provides an economically beneficial way to improve crop yields. PGPF can improve germination, vigor of seedlings, growth of plants, photosynthesis, and the development of roots.

While not wishing to be bound by theory, the mechanisms utilized by PGPF to improve plant growth appear to involve solubilizing and mineralizing nutrients such that they can be easily taken up by plants. They may also regulate hormonal balance, produce volatile organic compounds (VOC) and microbial enzymes, suppress plant pathogens, and help minimize plant stress. Interactions between PGPF and plant species require some specificity for the PGPR to exhibit growth-promoting effects and root colonization.

In embodiments, PGPF can be either endophytic (living inside roots), directly exchanging metabolites with plants, epiphytic (living on the root surface), or free-living, i.e., living in the rhizosphere. PGPF includes one or more fungi from the genera Aspergillus, Fusarium, Penicillium, Phoma, and Trichoderma. These can be found frequently in the rhizosphere or the roots of plants.

In embodiments, the Aspergillus species include A. oryzae, A. fumigatus, A. niger, A. terreus, A. ustus, and A. clavatus. In embodiments, the Aspergillus species include A. oryzae. In embodiments, the Fusarium species include F. equiseti, F. oxysporum, and F. verticillioides. In embodiments, the Penicillium species include P. chrysogenum, P. citrinum, P. kloeckeri, P. menonorum, P. resedanum, P. simplicissimum, P. janthinellum, and P. Viridicatum. In embodiments, the Phoma species include P. herbarum, and P. multirostrata. In embodiments, the Trichoderma species include T. asperellum, T. atroviride, T. hamatum, T. harzianum, T. longibrachiatum, T. pseudokoningii, T. viride, and T. virens.

In embodiments, wherein the PGPF comprises Aspergillus oryzae, it can be provided in the form of a dried, A. oryzae fermentation extract that is rich in non-animal source protein, free from amino acids, minerals, vitamins, enzymes, fibers, and other nutrients.

### PGPR of Enzyme Blend

Plant growth-promoting rhizobacteria (PGPR) are another component of the enzyme blend. PGPR represent a wide range of root-colonizing bacteria whose application often is associated with increased rates of plant growth, suppression of soil pathogens, and the induction of systemic resistance against insect pests.

Both plant growth and yield are accomplished via various plant growth substances as bio-fertilizers. PGPR colonize the plant roots that enhance plant growth. They also play a vital role in disease control. The goal is to manage soils and seeds to build up microbial communities.

In embodiments, the PGPR comprise one or more bacteria selected from the group consisting of Azospirillum, Actinobacter, Alcaligenes, Bacillus, Burkholderia, Buttiauxella, Enterobacter, Klebsiella, Kluyvera, Pseudomonas, Rahnella, Ralstonia, Rhizobium, Serratia, Stenotrophomonas, Paenibacillus, Lysinibacillus, and a combination thereof. In embodiments, the PGPR comprise Aspergillus oryzae.

Azospirillum is a gram-negative, microaerophilic, non-fermentative, and nitrogen-fixing bacterial genus from the family of Rhodospirillaceae. These bacteria can promote plant growth and are often associated with the root and rhizosphere of many non-leguminous crops.

Azospirillum fixes atmospheric nitrogen in the soil and helps to save chemical fertilizers, by not using them or using them in lesser amounts. They include species like A. lipferum, A. brasilense, A. amazonense, A. halopraeferens, A. irakense, A. largimobile, A. doebereinerae, A. oryzae, A. melini (A. melinis), and A. canadensis. Azospirillum is an important and common PGPR that pertains to such crops as grasses, rice, wheat, sugarcane, sorghum, maize, and millets, and can be an important biofertilizer used in the cultivation of rice.

Biofertilizers are preparations containing living cells or latent cells of efficient strains of microorganisms that help crop plants uptake nutrients by their interactions in the rhizosphere when applied through seed or soil. They accelerate certain microbial processes in the soil which augment the extent of availability of nutrients in a form easily assimilated by plants. The use of biofertilizers is one the most important components of integrated nutrient management, as they are cost-effective and renewable sources of plant nutrients to supplement the chemical fertilizers for sustainable agriculture.

In embodiments, wherein the PGPR are of the genus Bacillus, the organism is selected from the group consisting of B. acidiceler, B. acidicola, B. acidiproducens, B. aeolius, B. aerius, B. aerophilus, B. agaradhaerens, B. aidingensis, B. akibai, B. alcalophilus, B. algicola, B. alkalinitrilicus, B. alkalisediminis, B. alkalitelluris, B. altitudinis, B. alveayuensis, B. amyloliquefaciens, B. anthracis, B. aquimaris, B. arsenicus, B. aryabhattai, B. asahii, B. atrophaeus, B. aurantiacus, B. azotoformans, B. badius, B. barbaricus, B. bataviensis, B. beijingensis, B. benzoevorans, B. beveridgei, B. bogoriensis, B. boroniphilus, B. butanolivorans, B. canaveralius, B. carboniphilus, B. cecembensis, B. cellulosilyticus, B. cereus, B. chagannorensis, B. chungangensis, B. cibi, B. circulans, B. clarkii, B. clausii, B. coagulans, B. coahuilensis, B. cohnii, B. decisifrondis, B. decolorationis, B. drentensis, B. farraginis, B. fastidiosus, B. firmus, B. flexus, B. foraminis, B. fordii, B. fortis, B. fumarioli, B. funiculus, B. galactosidilyticus, B. galliciensis, B. gelatini, B. gibsonii, B. ginsengi, B. ginsengihumi, B. graminis, B. halmapalus, B. halochares, B. halodurans, B. hemicellulosilyticus, B. herbertsteinensis, B. horikoshi, B. horneckiae, B. horti, B. humi, B. hwajinpoensis, B. idriensis, B. indicus, B. infantis, B. infernus, B. isabeliae, B. isronensis, B. jeotgali, B. koreensis, B. korlensis, B. kribbensis, B. krulwichiae, B. lehensis, B. lentus, B. licheniformis, B. litoralis, B. locisalis, B. luciferensis, B. luteolus, B. macauensis, B. macyae, B. mannanilyticus, B. marisflavi, B. marmarensis, B. massiliensis, B. megaterium, B. methanolicus, B. methylotrophicus, B. mojavensis, B. muralis, B. murimartini, B. mycoides, B. nanhaiensis, B. nanhaiisediminis, B. nealsonii, B. neizhouensis, B. niabensis, B. niacini, B. novalis, B. oceanisediminis, B. odysseyi, B. okhensis, B. okuhidensis, B. oleronius, B. oshimensis, B. panaciterrae, B. patagoniensis, B. persepolensis, B. plakortidis, B. pocheonensis, B. polygoni, B. pseudoalcaliphilus, B. pseudofirmus, B. pseudomycoides, B. psychrosaccharolyticus, B. pumilus, B. qingdaonensis, B. rigui, B. ruris, B. safensis, B. salarius, B. saliphilus, B. schlegelii, B. selenatarsenatis, B. selenitireducens, B. seohaeanensis, B. shackletonii, B. siamensis, B. simplex, B. siralis, B. smithii, B. soli, B. solisalsi, B. sonorensis, B. sporothermodurans, B. stratosphericus, B. subterraneus, B. subtilis, B. taeansis, B. tequilensis, B. thermantarcticus, B. thermoamylovorans, B. thermocloacae, B. thermolactis, B. thioparans, B. thuringiensis, B. tripoxylicola, B. tusciae, B. vallismortis, B. vedderi, B. vietnamensis, B. vireti, B. wakoensis, B. weihenstephanensis, B. xiaoxiensis, and combination thereof.

In a preferred embodiment, the PGPR comprise Bacillus subtilis. In embodiments, the Bacillus subtilis is commercially available as “SEBtilis™” as a probiotic (from Specialty Enzymes & Probiotics; SpecialtyEnzymes.com; Chino, California).

SEBtilis™ is the Specialty Enzymes' trademark name for Bacillus subtilis. SEBtilis is a supplemental probiotic that can be used in combination with other probiotics or by itself. It is a gram-positive, spore-forming, bacteriocin-producing bacteria that lack the potential to mate with pathogens and appears to be a facultative anaerobe. This spore-forming capability provides the probiotic with a protective endospore which ensures an increase in stability and viability throughout the pH and temperature extremes of the digestive tract. The greater stability helps to prolong shelf-life. SEBtilis produces the bacteriocin, subtilin, which can act as antimicrobial or killing peptides, directly inhibiting competing strains or pathogens. The bacteriocins' ability to occupy and take over a niche from deleterious pathogens, also known as competitive exclusion, keeps a presence of favorable bacteria over those that may be harmful (Joseph, Baby, et al. “Bacteriocin from Bacillus Subtilis as a Novel Drug against Diabetic Foot Ulcer Bacterial Pathogens” Asian Pacific Journal of Tropical Biomedicine 2013).

Some exemplary characteristics of SEBtilis as sold are that it has the appearance of an off-white to tan powder, has an optimum pH of 4.5 to 7.0, and has a moisture content of not more than 10%. The various probiotic potencies available are 1 billion, 10 billion, or 20 billion CFU/gram.

### Exemplary Enzyme Blend and its Properties

As an example, the enzyme blend contains PGPF (Aspergillus oryzae), wherein the A. oryzae is present as a dry fermentation extract, and further includes the minerals, vitamins, amino acids, and enzymes described herein. In embodiments, the enzyme blend includes only PGPF or only PGPR. In embodiments, the enzyme blend includes both PGPF and PGPR.

The enzyme blends described herein are commercially available, for example, from Specialty Enzymes & Probiotics (Chino, California; www.SpecialtyEnzymes.com). The enzyme blend comprising PGPF (A. oryzae) can be obtained from Specialty Enzymes & Probiotics under the name “AgroSEB™”. The enzyme blend including PGPF (A. oryzae) and PGPR (B. subtilis) can be obtained from Specialty Enzymes & Probiotics and is commercially available under the name “AgroSEB PB™”. AgroSEB PB™ contains a mixture of AgroSEB™, and SEBtilis™, both described herein.

The enzyme blend described herein is specifically designed as a natural biofertilizer. The enzyme blend is an important addition to natural agriculture, over-farmed soil, and soil that is depleted of minerals and other nutrients. It is also suitable in any agricultural situation where the substitution of chemical fertilizers is desired. Studies demonstrate that the enzyme blend increases the energy and nutrient quality of soil, thus maintaining essential soil microbes needed to keep soil healthy and fertile.

In embodiments, the enzyme blend comprising PGPF (A. oryzae) and no PGPR has an off-white to tan powder appearance, is soluble in water, has less than 15% loss of water on drying, and has a protein content of no less than 50% (as measured by Kjeldal method). Mineral, vitamin, amino acid, and enzyme content of the AgroSEB enzyme blend are shown in Tables 2, 3, 4, and 5 respectively.

### Composition and Methods of Making the Composition Comprising MMT and Enzyme Blend

The composition is prepared by mixing the MMT described herein with the enzyme blend described herein. Before mixing the two components, the MMT can be micronized to an optimal size, so that the plant cells can easily access the MMT, especially its contents such as the minerals. The MMT can be agriculture grade. After micronization, the MMT is mixed with the enzyme blend comprising PGPF and/or PGPR in a mixer, for example, a ribbon mixture.

The weight ratio of the MMT and enzyme blend can be adjusted depending on various factors, such as the type of plant, the soil, and the time of year. In embodiments, the weight ratio of the MMT to the enzyme blend ranges from 95:5 to 5:95, 90:10 to 10:90, 80:20 to 20:80, 70:30 to 30:70, 60:40 to 40:60, 50:50, 85:15 to 15:85, 75:25 to 25:75, 65:35 to 35:65, or 55:45 to 45:55. In an especially preferred embodiment the weight ratio of MMT to the enzyme blend is 88:12.

In embodiments, the enzyme blend comprises PGPR at a concentration of at least 1×10⁴ to 1×10¹⁰ colony-forming units/milliliter (CFU/mL).

In embodiments, the enzyme blend comprises PGPF at an average concentration of 1×10⁸ CFU/mL.

The composition described herein can be either in the form of a solid or liquid. The solid form of the composition can also be semi-solid, such as a gel.

In embodiments, the composition of the present disclosure is in the form of a micronized solid. In embodiments, the composition of the present disclosure in the form of a solid is in the form of a powder.

In embodiments, the composition of the present disclosure is in the form of a tablet, gel, or capsule.

### Methods of Using the Composition

The present disclosure also describes a method for promoting plant health, or plant growth, and/or for improving the root health of a plant, comprising administering an effective amount of the composition described herein.

In embodiments, the composition is administered to the root of a plant, seeds of a plant, leaves of a plant, or the soil surrounding the plant.

In embodiments, the composition is administered in the form of a liquid composition. The liquid composition can be prepared by dissolving a solid form of the composition with water. In embodiments, the solid form is completely soluble in water. In embodiments, the solid form is at least 98% or 99% soluble in water.

In embodiments, the composition is in the form of a solid powder and is administered to the plant by dusting using a strainer. The use of a strainer minimizes the clumping of the solid powder and also provides for a more even distribution of the composition to the desired area to cover. In embodiments, the composition in the form of a powder is applied by blending it into the soil of the plant.

The MMT and enzyme blend in the composition work synergistically at the root level of the plant. As an example, cellulase, hemicellulase, and pectinase can break down cellulosic and pectin material which allows the MMT to saturate the soil and inner root system. The trace minerals of the MMT can provide nutrients to the root system and soil enabling the plant to grow and thrive. The composition saturates the rhizosphere with trace minerals in the soil.

The composition described herein can enhance plant growth and development, for example, by increasing the above-ground biomass of the plant, enabling the production of higher yield in quantity and enhanced quality of fruit or foliage, and increased resiliency to abiotic and biotic constraints. Examples of abiotic constraints include abiotic stress due to temperature, moisture, ultraviolet radiation, salinity, floods, and drought. Examples of biotic constraints include biotic stress caused by weeds, insects, herbivores, nematodes, fungi, and bacteria.

The composition described herein can provide direct effects on the plants including resiliency to abiotic and/or biotic stress, suppression of soil pathogens, systemic resistance against insect pests, promote microbial growth in soil, enhance root colonizing bacteria and microbial saturation build up in the soil, enhance nutrient uptake of trace minerals into the root system, promote root growth and stimulation, and increase the rate of plant growth, improve root health of the plant, or any combination thereof.

The composition described herein can provide improvements in sprouting time, number of sprouts, time to fruit, number of fruit, healthier leaves and stronger vines, increased vine size, larger vegetable or fruit size, flowering and budding time, scent intensity, abundance of hairs, fruit color change, flavor of fruit or vegetable, moisture of fruit, and/or number of vines. “Strong” vegetables or fruits have a good physical condition, have indications of good health, and are not diseased. “Full” looking plants contain or hold as much or as many as possible, having no empty space in comparison to the plants that were not full.

As will be understood by one of ordinary skill in the art, each embodiment disclosed herein can comprise, consist essentially of, or consist of its particular stated element, step, ingredient, or component. Thus, the terms “include” or “including” should be interpreted to recite: “comprise, consist of, or consist essentially of.” As used herein, the transition term “comprise” or “comprises” means includes, but is not limited to, and allows for the inclusion of unspecified elements, steps, ingredients, or components, even in major amounts. The transitional phrase “consisting of” excludes any element, step, ingredient, or component not specified. The transition phrase “consisting essentially of” limits the scope of the embodiment to the specified elements, steps, ingredients, or components and to those that do not materially affect the embodiment. As used herein, a material effect would cause a statistically significant increase, for example, in plant growth.

Unless otherwise indicated, all numbers expressing quantities of ingredients, properties such as molecular weight, reaction conditions, and so forth used in the specification and claims are to be understood as being modified in all instances by the term “about.” Accordingly, unless indicated to the contrary, the numerical parameters set forth in the specification and attached claims are approximations that may vary depending upon the desired properties sought to be obtained by the present disclosure. At the very least, and not as an attempt to limit the application of the doctrine of equivalents to the scope of the claims, each numerical parameter should at least be construed in light of the number of reported significant digits and by applying ordinary rounding techniques. When further clarity is required, the term “about” has the meaning reasonably ascribed to it by a person skilled in the art when used in conjunction with a stated numerical value or range, i.e. denoting somewhat more or somewhat less than the stated value or range, to within a range of ±20% of the stated value; ±19% of the stated value; ±18% of the stated value; ±17% of the stated value; ±16% of the stated value; ±15% of the stated value; ±14% of the stated value; ±13% of the stated value; ±12% of the stated value; ±11% of the stated value; ±10% of the stated value; ±9% of the stated value; ±8% of the stated value; ±7% of the stated value; ±6% of the stated value; ±5% of the stated value; ±4% of the stated value; ±3% of the stated value; ±2% of the stated value; or ±1% of the stated value.

Notwithstanding that the numerical ranges and parameters setting forth the broad scope of the disclosure are approximations, the numerical values set forth in the specific examples are reported as precisely as possible. Any numerical value, however, inherently contains certain errors necessarily resulting from the standard deviation found in their respective testing measurements.

The terms “a,” “an,” “the” and similar referents used in the context of describing the disclosure (especially in the context of the following claims) are to be construed to cover both the singular and the plural, unless otherwise indicated herein or clearly contradicted by context. Recitation of ranges of values herein is merely intended to serve as a shorthand method of referring individually to each separate value falling within the range. Unless otherwise indicated herein, each individual value is incorporated into the specification as if it were individually recited herein. All methods described herein can be performed in any suitable order unless otherwise indicated herein or otherwise clearly contradicted by context. The use of any and all examples, or exemplary language (e.g., “such as”) provided herein is intended merely to better illuminate the disclosure and does not pose a limitation on the scope of the disclosure otherwise claimed. No language in the specification should be construed as indicating any non-claimed element essential to the practice of the disclosure.

An “effective amount” is the amount of the composition necessary to result in a desired physiological change in a plant. Effective amounts are often administered for research purposes. Representative effective amounts disclosed herein can improve or promote plant health, plant growth, or plant root health.

Groupings of alternative elements or embodiments of the disclosure disclosed herein are not to be construed as limitations. Each group member may be referred to and claimed individually or in any combination with other members of the group or other elements found herein. It is anticipated that one or more members of a group may be included in, or deleted from, a group for reasons of convenience and/or patentability. When any such inclusion or deletion occurs, the specification is deemed to contain the group as modified thus fulfilling the written description of all Markush groups used in the appended claims.

Certain embodiments of this disclosure are described herein, including the best mode known to the inventors for carrying out the disclosure. Of course, variations on these described embodiments will become apparent to those of ordinary skill in the art upon reading the foregoing description. The inventor expects skilled artisans to employ such variations as appropriate, and the inventors intend for the disclosure to be practiced otherwise than specifically described herein. Accordingly, this disclosure includes all modifications and equivalents of the subject matter recited in the claims appended hereto as permitted by applicable law. Moreover, any combination of the above-described elements in all possible variations thereof is encompassed by the disclosure unless otherwise indicated herein or otherwise clearly contradicted by context.

Furthermore, numerous references have been made to patents, printed publications, journal articles, and other written text throughout this specification (referenced materials herein). Each of the referenced materials is individually incorporated herein by reference in their entirety for their referenced teaching.

Definitions and explanations used in the present disclosure are meant and intended to be controlling in any future construction unless clearly and unambiguously modified in the examples or when application of the meaning renders any construction meaningless or essentially meaningless. In cases where the construction of the term would render it meaningless or essentially meaningless, the definition should be taken from Webster's Dictionary, 3rd Edition, or a dictionary known to those of ordinary skill in the art, such as the Oxford Dictionary of Biochemistry and Molecular Biology (Ed. Anthony Smith, Oxford University Press, Oxford, 2004).

The Exemplary Embodiments and Examples below are included to demonstrate particular embodiments of the disclosure. Those of ordinary skill in the art should recognize in light of the present disclosure that many changes can be made to the specific embodiments disclosed herein and still obtain a like or similar result without departing from the spirit and scope of the disclosure.

### Exemplary Embodiments

The following are exemplary embodiments:
1. A composition for promoting plant health and growth, the composition comprising: montmorillonite clay (MMT); and an enzyme blend comprising plant growth-promoting fungi (PGPF) and/or plant growth-promoting rhizobacteria (PGPR).
2. The composition of Embodiment 1, wherein the enzyme blend comprises PGPF, and does not comprise PGPR.
3. The composition of Embodiment 1, wherein the enzyme blend comprises both PGPF and PGPR.
4. The composition of Embodiment 1, wherein the enzyme blend comprises PGPR, and does not comprise PGPF.
5. The composition of any of Embodiments 1-4, wherein the enzyme blend further comprises one or more vitamins, minerals, enzymes, and amino acids.
6. The composition of any of Embodiments 1-5, wherein the MMT and enzyme blend are present in a weight ratio of MMT:enzyme blend from 95:5 to 5:95.
7. The composition of any of Embodiments 1-6, wherein the MMT comprises one or more of nitrogen (N), phosphorus (P), potassium K), calcium (Ca), magnesium (Mg), iron (Fe), oxygen (O₂), and additional trace minerals.
8. The composition of any of Embodiments 1-7, wherein the MMT is in the form of a micronized solid.
9. The composition of Embodiment 8, wherein the micronized solid has a mean particle size diameter equal to or less than 40 microns (≤40 μm).
10. The composition of any of Embodiments 1-9, wherein the MMT comprises:
   500-800 ppm of N;
   100-300 ppm of P;
   25,000-35,000 ppm of K;
   16,000-24,000 ppm of Ca;
   4,000-8,000 ppm of Mg;
   11,000-16,000 ppm of Fe; and/or
   400,000-700,000 ppm of O₂.
11. The composition of Embodiment 5, wherein the one or more minerals of the enzyme blend comprise zinc, magnesium, selenium, copper, cobalt, manganese, iron, iodine, phosphorus, sulfur, potassium, and sodium.
12. The composition of Embodiment 11, wherein the amount of the one or more minerals in the enzyme blend by weight in grams per kilogram of the enzyme blend comprises:
   7.0-11.0 g of zinc (Zn);
   5.0-7.0 g of magnesium (Mg);
   0.005-0.015 g of selenium (Se).
   0.8-1.6 g of copper (Cu);
   0.10-0.20 g of cobalt (Co);
   1.0-2.0 g of manganese (Mn);
   1.0-2.0 g of iron (Fe);
   0.25-0.40 g of iodine (I);
   13.0-14.5 g of phosphorus (P)
   0.3-1.1 g of sulfur(S);
   0.05-0.15 g of potassium (K); and/or
   0.002-0.010 g of sodium (Na).
13. The composition of Embodiment 5, wherein the one or more vitamins of the enzyme blend comprise vitamin A, vitamin D₃, and vitamin E.
14. The composition of Embodiment 13, wherein the amount of one or more vitamins in the enzyme blend in international units (iu) per kilogram of the enzyme blend comprises:
   650,000-710,000 international units (iu) of vitamin A;
   80,000-115,00 iu of vitamin D₃; and
   15-350 of vitamin E.
15. The composition of Embodiment 5, wherein the one or more enzymes of the enzyme blend comprise cellulase, hemicellulase, and pectinase.
16. Embodiment 16: The composition of Embodiment 16, wherein the amount of enzymes in the enzyme blend in international units (iu) per kilogram of the blend comprises:
   700-1300 international units (iu) of cellulase;
   700-1300 iu of hemicellulase; and/or
   700-1300 iu of pectinase.
17. The composition of Embodiment 5, wherein the one or more amino acids of the enzyme blend comprise glutamine (Gln), alanine (Ala), threonine (Thr), valine (Val), serine (Ser), proline (Pro), isoleucine (Ile), leucine (Ile), leucine (Leu), histidine (His), phenylalanine (Phe), glutamic acid (Glu), aspartic acid (Asp), cysteine (Cys), tyrosine (Tyr), and tryptophan (Trp).
18. The composition of Embodiment 17, wherein the amount of amino acids in the enzyme blend by weight in milligrams per gram of the enzyme blend comprises:
   40.0-43.0 mg of Gln;
   44.5-47.0 mg of Ala;
   3.0-5.0 mg of Thr;
   2.8-4.0 mg of Val;
   0.3-1.3 mg of Ser;
   0.3-1.3 mg of Pro;
   0.10-1.0 mg of Ile;
   14.5-16.0 mg of Leu;
   0.1-0.5 mg of His;
   0.08-0.6 mg of Phe;
   0.3-1.2 mg of Glu;
   0.2-1.4 mg of Asp;
   0.2-1.2 mg of Cys;
   1.0-2.0 mg of Tyr; and/or
   0.005-0.015 mg of Trp.
19. The composition of Embodiment 15 or 16, wherein the cellulase enzyme is derived from organisms selected from the group consisting of Aspergillus niger, Aspergillus nidulans, and Aspergillus oryzae.
20. The composition of Embodiment 15 or 16, wherein the pectinase enzyme is derived from organisms selected from the group consisting of Aspergillus Niger, Aspergillus awamori, Aspergillus oryzae, Penicillium expansum, Penicillium restrictum, Trichoderma viride, Mucor piriformis, Yarrowia lipolytica, Penicillium janthinellum, Tetracoccosporium sp., Penicillium chrysogenum, Saccharomyces fragilis, Saccharomyces thermantitonum, Torulopsis kefyr, Candida pseudotropicalis var, lactosa, Candida pseudotropicalis, Saccharomyces sp, Cryptococcus sp., Aureobasidium pullulans, Rhodotorula dairenensis, Kluyveromyces marxianus, Geotrichum klebahnii, Wickerhanomyces anomalus, Hanseniaspora sp., Saccharomyces cerevisiae, Rhodotorula dairenensis, Candida zemplinina, Metschnikowia sp., Aureobasidium pullulans, Cryptococcus saitoi, Pseudomonas fluorescens, Bacillus sp., Pseudomonas sp., Micrococcus sp., Bacillus licheniformis, and Brevibacillus borstelensis.
21. The composition of Embodiment 15 or 16, wherein the hemicellulase is derived from saprophytic microbes.
22. The composition of Embodiment 21, wherein the saprophytic microbes comprise members of the Bacillus or Paenibacillus genera.
23. The composition of any of Embodiments 1, 3, and 4-22, wherein the enzyme blend comprises PGPR at a concentration of at least 1×10⁴ to 1×10¹⁰ colony forming units/milliliter (CFU/mL).
24. The composition of any of Embodiments 1-3, and 4-22, wherein the enzyme blend comprises PGPF at an average concentration of about 1×10⁸ CFU/mL.
25. The composition of any of Embodiments 1, 3, and 4-22, wherein the PGPR comprise bacteria selected from the group consisting of Azospirillum, Actinobacter, Alcaligenes, Bacillus, Burkholderia, Buttiauxella, Enterobacter, Klebsiella, Kluyvera, Pseudomonas, Rahnella, Ralstonia, Rhizobium, Serratia, Stenotrophomonas, Paenibacillus, Lysinibacillus, and a combination thereof.
26. The composition of Embodiment 25, wherein the PGPR comprise Azospirillum and/or Bacillus.
27. the composition of Embodiment 25 or 26, wherein the PGPR comprise Bacillus subtilis.
28. The composition of any of Embodiments 1-3, and 4-22, wherein the PGPF comprise fungi selected from the group consisting of Aspergillus, Fusarium, Penicillium, Phoma, and Trichoderma.
29. The composition of Embodiment 28, wherein the PGPF comprise Aspergillus.
30. The composition of Embodiment 28 or 29, wherein the PGPF comprise Aspergillus oryzae.
31. The composition of any of Embodiments 1-3, 4-22, and 28-30, wherein the PGPF comprise Aspergillus oryzae and the PGPR comprise Bacillus subtilis.
32. The composition of any of Embodiments 1-31 in the form of a solid or liquid.
33. The composition of Embodiment 32, wherein the solid is in the form of a powder.
34. The composition of Embodiment 32, wherein the solid is in the form of a tablet, capsule, or gel.
35. A method for promoting plant health or plant growth, or for improving the root health of a plant, wherein the method comprises administering an effective amount of a composition of any of Embodiments 1-34 to a plant.
36. The method of Embodiment 35, wherein the composition is administered to the root of the plant, seeds of the plant, leaves of the plant, or soil surrounding the plant.
37. The method of Embodiment 35 or 36, wherein the composition is in the form of a solid or liquid.
38. The method of Embodiment 37, wherein the solid is in the form of a powder.
39. The composition of Embodiment 37, wherein the solid is in the form of a tablet, capsule, or gel.
40. The method of Embodiment 36, wherein the composition is applied primarily in the form of a liquid composition, and optionally wherein the liquid composition is prepared by dissolving a solid form of the composition with water.
41. The method of Embodiment 38, wherein the composition is administered to the plant by dusting using a strainer.
42. The method of Embodiment 38, wherein the method comprises blending the composition of any of claims 1-34 into the soil used for growing the plant.

### Examples

### Example 1: Enzyme Blend Comprising Both PGPF and PGPR

An enzyme blend comprising both PGPF (with Aspergillus oryzae) and PGPR (with Bacillus subtilis) can be obtained commercially (from Specialty Enzymes & Probiotics; Chino, California; website: www.SpecialtyEnzymes.com) under the name “AgroSEB PB™”.

AgroSEB PB™ contains a mixture of AgroSEB™, and SEBtilis™, both described herein. This product (AgroSEB PB™) is standardized in a base of maltodextrin (from corn). Some exemplary parameters are described in Table 6 below.

TABLE 6
AgroSEB PB ™

| | | |
|---|---|---|
| PARAMETER | SPECIFICATION | TEST METHOD |

IDENTIFICATION

| | | |
|---|---|---|
| FTIR Spectral Match | ≥90% Spectral Correlation | FTIR (In-House) |

PHYSICAL PROPERTIES

| | | |
|---|---|---|
| Appearance | Off-white to Tan | Organoleptic |
| Moisture Content | Powder <10.0% | Thermogravimetric |

| | |
|---|---|
| PARAMETER | SPECIFICATION |

GENERAL

| | |
|---|---|
| Storage | Cool, dry environment, away from direct |
| | sunlight (optimal storage in closed |
| | containers at or below 10° C. under |
| | low relative humidity). |
| Expiration | 24 months from the date of manufacture |
| | under the recommended storage conditions. |

Spectral identity, probiotic potencies, and activities are measured at the time of manufacture.

Enzyme activity may vary within 15% of the specified value as per FCC Enzyme Preparations Monograph: p. 413-415, 11th Ed., 2016

Test methods are subject to change based on methodology and technology improvements.

### Example 2: Preparing the Composition Comprising MMT and the Enzyme Blend Comprising PGPF

The composition comprises a mixture of MMT and the enzyme blend comprising PGPF (with Aspergillus oryzae). The enzyme blend comprising PGPF comes directly from an outsider manufacturer who specializes in enzyme and probiotic blends that are food grade (viz., Specialty Enzymes & Probiotics, Chino, California); website: www.SpecialtyEnzymes.com). The MMT is the agricultural grade at the site of the quarry. From the quarry, the MMT is moved to a secondary processing facility where it is micronized at 40 micrometers or less (≤40 μm; average/mean particle size diameter). The micronization is done in a vortex chamber using compressed air and resonating frequencies for pulverization where the MMT becomes a dry powder with 97% of the particles having an average diameter of 40 micrometers or less. Once the micronization process is complete, the MMT is transported to another facility (mixing facility) where the mixing of the micronized MMT and the enzyme blend comprising PGPF takes place.

To prepare one hundred (100) pound batches of the target (MMT+enzyme blend comprising PGPF) composition, eighty-eight (88) pounds of micronized MMT, and twelve (12) pounds of the enzyme blend with PGPF are used. The enzyme blend comprising PGPF (with Aspergillus oryzae) (available under the name “AgroSEB™”) is available and can be purchased directly from a manufacturer who specializes in enzyme and probiotic blends that are food grad (Specialty Enzymes & Probiotics; SpecialtyEnzymes.com; Chino, California). These ratio contents are added to a food-grade ribbon mixer in the mixing facility. Both the facility and ribbon mixer are sanitized after each production run.

### Example 3: Composition in Liquid Form

Two (2) teaspoons (approximately 6 grams) of the composition of Example 2 are mixed with a gallon of water. The mixture can be applied to a plant in a foliar method or poured directly on the soil. For optimal results, it is applied to the soil, plant leaves, and/or root base every 2 weeks or as needed. The mixture with water can cover an area of approximately 600 square feet.

### Example 4: Composition in Powder Form

The composition as prepared by the method of Example 2 in the form of a powder is sprinkled lightly on the soil root base. The composition can be applied with a strainer. The composition as prepared by the method of Example 2 is blended in the soil for growing the plant before the plant or the seed of a plant is placed in the soil.

### Example 5: Composition for Winter Application

When preparing the soil for rest, the composition as prepared in Example 2 is blended into the soil.

### Example 6: Uses of the Composition to Promote Growth of Plants

A series of experiments are conducted using the composition described herein (MMT+PGPF; MMT+PGPF+PGPR; or MMT+PGPR) on plants to increase their biomass, quantity, and quality of crop output. The information or data collected from these experiments are compared with corresponding plants that are not administered the composition. The experiments include a few plants, for example, three fruit plants and three vegetable plants using the present composition, and three fruit plants and three vegetable plants not using the present composition. The three fruit plants and three vegetable plants are of the same species for both using the present composition and not using the present composition.

Data was collected to show that the present composition helps to create microbial growth in soil. These tests are conducted using an XSZ-107T microscope, with a binocular configuration, and capturing the images of all observations. These images are then sent to an accredited laboratory for verification of changes to the soil and the crop output.

### Example 7: Improved Growth of Plants and Vegetation with the Composition

### Example 7A: Grass on the Lawn

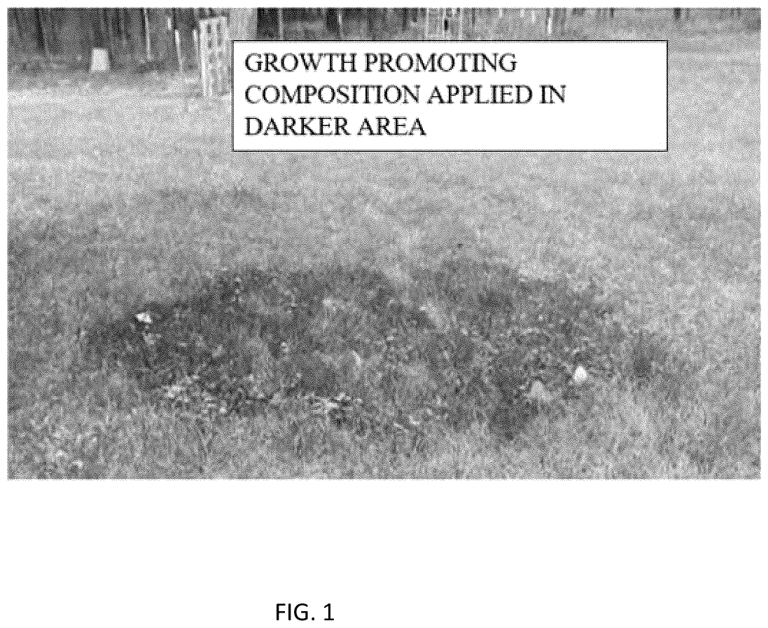

The composition as prepared in Example 1 was applied as a powder form to a small area of grass on a lawn. The application was done by using bare soil with grass seeds. The growth was documented from April through October of the following year with approximately a total of 17 months of observation time. The lawn outside this area serves as a control for comparison of the growth of the grass without the application of the composition described herein. FIG. 1 shows the results of using the present growth-promoting composition on grass. A thick, darker lush green, healthy grass was seen to be growing in the area where the composition was applied.

### Example 7B: Bell Pepper Plants

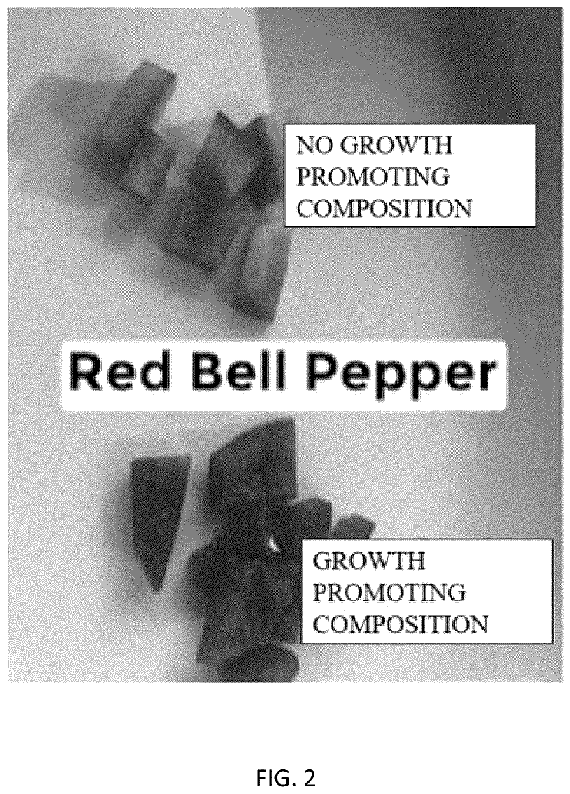

The composition as prepared in Example 1 was applied as a powder form to the root of or the soil around a bell pepper plant. The bell pepper plant was in a bed of about 40 sq. feet with other types of plants. There was a total of about 10-12 plants in this bed, and the composition (about 1 ounce/28 grams) was applied once every 3-4 weeks for a total of two applications in about 7-8 weeks, after which the bell peppers were harvested. A bell pepper plant grown at the same time and in the same season, but without application of the composition of Example 1, was used as the control. FIG. 2 shows the effect of the composition of Example 1 on the cultivation of red bell peppers. The red bell peppers harvested from the plant treated with the composition have a darker red color and appear more succulent.

### Example 8

Five formulations: MMT; PGPF-PGPR; Formula A; Formula B; and Soil (alone); were prepared in the following manner.

MMT and PGPF-PGPR were prepared as described in Examples 2 and 1, respectively. Formula A includes MMT, PGPR, and PGPF. Formula B comprises of MMT and PGPF (and soil). The Soil is plain soil without additives and free from compost and other enhancers. All experimental groups including the MMT formulation and PGPF-PGPF formulation used this soil. Formula B and Formula A were applied to the soil every two weeks from May through August. All groups used the same soil, had the same species of fruits and vegetables, and were planted in the same type and size of pots. They were also watered at the same times every day with the same amount of water from the same source. The water came from a natural spring that is purified via a sand filter. The watering was done at 6 AM (PST) and 6 PM (PST). The watering duration lasted 10 minutes per watering cycle. All 5 groups were planted in the same vicinity as one another and received similar amounts of sunlight.

### Example 9: Radishes

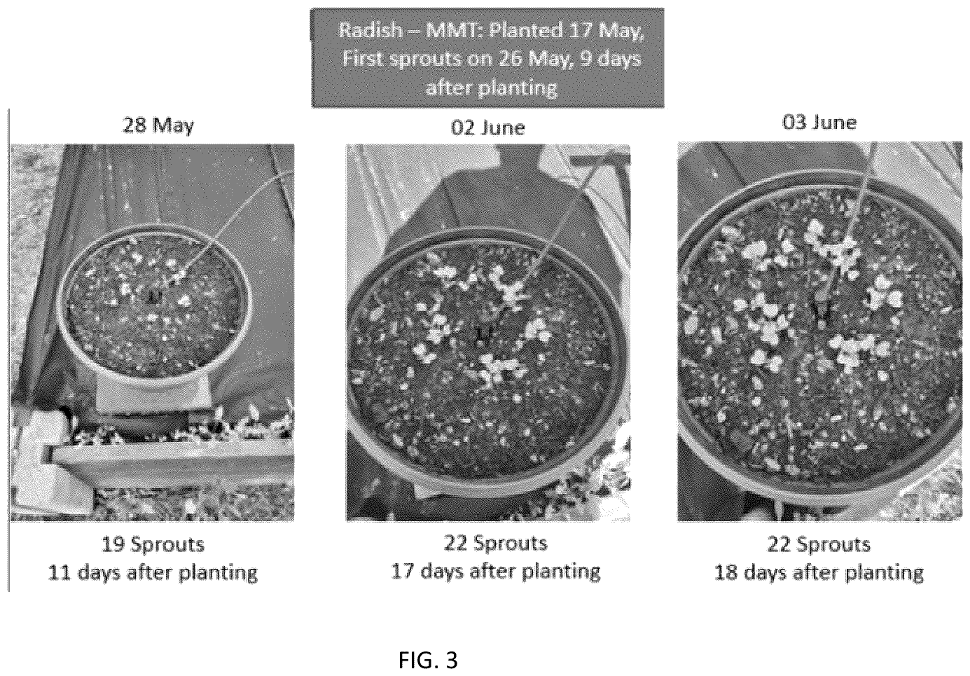

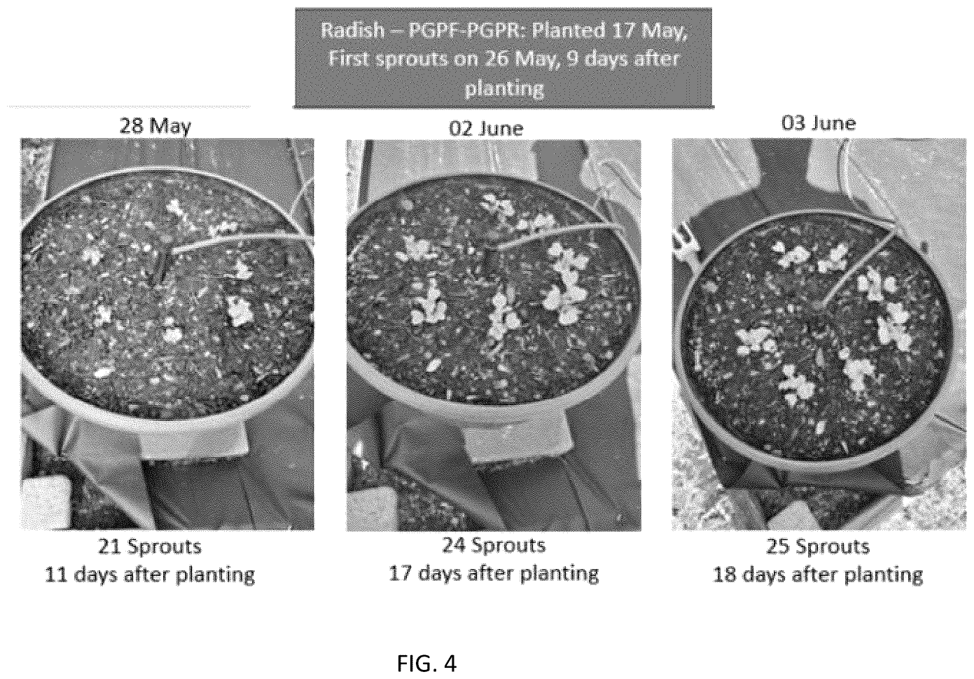

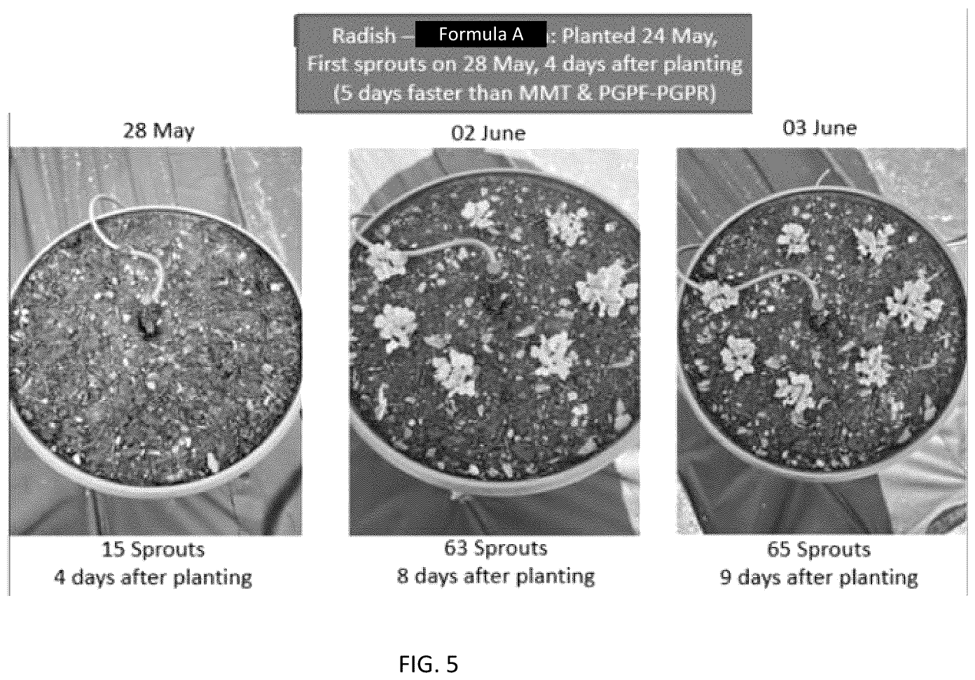

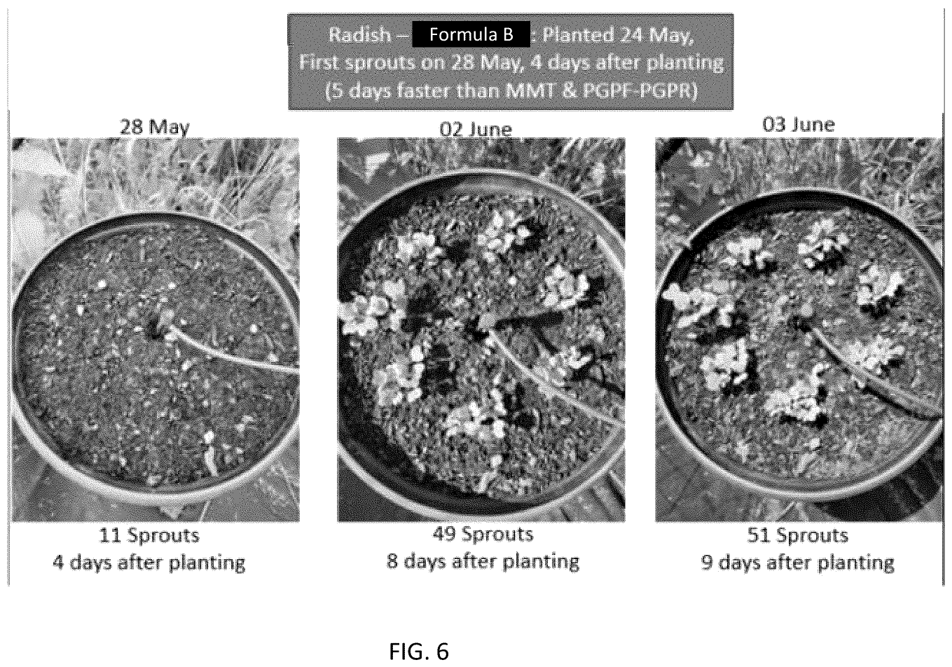

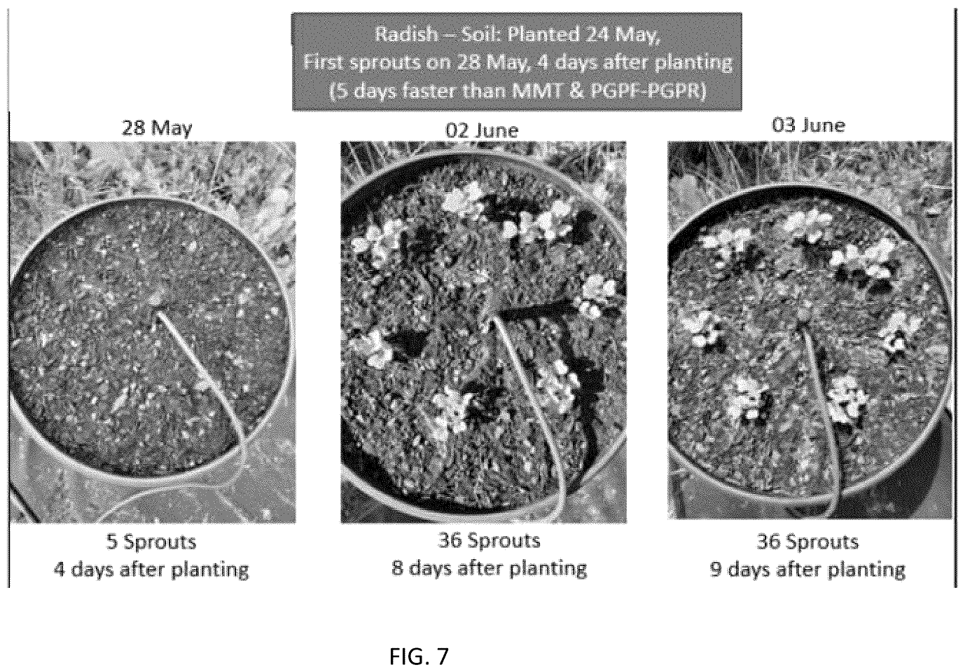

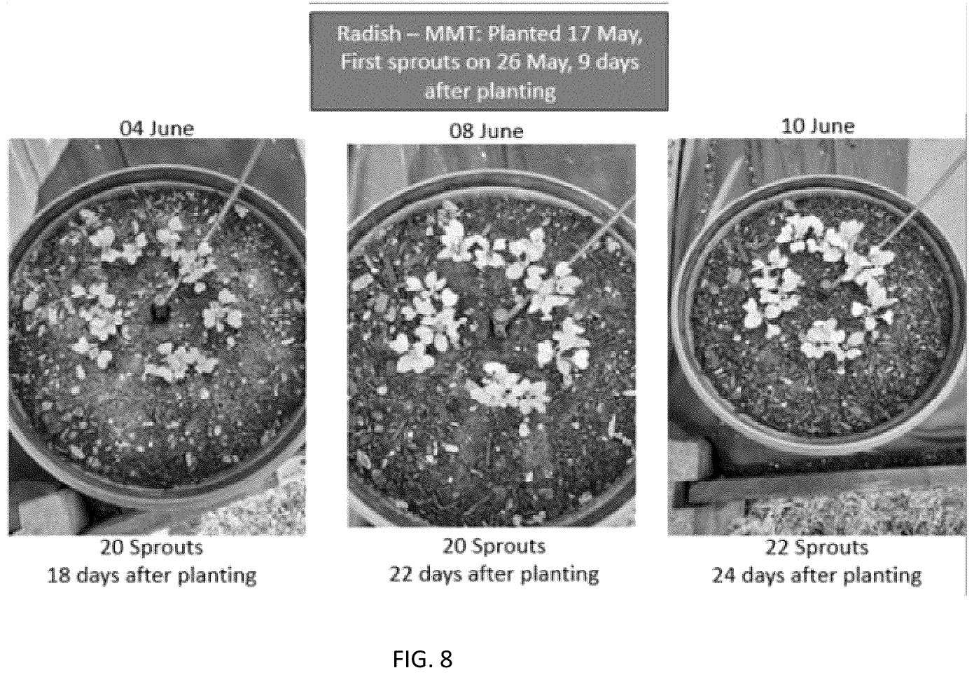

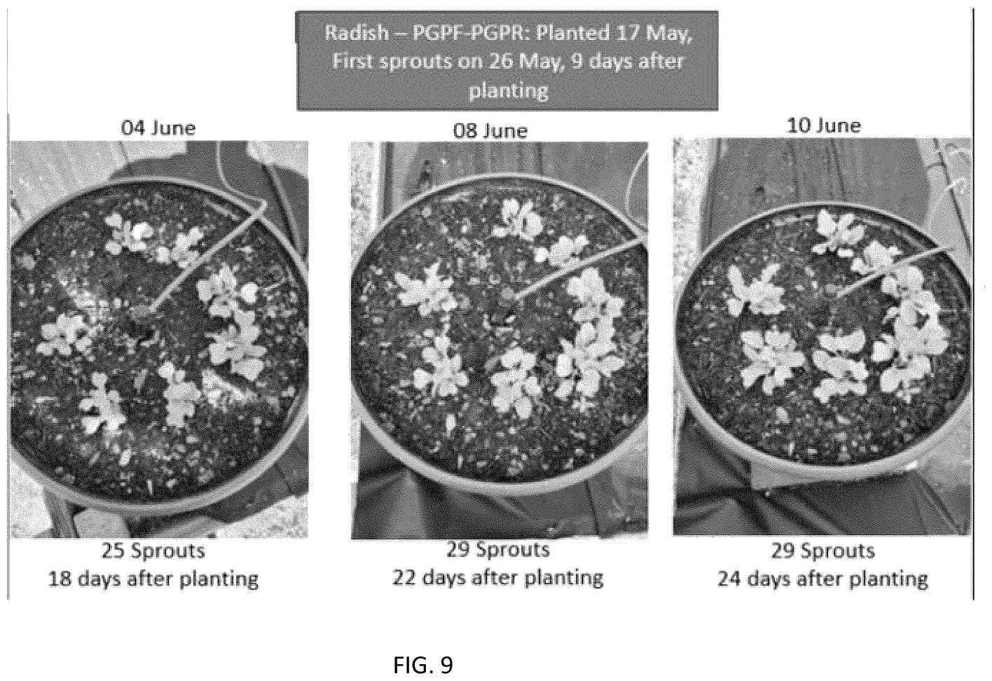

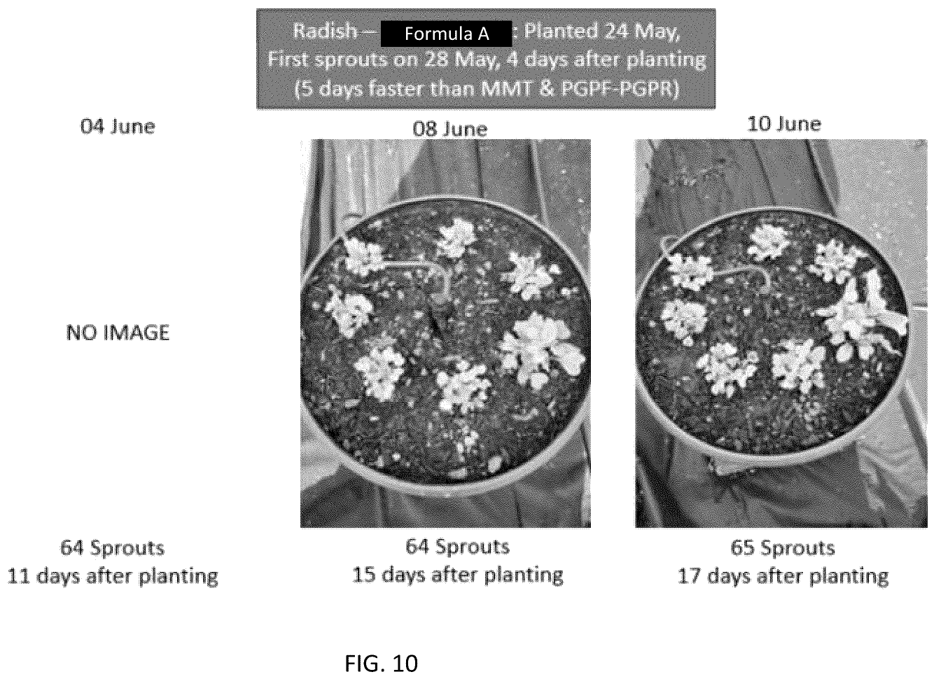

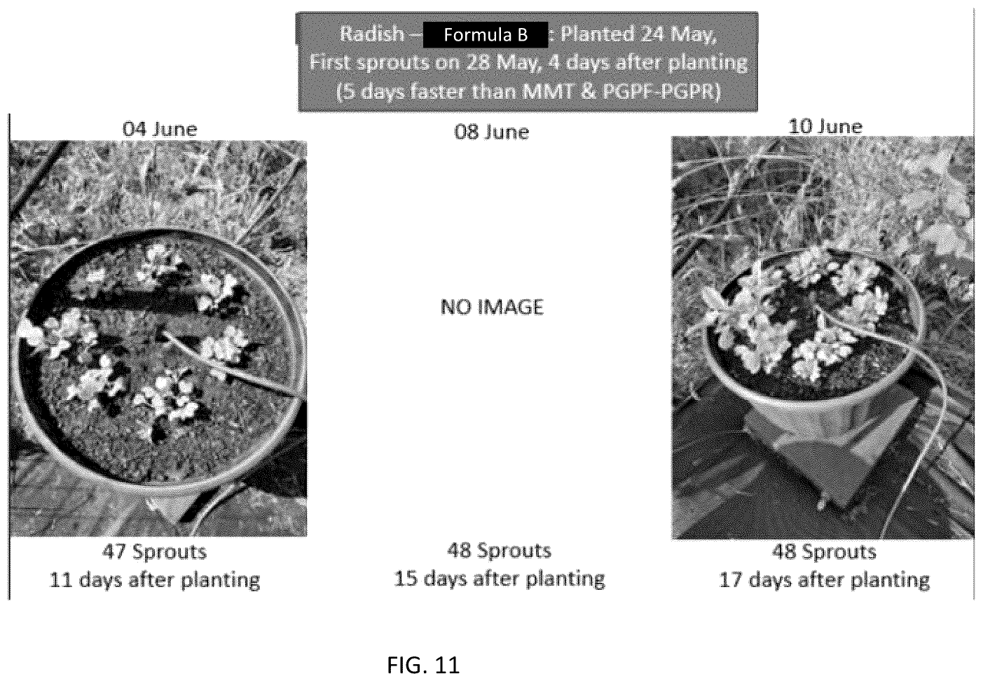

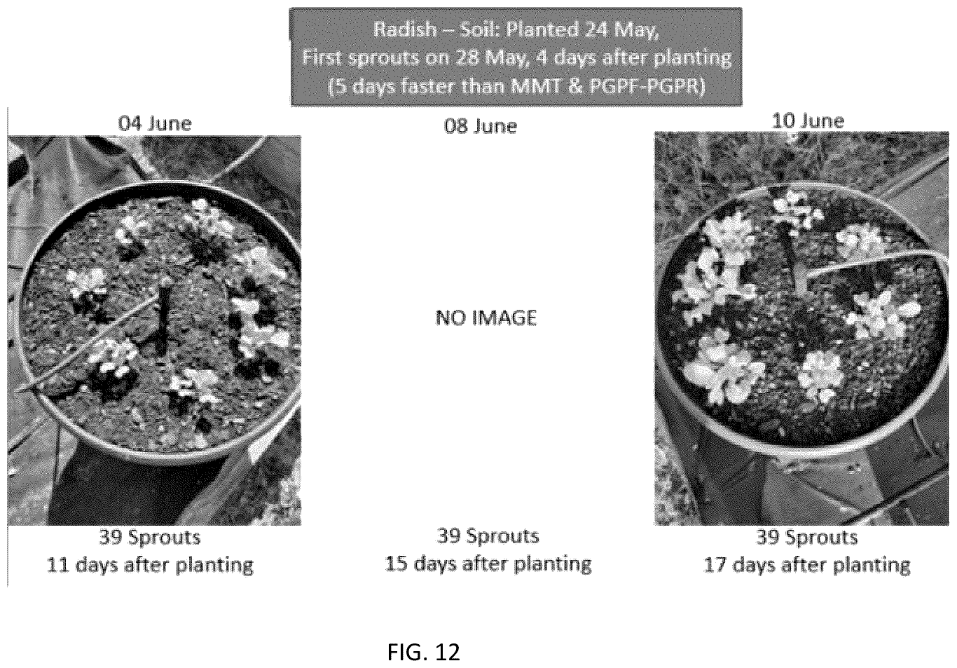

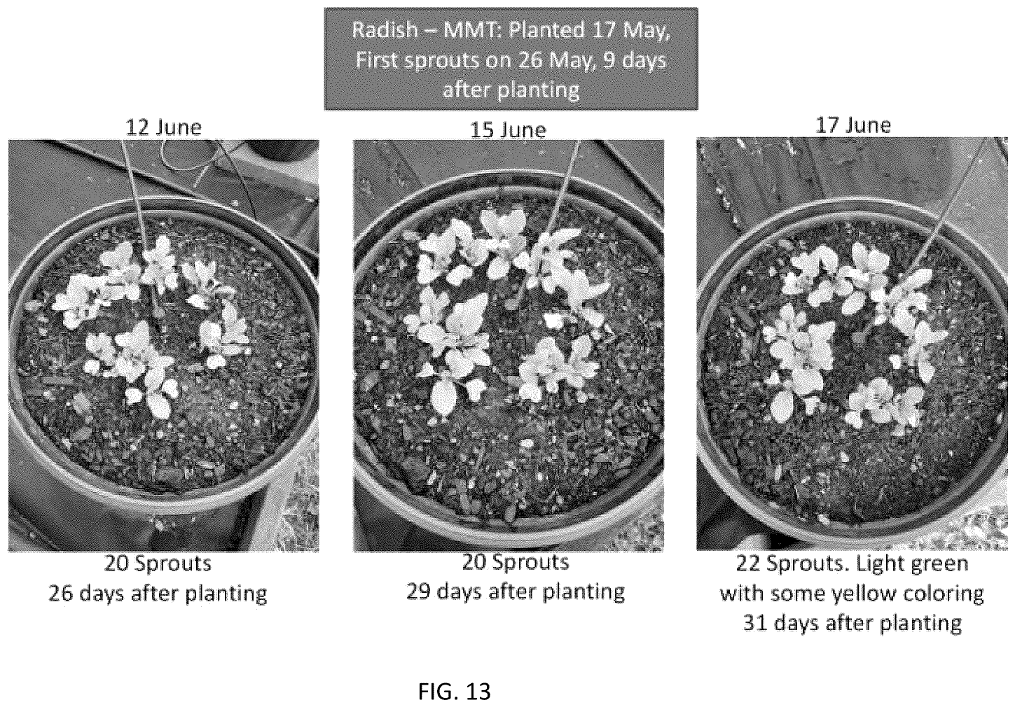

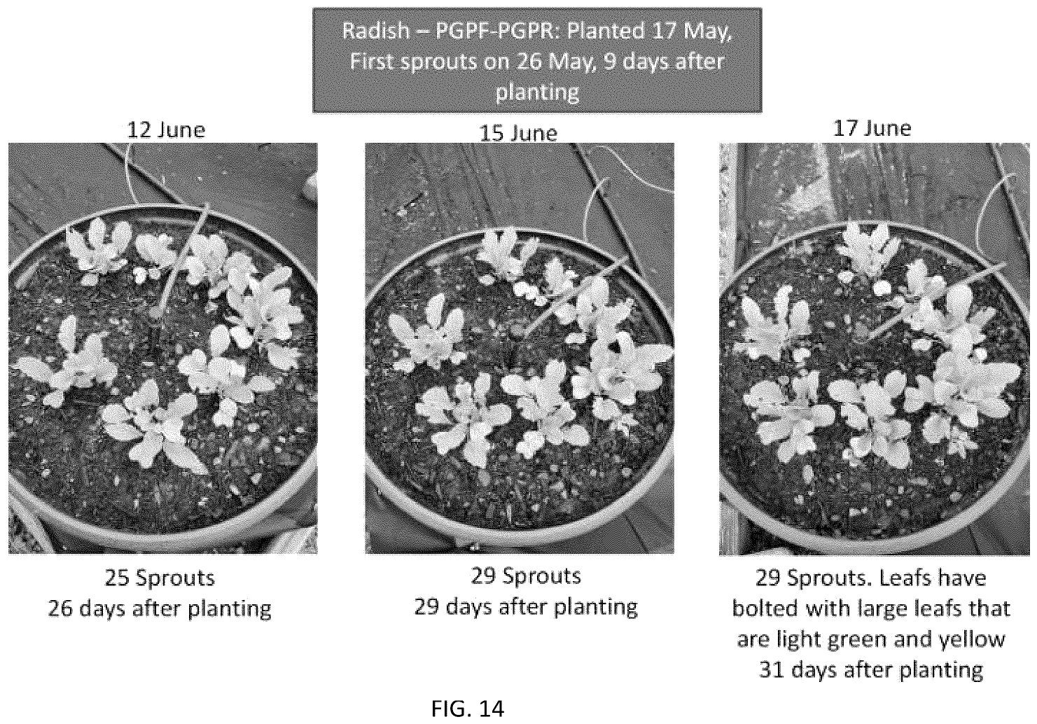

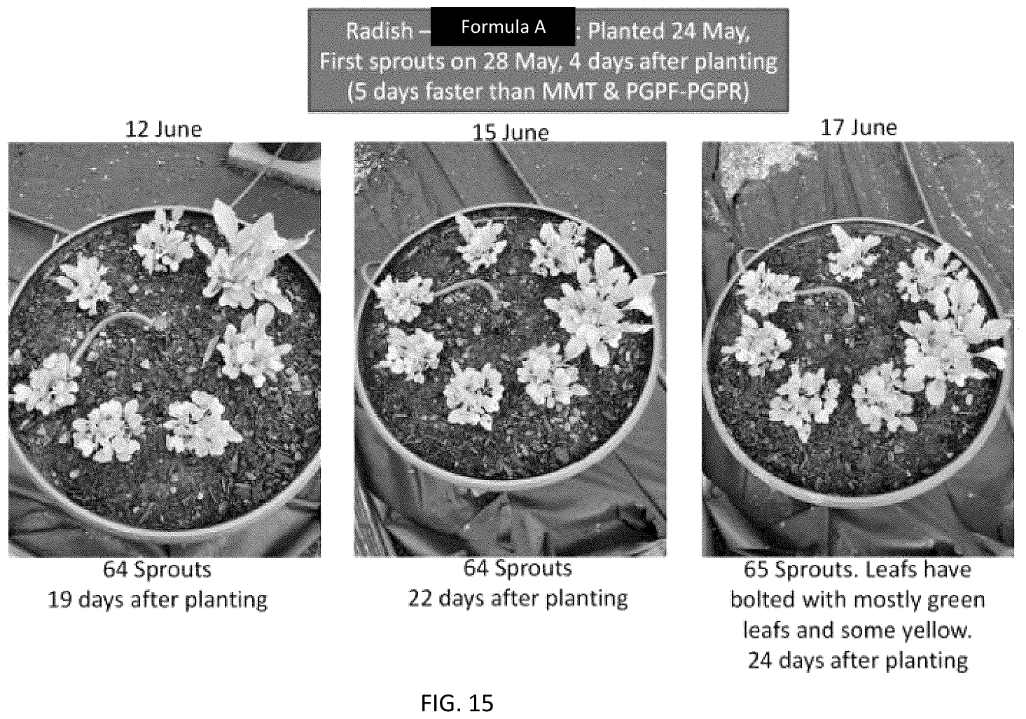

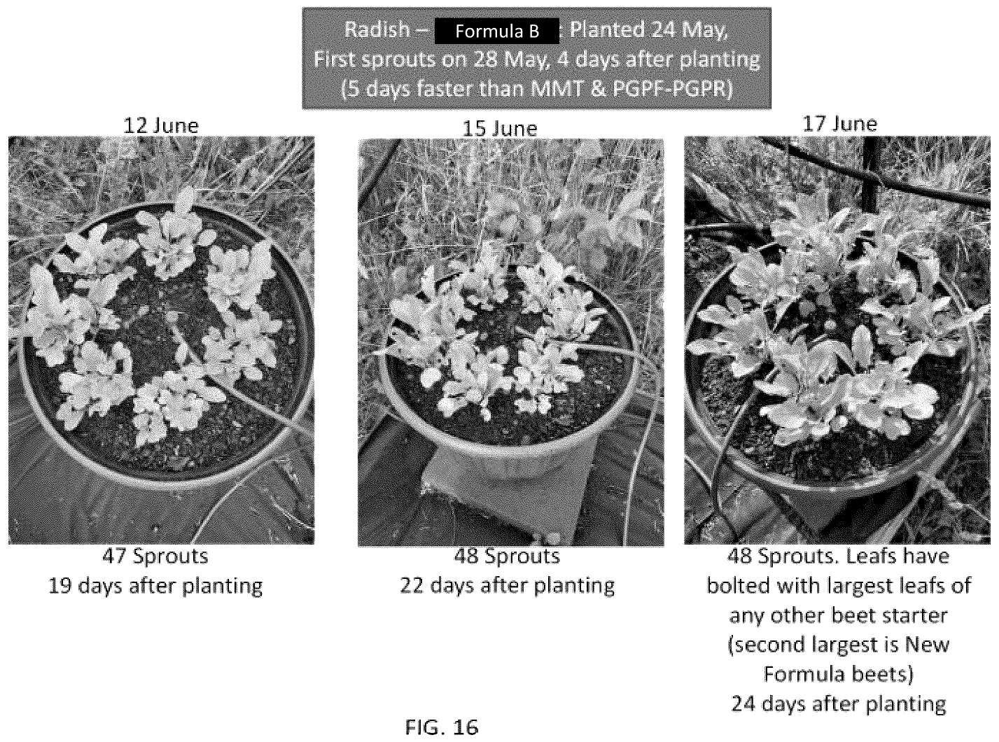

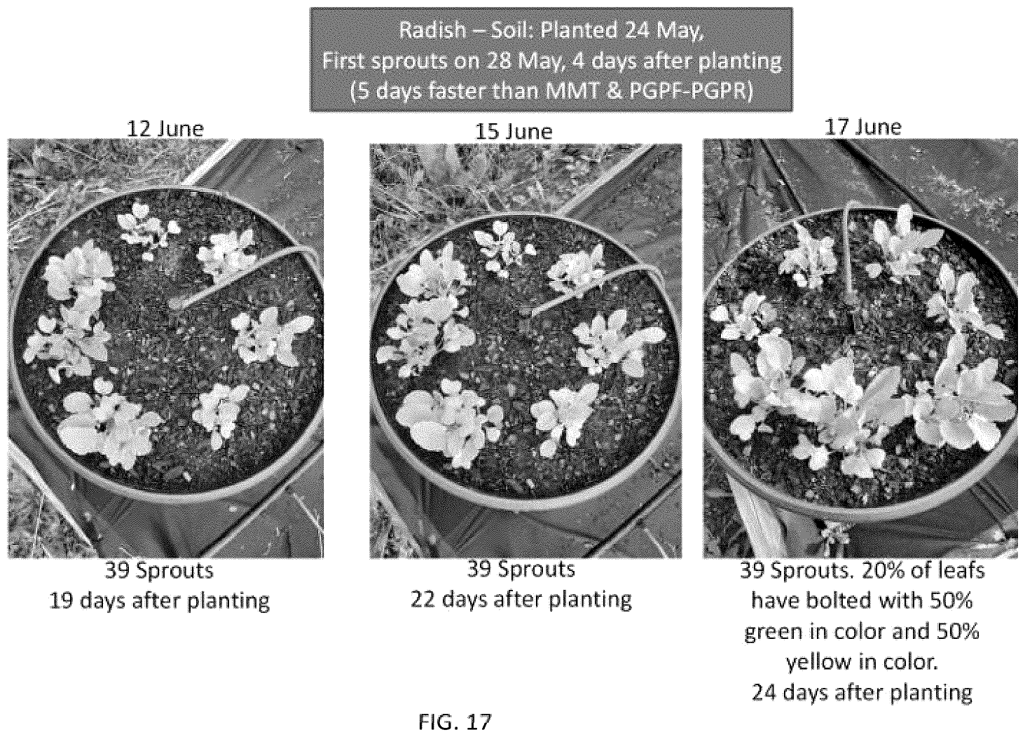

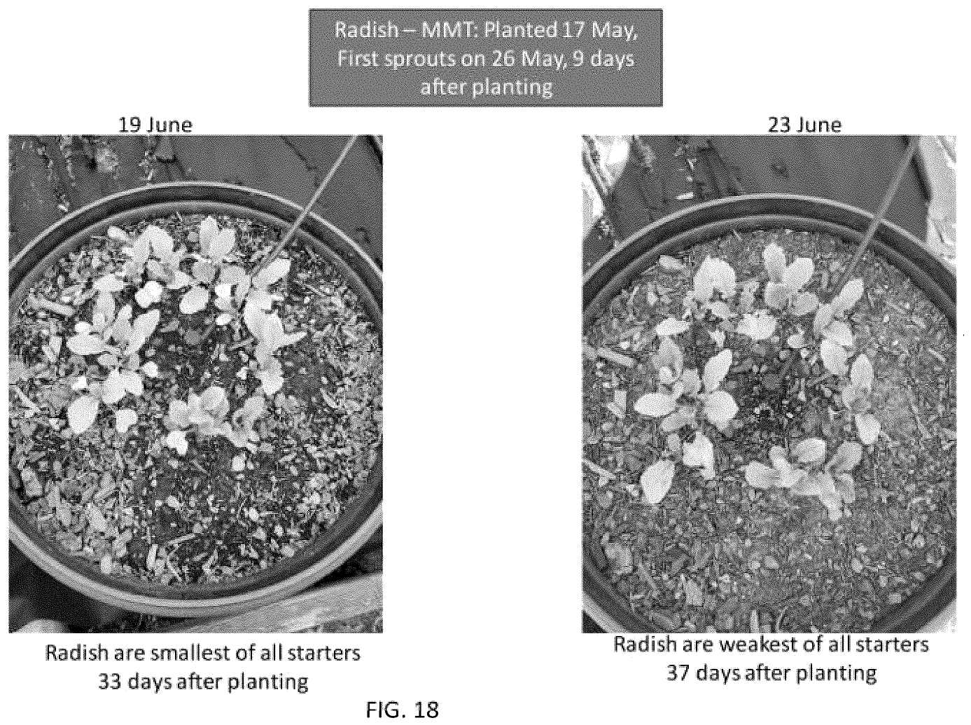

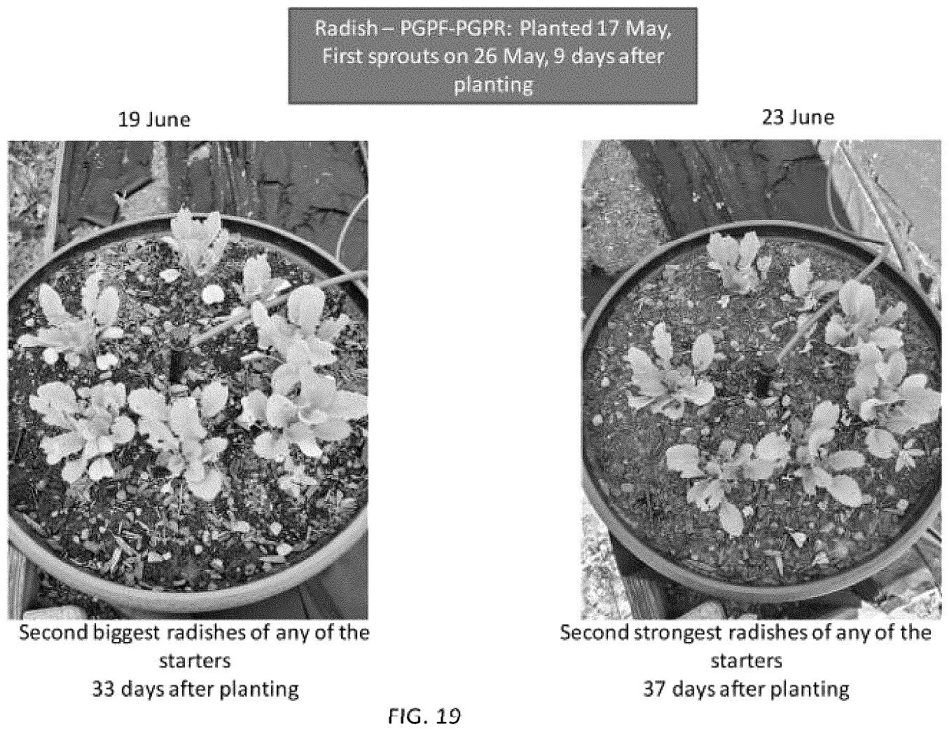

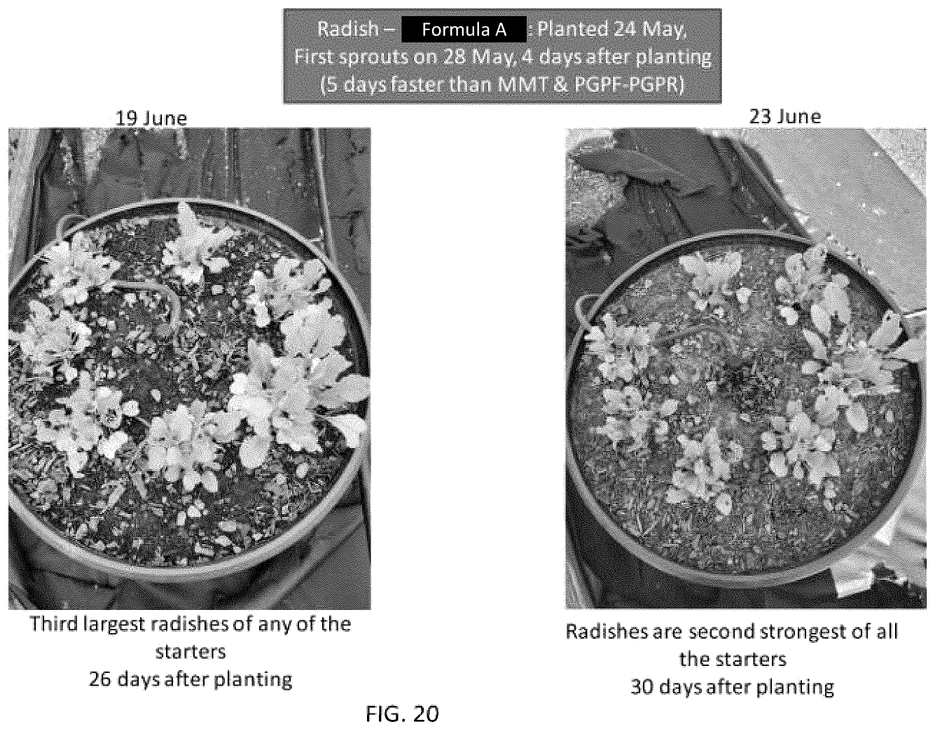

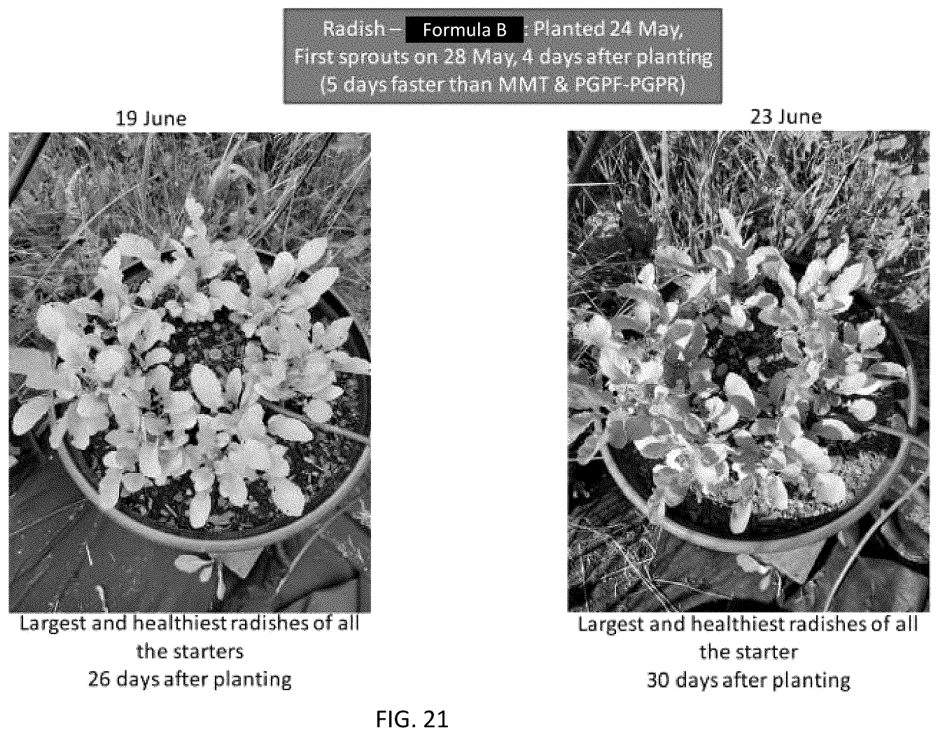

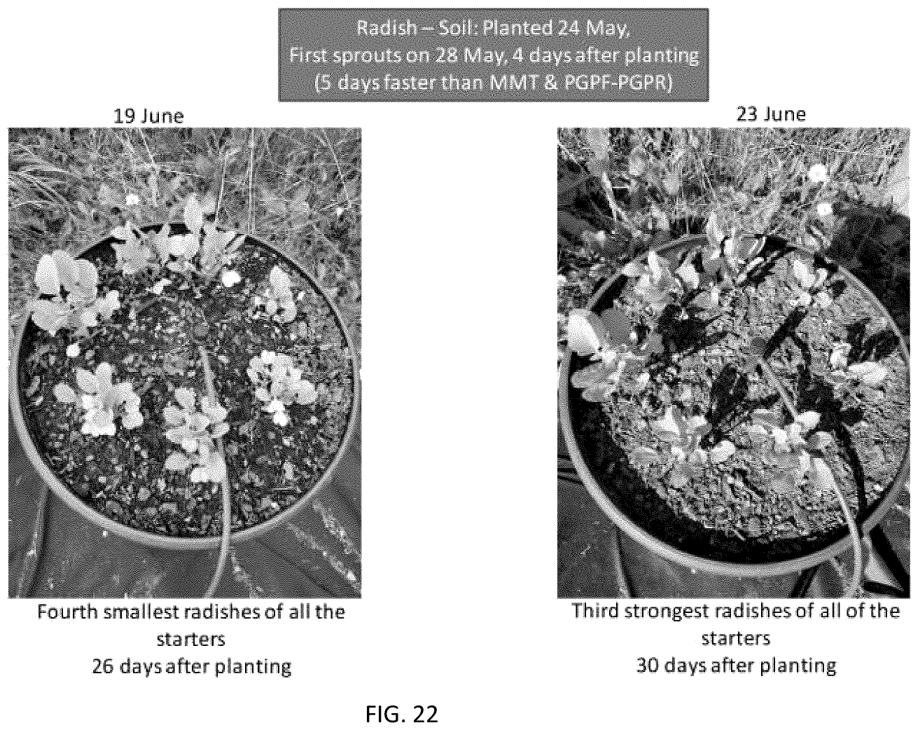

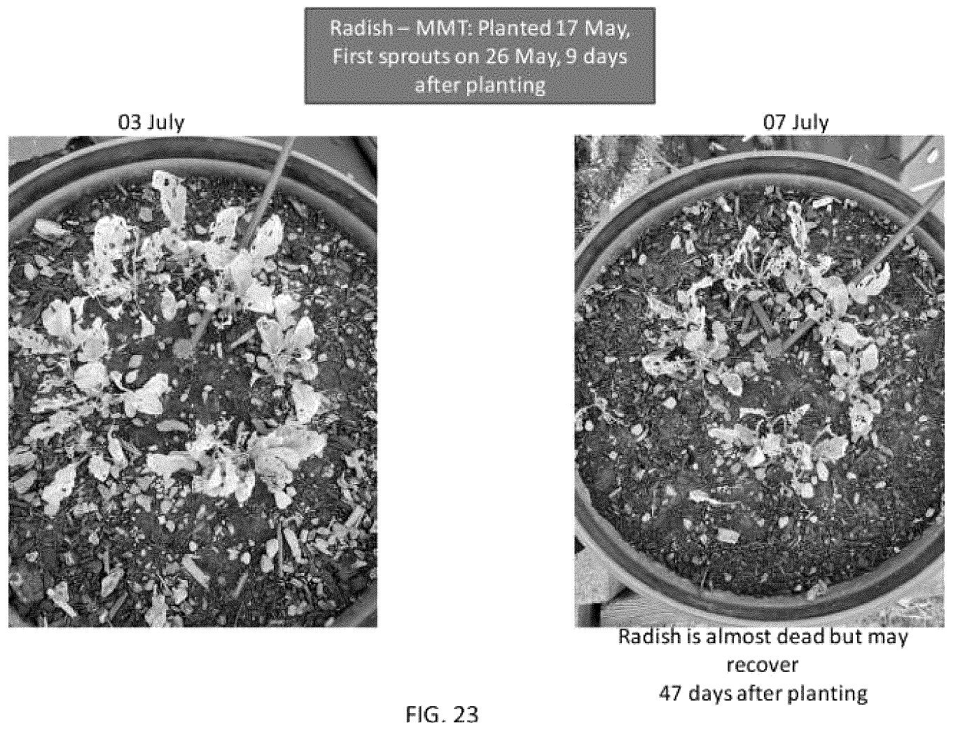

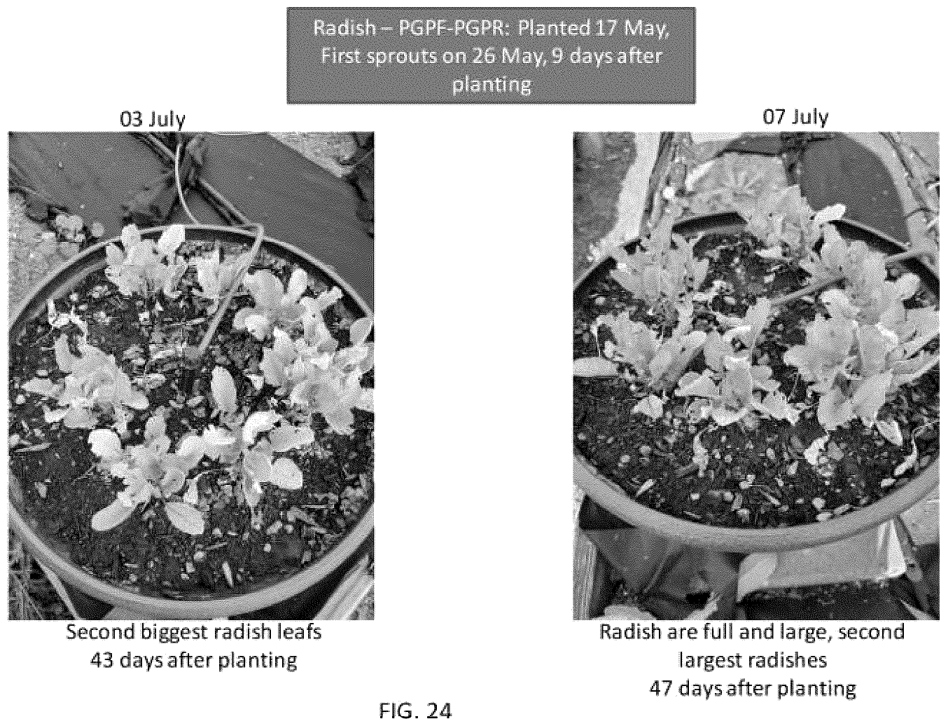

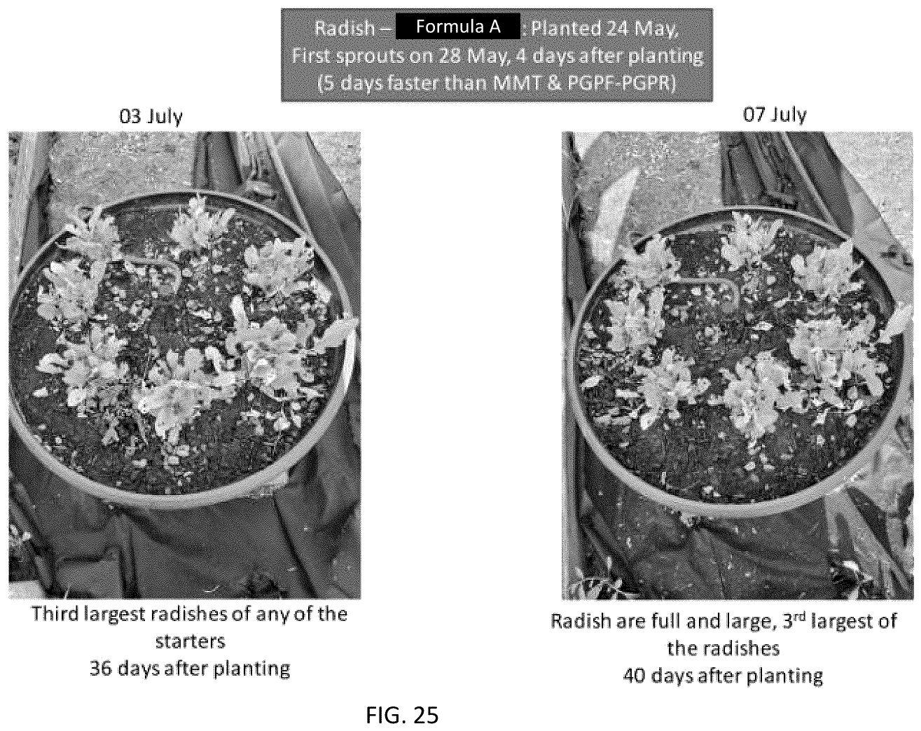

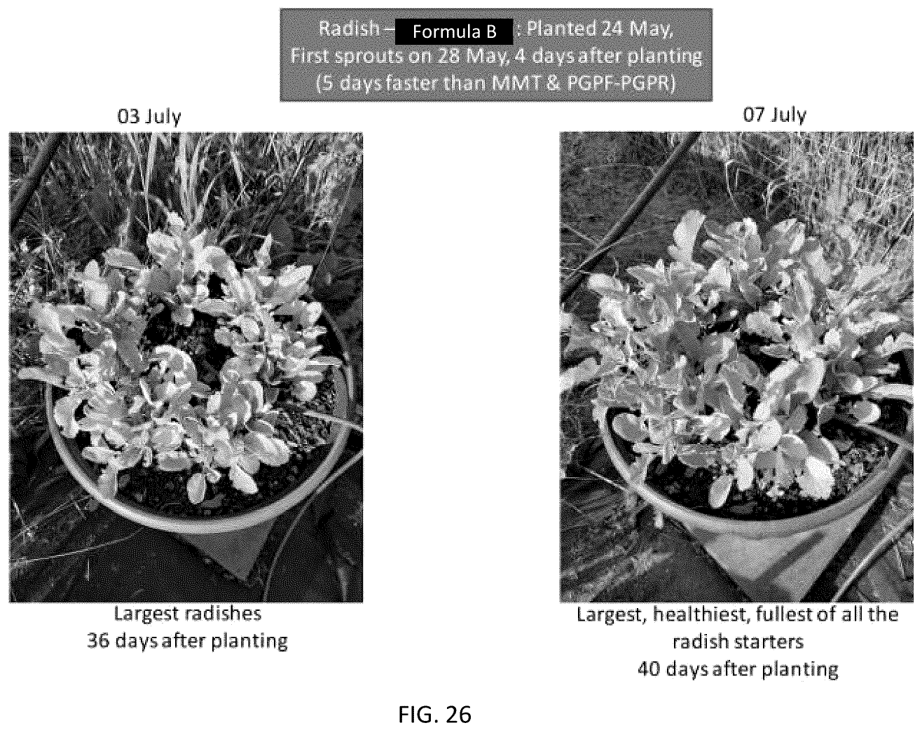

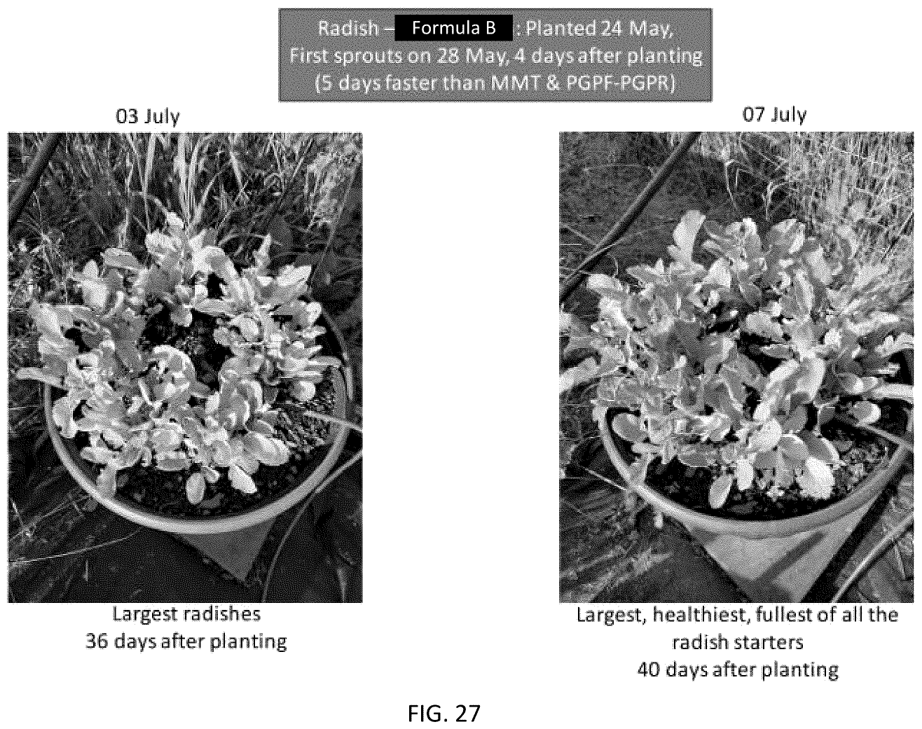

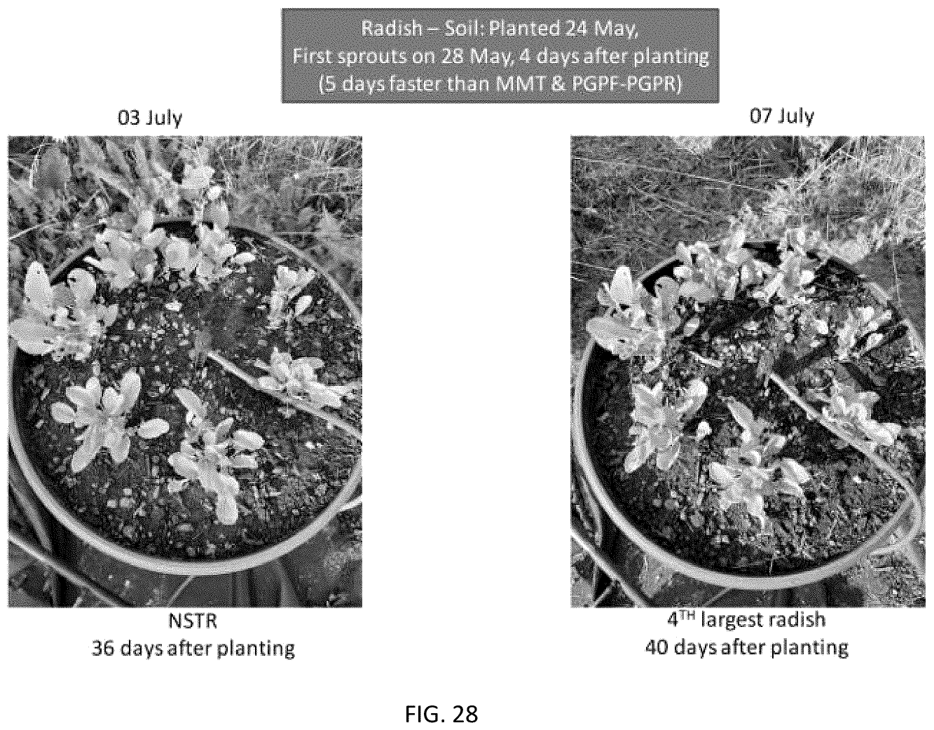

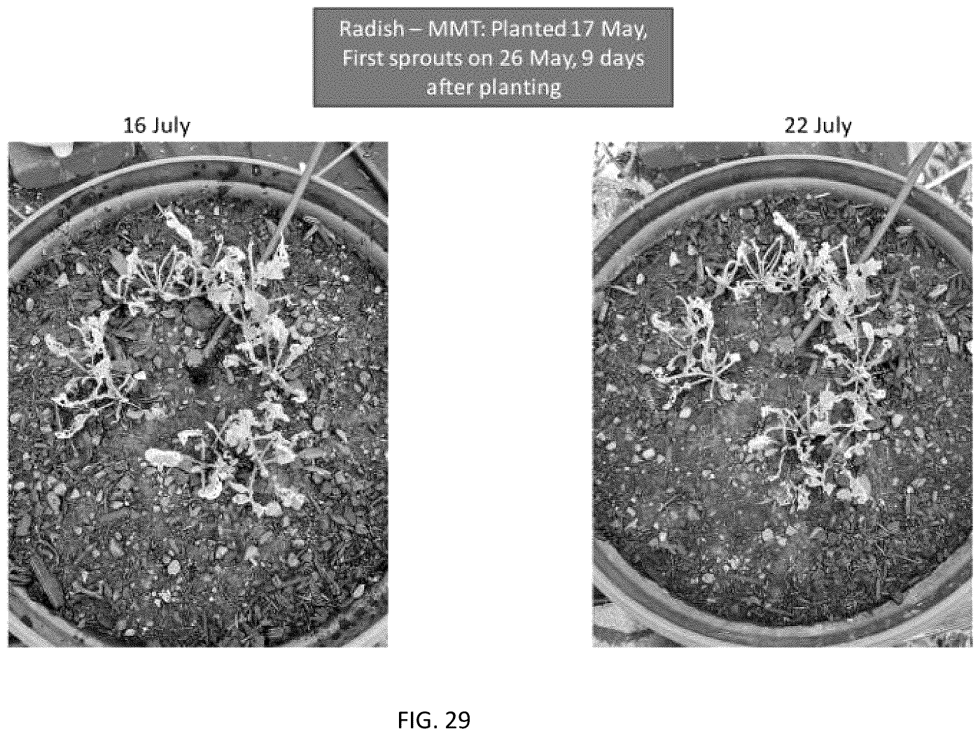

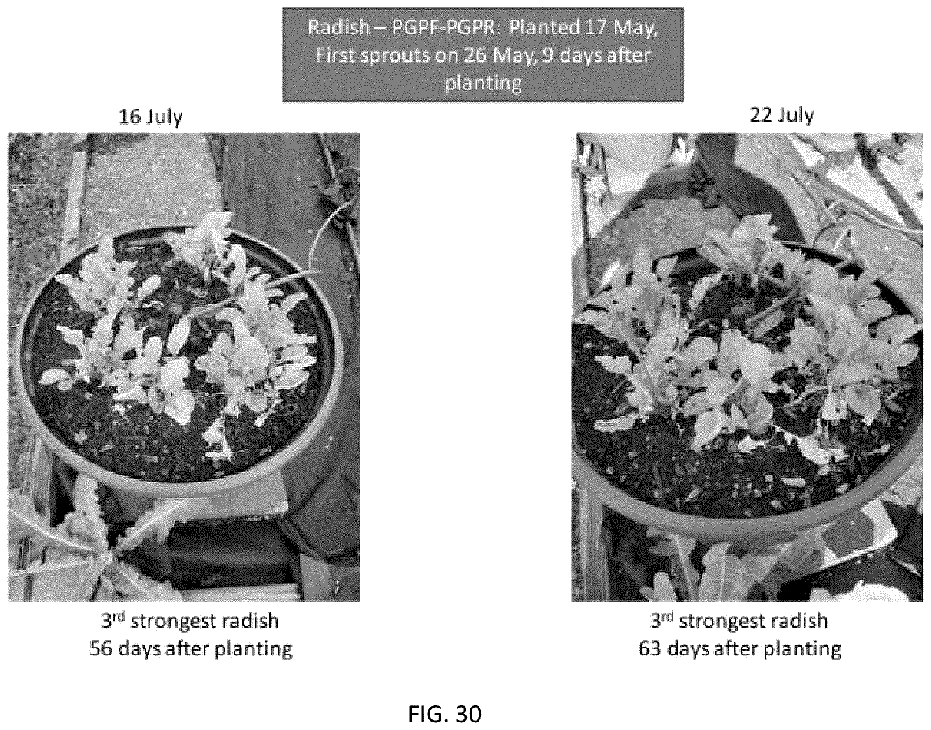

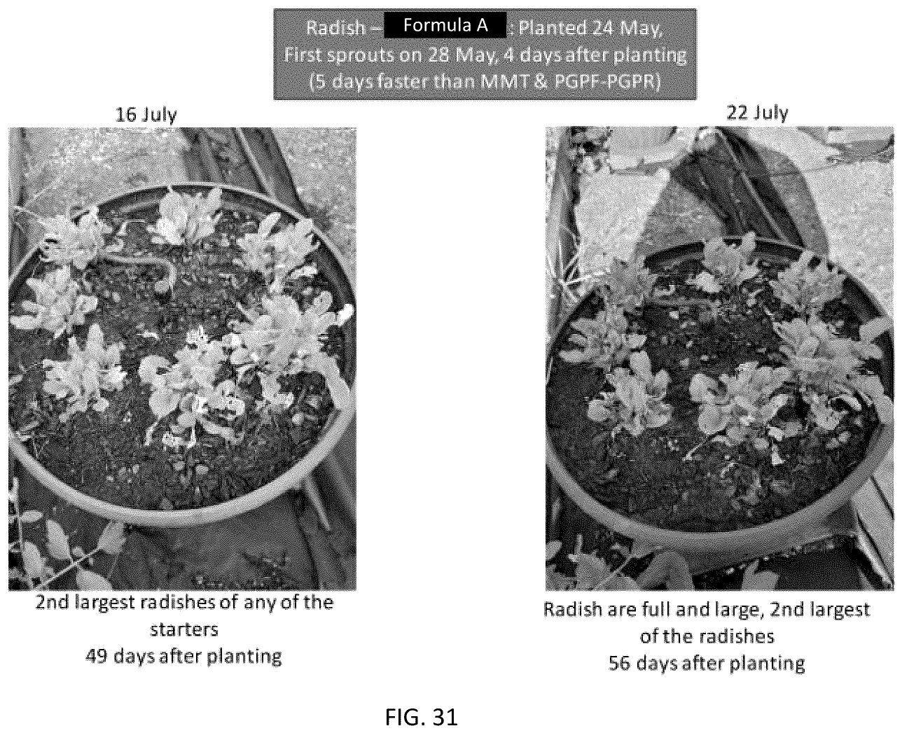

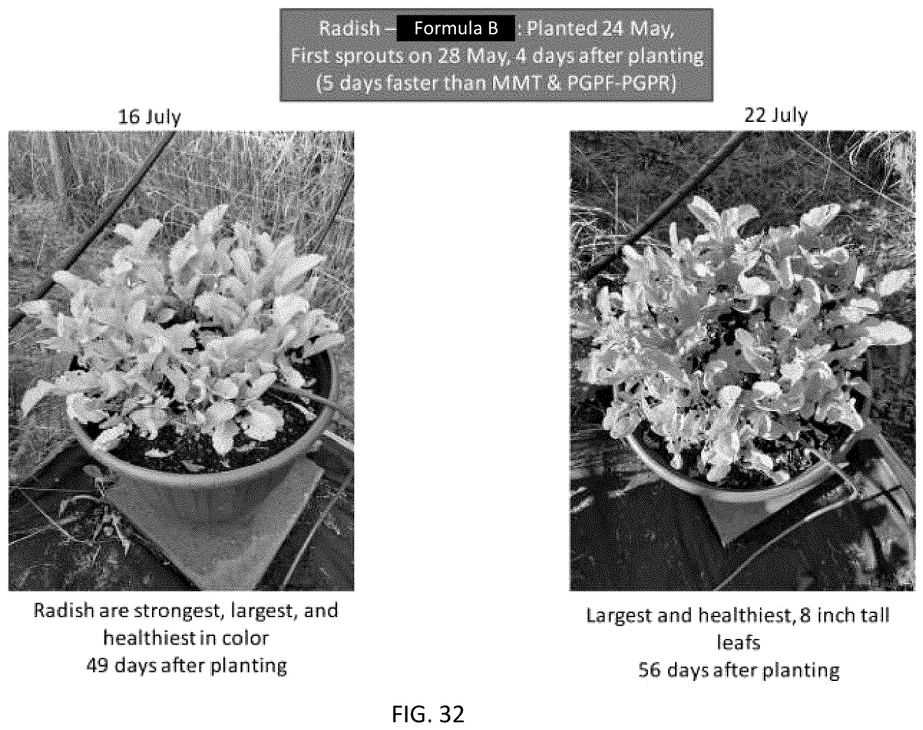

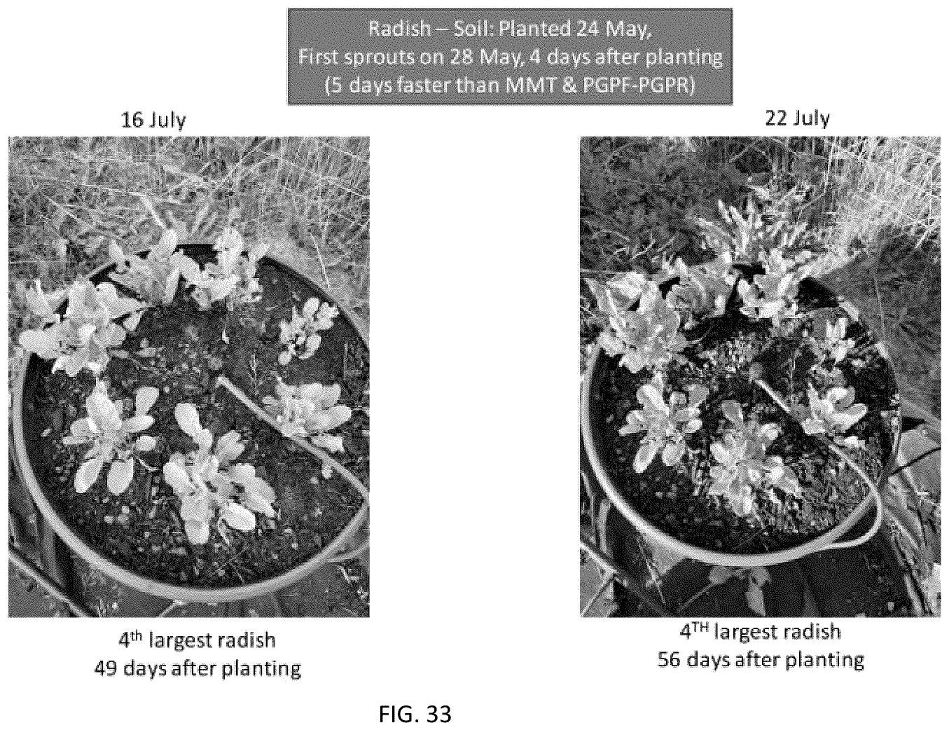

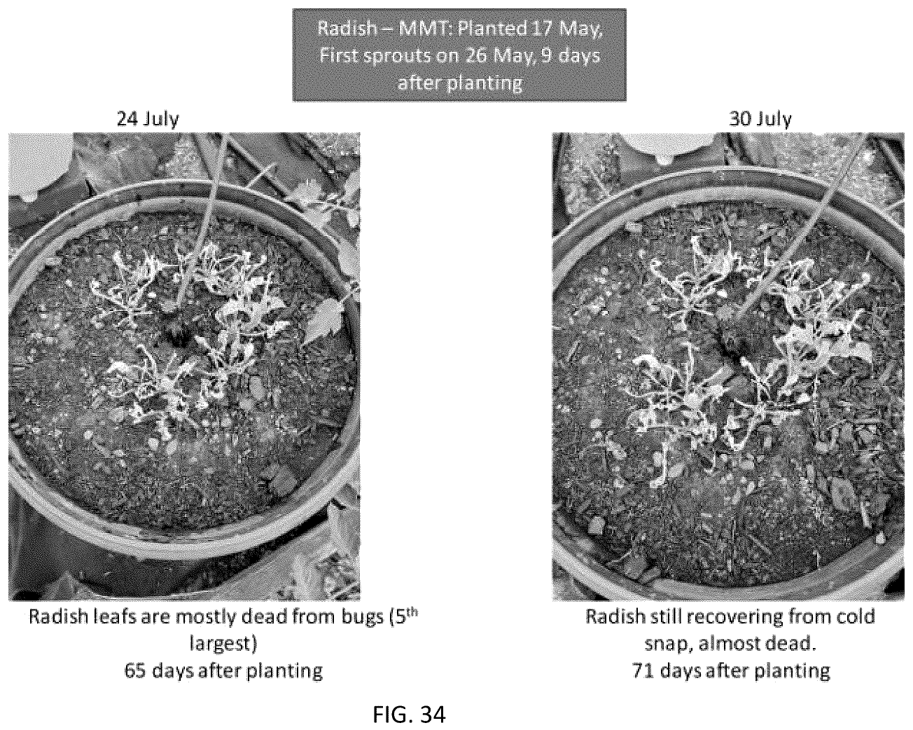

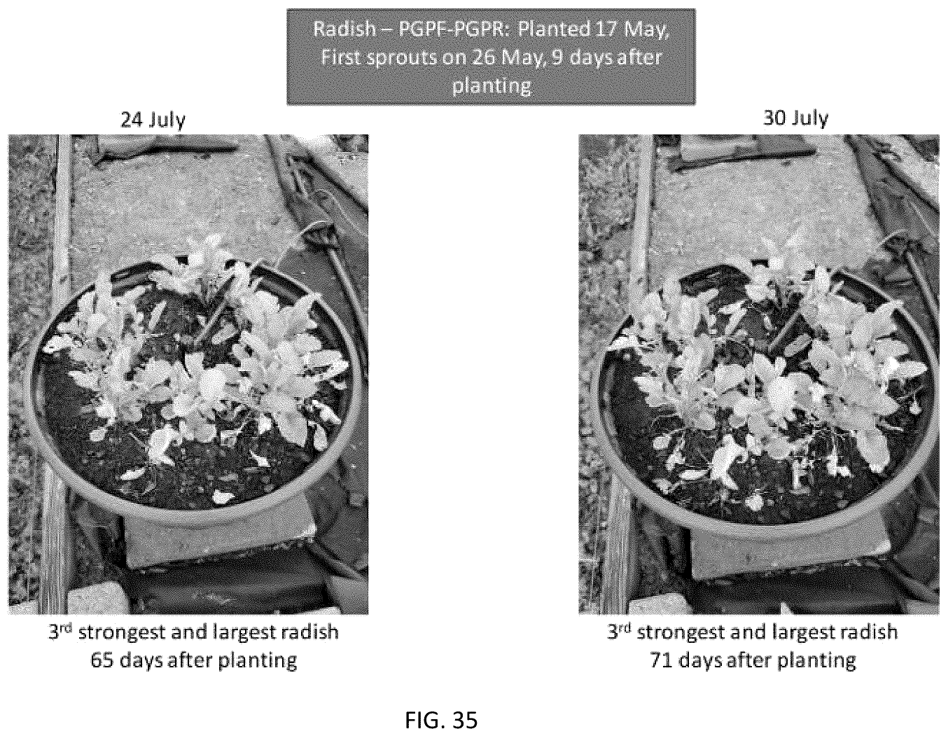

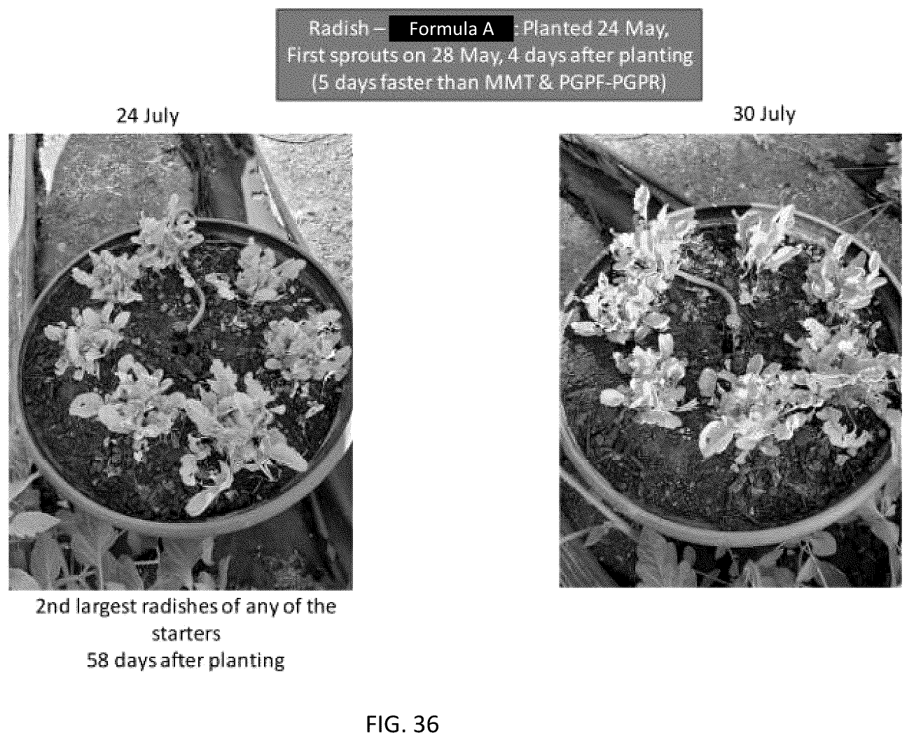

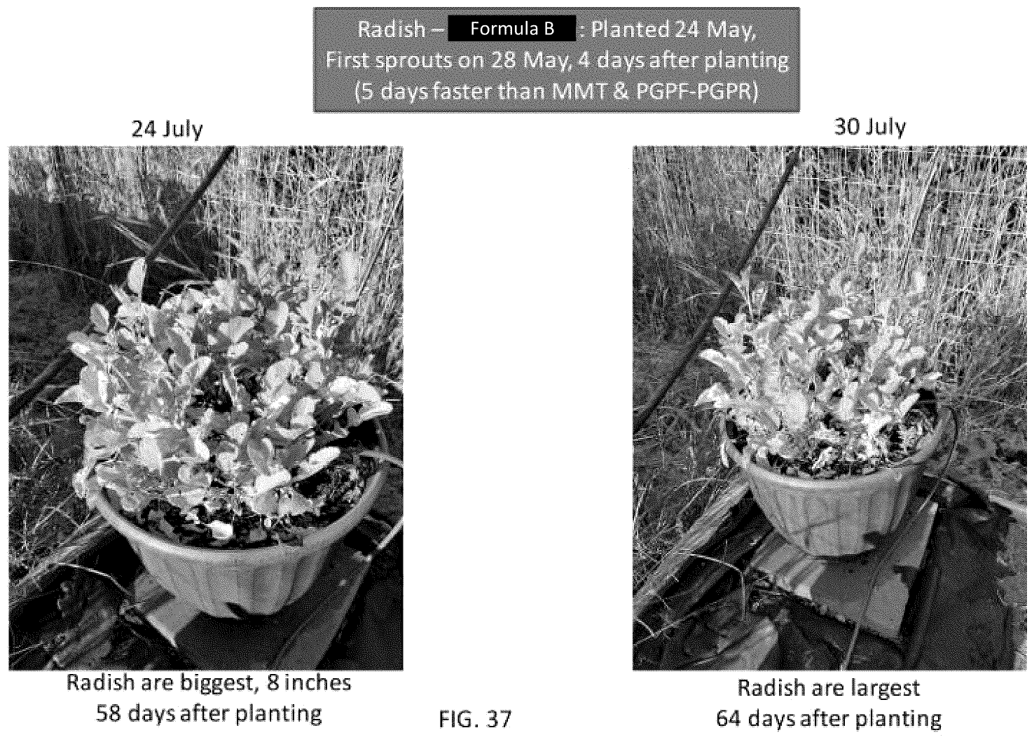

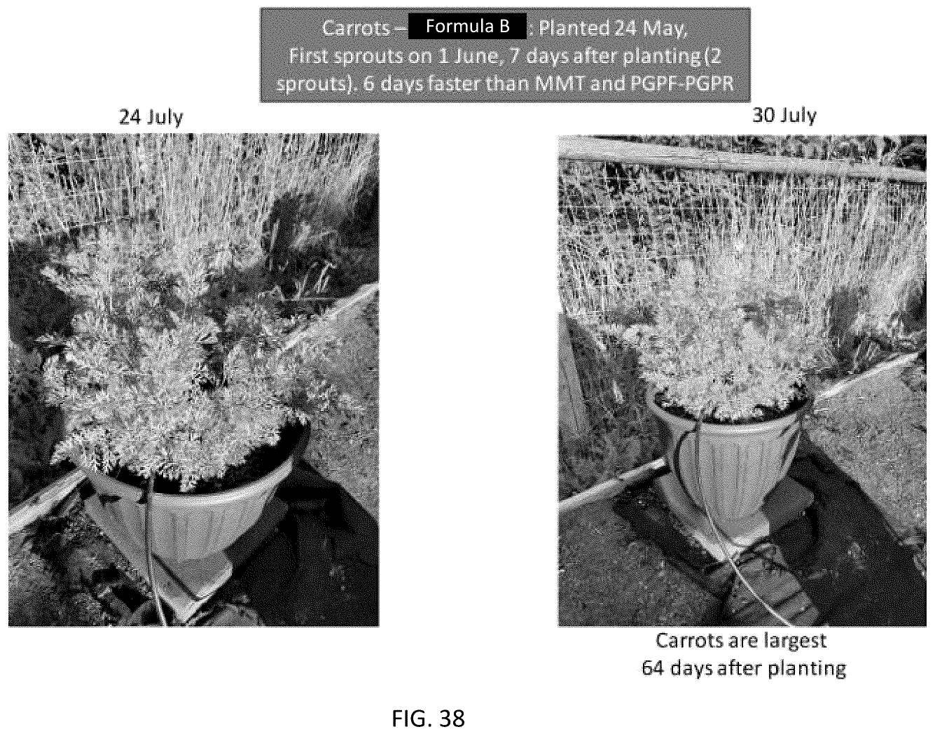

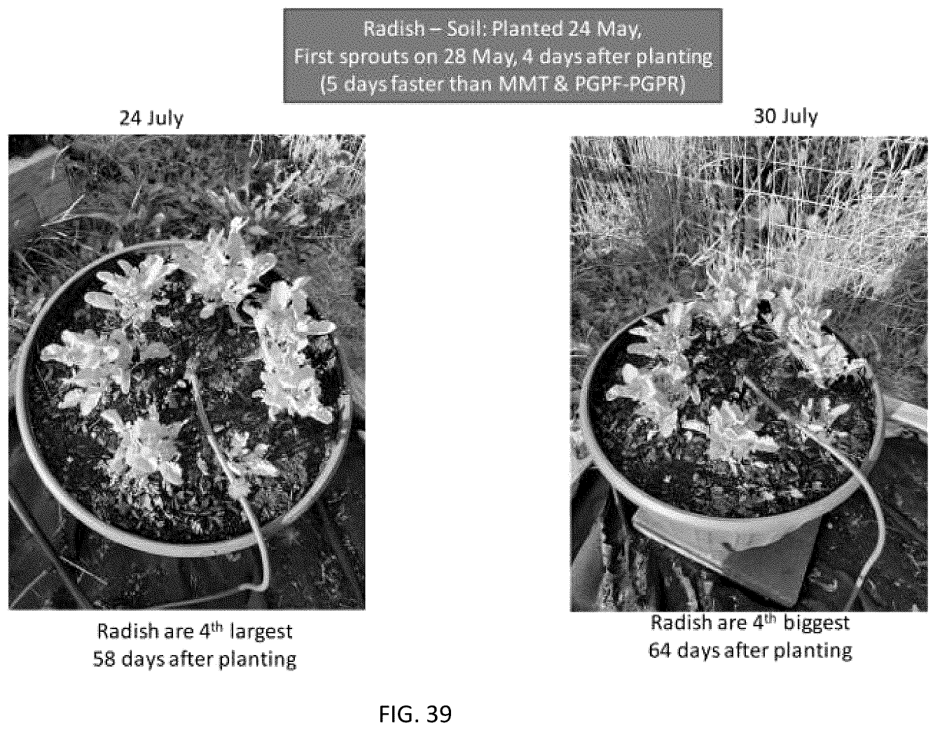

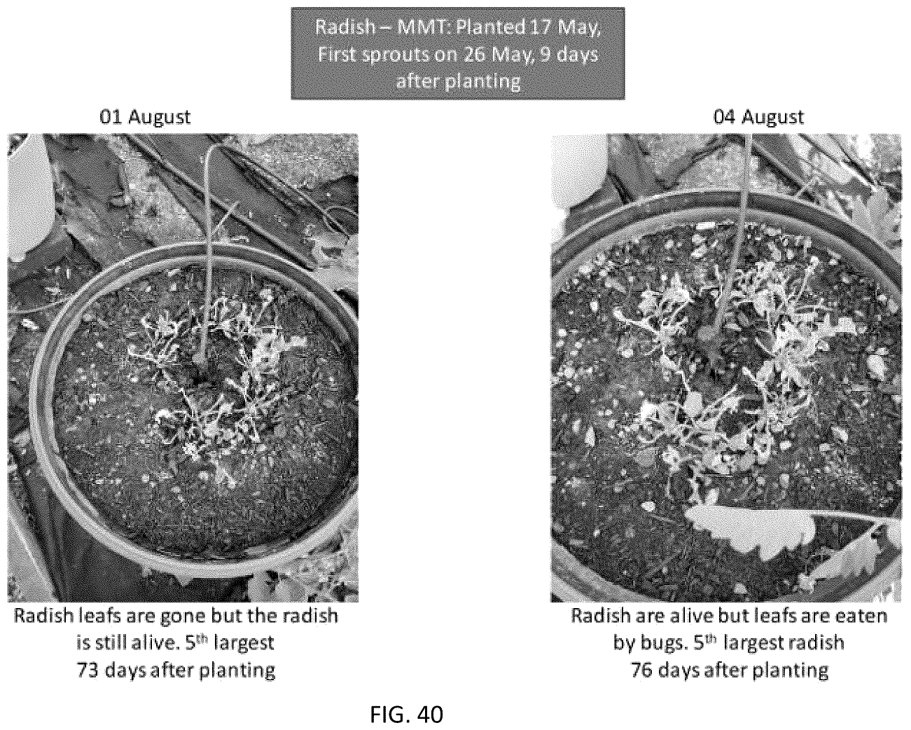

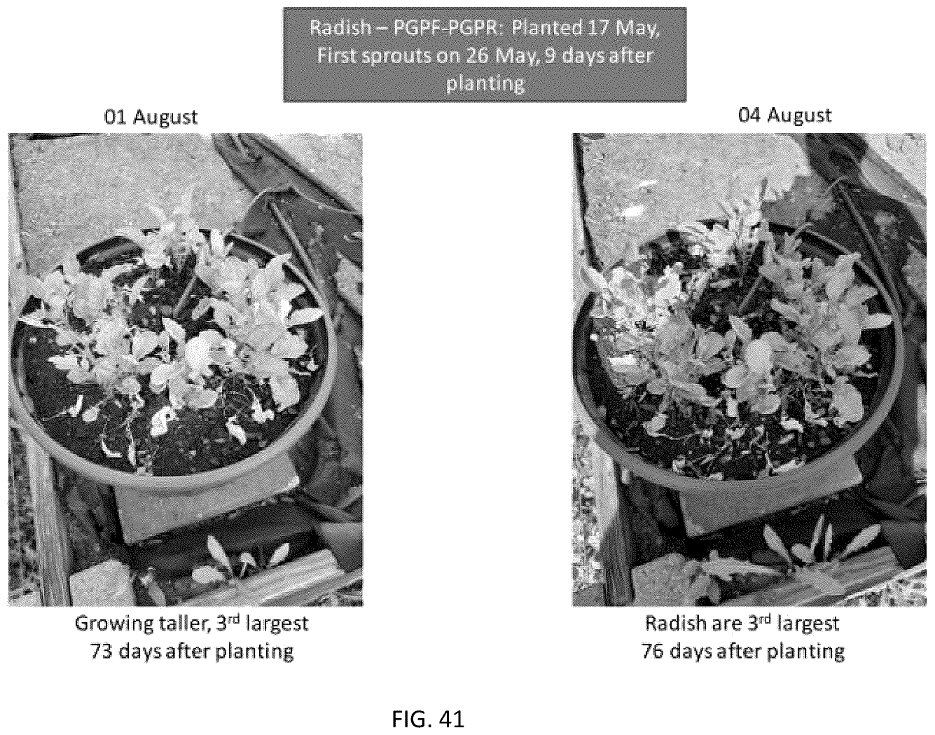

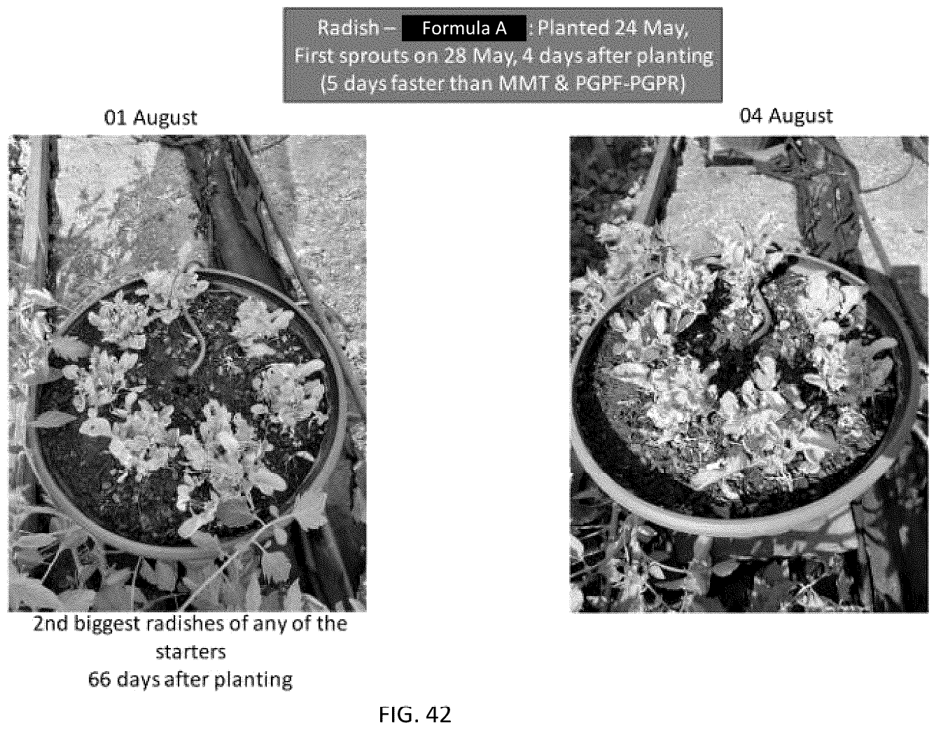

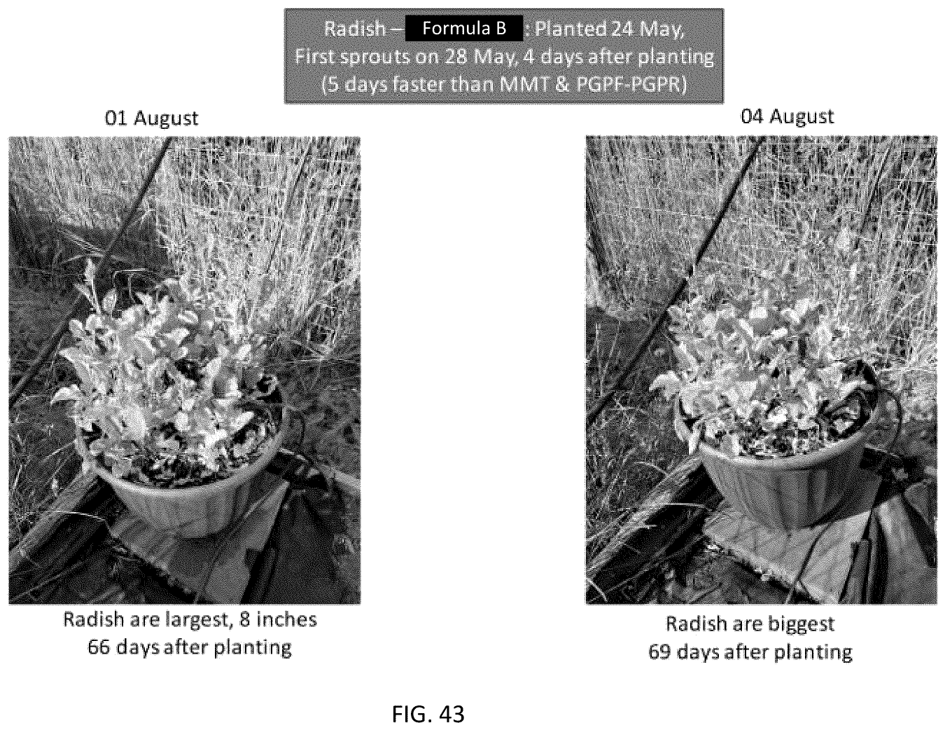

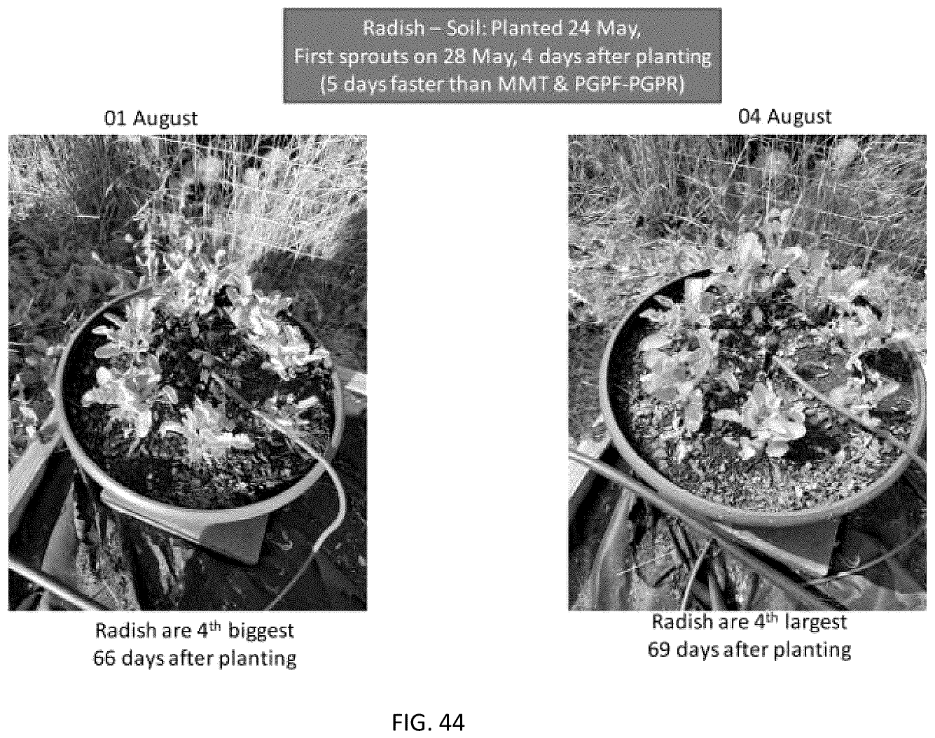

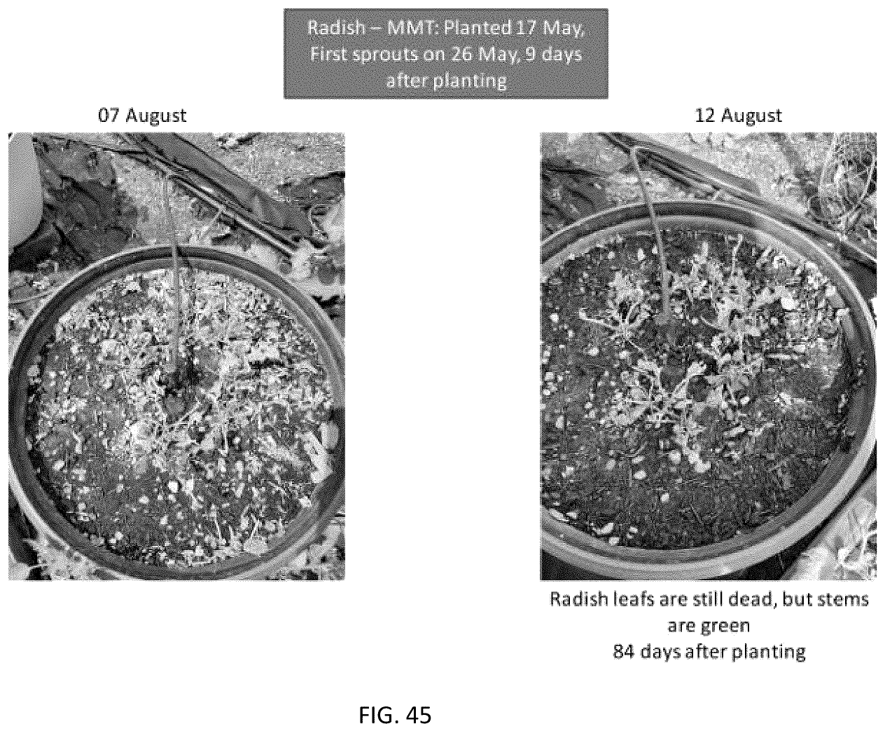

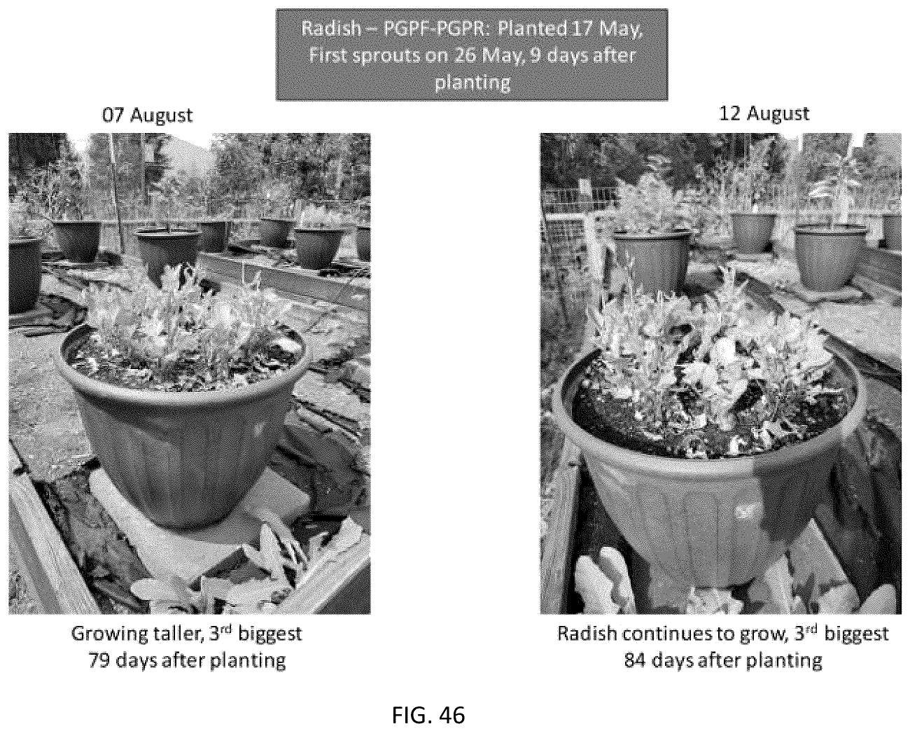

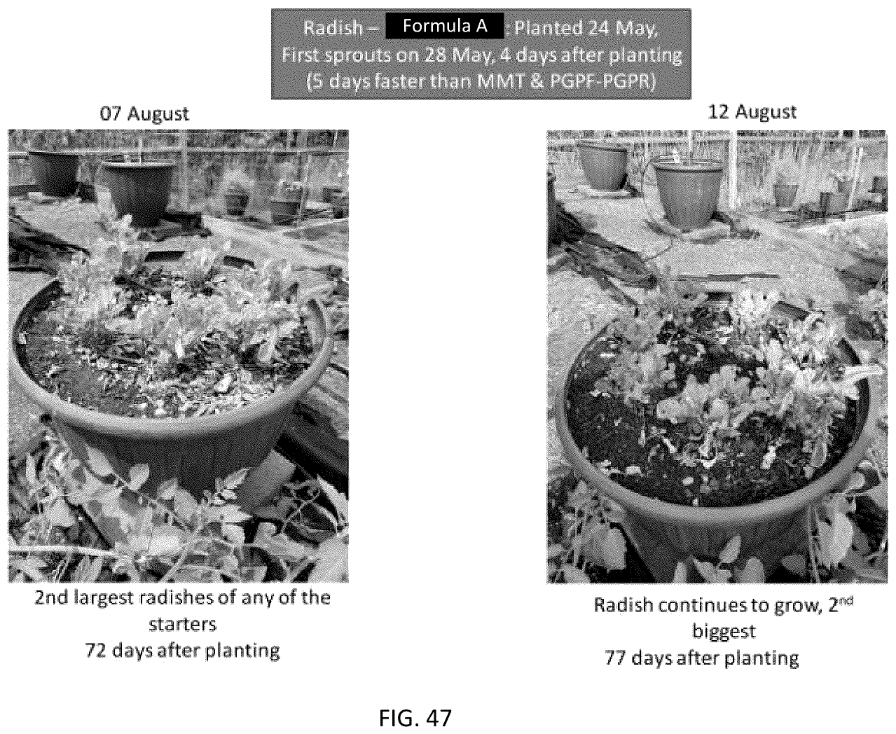

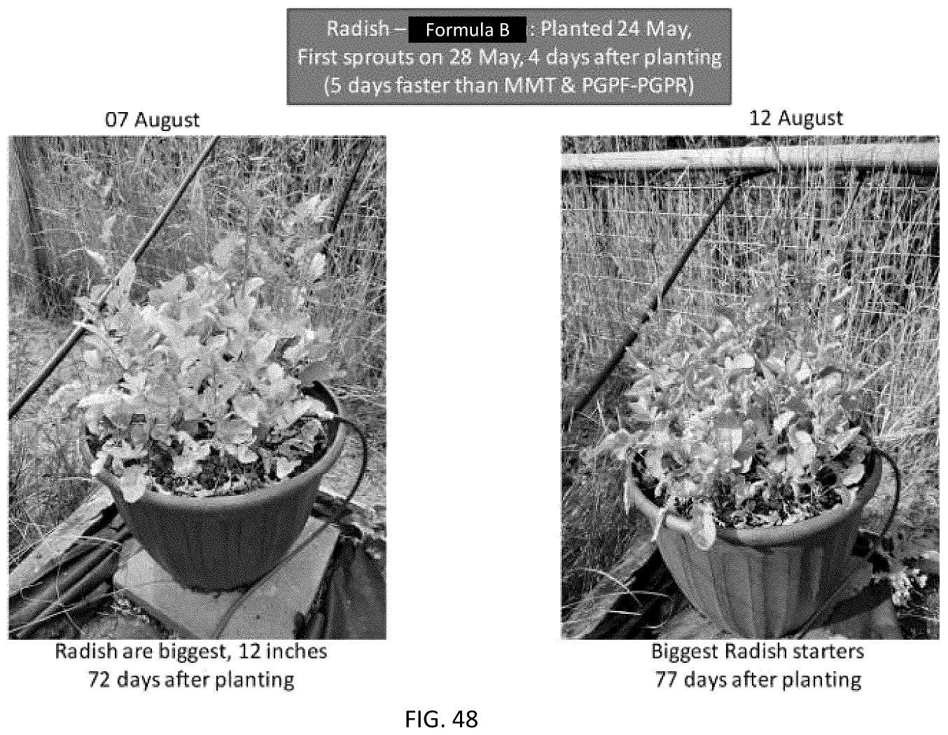

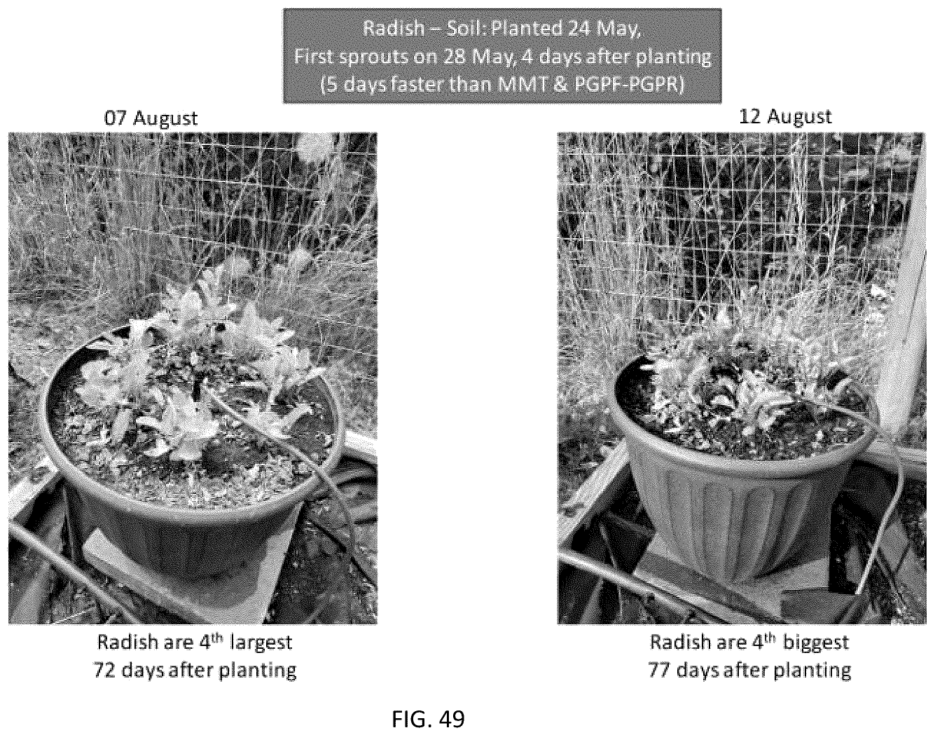

The compositions as prepared in Example 8 were applied to radish starters. Radish starters were observed to 9 weeks after planting. Images of the radishes are shown in FIGS. 3-49.

TABLE 7
Number of radish sprouts over time

| | | Days post planting | | | | | | | | | | | | |
|---|---|---|---|---|---|---|---|---|---|---|---|---|---|---|
| Plant date | Test Group | 4 | 8 | 9 | 11 | 15 | 17 | 18 | 19 | 22 | 24 | 26 | 29 | 31 |
| May 17 | MMT | | | * | 19 | | 22 | 22 | | 20 | 22 | 20 | 20 | 22 |
| May 17 | PGPF-PFPR | | | * | 21 | | 24 | 25 | | 29 | 29 | 25 | 29 | 29 |
| May 24 | Formula A | 15 | 63 | 65 | 64 | 64 | 65 | | 64 | 64 | 65 | | | |
| May 24 | Formula B | 11 | 49 | 51 | 47 | 48 | 48 | | 47 | 48 | 48 | | | |
| May 24 | Soil | 5 | 36 | 36 | 39 | 39 | 39 | | 39 | 39 | 39 | | | |

* first sprouts observed

In the MMT and PGPF-PGPR groups, the first sprouts were seen 9 days after planting. In the Formula A, Formula B, and Soil groups, the first sprouts were seen 4 days after planting, which was 5 days faster than the MMT and PGPF-PGPR groups. During weeks 2-4, MMT and PGPR-PGPF beds had minimal growth. The Formula A, Formula B, and Soil beds had increased growth.

During week 3, at 31 days after planting, the MMT group was light green with some yellow coloring. The PGPF-PGPR group had leaves that had bolted and had large leaves that were light green and yellow. The Formula A group had leaves that had bolted and were mostly green with some yellow. In the Formula B group, the leaves had bolted and had the largest leaves of all groups. The Soil group had 20% of leaves that had bolted, half were green in color and the other half were yellow in color.

TABLE 8
Week 4 Radish Observations

| | June 19, 33 days | June 23, 37 days |
|---|---|---|
| | after planting | after planting |
| MMT | Smallest of all groups | Weakest of all groups |
| PGPF-PGPR | Second biggest of | Second strongest of |
| | all groups | all groups |
| Formula A | Third largest of | Second strongest of |
| | all groups | all groups |
| Formula B | Largest and healthiest | Largest and healthiest |
| | of all groups | of all groups |
| Soil | Fourth smallest of | Third strongest of |
| | all groups | all groups |

During weeks 3 and 4, the Formula A group had the healthiest-looking fruits out of the three groups that received less sunlight. Growth was stunted during week 4 due to a cold snap where temperatures dropped to 43° F. at night for 4 consecutive days starting June 18. Minimal sunlight was observed during this time with wet and rainy conditions. The temperature ranged between 46° F. and 51° F.

During week 5, radish plants in the MMT group seemed to have died due to a cold snap and insects. The Formula B group had the largest and healthiest radish plants. The second strongest formulation group was tied between the PGPF-PGPR and Formula A groups.

TABLE 9
Week 5 Radish Observations

| | July 3, 43 days | July 7, 47 days |
|---|---|---|
| | after planting | after planting |
| MMT | Eaten by insects | Almost dead |
| PGPF-PGPR | Second biggest leaves | Full and large, second largest |
| Formula A | Third largest of | Full and large, third largest |
| | all groups | of all groups |
| Formula B | Largest | Largest, healthiest, and |
| | | fullest of all groups |
| Soil | Nothing serious | Fourth largest |
| | to report | |

Growth had picked up from the previous wet and cloudy weather that stunted growth. The Formula B group had taken the lead out of all groups, by far showing the largest and healthiest radishes. The second strongest were the PGPF-PGPR and Formula A groups.

TABLE 10
Week 6 Radish Observations

| | July 16, 56 days | July 22, 63 days |
|---|---|---|
| | after planting | after planting |
| MMT | Leaves mostly dead | Still recovering from cold |
| | from bugs | snap, almost dead |
| PGPF-PGPR | Third strongest radish | Third strongest radish |
| | July 16, 49 days | July 22, 56 days |
| | after planting | after planting |
| Formula A | Second largest of | Full and large, second |
| | all groups | largest of all groups |
| Formula B | Strongest, largest and | Largest and healthiest, |
| | healthiest in color | 8-inch tall leaves |
| Soil | Fourth largest | Fourth largest |

During week 6, the Formula B group was the strongest, largest, and healthiest in color, and had 8-inch tall leaves. The Formula A group had the second largest radishes and were full and large. The PGPF-PGPR group was third strongest and the Soil group had the fourth largest radishes.

TABLE 11
Week 7 Radish Observations

| | July 24, 65 days | July 30, 71 days |
|---|---|---|
| | after planting | after planting |
| MMT | Leaves mostly dead | Still recovering from |
| | from bugs | cold snap, almost dead |
| PGPF-PGPR | Third strongest and | Third strongest and |
| | largest radish | largest radish |
| | July 24, 58 days | July 30, 64 days |
| | after planting | after planting |
| Formula A | Second largest of | Full and large, second |
| | all groups | largest of all groups |
| Formula B | Biggest radish, | Largest radish |
| | 8 inches | |
| Soil | Fourth largest | Fourth largest |

Of the MMT, PGPF-PGPR, and Formula A groups that received less sunlight, the Formula A group had the healthiest-looking vegetables. The Formula B plants were noticeably the most abundant, healthy, and vibrant out of all groups tested, followed by the Formula A plants.

TABLE 12
Week 8 Radish Observations

| | August 1, 73 days | August 4, 76 days |
|---|---|---|
| | after planting | after planting |
| MMT | Leaves were gone | Radish were alive |
| | but radish was | but leaves were |
| | still alive | eaten by bugs |
| PGPF-PGPR | Growing taller, third- | Third largest |
| | largest radish | radish |
| | August 1, 66 days | August 4, 69 days |
| | after planting | after planting |
| Formula A | Second biggest of | Full and large, second |
| | all groups | biggest of all groups |
| Formula B | Largest radish, | Biggest radish |
| | 8 inches | |
| Soil | Fourth biggest | Fourth largest |

Of the MMT, PGPF-PGPR, and Formula A groups that received less sunlight, the Formula A group had the healthiest-looking vegetables. The Formula B plants were noticeably the most abundant, healthy, and vibrant out of all groups tested, followed by the Formula A plants.

TABLE 13

| | August 7, 79 days | August 12, 84 days |
|---|---|---|
| | after planting | after planting |
| MMT | Leaves were dead but | Leaves were still dead, |
| | radish was still alive, | but stems were green |
| | stems still green | |
| PGPF-PGPR | Grew taller, | Continued to grow, |
| | third biggest | third biggest |
| | August 7, 72 days | August 12, 77 days |
| | after planting | after planting |
| Formula A | Second largest of | Continued to grow, |
| | all groups | second biggest |
| Formula B | Biggest radish, | Biggest radish |
| | 12 inches | |
| Soil | Fourth largest | Fourth biggest |

Of the MMT, PGPF-PGPR, and Formula A groups that received less sunlight, the Formula A group had the healthiest-looking vegetables. The Formula B plants were noticeably the most abundant, healthy, and vibrant out of all groups tested, followed by the Formula A plants.

### Example 10: Carrots

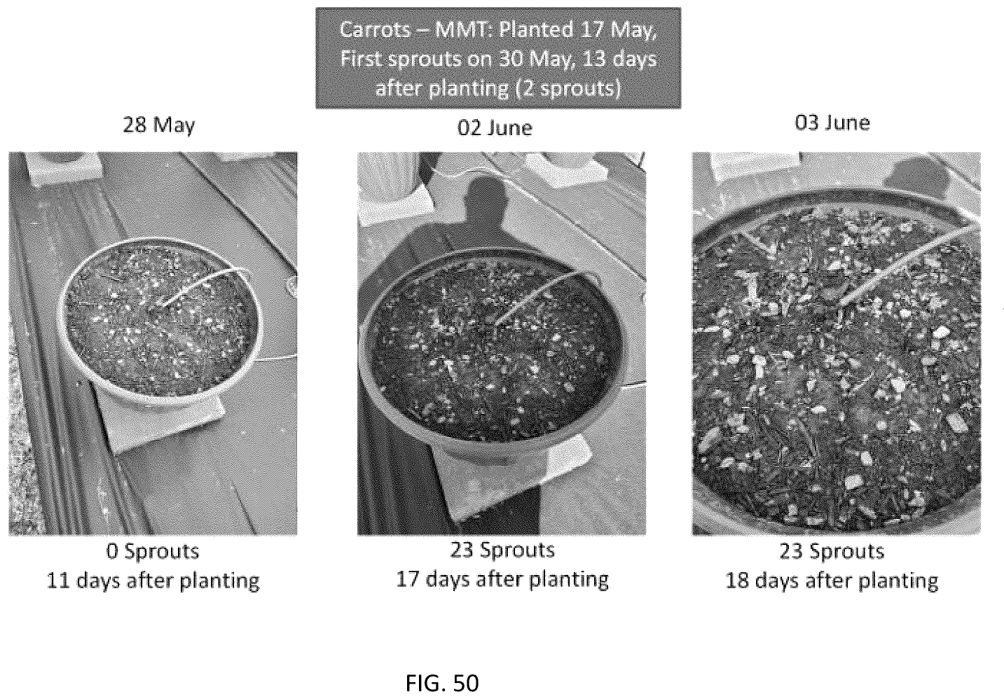

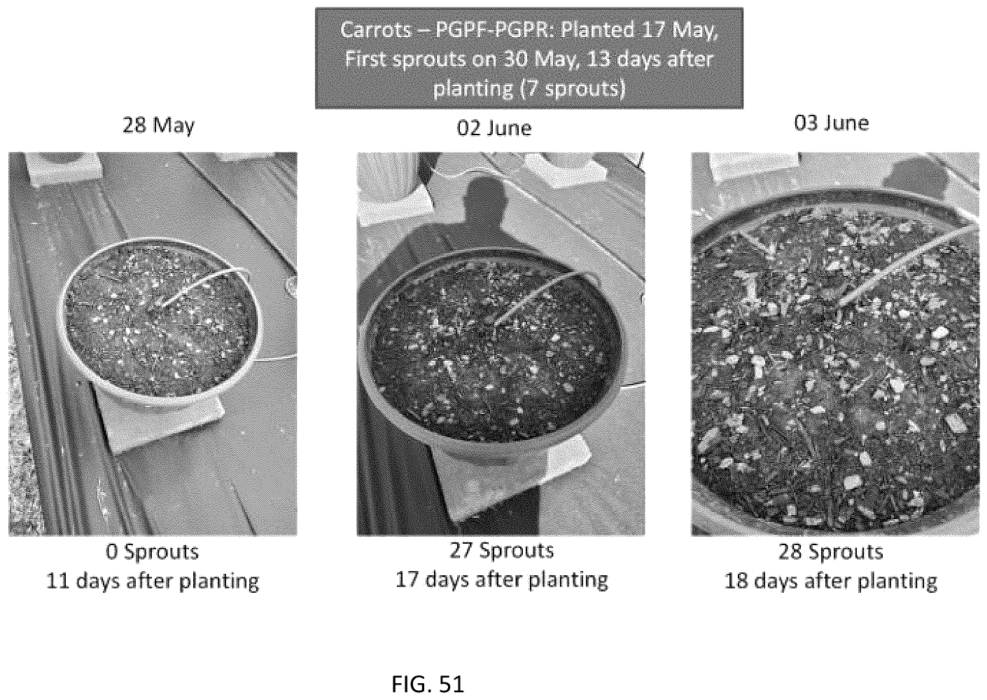

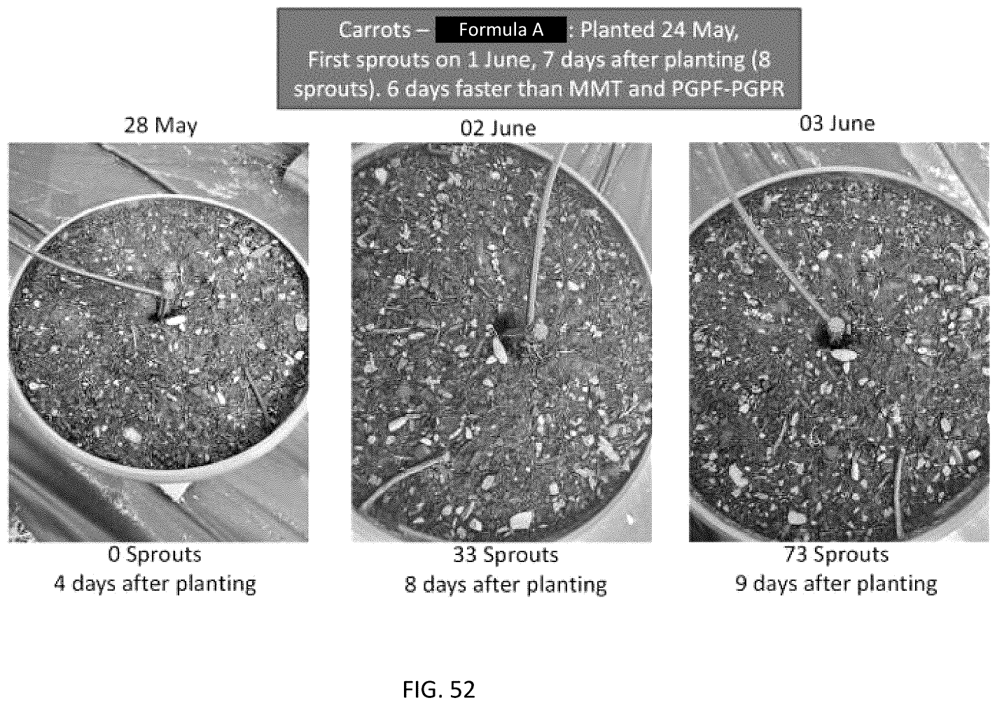

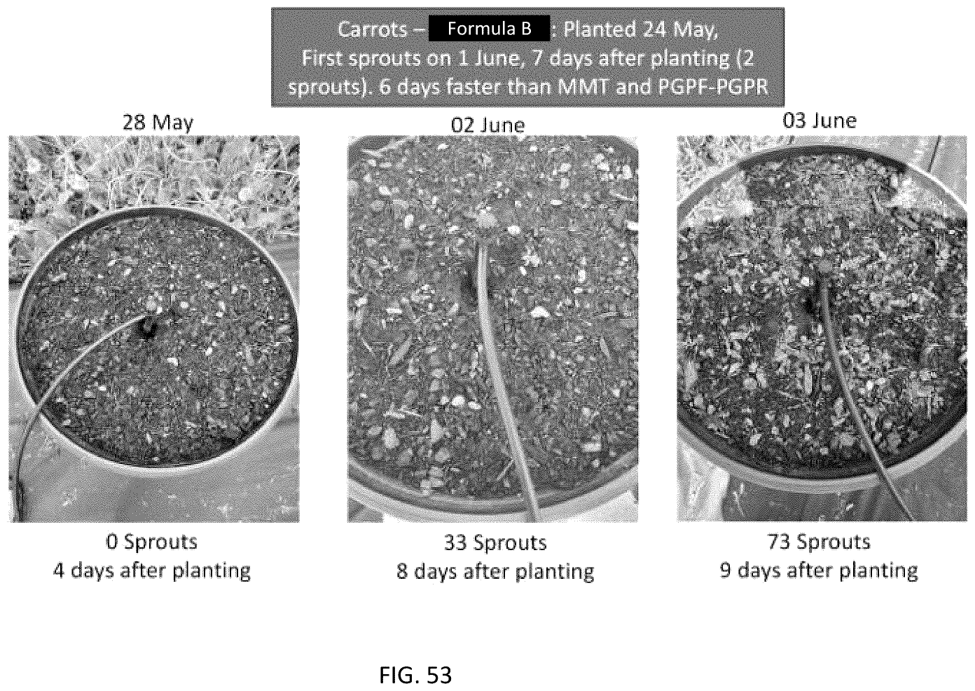

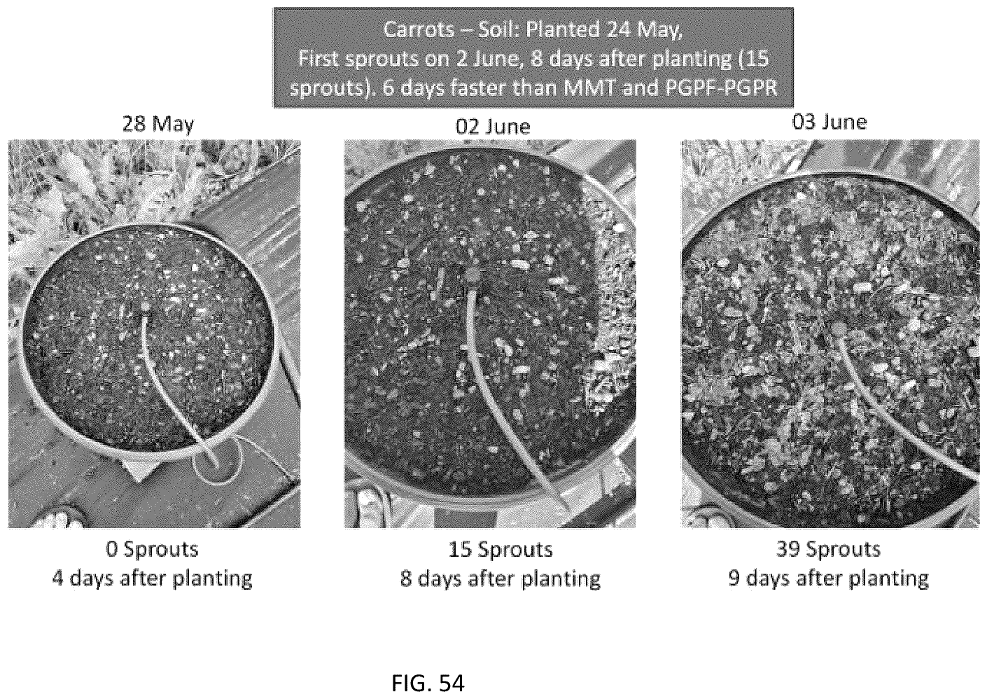

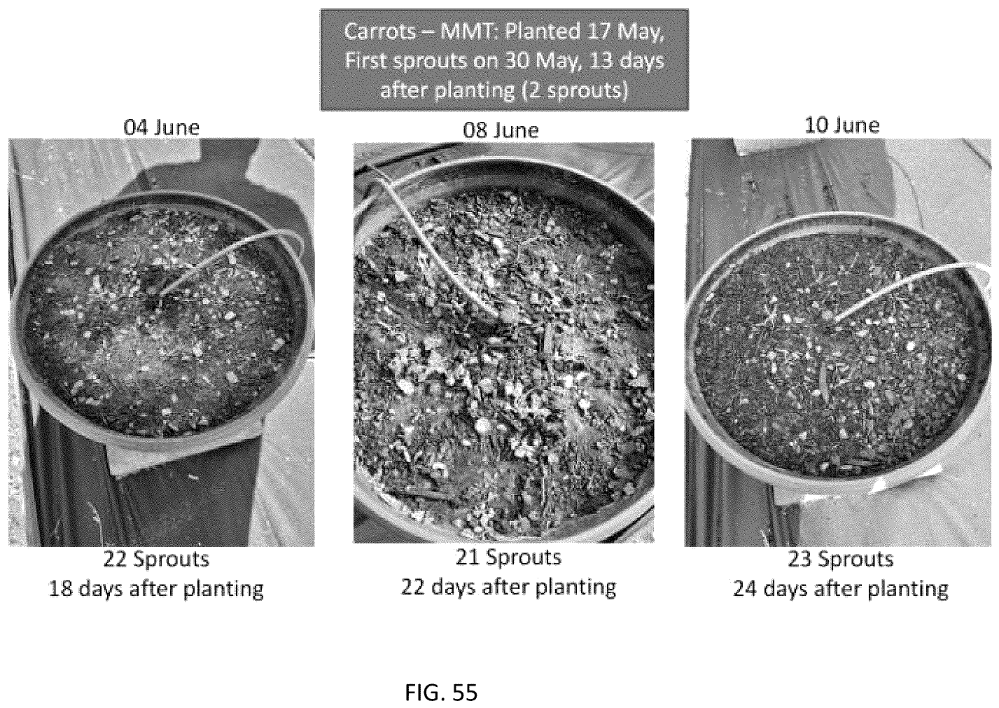

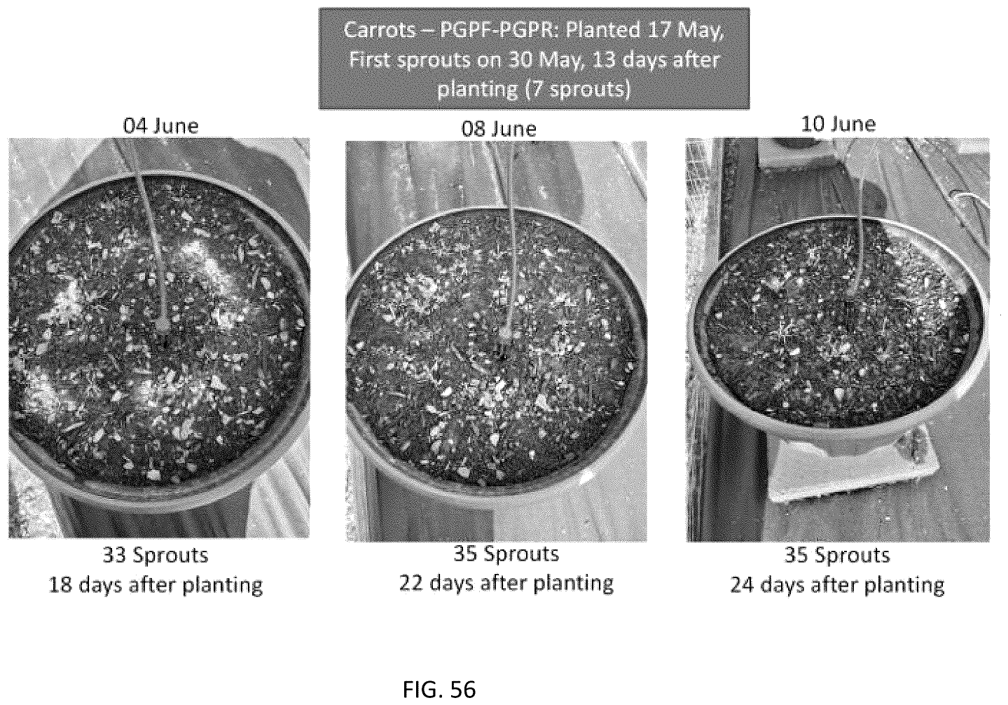

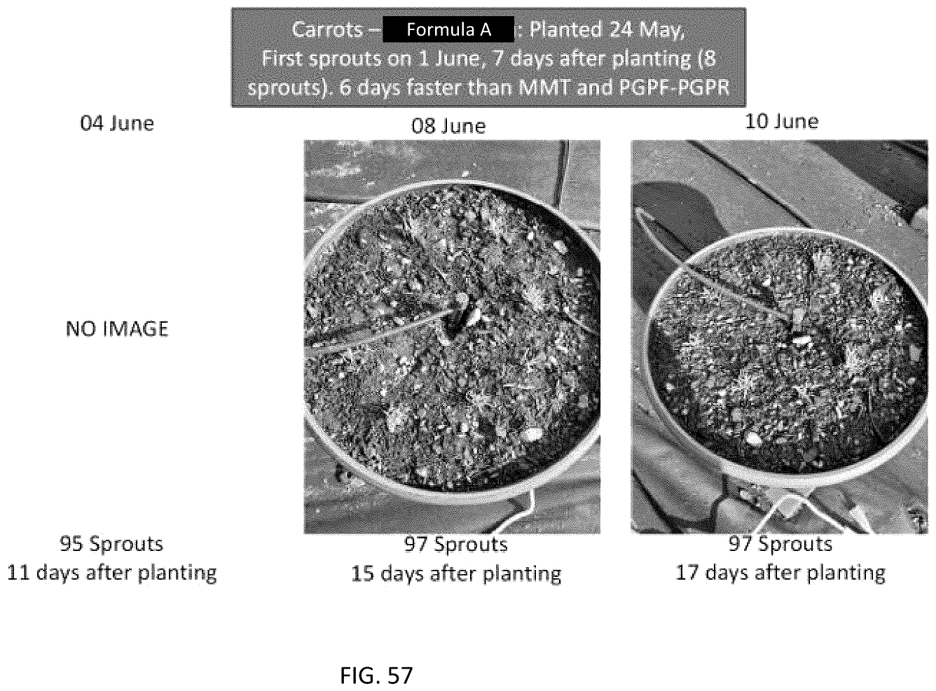

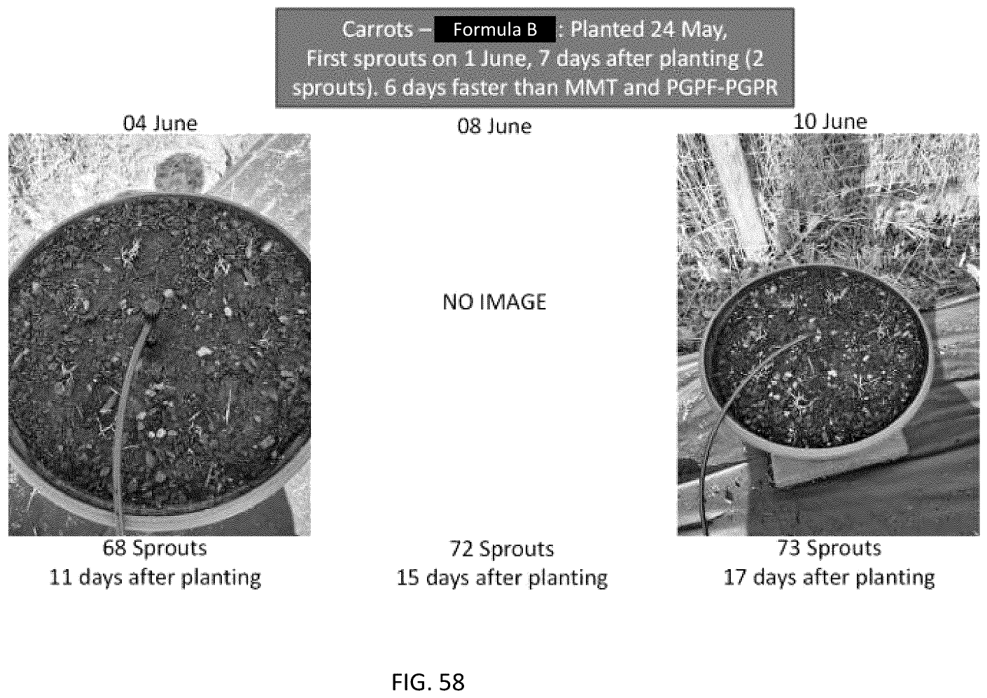

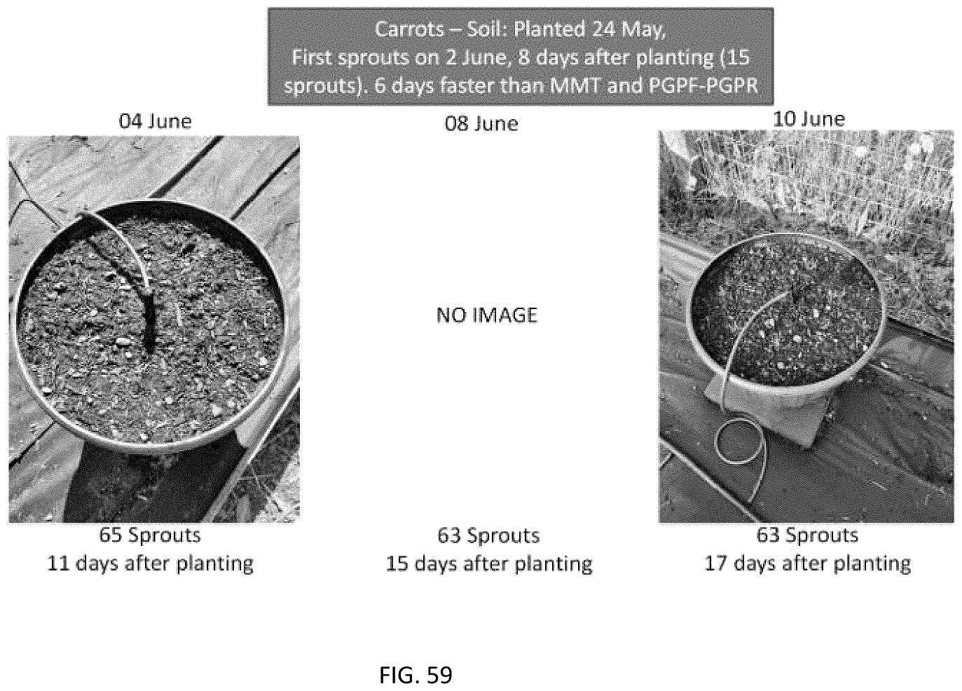

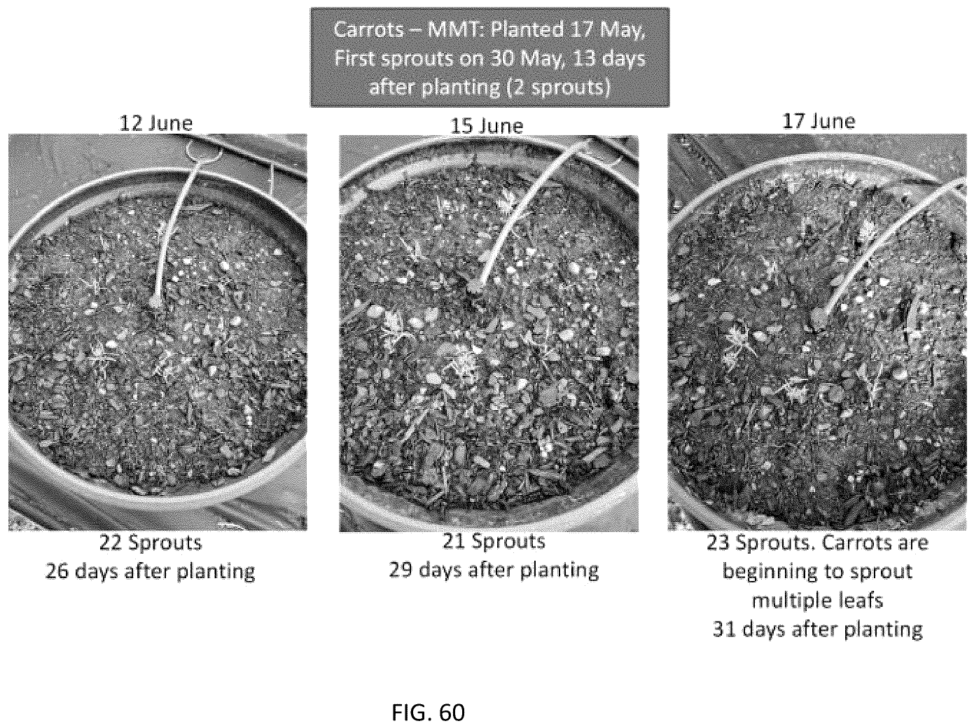

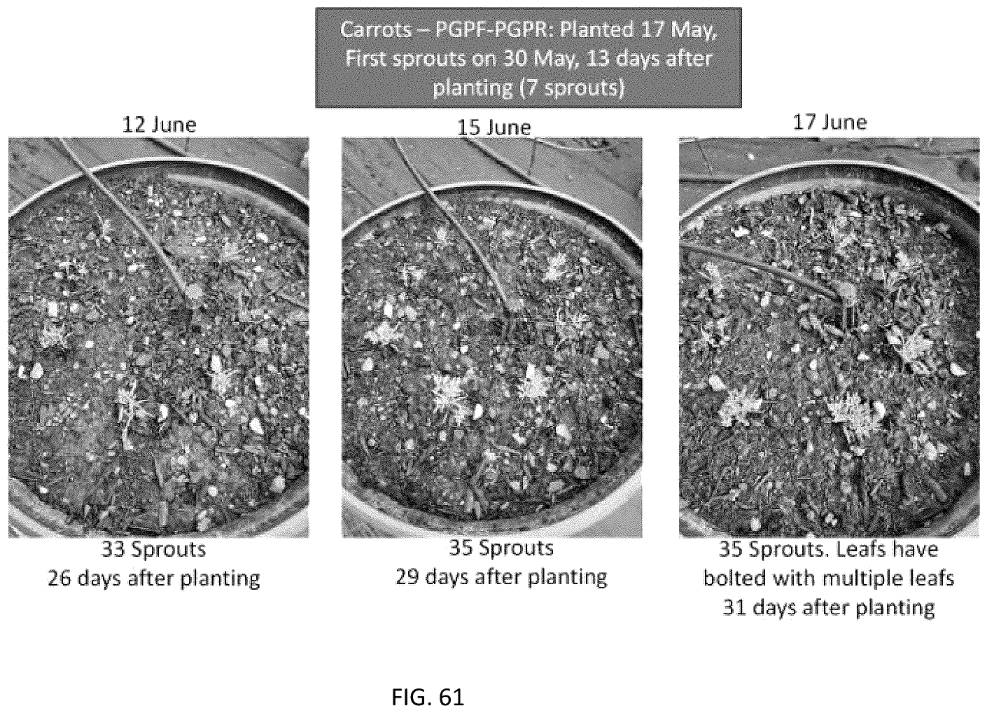

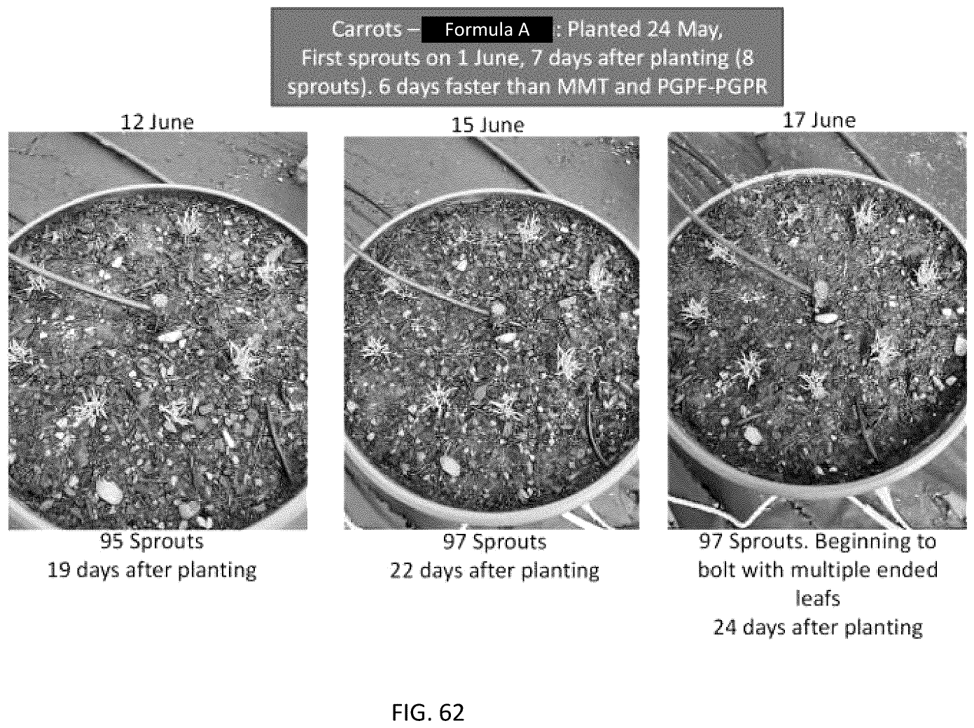

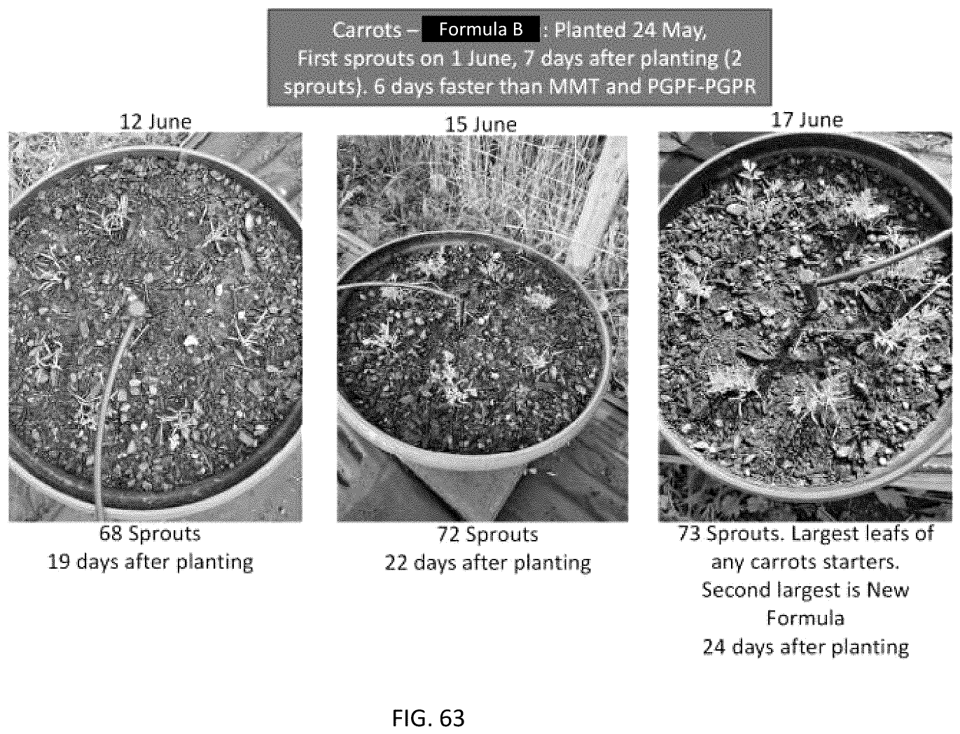

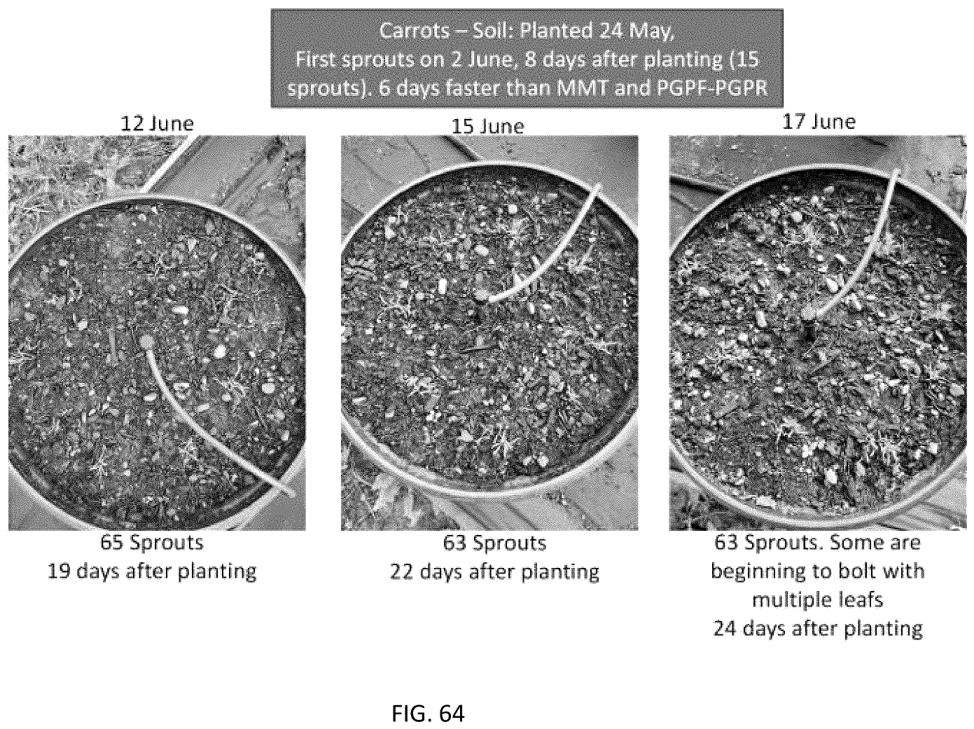

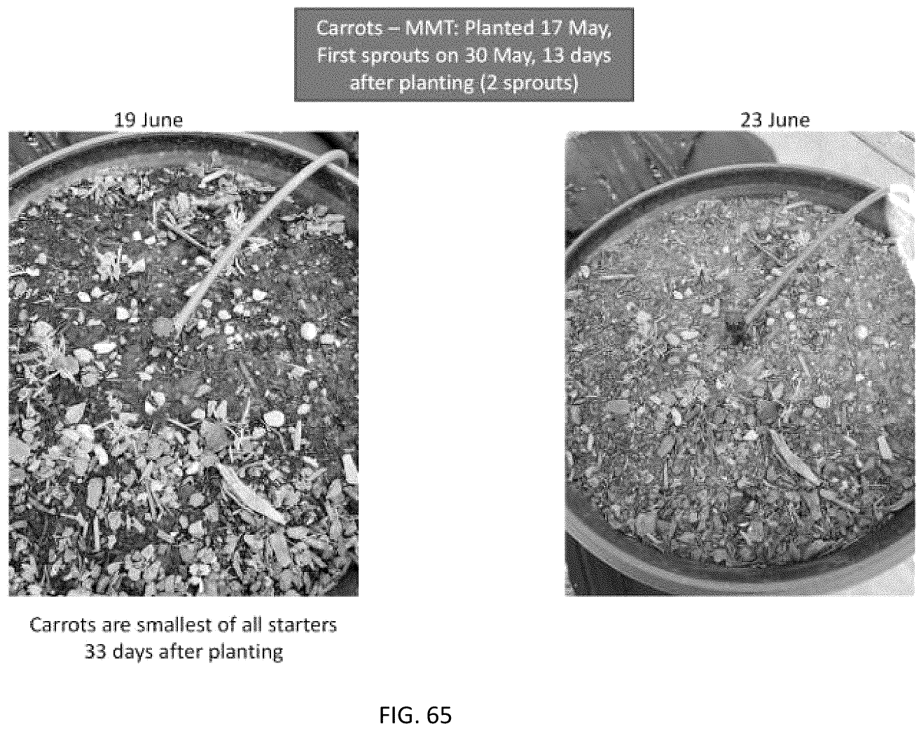

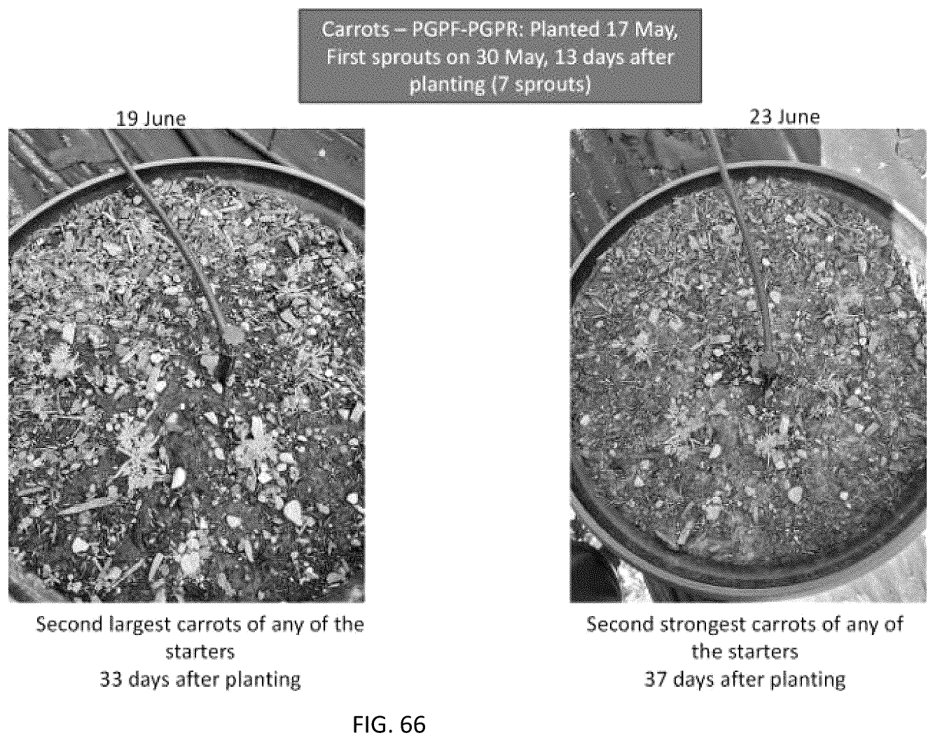

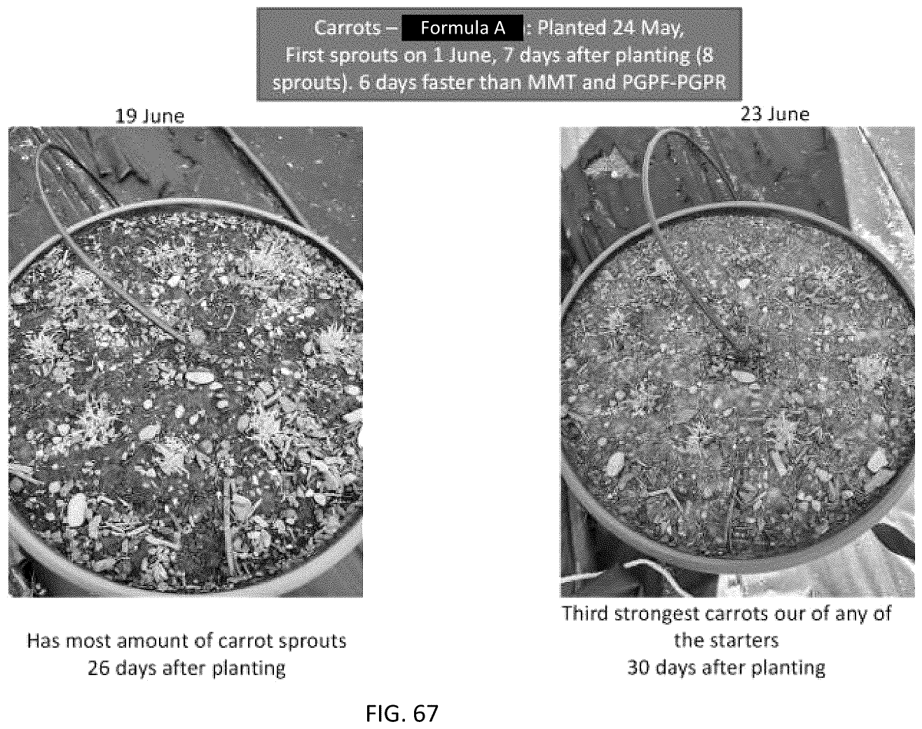

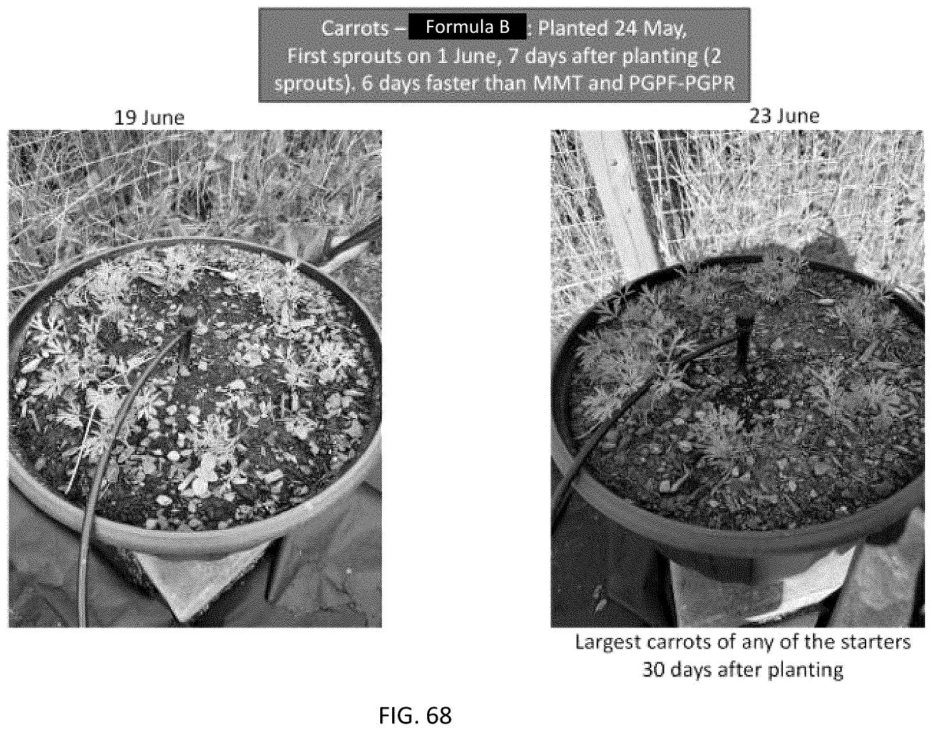

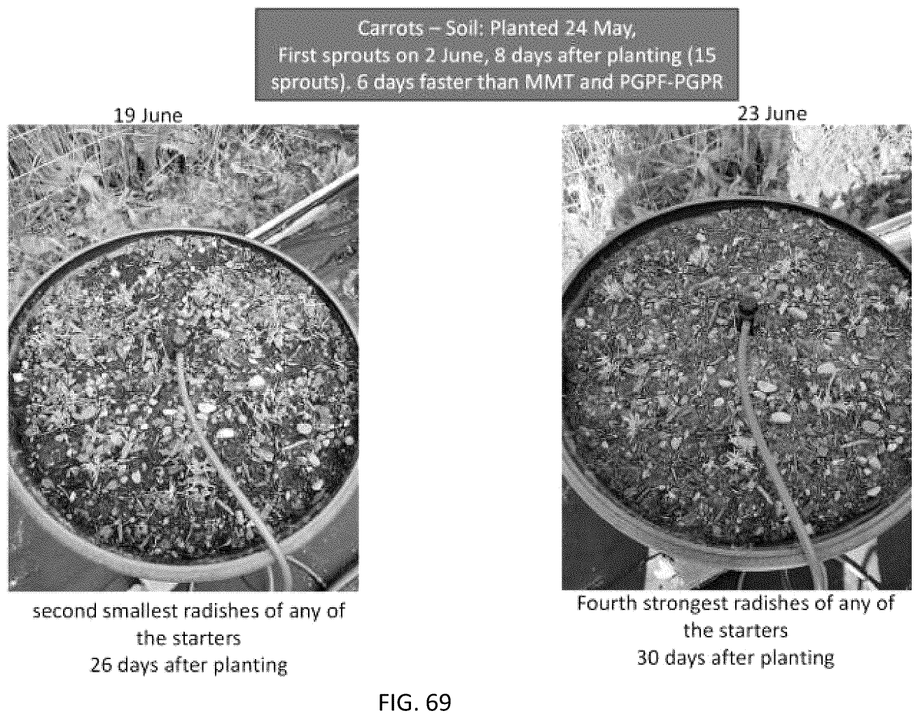

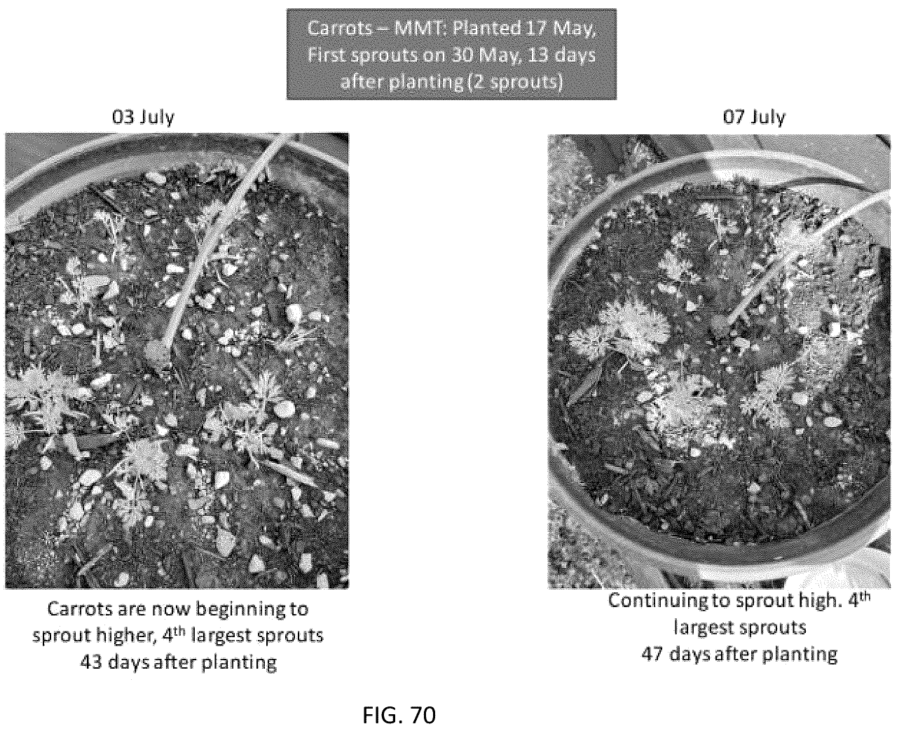

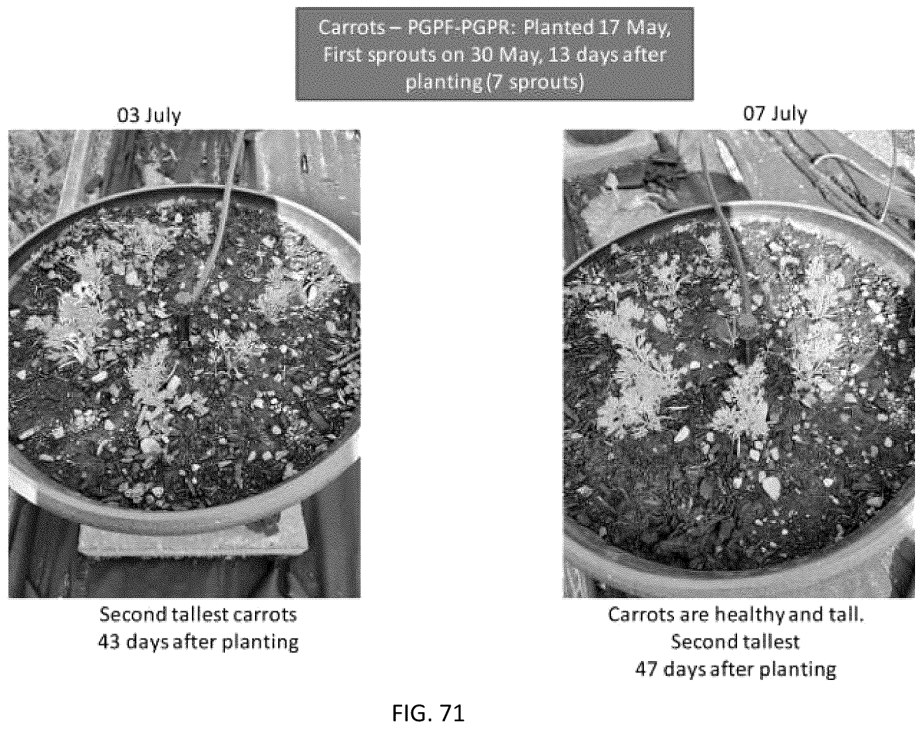

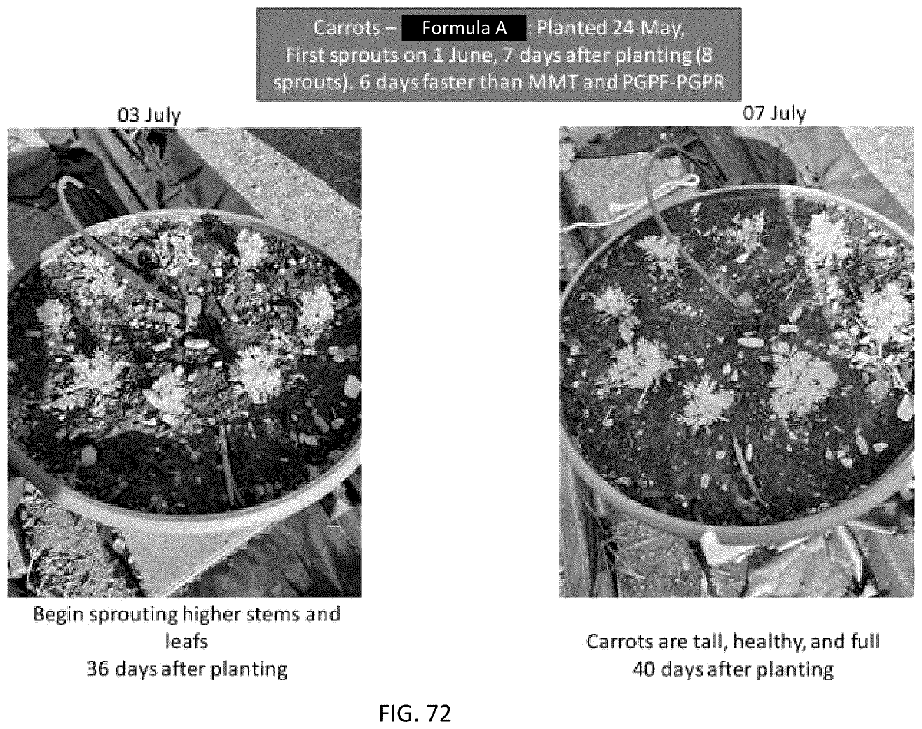

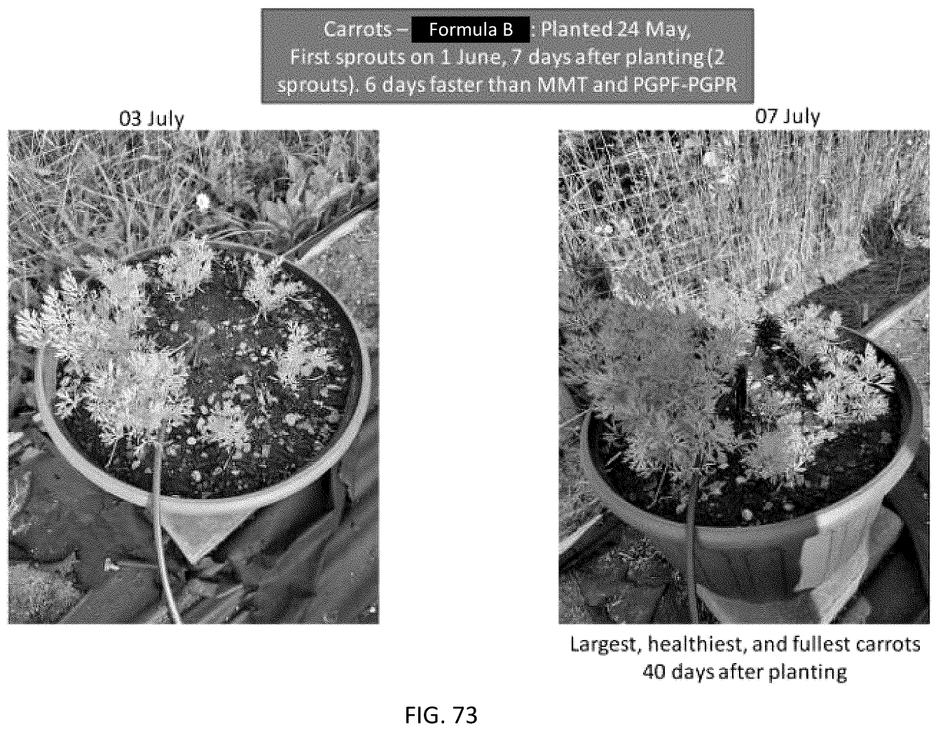

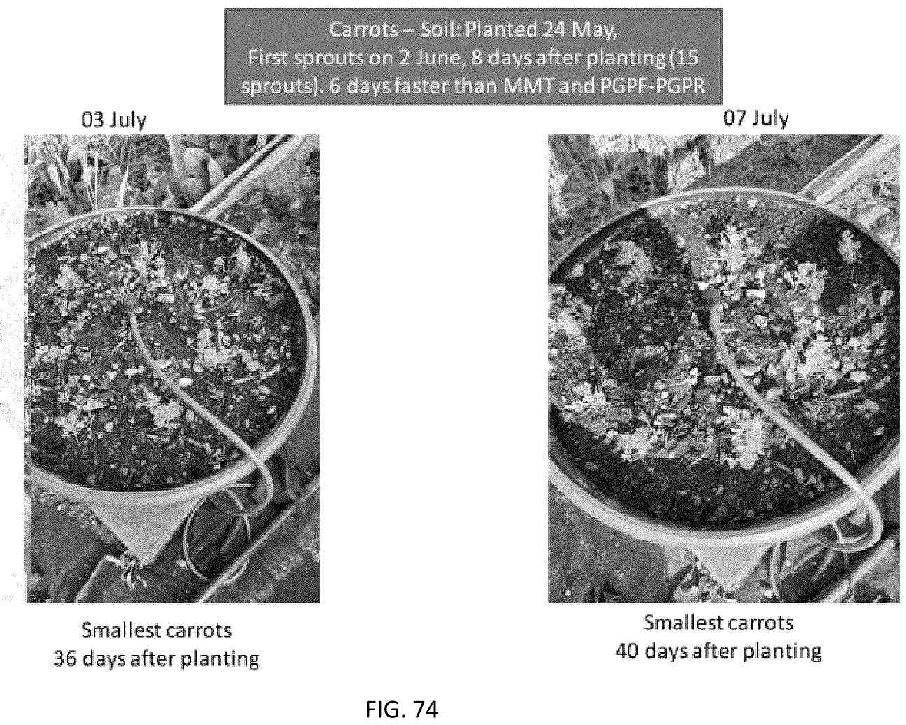

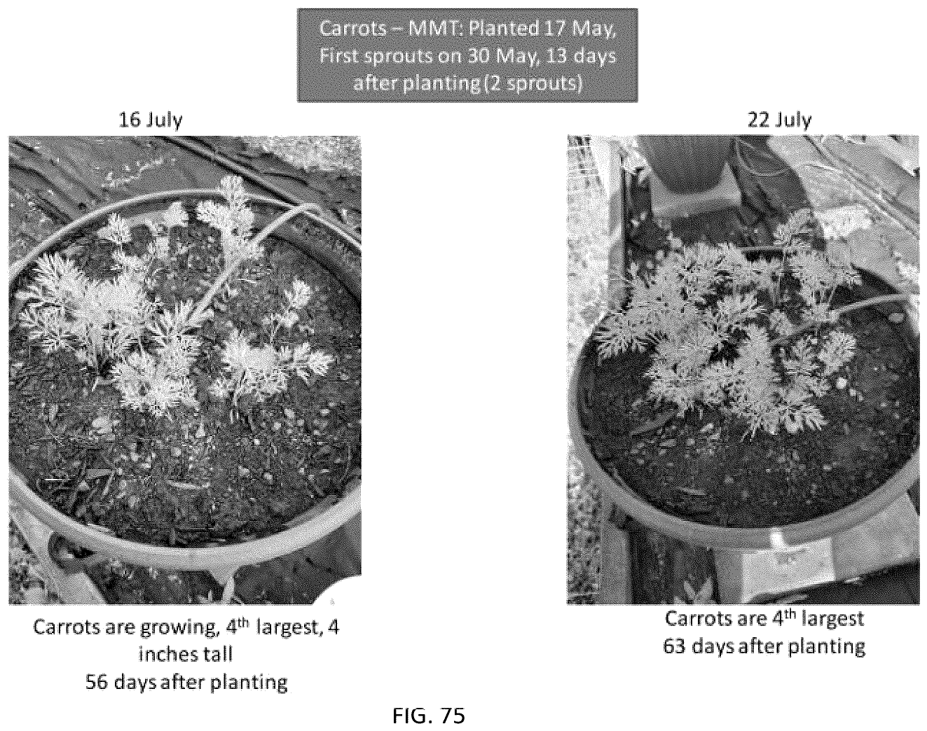

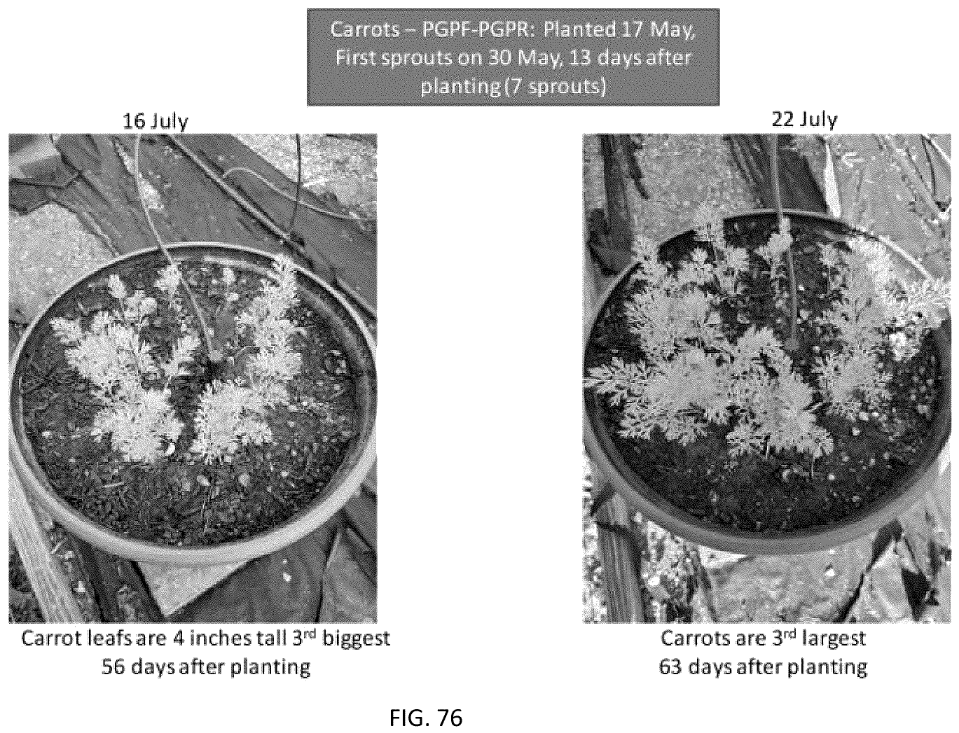

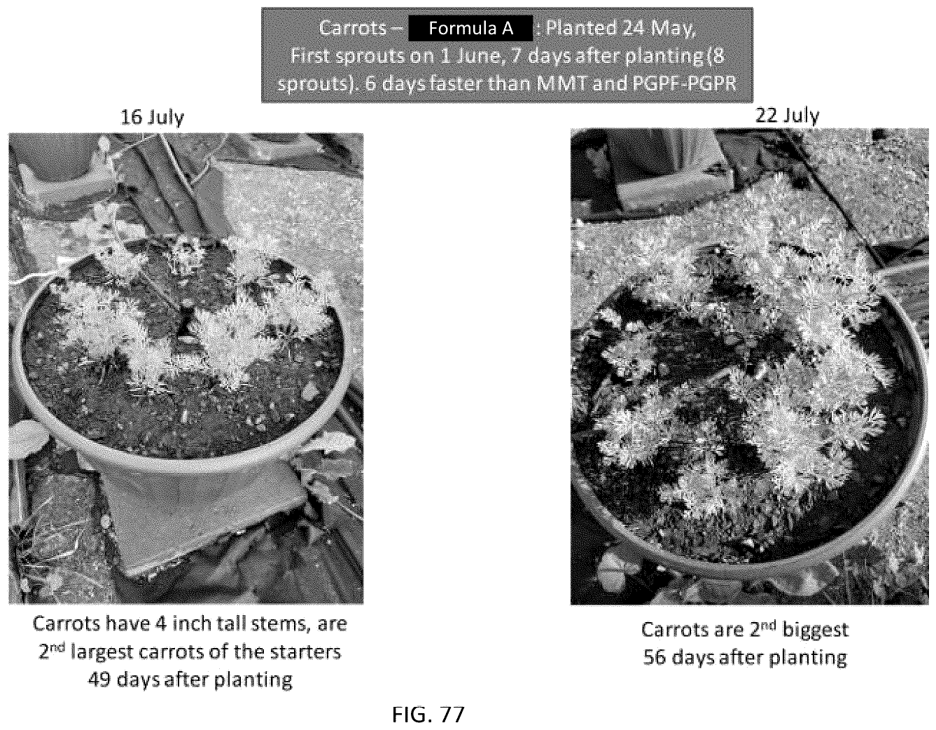

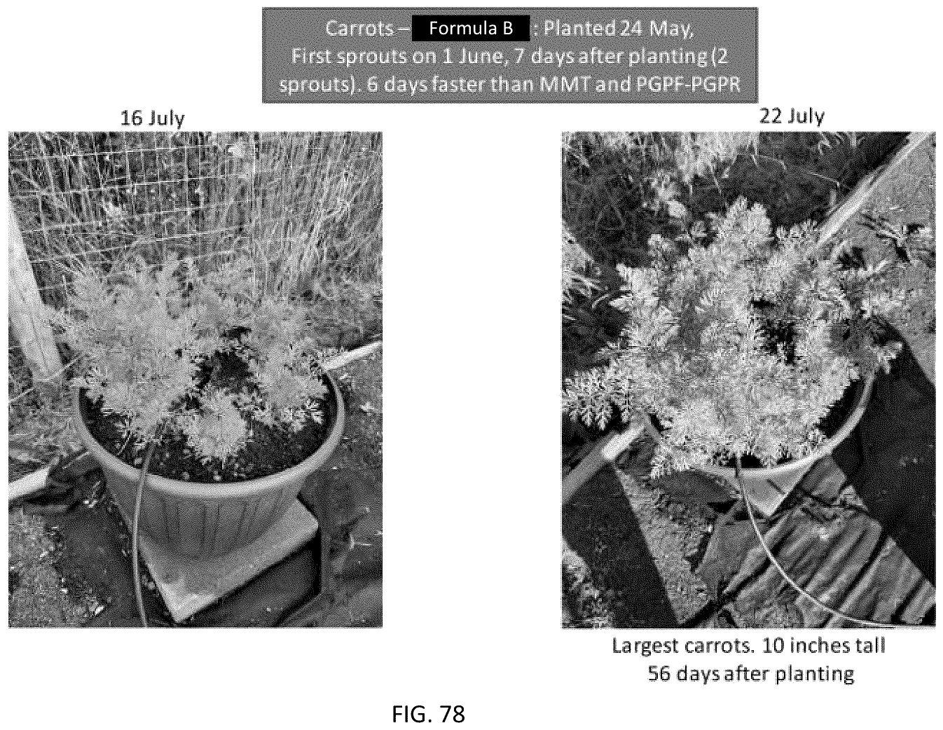

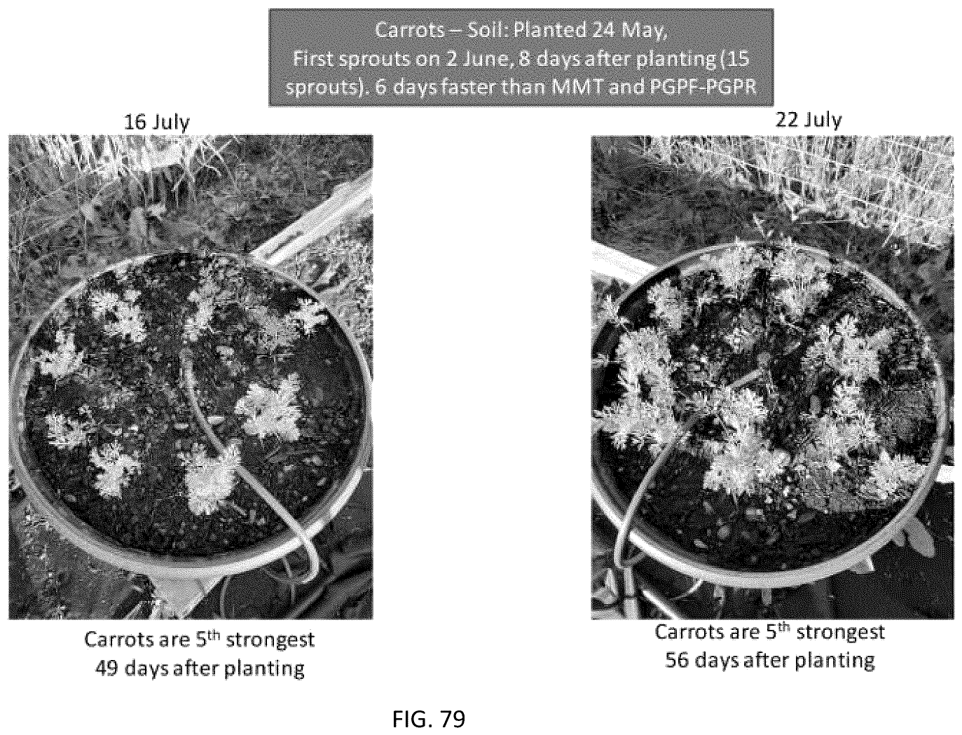

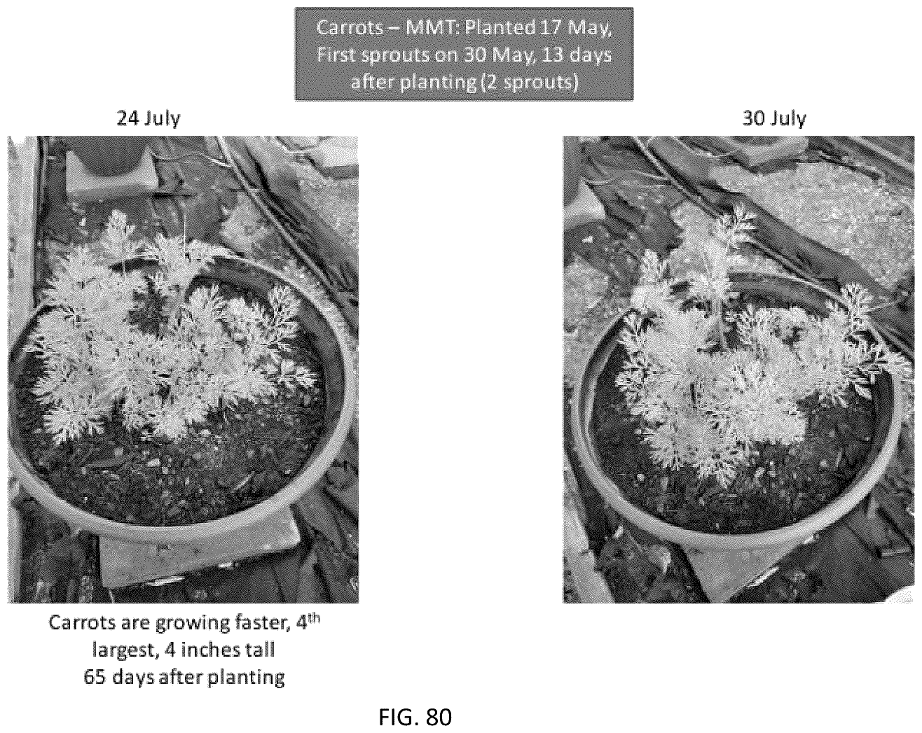

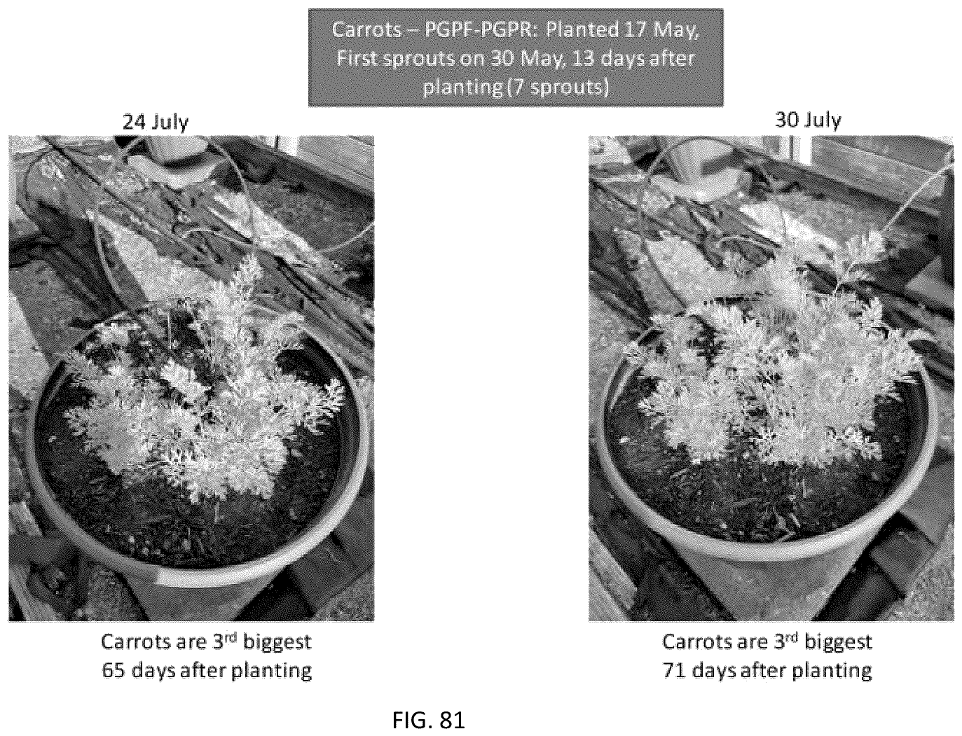

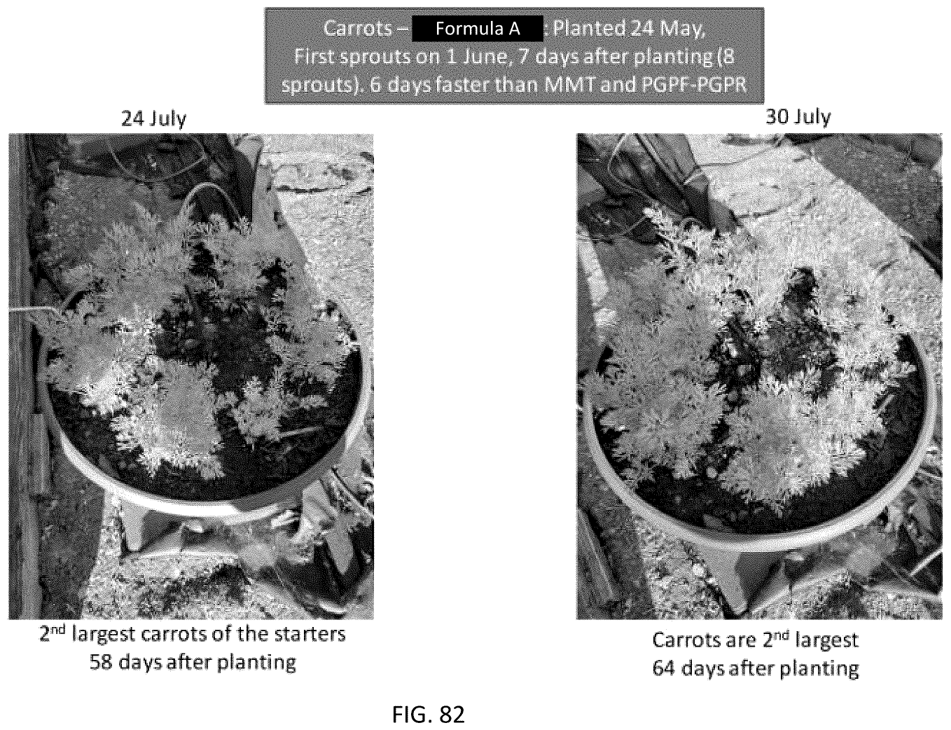

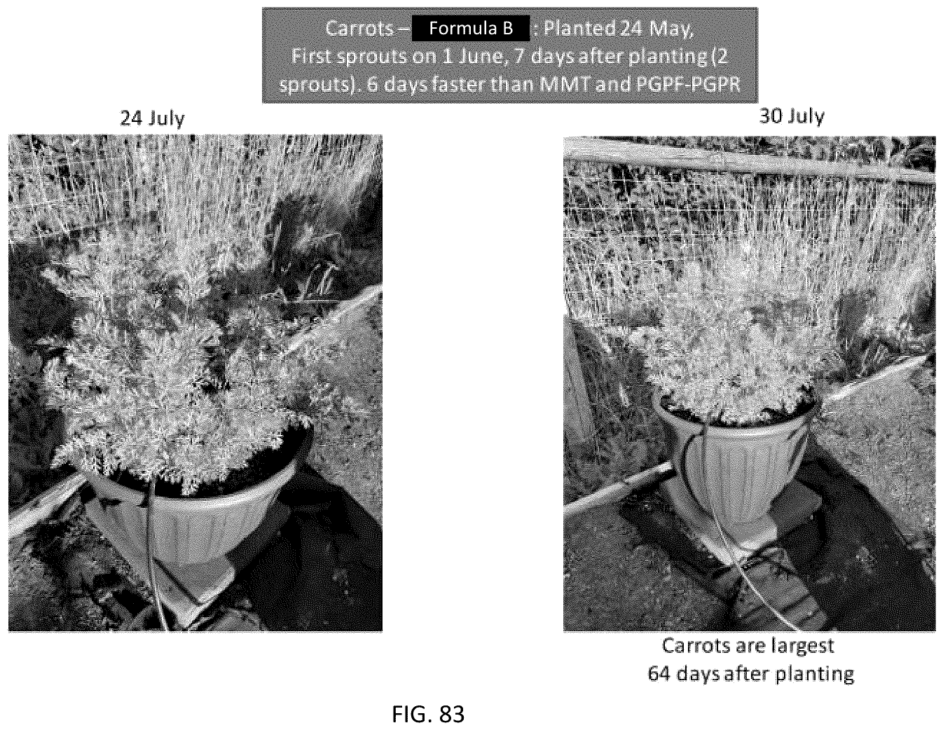

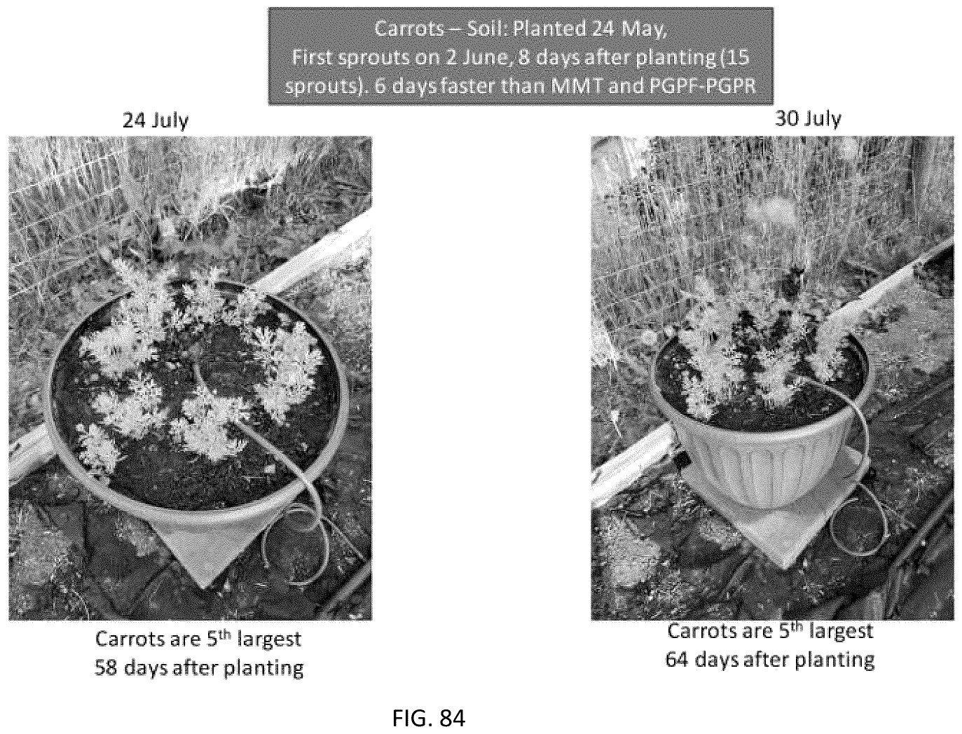

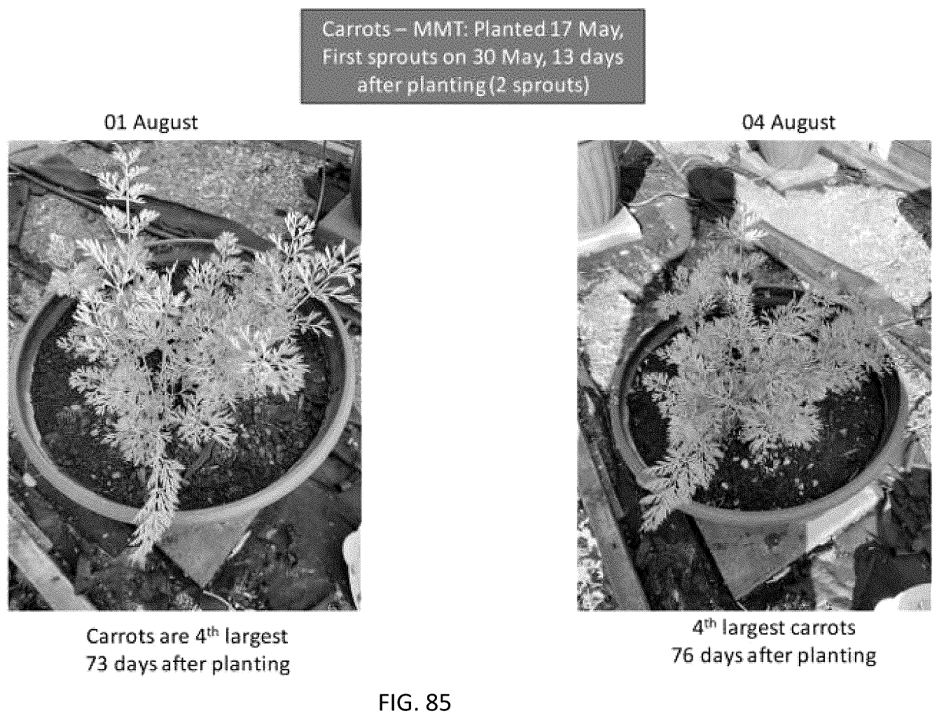

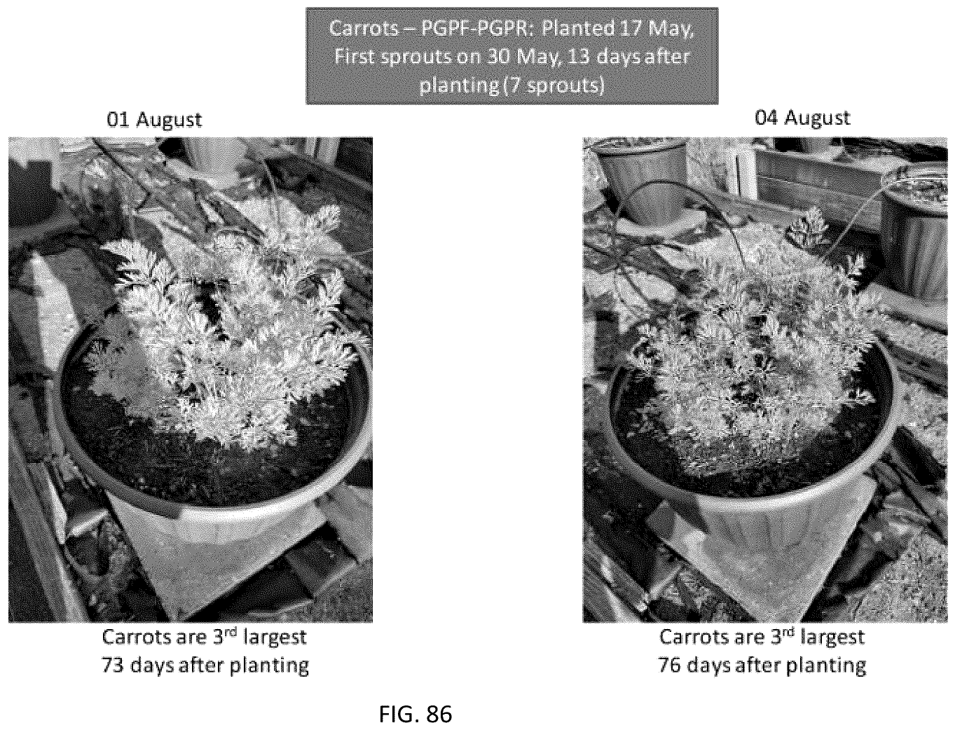

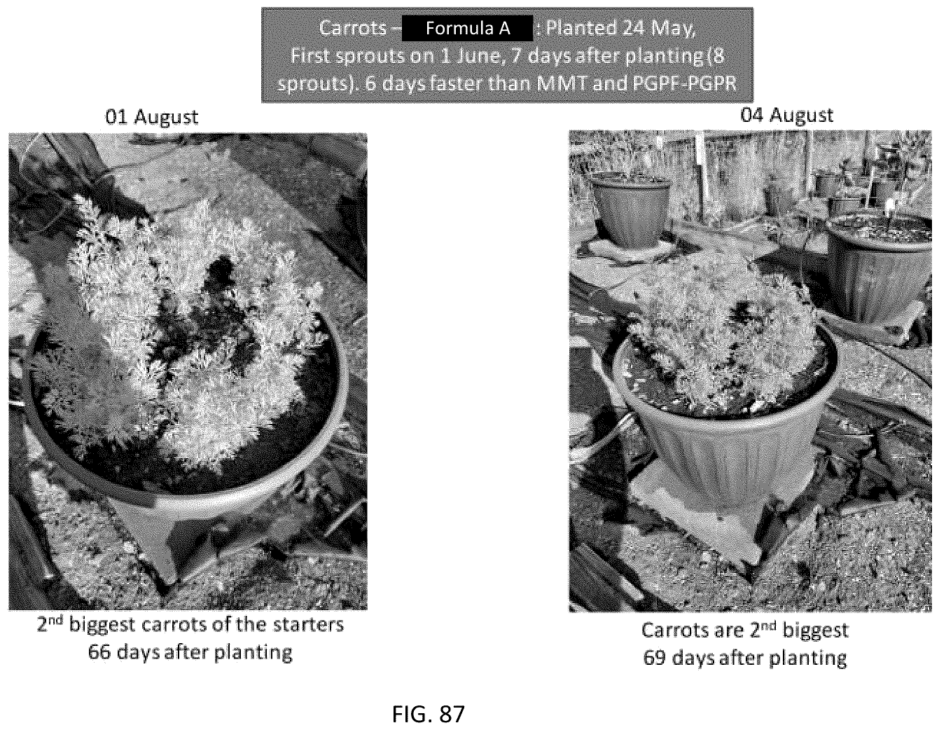

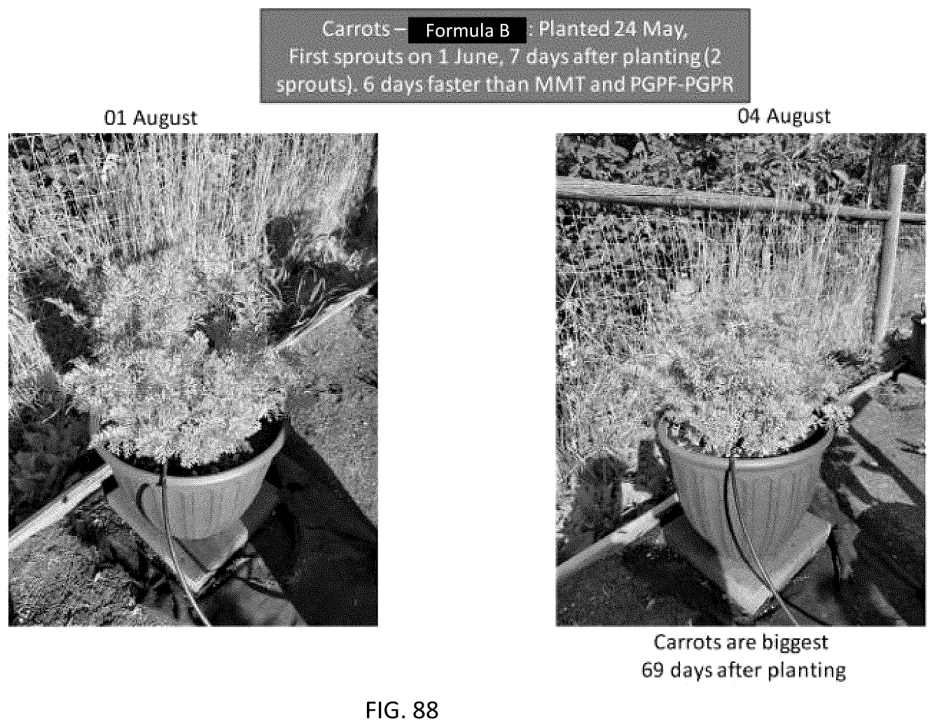

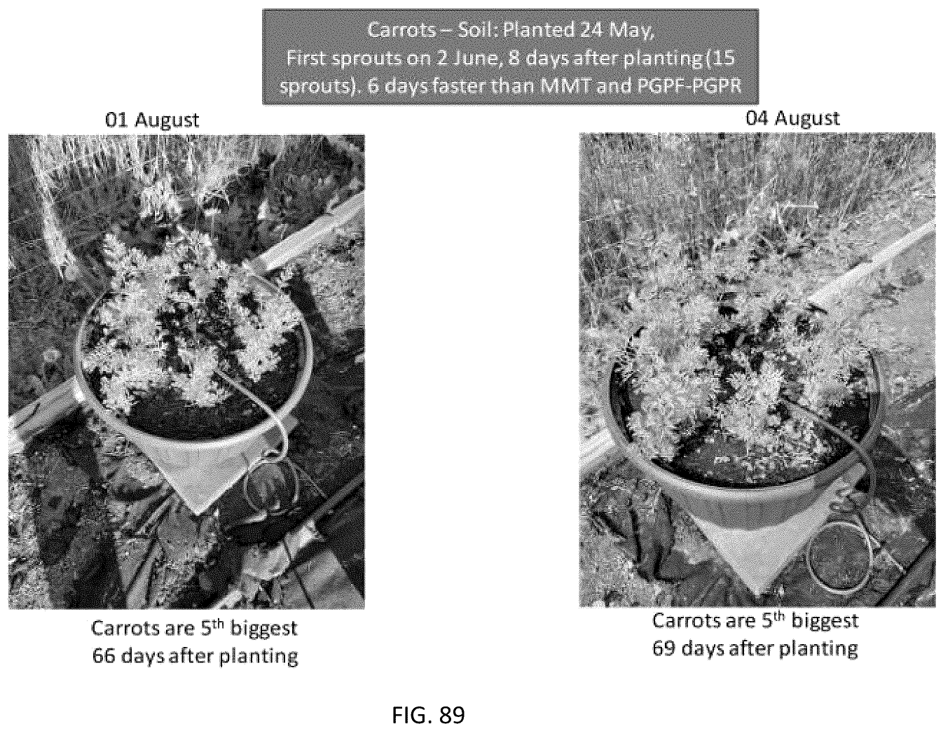

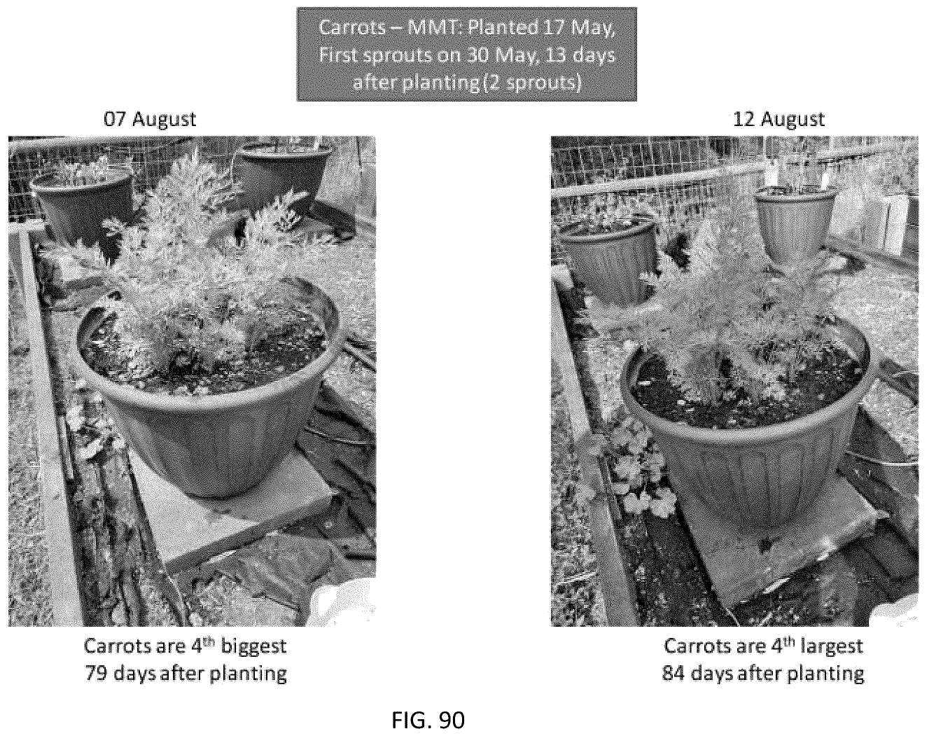

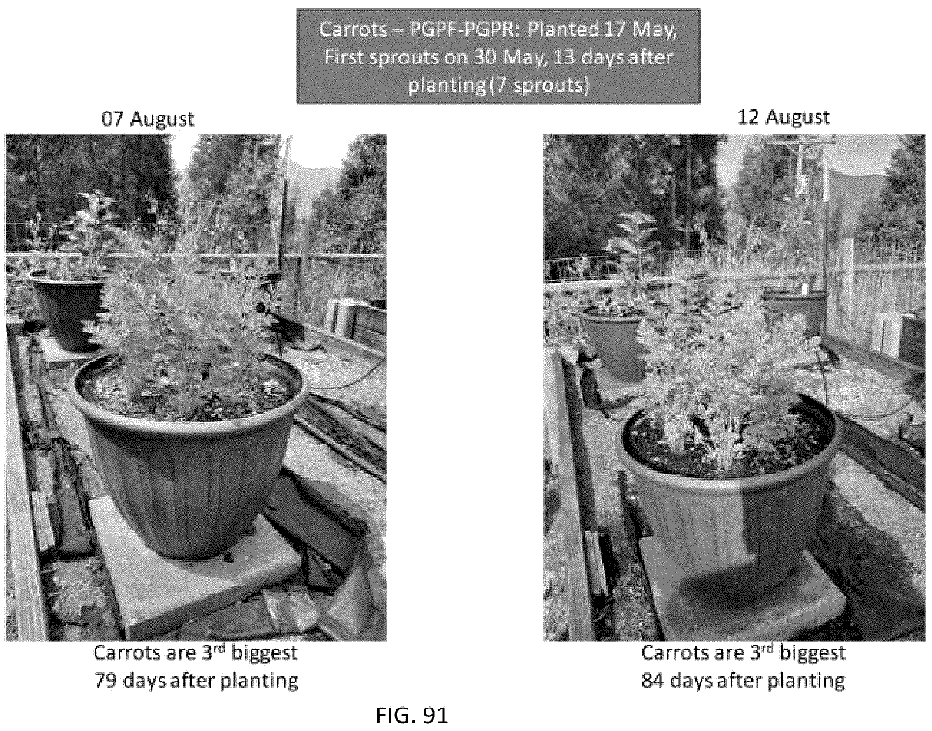

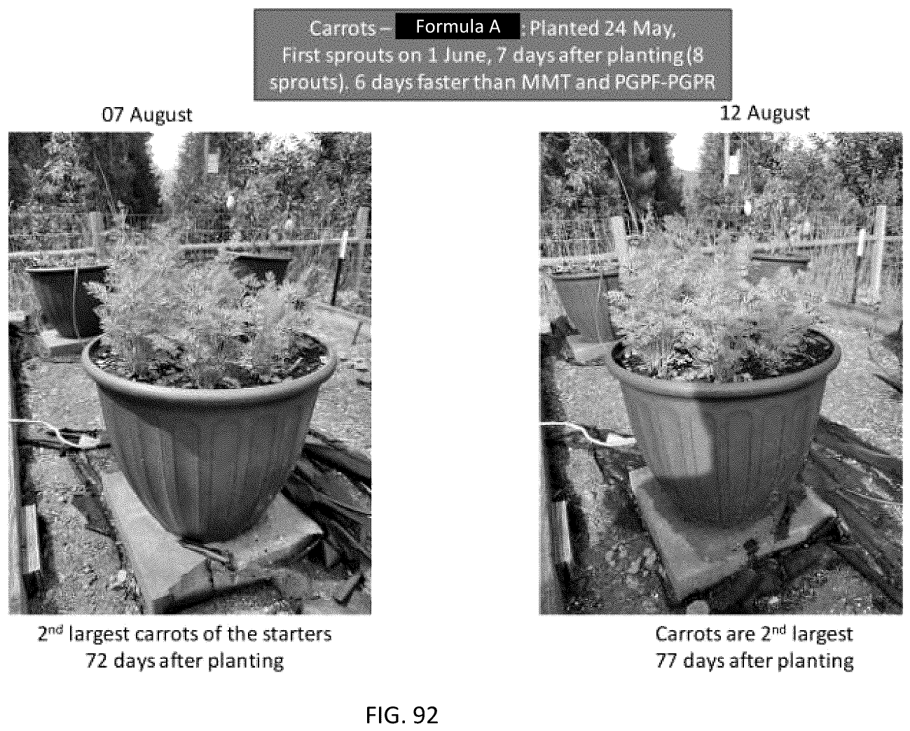

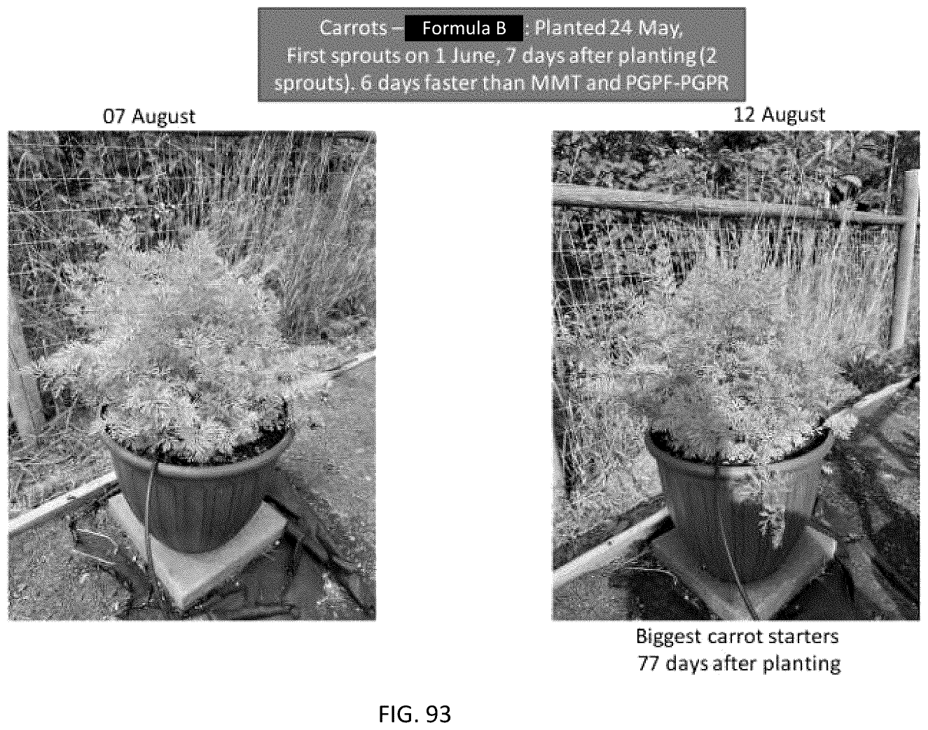

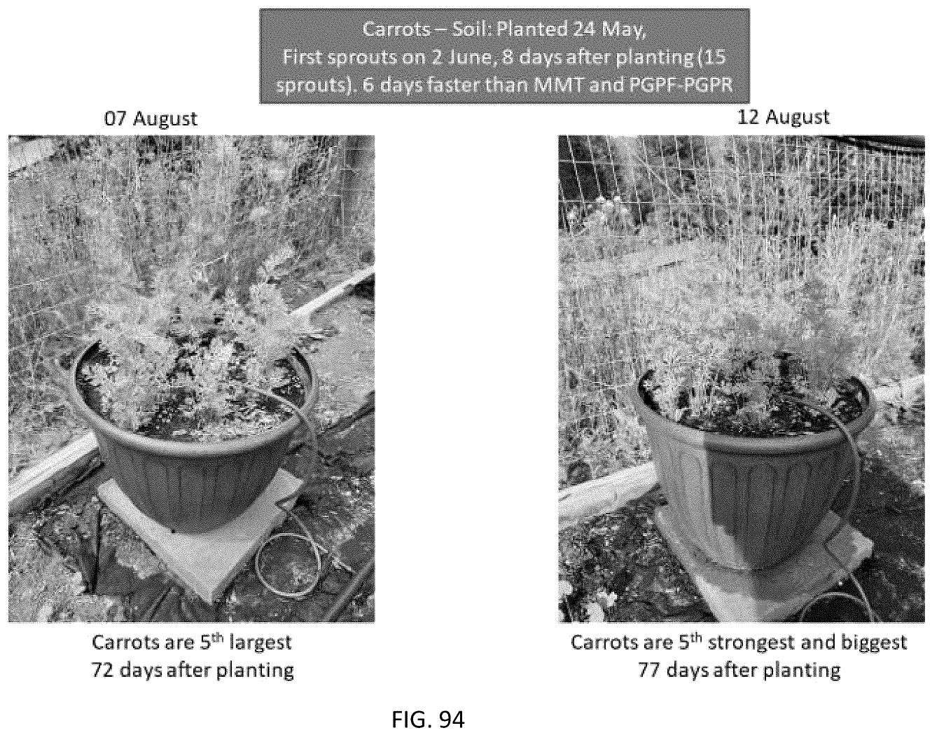

The compositions as prepared in Example 8 were applied to carrot starters. Carrot starters were observed to 9 weeks after planting. Images of the carrots are shown in FIGS. 50-94. The carrots in the Formula A and Formula B groups showed their first sprouts 7 days after planting, which was 6 days earlier than shown in the MMT and PGPF-PGPR groups. During weeks 2-4, MMT and PGPR-PGPF beds saw minimal growth. The Formula A, Formula B, and Soil beds saw increased growth. The Formula B and Soil groups received about 3 extra hours of sunlight, which may be a factor in the difference in the growth beds. Among the MMT, PGPF-PGPR, and Formula A groups, the Formula A group had the healthiest-looking vegetables. Overall, the Formula B group showed the largest and healthiest vegetables.

TABLE 14
Number of Carrot Sprouts Over Time During Weeks 1 to 3

| | | Days post planting | | | | | | | | | | | | |
|---|---|---|---|---|---|---|---|---|---|---|---|---|---|---|
| Plant date | Test Group | 7 | 8 | 11 | 13 | 15 | 17 | 18 | 19 | 22 | 24 | 26 | 29 | 31 |
| May 17 | MMT | | | | 2 | | | 22 | | 21 | 23 | 22 | 21 | 23 |
| May 17 | PGPF-PFPR | | | | 7 | | | 33 | | 35 | 35 | 33 | 35 | 35 |
| May 24 | Formula A | 8 | | 95 | | 97 | 97 | | 95 | 97 | 97 | | | |
| May 24 | Formula B | 2 | | 68 | | 72 | 73 | | 68 | 73 | 73 | | | |
| May 24 | Soil | | 15 | 65 | | 63 | 63 | | 65 | 63 | 63 | | | |

Growth was stunted during week 4 due to a cold snap where temperatures dropped to 43° F. at night for 4 consecutive days starting June 18. Minimal sunlight was observed during this time with wet and rainy conditions. The temperature ranged between 46° F. and 51° F.

During week 4, the Formula B group had the largest carrot plants while the PGPF-PGPR group had the second largest and second strongest carrot plants. The Formula A group had the most number of sprouts and was the third strongest. The Soil group showed the second smallest and fourth strongest carrot plants, while the MMT group was the smallest.

During week 5, carrot plants were sprouting higher. The Formula B group had the largest carrots and was the healthiest and fullest. The PGPF-PGPR group had the second tallest carrot plants and were healthy and tall. The Formula A group was beginning to sprout higher stems and leaves and was tall, healthy, and full. The MMT group had the fourth largest sprouts, while the Soil group had the smallest carrots.

During week 6, the Formula B group had the largest carrots and were 8 inches tall 49 days after planting and 10 inches tall at 56 days after planting. The Formula A group had carrots with 4-inch tall stems and were the second largest carrots. The PGPF-PGPR group had the third biggest carrots and the carrot leaves were 4 inches tall, while the MMT group had the fourth largest carrots and were 4 inches tall. The carrots in the Soil group were the fifth strongest of all test groups.

During week 7, carrots were growing faster. The Formula B group had the biggest carrots and measured at 12 inches. The Formula A group had the second largest carrots while the PGPF-PGPR group had the third biggest carrots. The MMT group had the fourth largest carrots that were 4 inches tall while the Soil group had the fifth largest carrots. Plants in the Formula B group were most noticeably abundant, healthy, and vibrant, followed by the plants in the Formula A group.

During week 8, the Formula B group showed the largest carrots measuring 12 inches, while the Formula A group had the second largest carrots. The PGPF-PGPR group had the third largest carrots while the MMT group had the fourth largest carrots. The Soil group showed the fifth biggest carrots. Plants in the Formula B group continued to be the most noticeably abundant, healthy, and vibrant, followed by the plants in the Formula A group.

During week 9, the Formula B group showed the largest carrots measuring 12 inches, while the Formula A group had the second largest carrots. The PGPF-PGPR group had the third largest carrots while the MMT group had the fourth largest carrots. The Soil group showed the fifth biggest carrots.

### Example 11: Beets

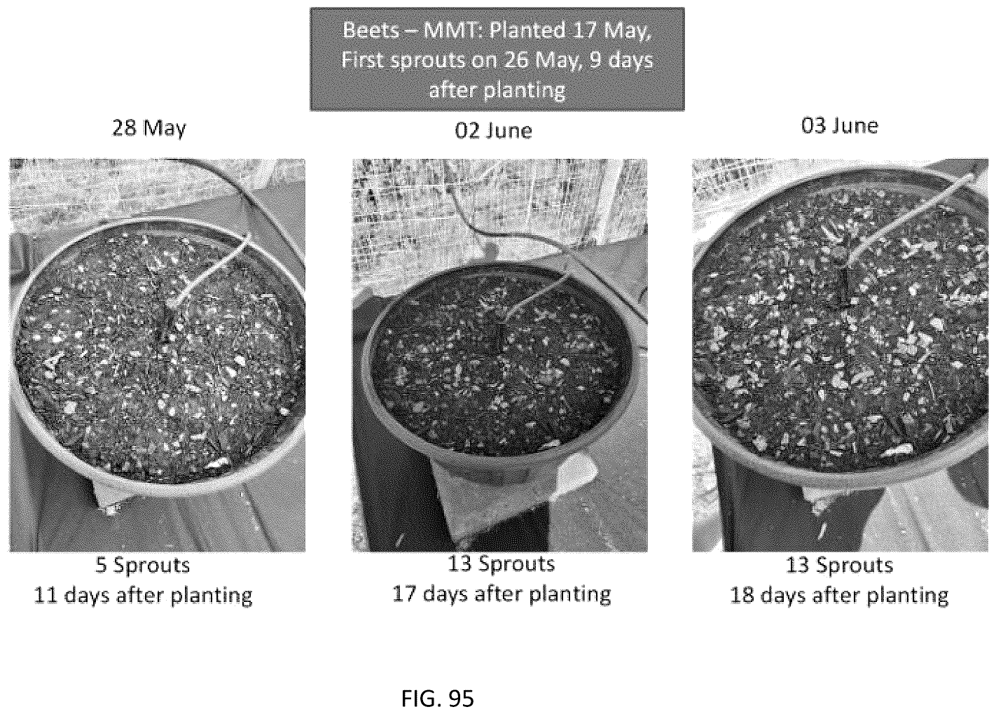

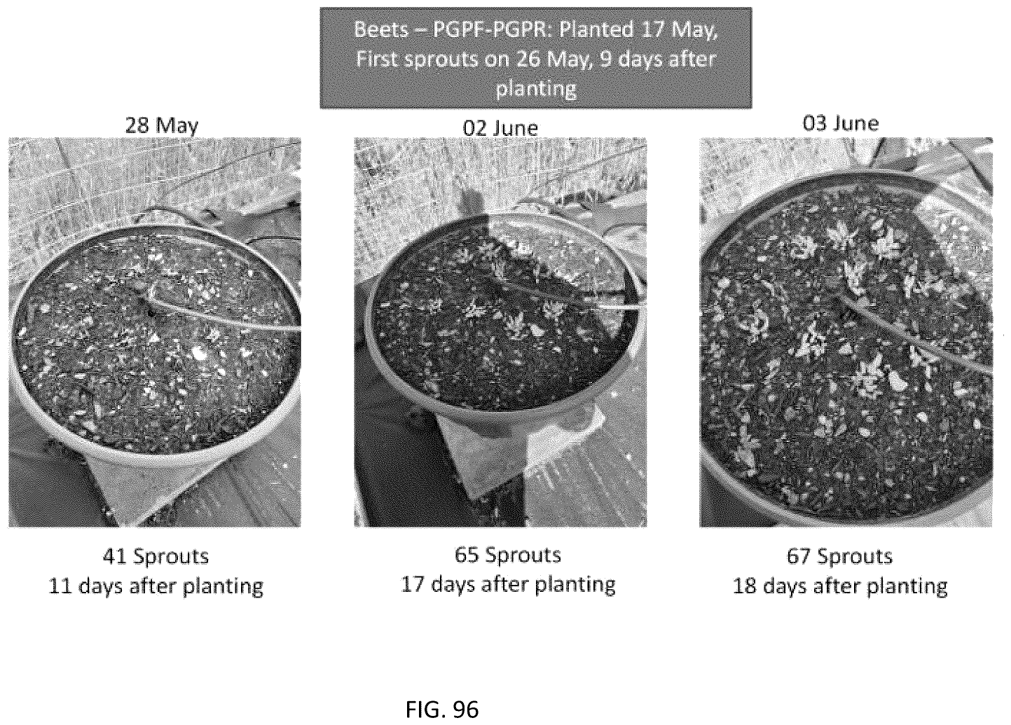

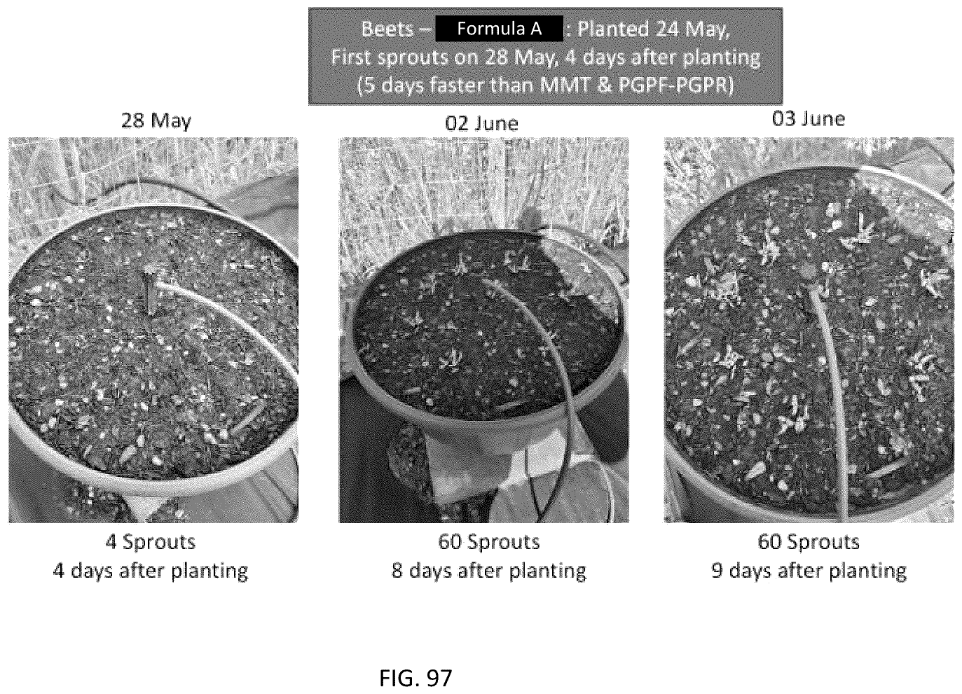

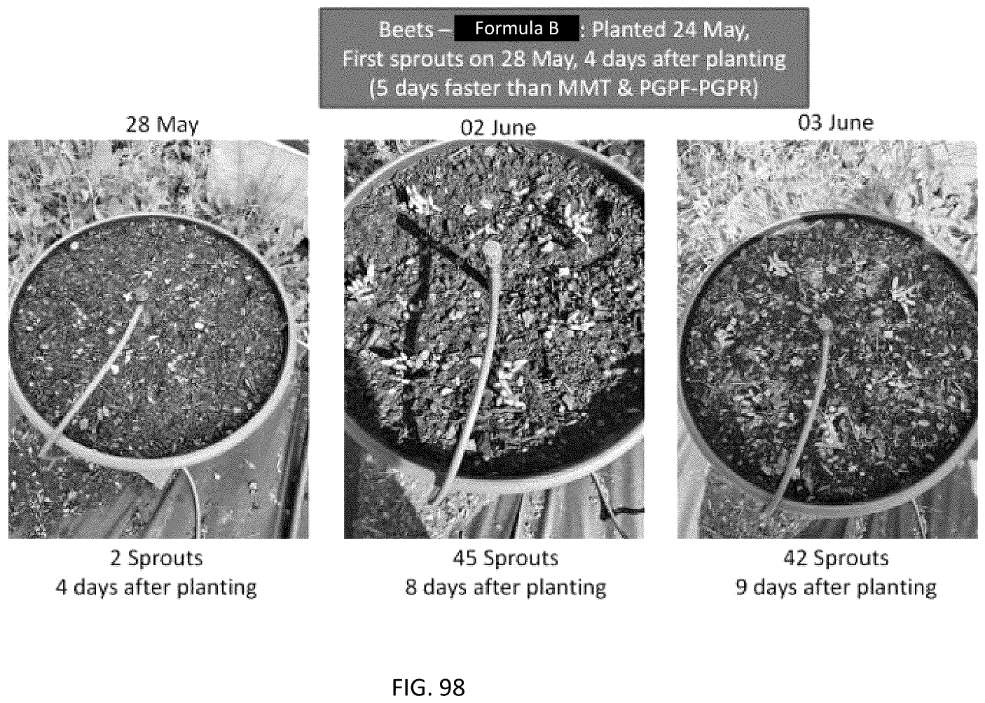

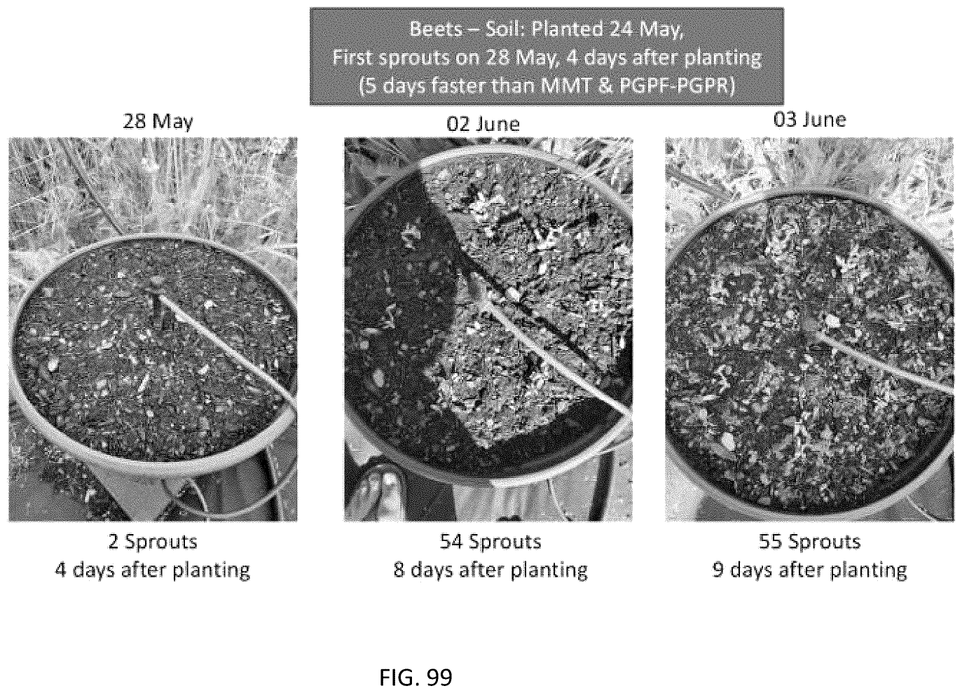

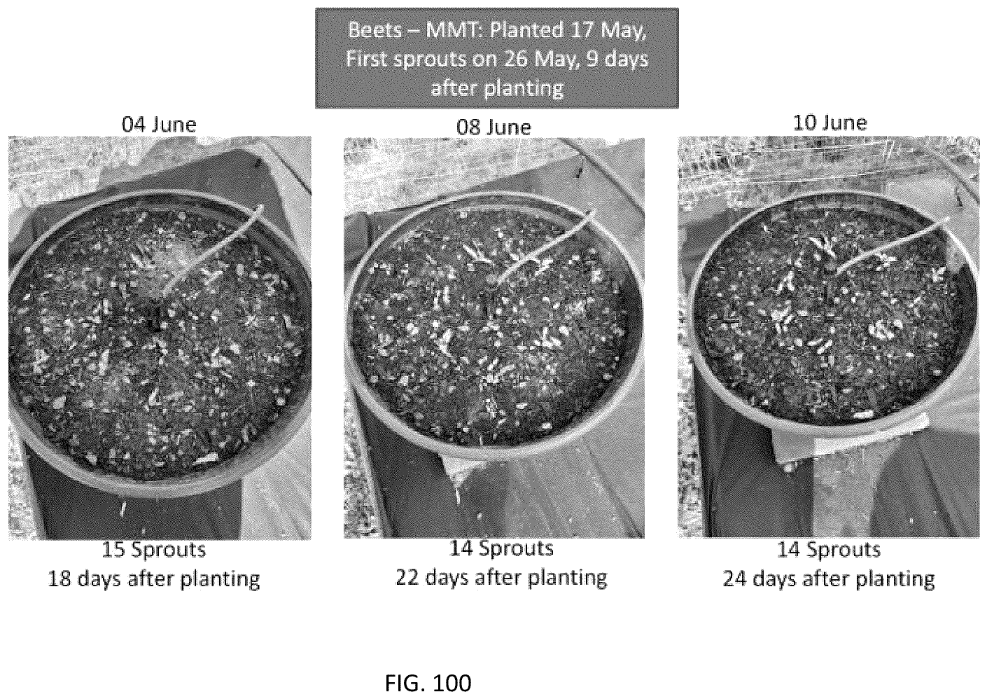

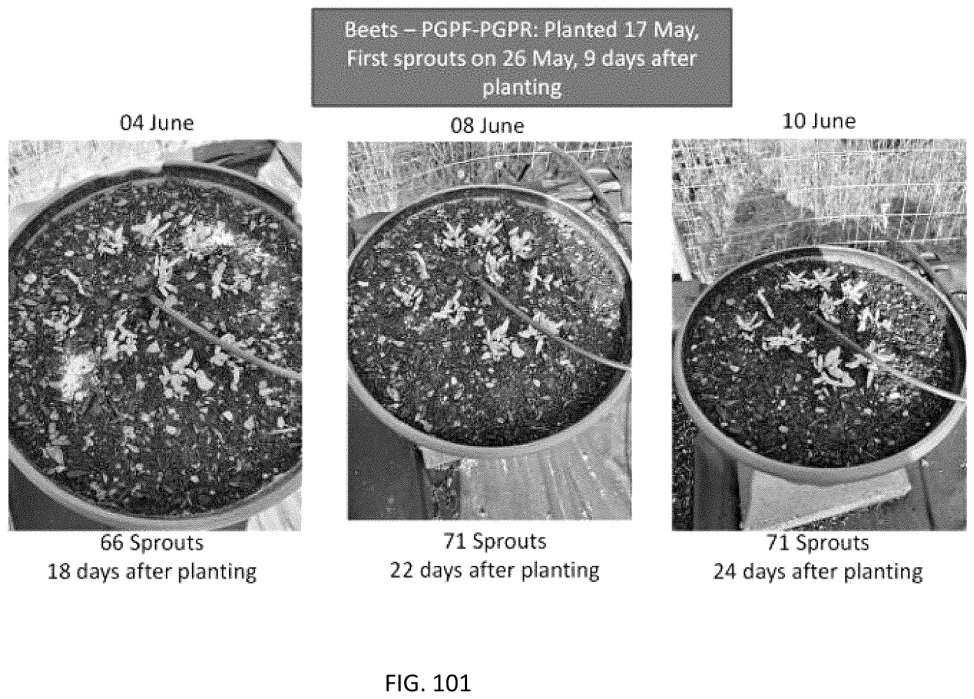

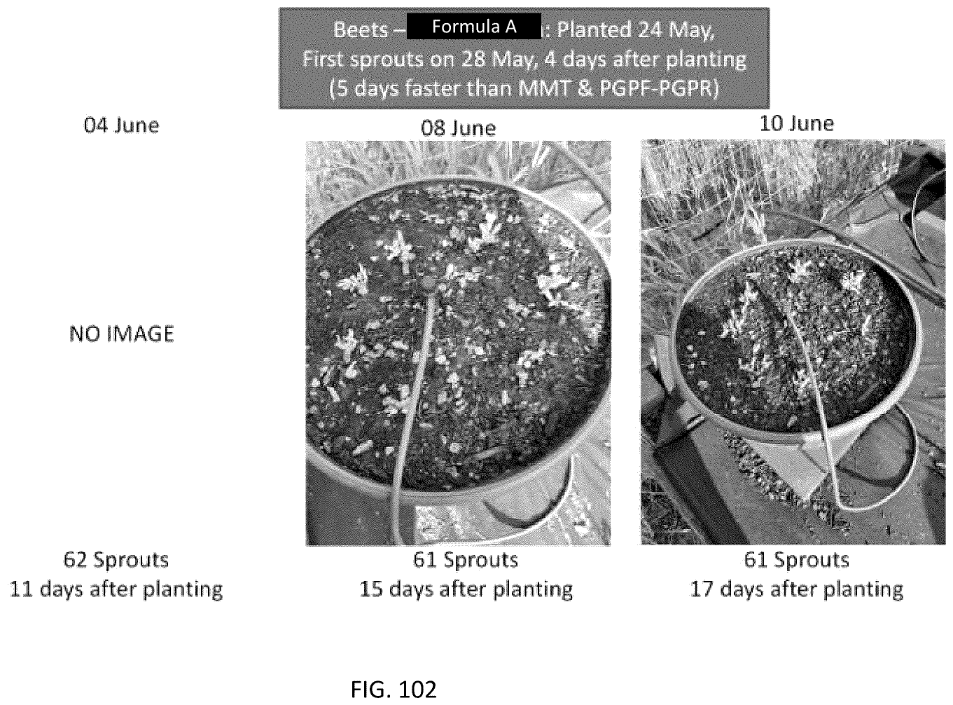

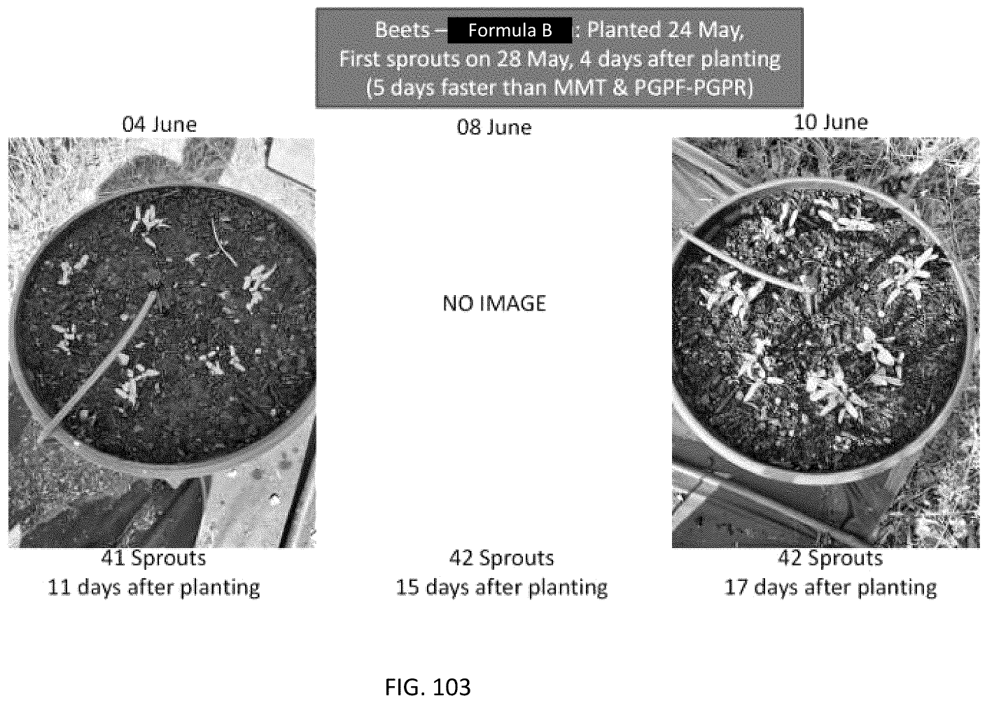

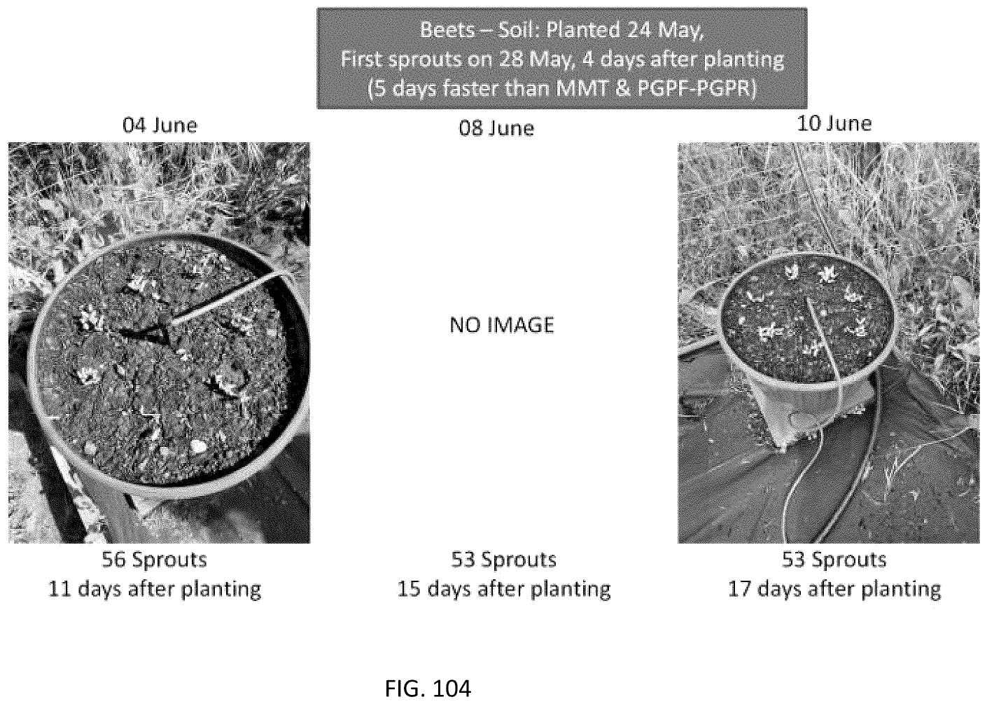

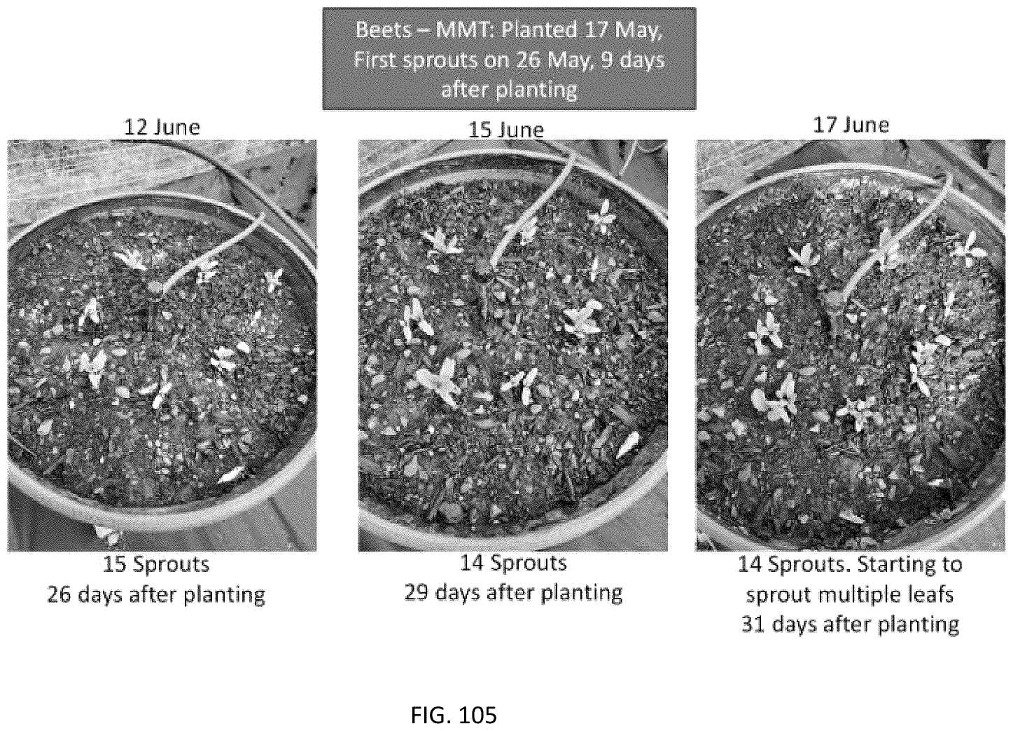

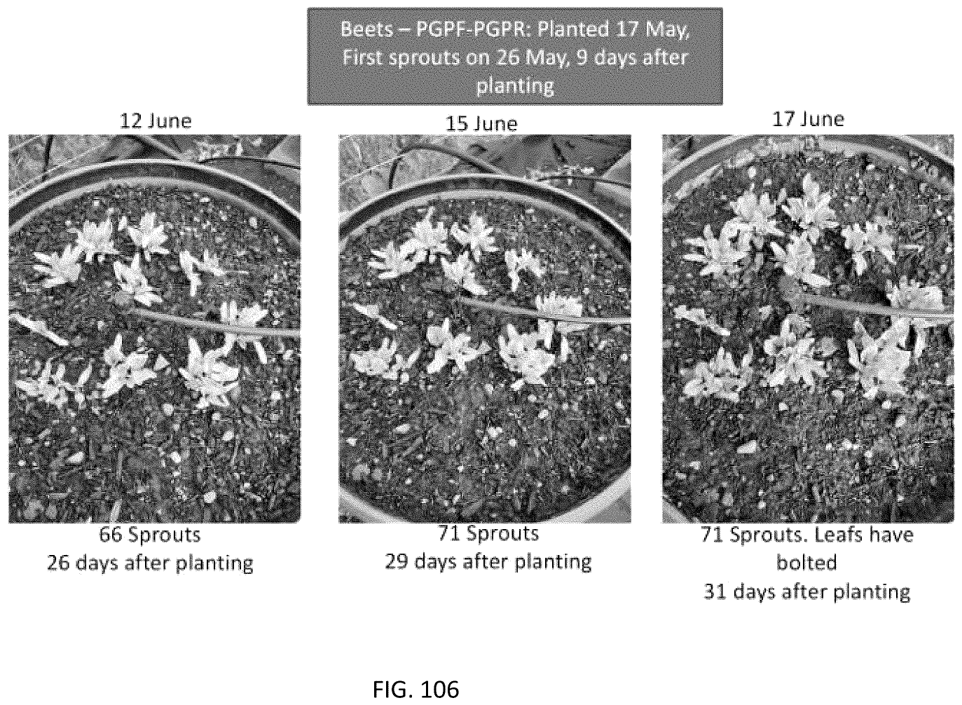

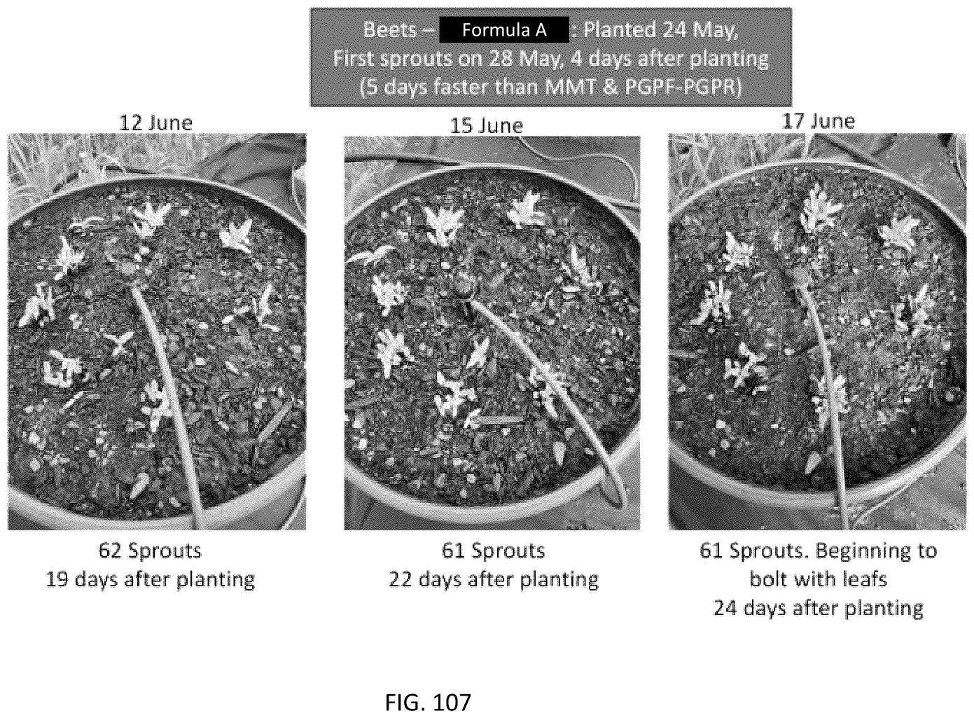

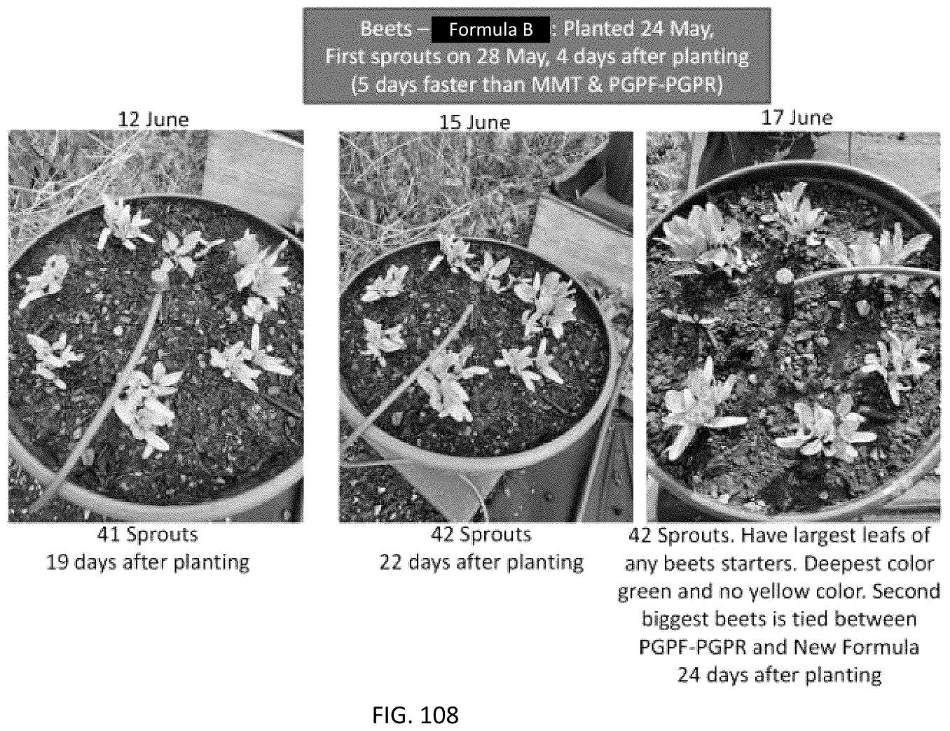

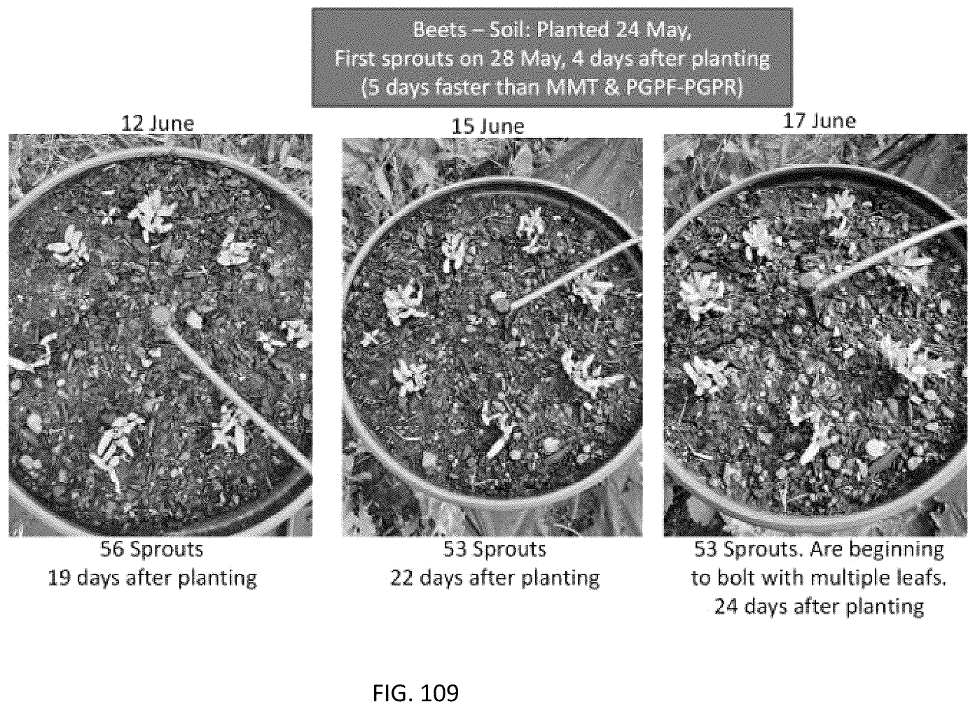

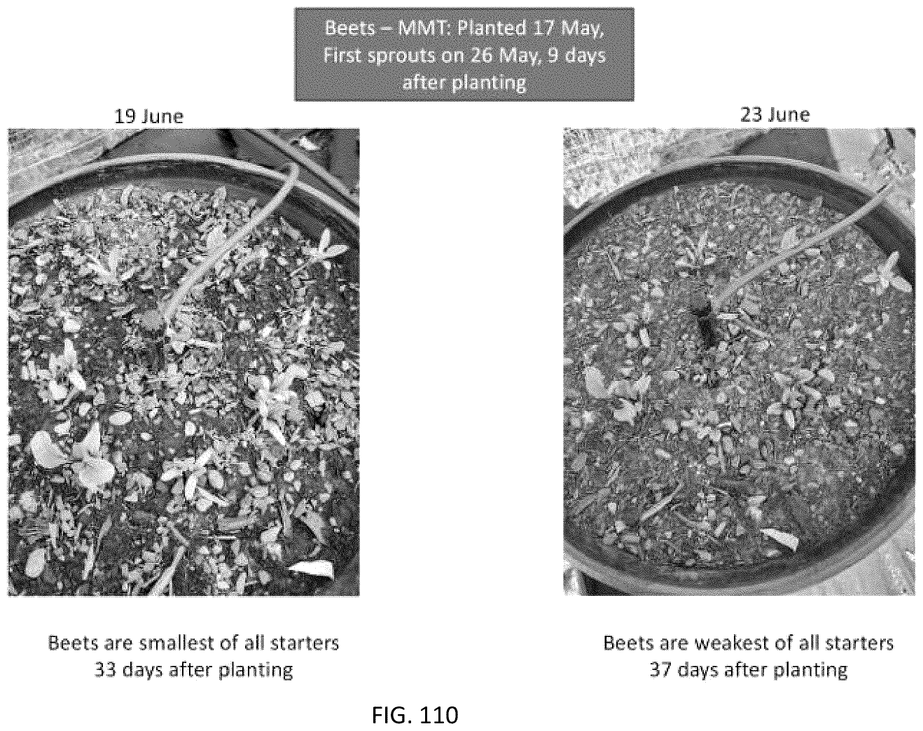

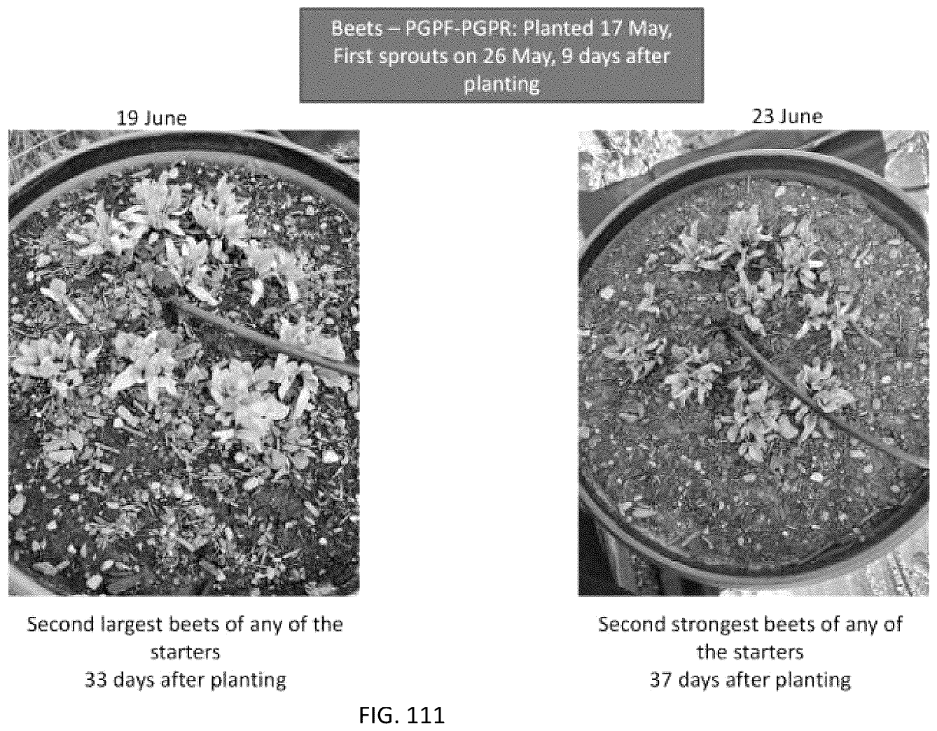

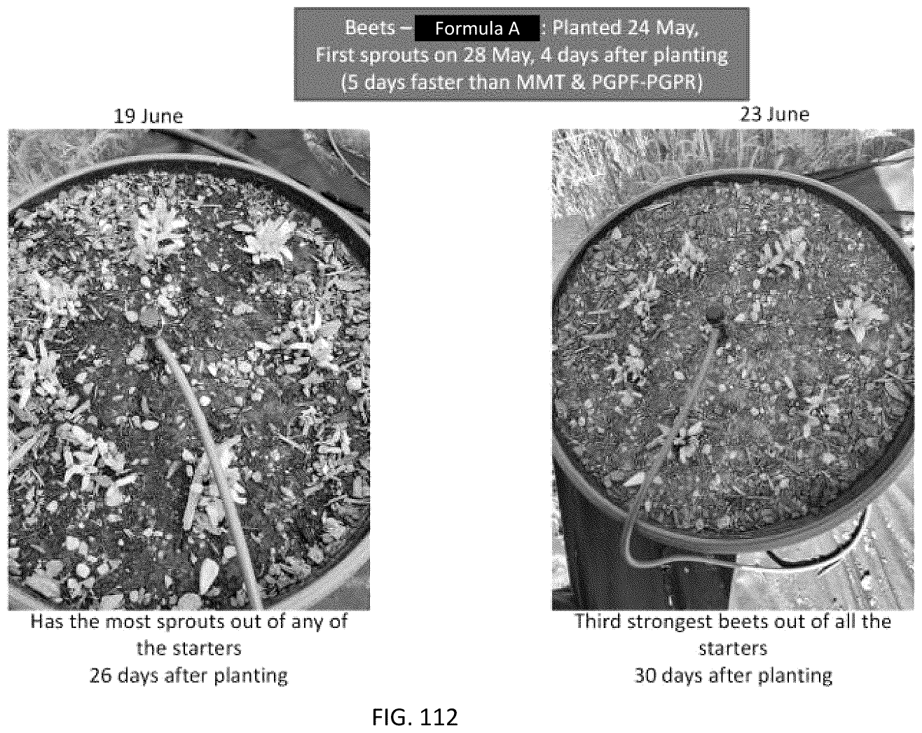

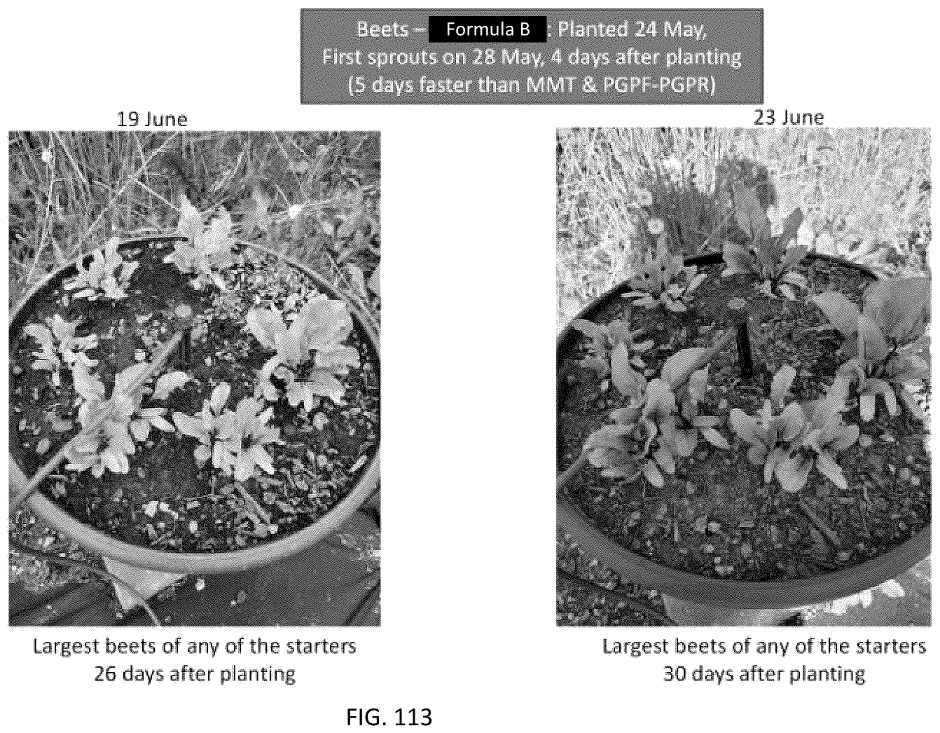

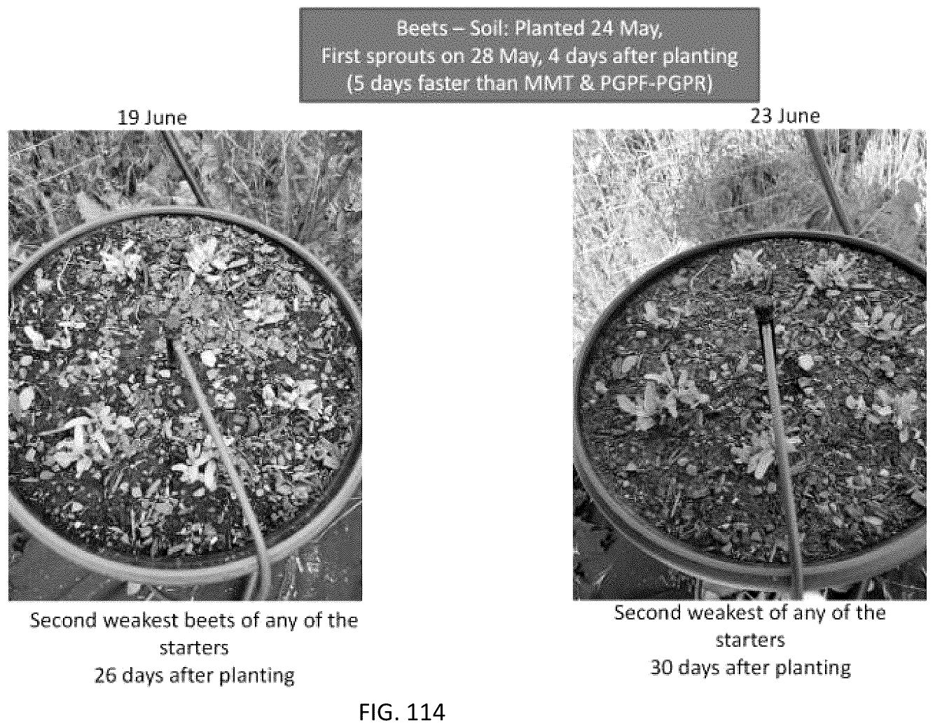

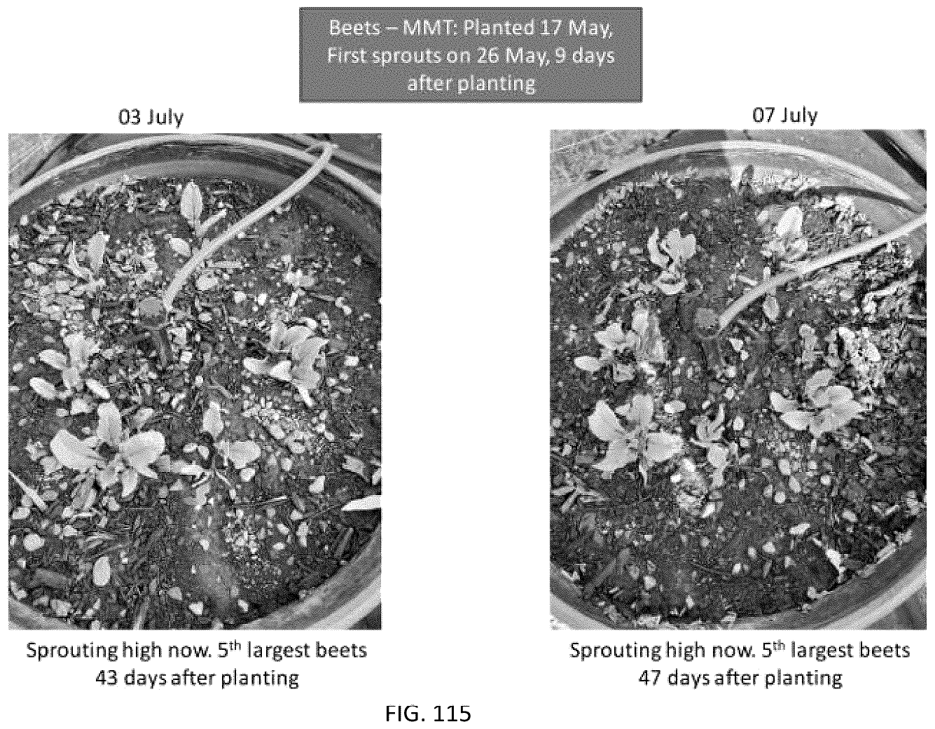

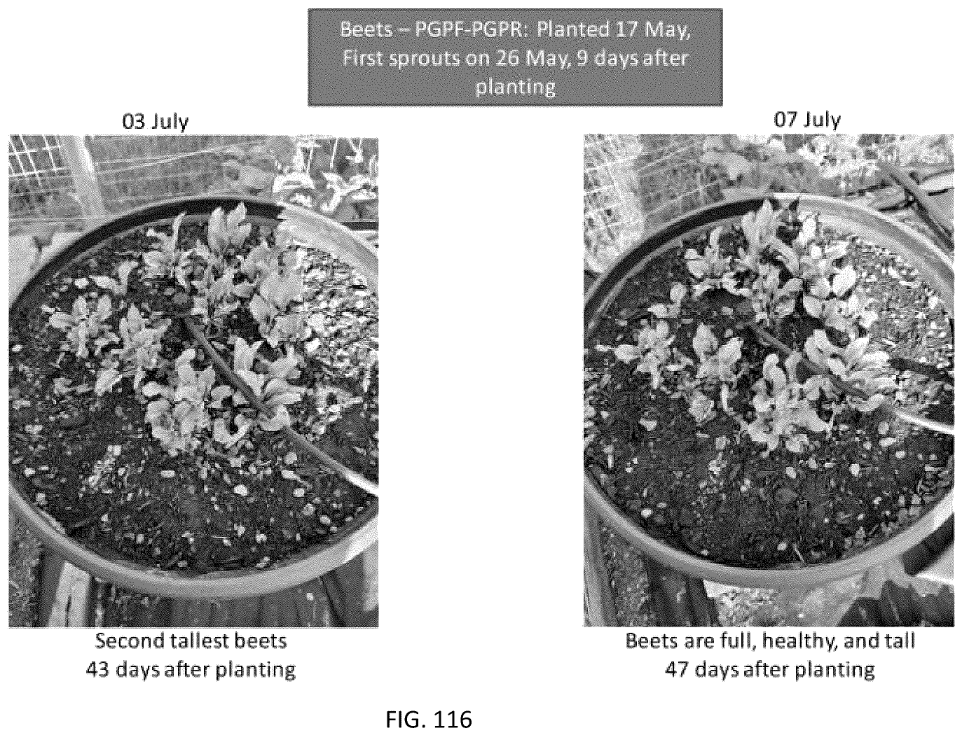

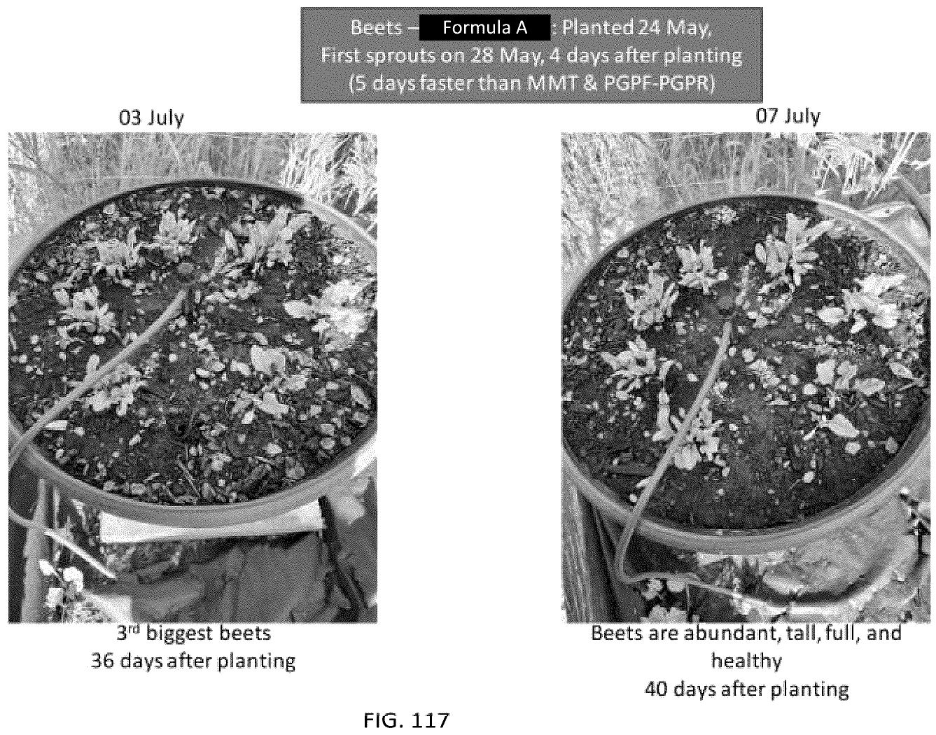

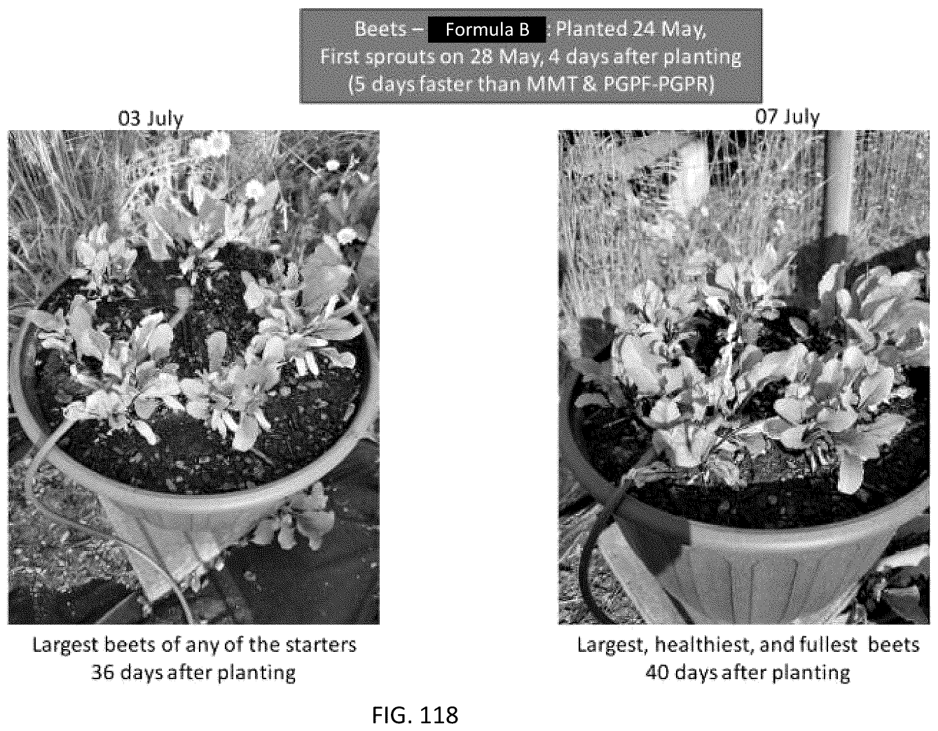

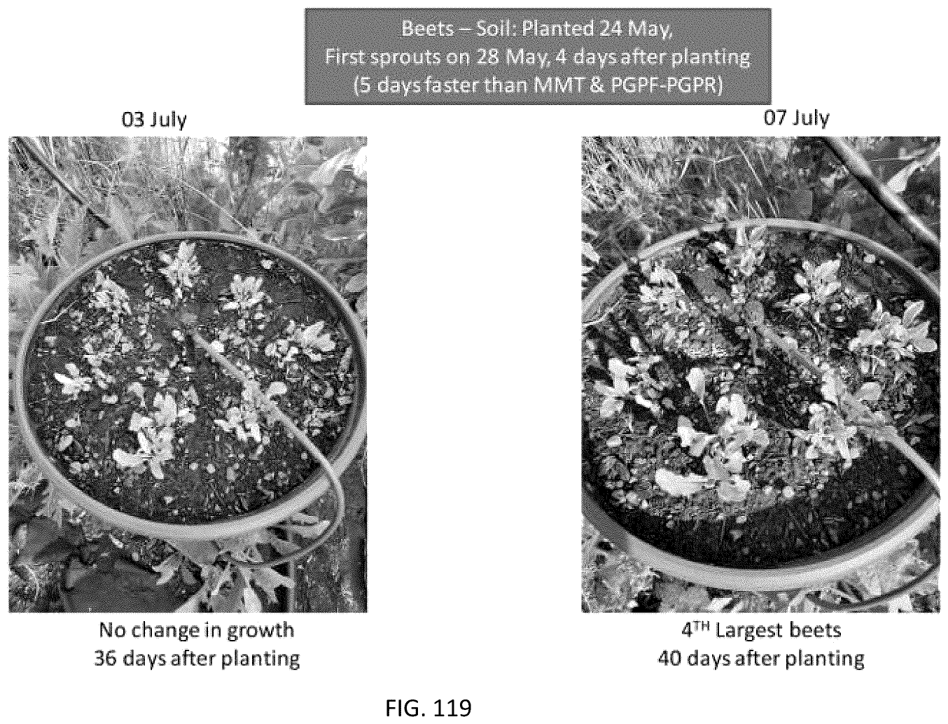

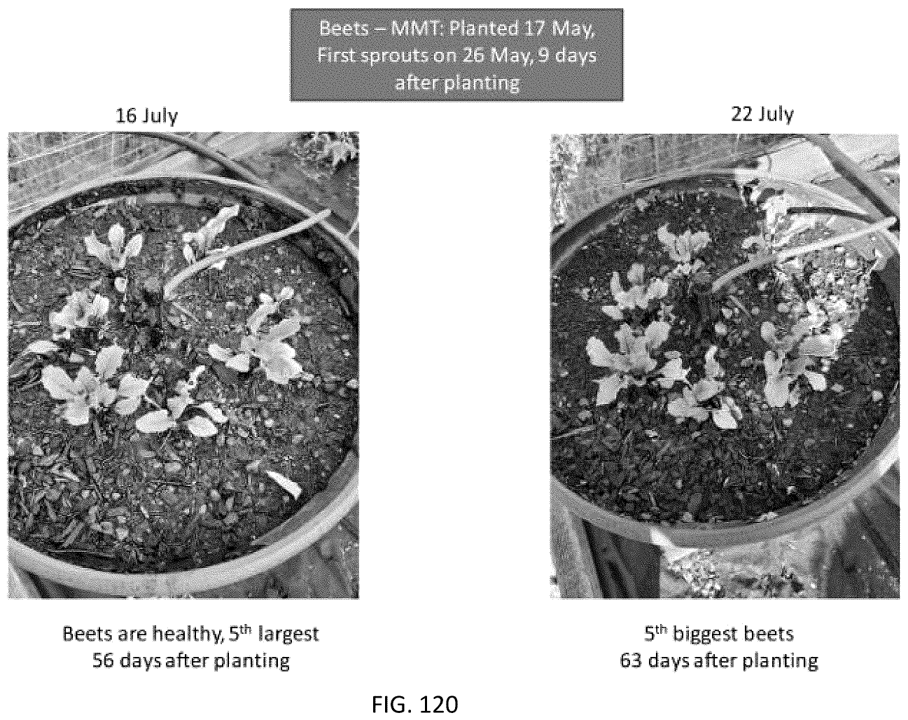

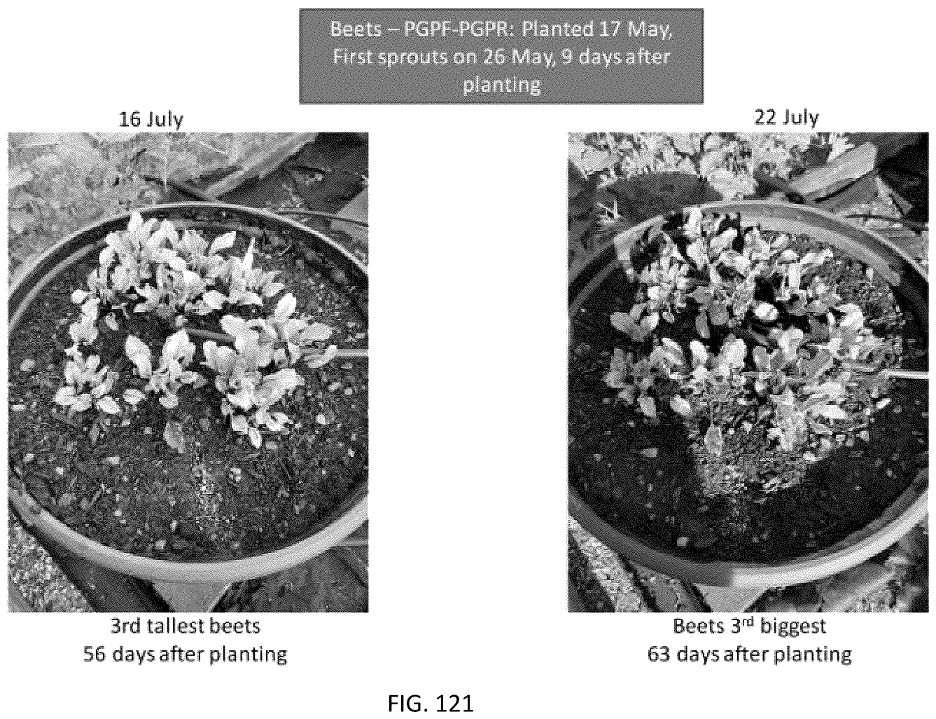

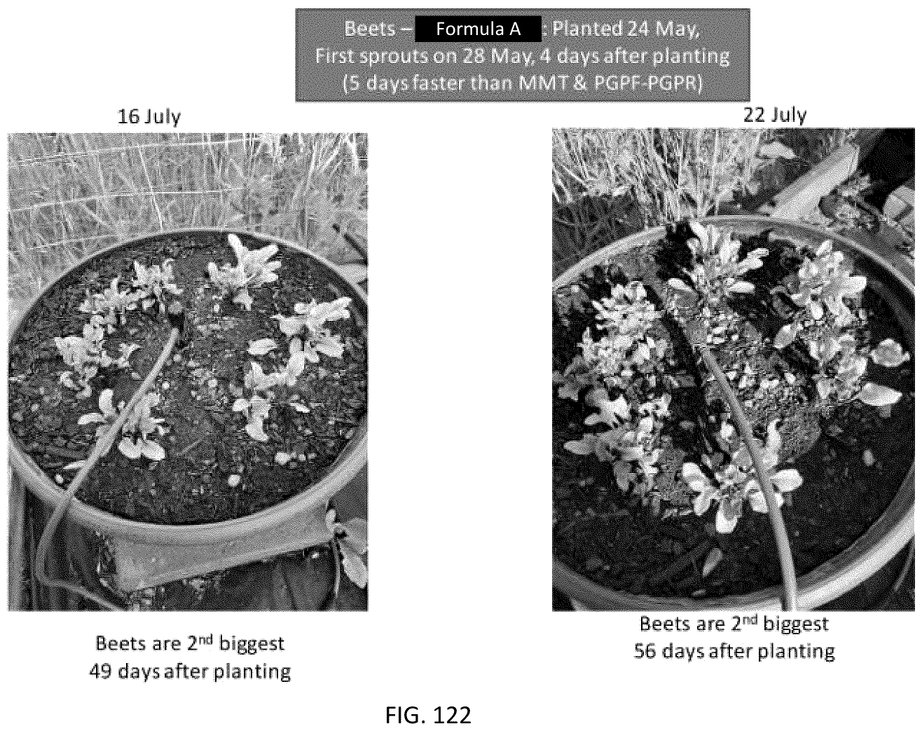

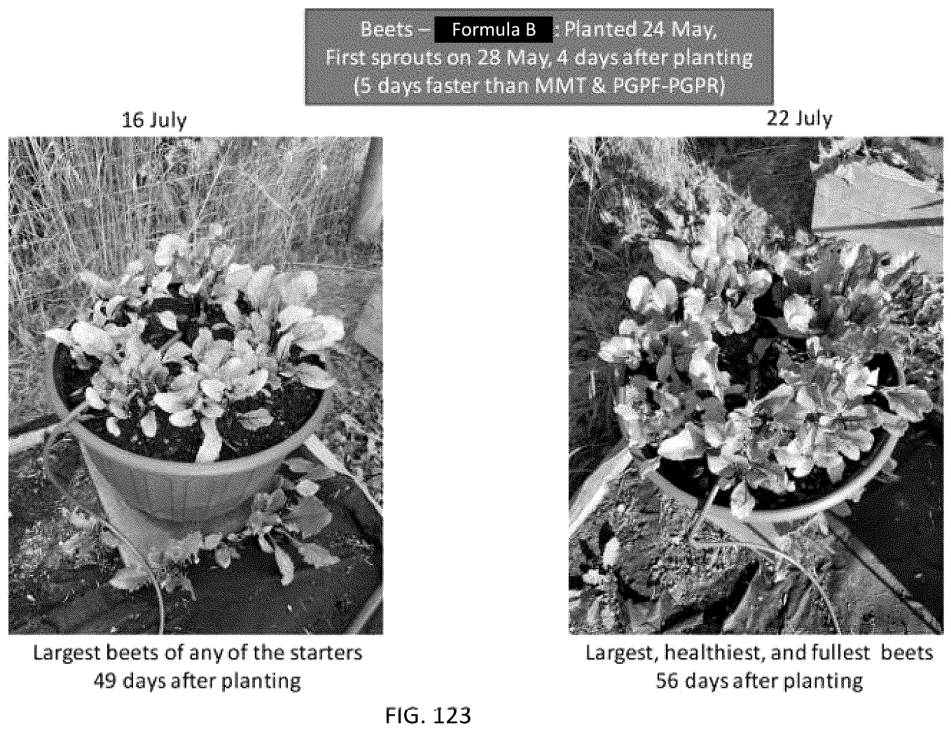

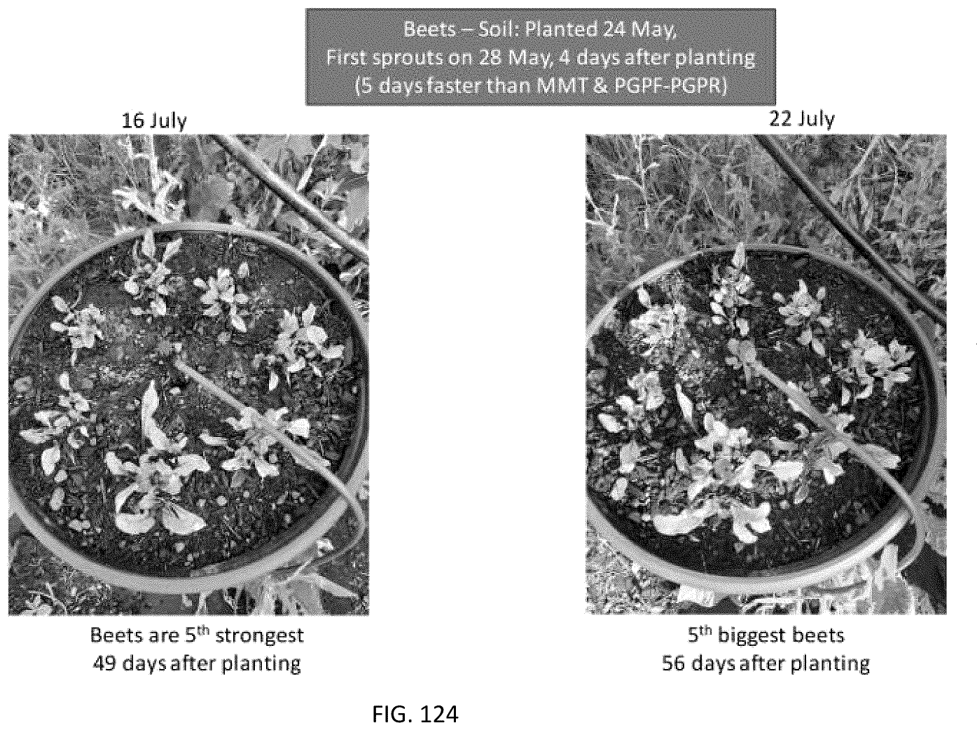

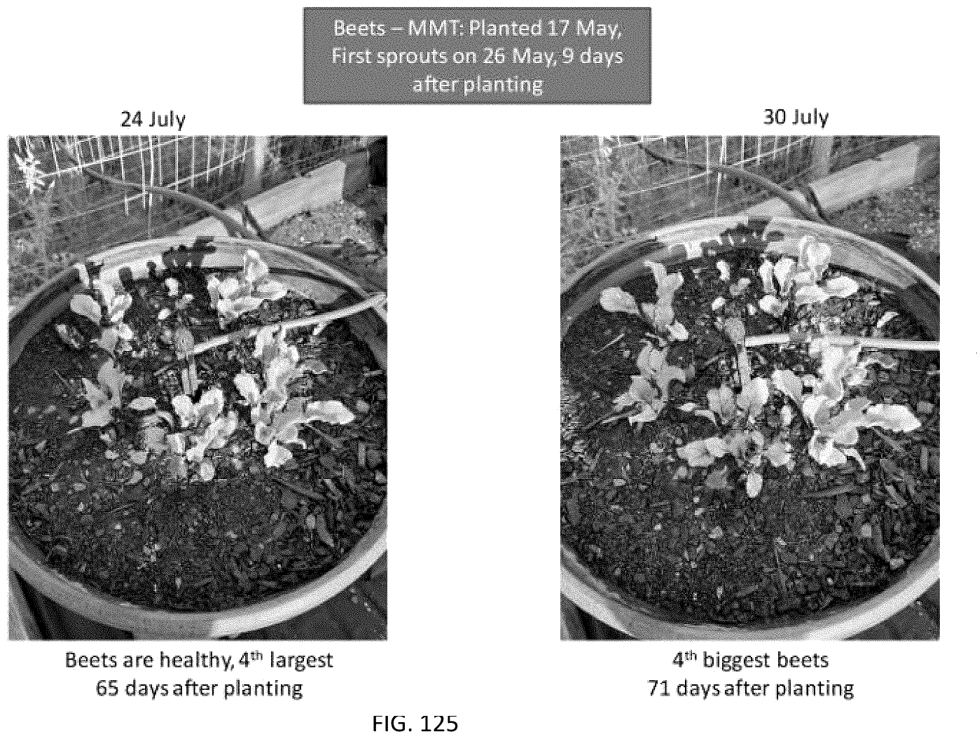

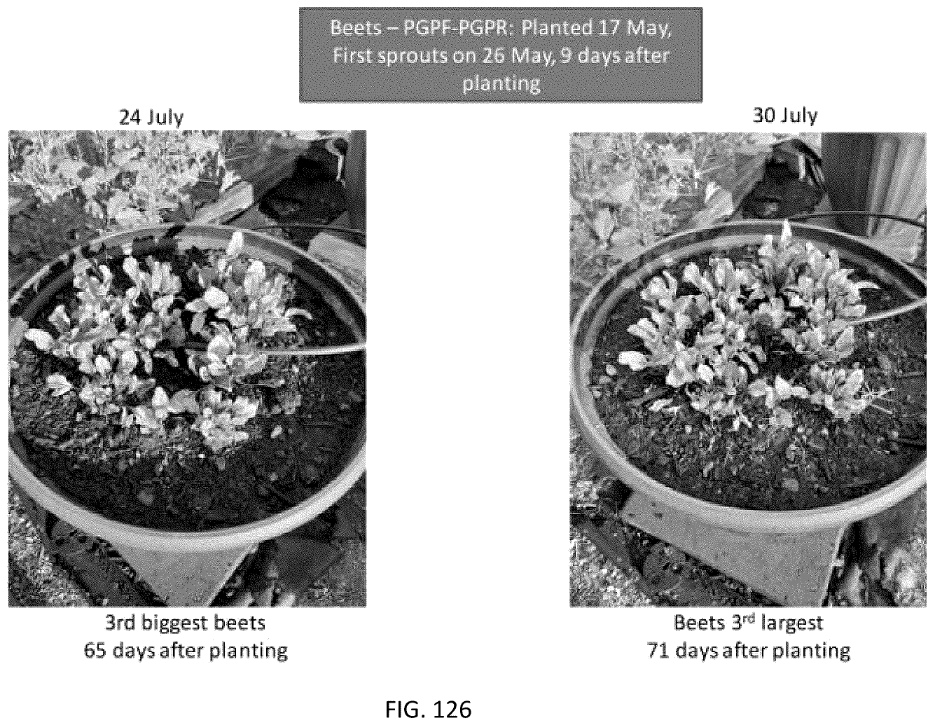

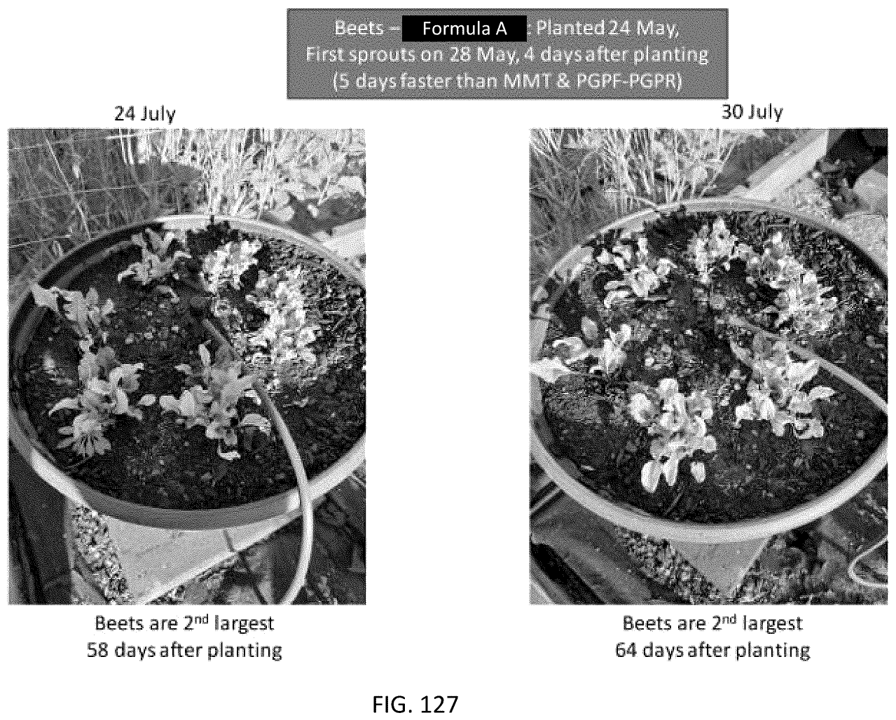

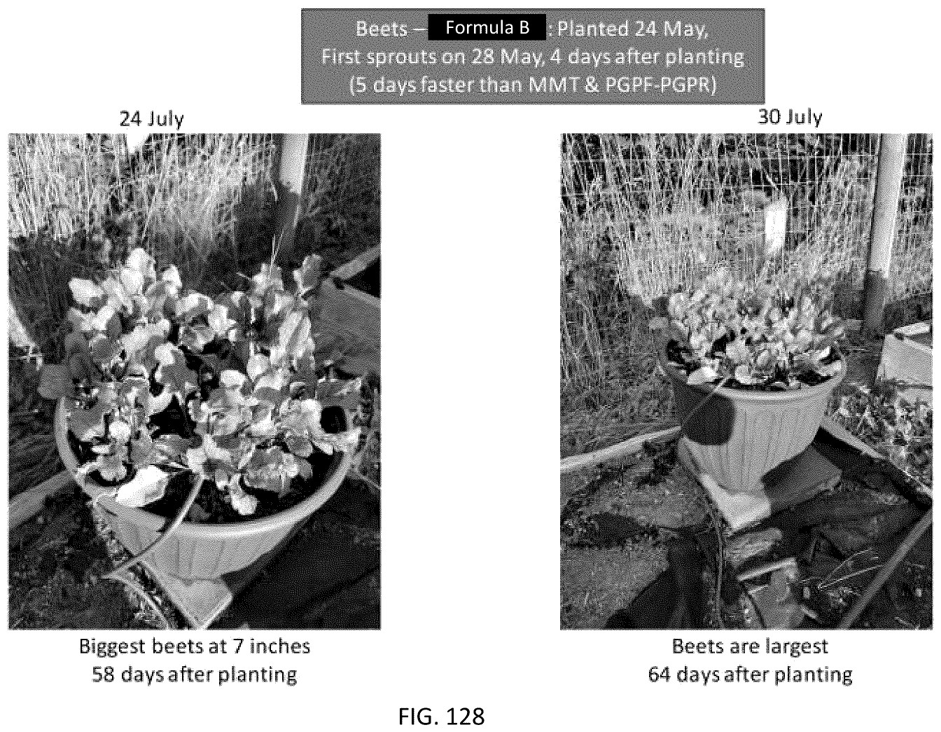

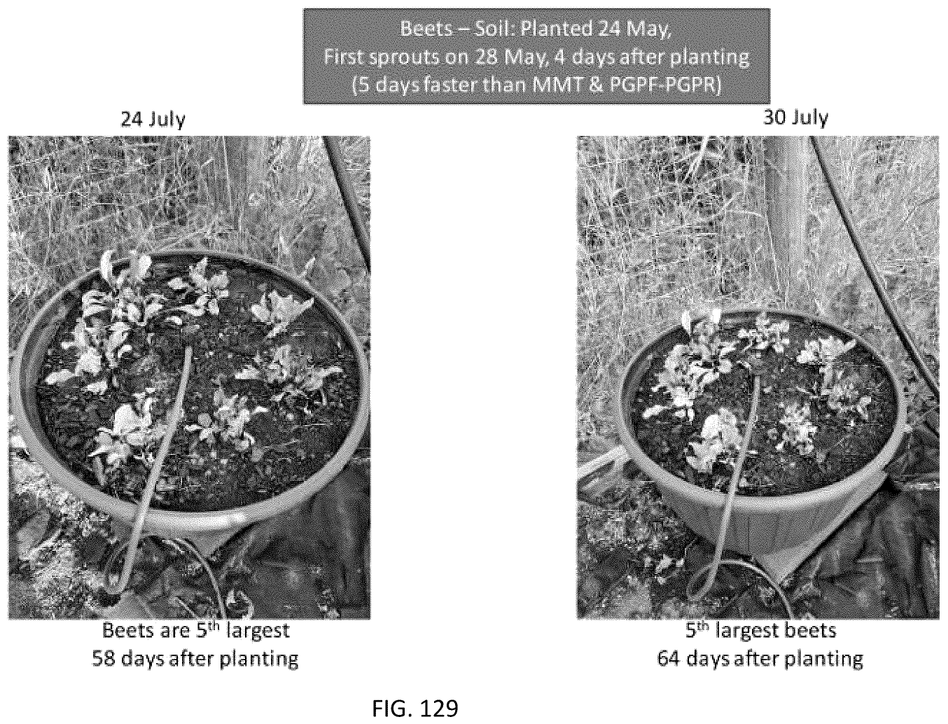

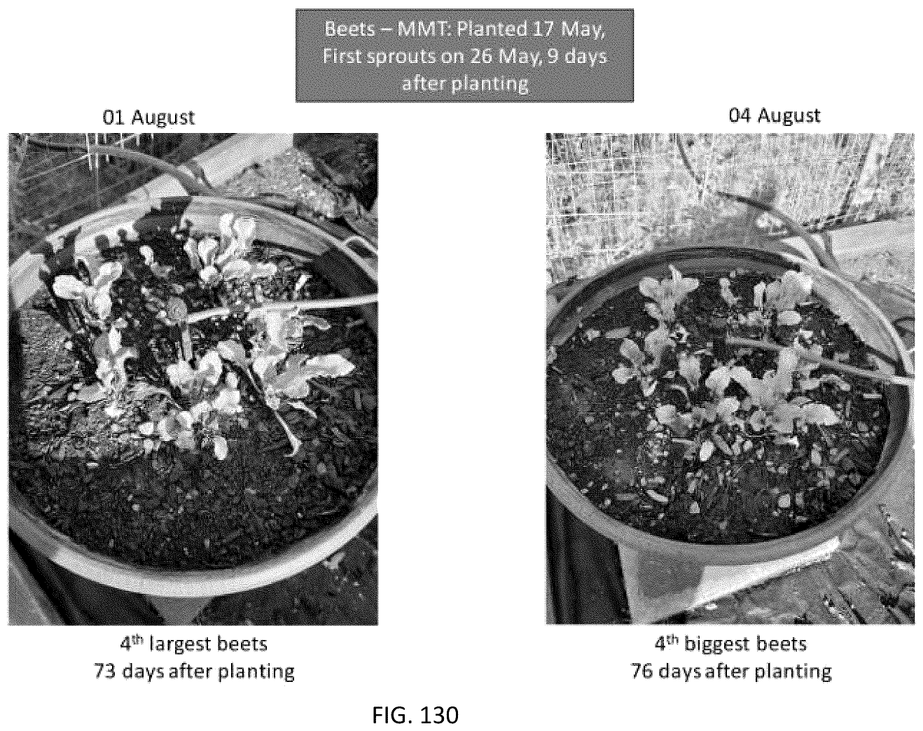

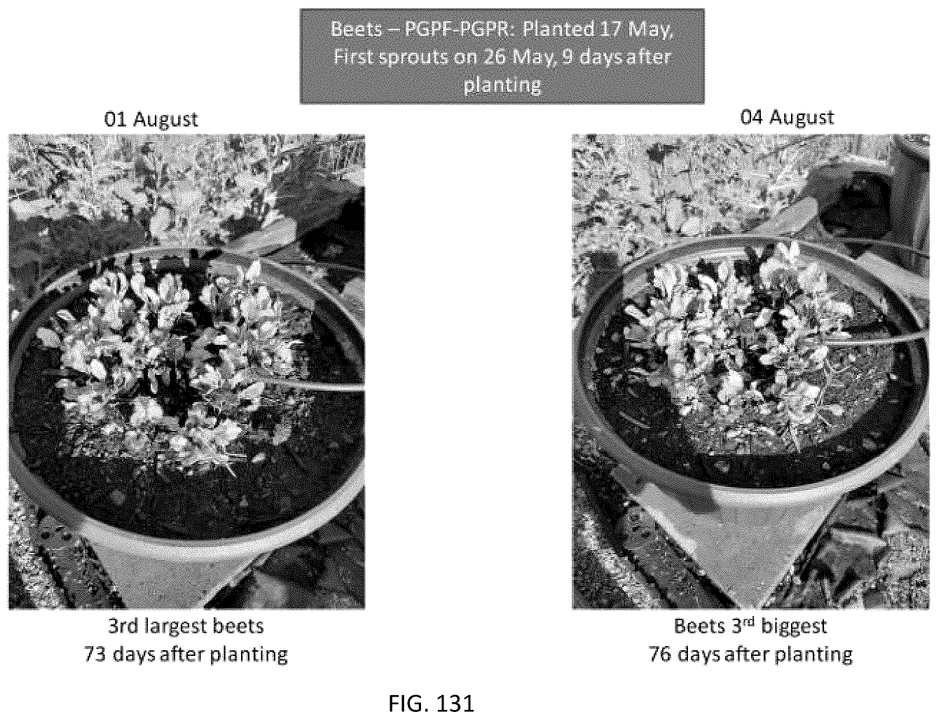

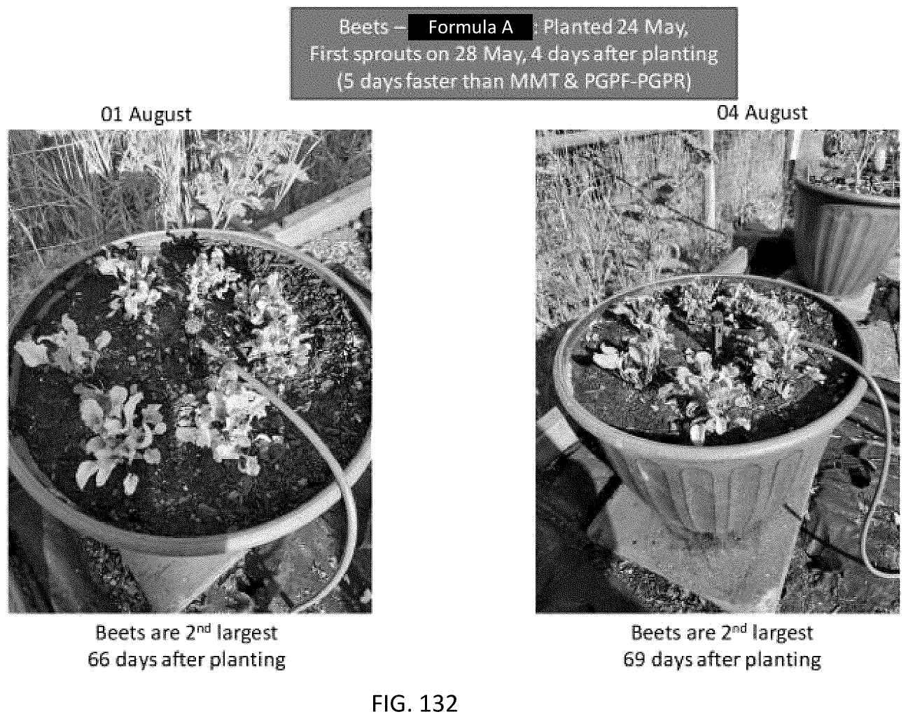

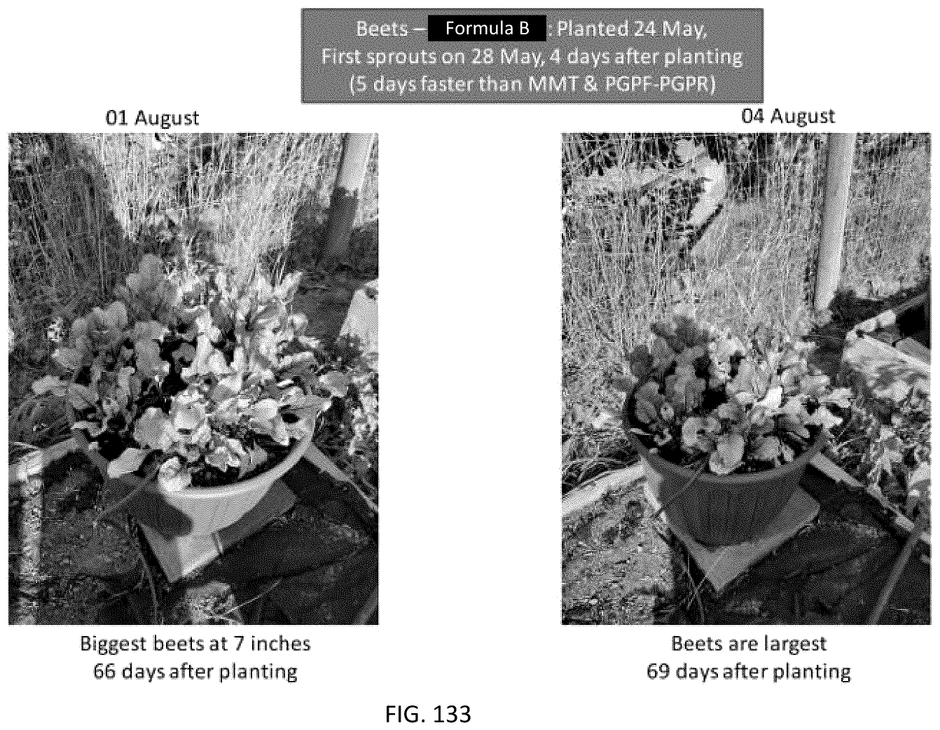

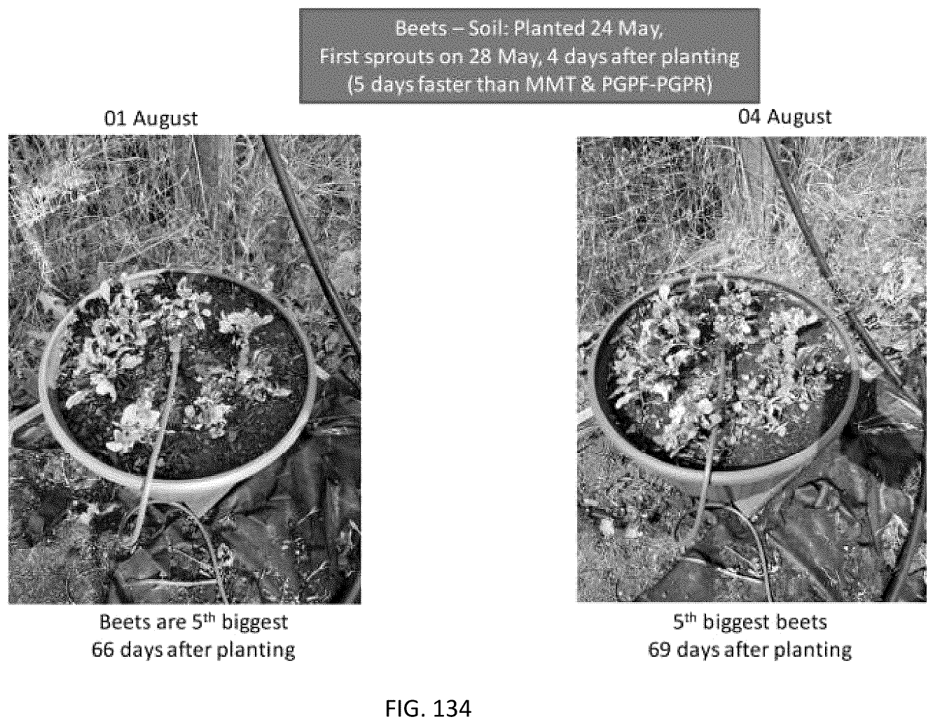

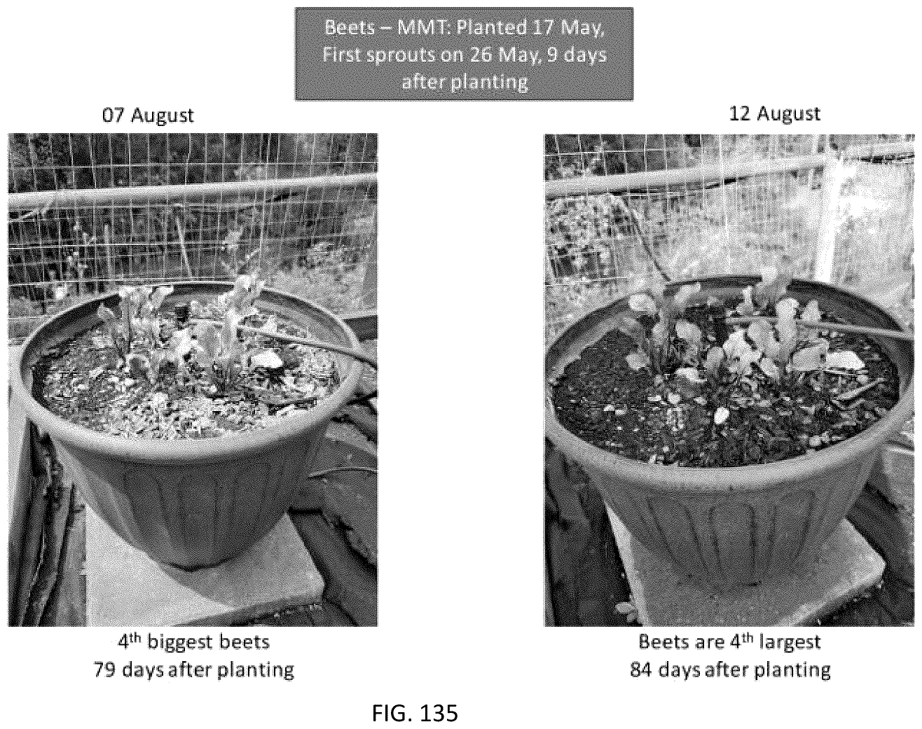

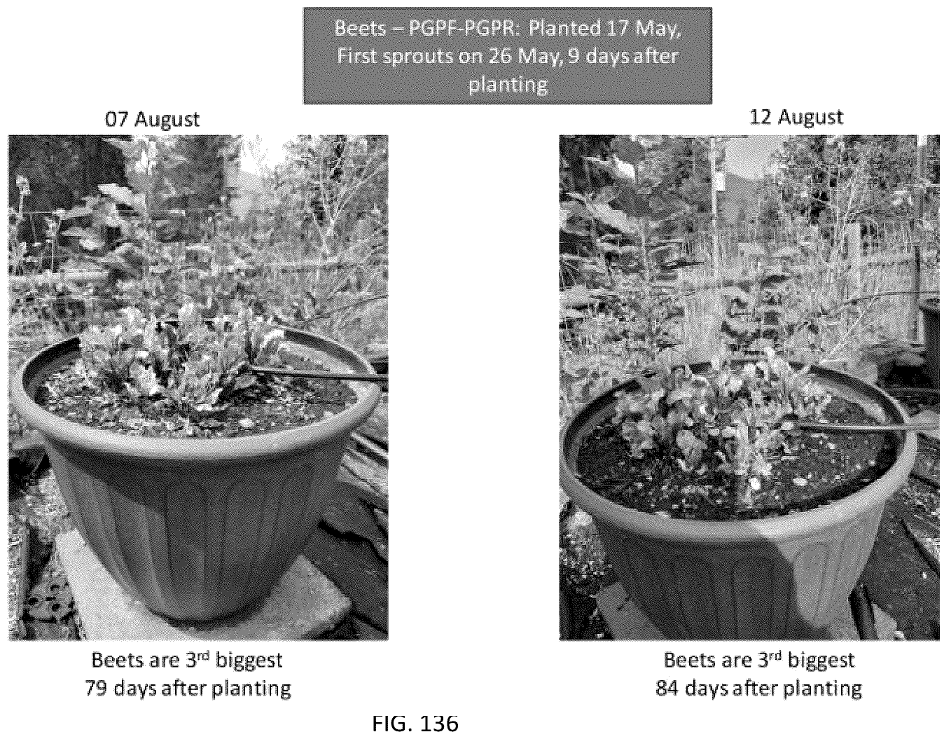

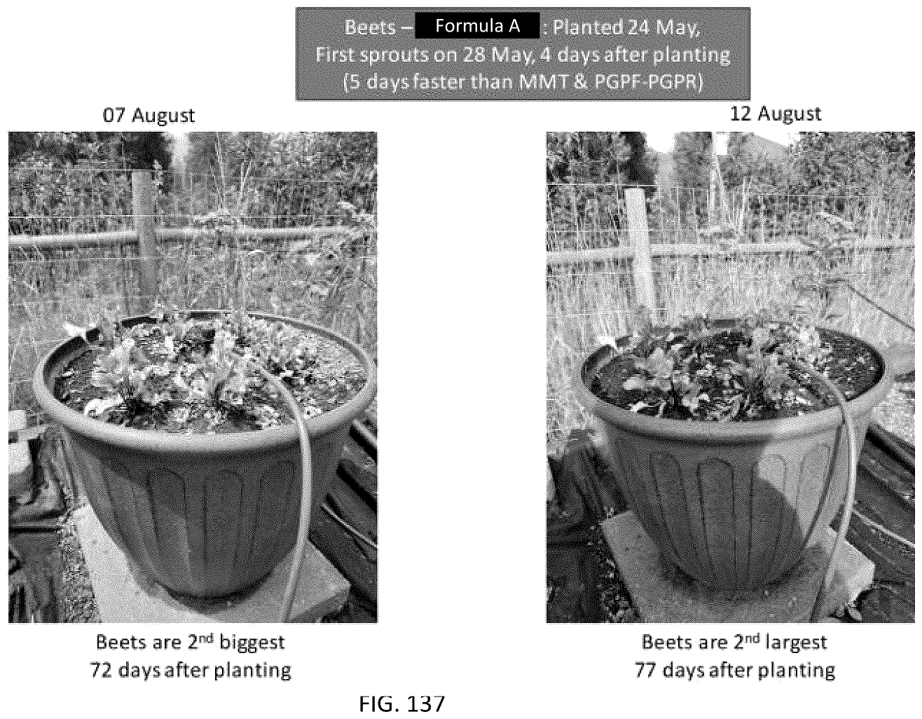

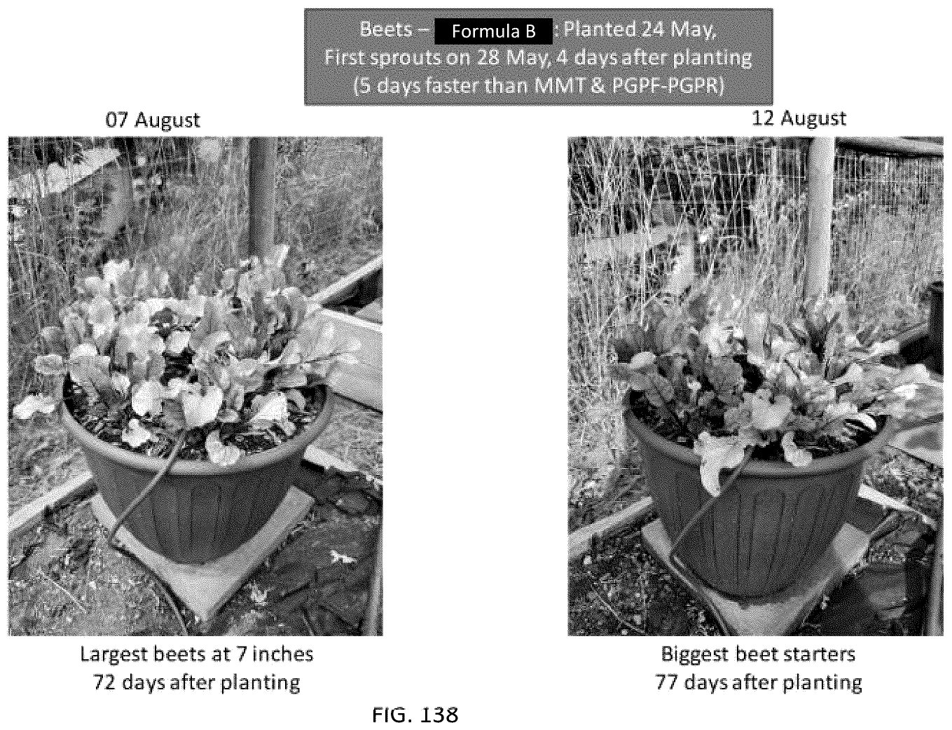

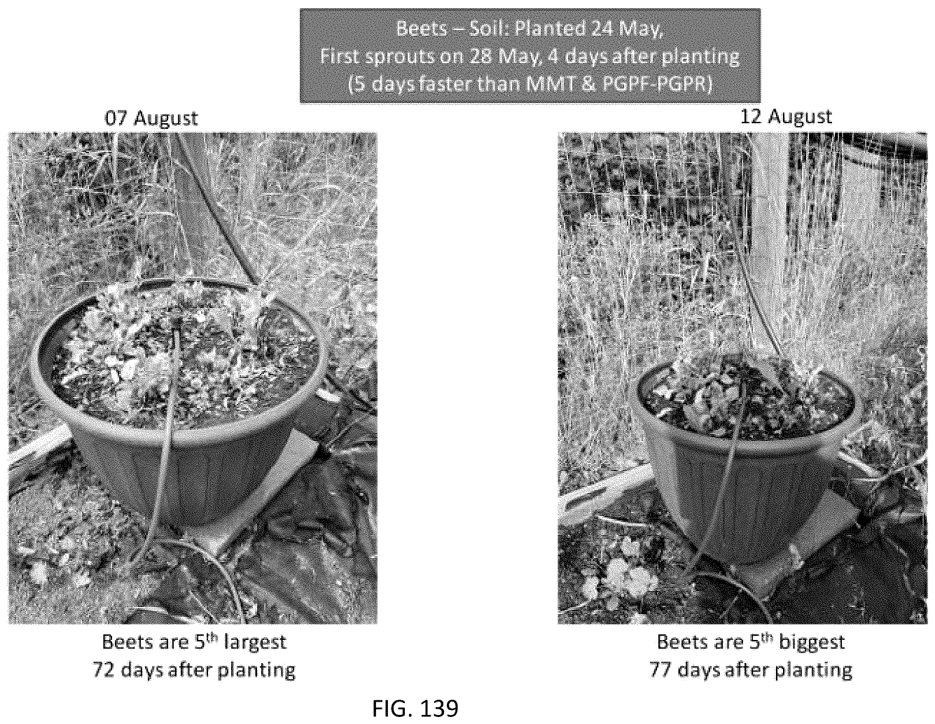

The compositions as prepared in Example 8 were applied to beet starters. Beet starters were observed to 9 weeks after planting. Images of the beets are shown in FIGS. 95-139.

In the MMT and PGPF-PGPR groups, the first sprouts were seen 9 days after planting. The Formula A, Formula B, and Soil groups showed first sprouts at 4 days after planting, which was 5 days before sprouts were seen in the MMT and PGPF-PGPR groups.

During weeks 2-4, MMT and PGPR-PGPF beds saw minimal growth. The Formula A, Formula B, and Soil beds saw increased growth. The Formula B and Soil groups received about 3 extra hours of sunlight, which may be a factor in the difference in the growth beds. During weeks 3 and 4, the Formula A group had the healthiest-looking vegetables out of the three groups that received less sunlight.

TABLE 15
Number of Beet Sprouts Over Time

| | | Days post planting | | | | | | | | | | | | | |
|---|---|---|---|---|---|---|---|---|---|---|---|---|---|---|---|
| Plant date | Test Group | 4 | 8 | 9 | 11 | 13 | 15 | 17 | 18 | 19 | 22 | 24 | 26 | 29 | 31 |
| May 17 | MMT | | | * | 5 | | | 13 | 15 | | 14 | 14 | 15 | 14 | 14 |
| May 17 | PGPF-PFPR | | | * | 41 | | | 65 | 66 | | 71 | 71 | 66 | 71 | 71 |
| May 24 | Formula A | 4 | 60 | 60 | 62 | | 61 | 61 | | 62 | 61 | 61 | | | |
| May 24 | Formula B | 2 | 45 | 42 | 41 | | 42 | 42 | | 41 | 42 | 42 | | | |
| May 24 | Soil | 2 | 54 | 55 | 56 | | 53 | 53 | | 56 | 53 | 53 | | | |

* first sprouts observed

24 days after planting, the sprouts in the Formula A and Soil groups had begun to bolt with leaves. The Formula B group had the largest leaves and deepest green color and had no yellow color. The second largest beets were tied between PGPF-PGPR and Formula A. 31 days after planting, the MMT group showed that multiple leaves had started to sprout. In the PGPF-PGPR group, leaves had bolted.

During week 4, the Formula B group showed the largest beets out of all test groups. The PGPF-PGPR group had the second largest and second strongest beets. The Formula A group had the most number of sprouts at 26 days after planting and the third strongest beets at 30 days after planting. The Soil group had the second weakest beets while the MMT group had the smallest and weakest beets. Growth was stunted during week 4 due to a cold snap where temperatures dropped to 43° F. at night for 4 consecutive days starting June 18. Minimal sunlight was observed during this time with wet and rainy conditions. The temperature ranged between 46° F. and 51° F.

During week 5, the Formula B had the largest beets. These were the largest, healthiest, and fullest. The PGPF-PGPR group had the second tallest beets and were full, healthy, and tall. The Formula A group showed the third biggest beets, and were abundant, tall, full, and healthy. The Soil group showed no change in growth at 36 days after planting, and at 40 days after planting, they were the fourth largest beets. The MMT group were sprouting high and were the fifth largest beets. Growth had picked up from the previous wet and cloudy weather that stunted growth. The Formula B group had the largest and healthiest vegetables, while the second strongest groups were PGPF-PGPR and Formula A groups.

During week 6, the Formula B group had the largest, healthiest, and fullest beets out of all test groups. The Formula A group had the second biggest beets while the PGPF-PGPR group had the third tallest and third biggest beets. The MMT group had healthy beets that were the fifth largest while the Soil group had the fifth strongest and fifth biggest beets. The Formula B plants were noticeably the most abundant, healthy, and vibrant out of all groups tested, followed by the Formula A plants.

During week 7, the Formula B group had the largest beets measuring at 7 inches tall. The Formula A group had the second biggest beets while the PGPF-PGPR group had the third biggest beets. The MMT group had healthy beets that were the fourth largest while the Soil group had the fifth largest beets. The Formula B plants continued to be noticeably most abundant, healthy, and vibrant out of all groups tested, followed by the Formula A plants.

During week 8, the Formula B group had the biggest beets at 7 inches 66 days after planting. The Formula A group had the second largest beets while the PGPF-PGPR group had the third largest and third biggest beets. The MMT group had the fourth largest beets while the Soil group had the smallest beets. The Formula B plants continued to be the noticeably most abundant, healthy, and vibrant out of all groups tested, followed by the Formula A plants.

During week 9, the Formula B group had the largest beets at 7 inches 72 days after planting. The Formula A group had the second largest beets while the PGPF-PGPR group had the third biggest beets. The MMT group had the fourth largest beets while the Soil group had the smallest beets. The Formula B plants continued to be the noticeably most abundant, healthy, and vibrant out of all groups tested, followed by the Formula A plants.

### Example 12: Strawberries

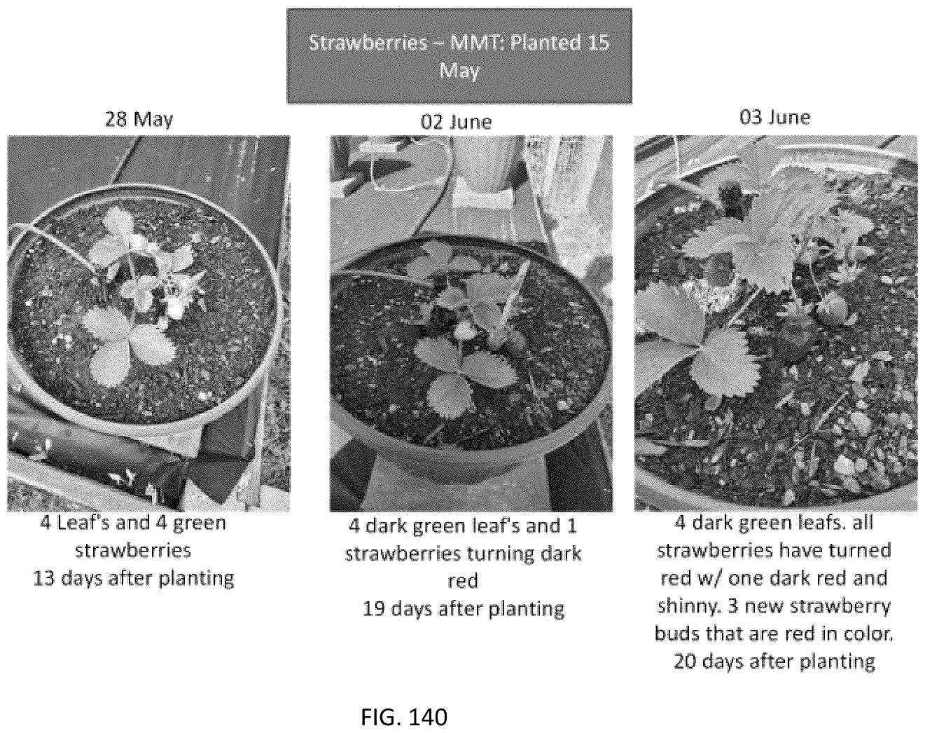

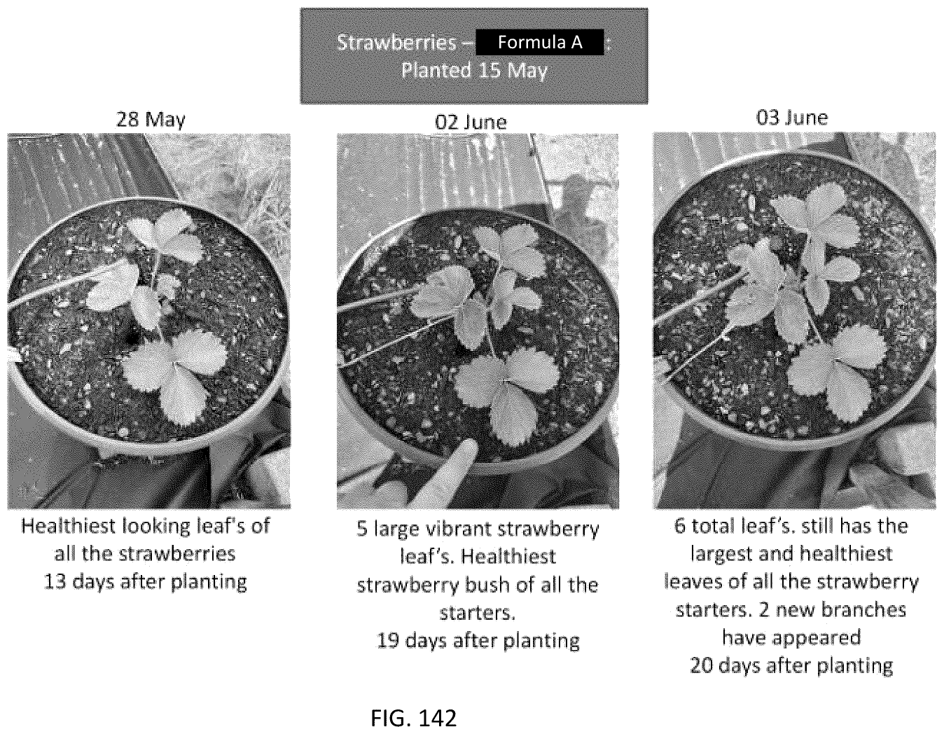

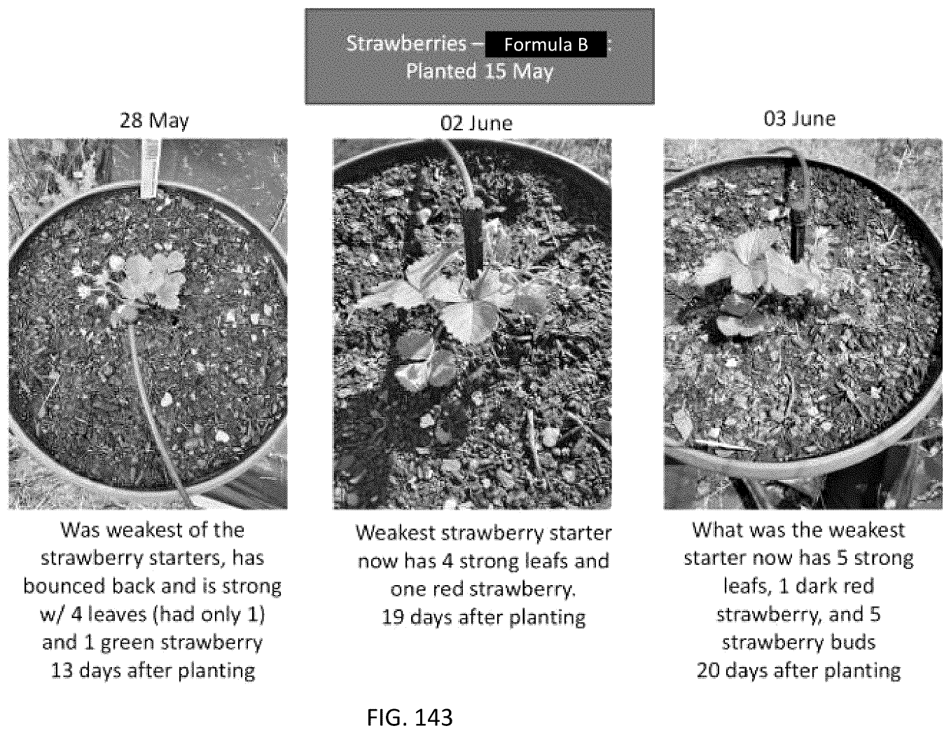

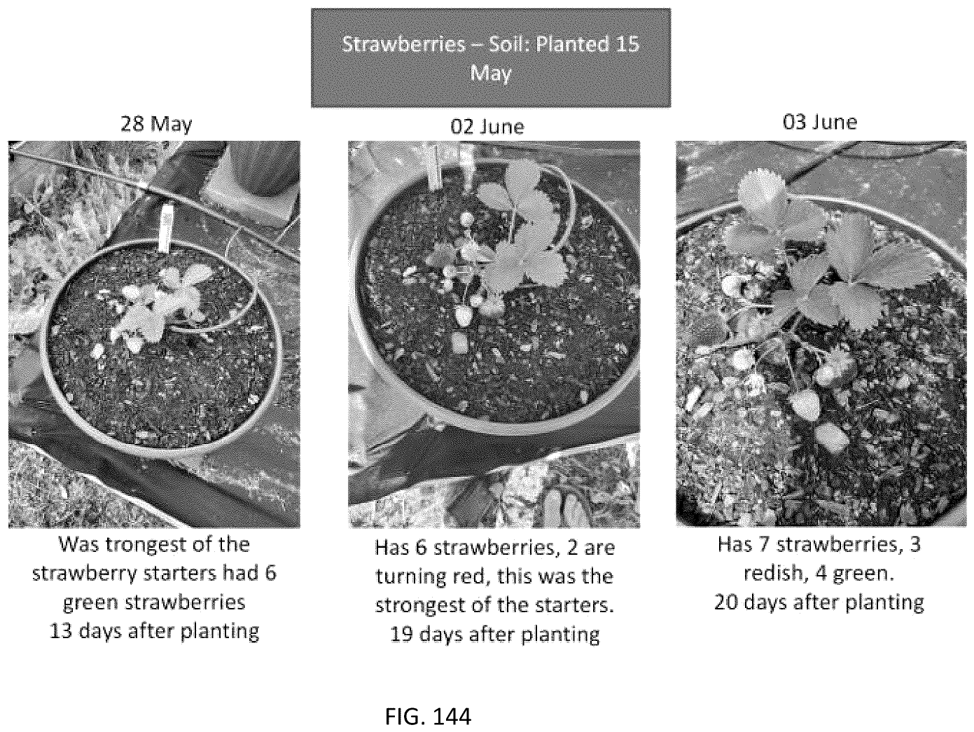

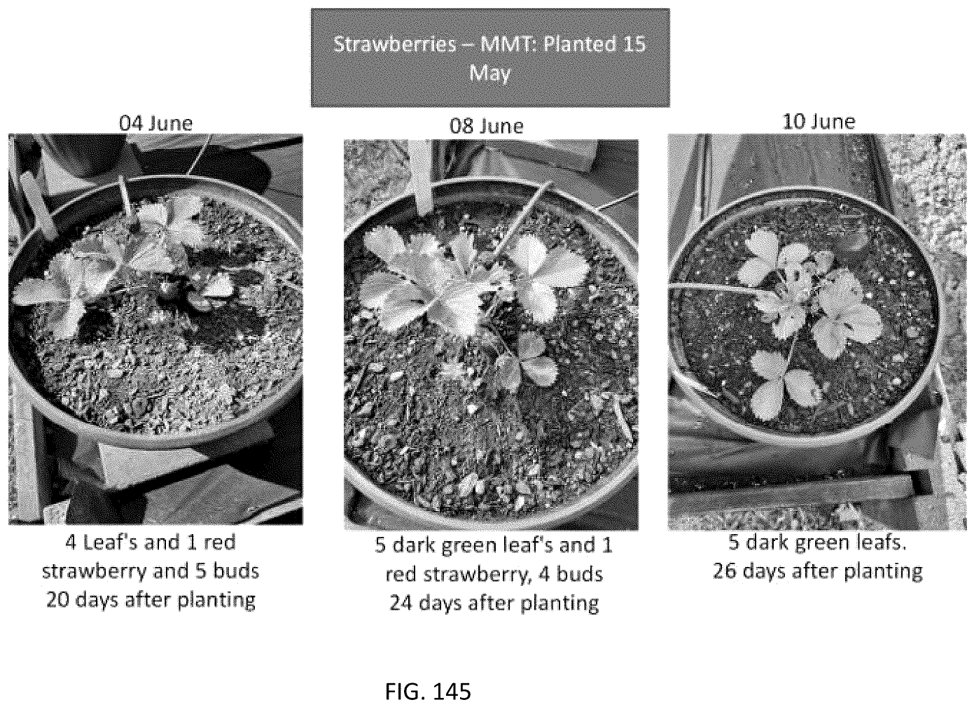

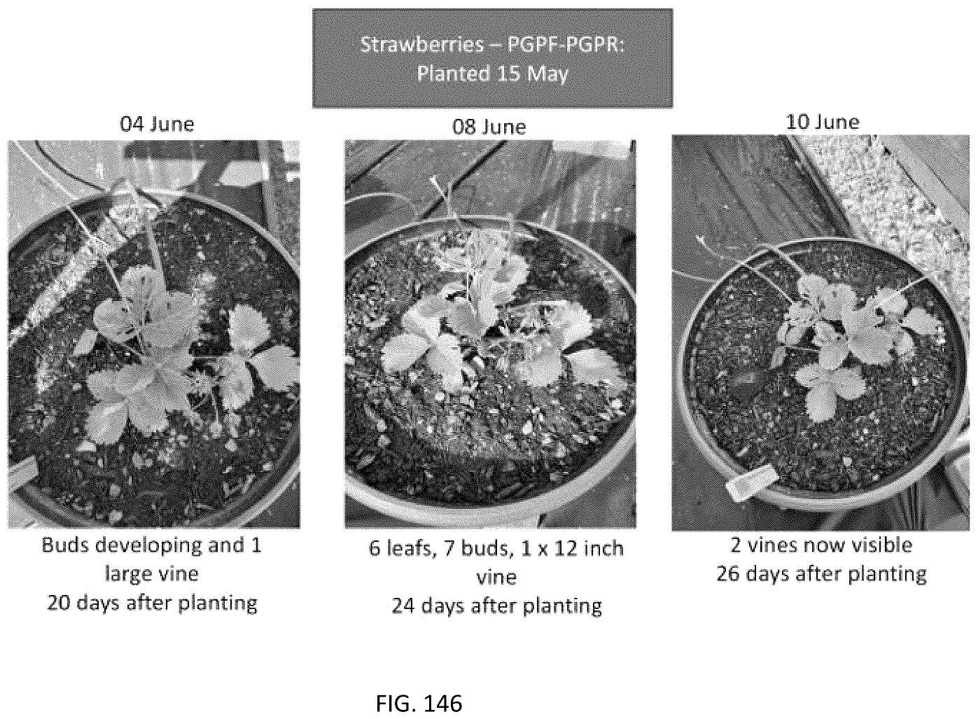

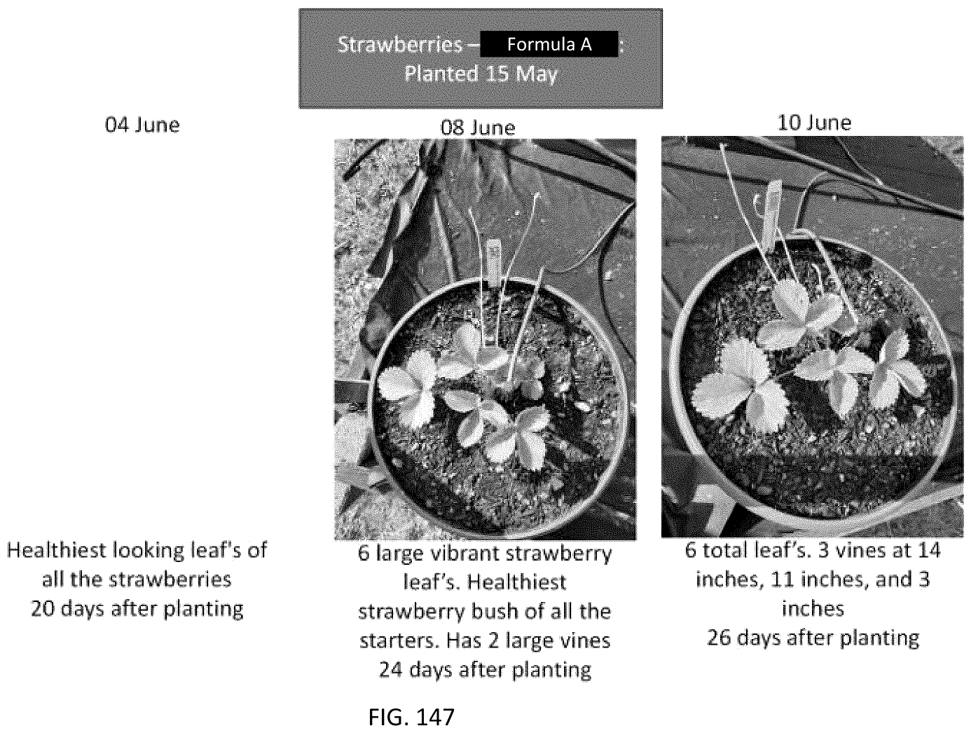

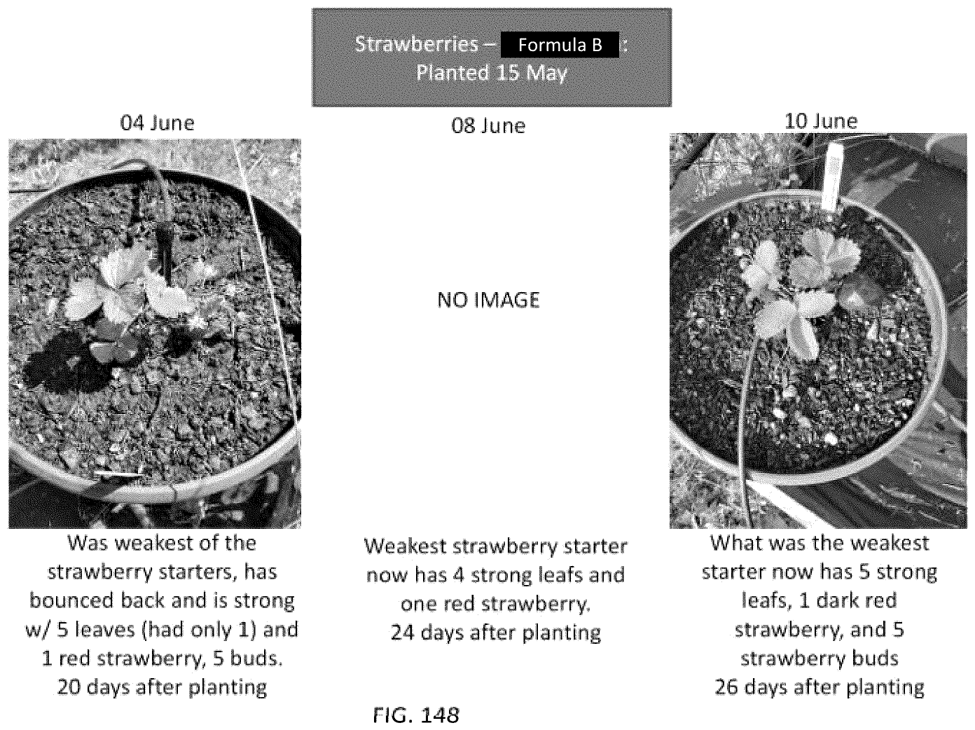

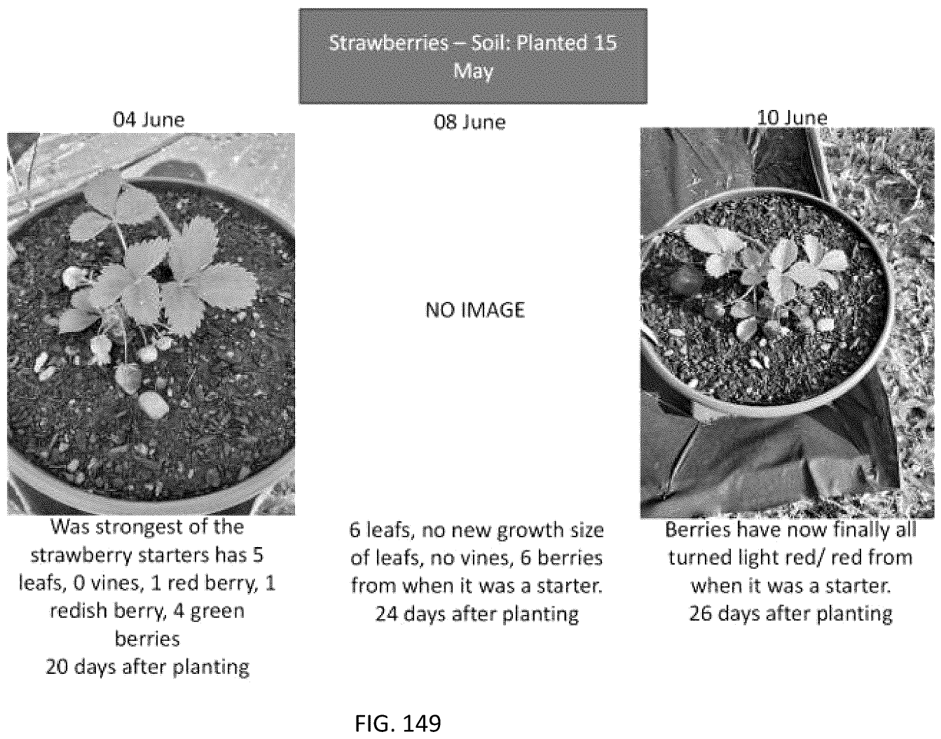

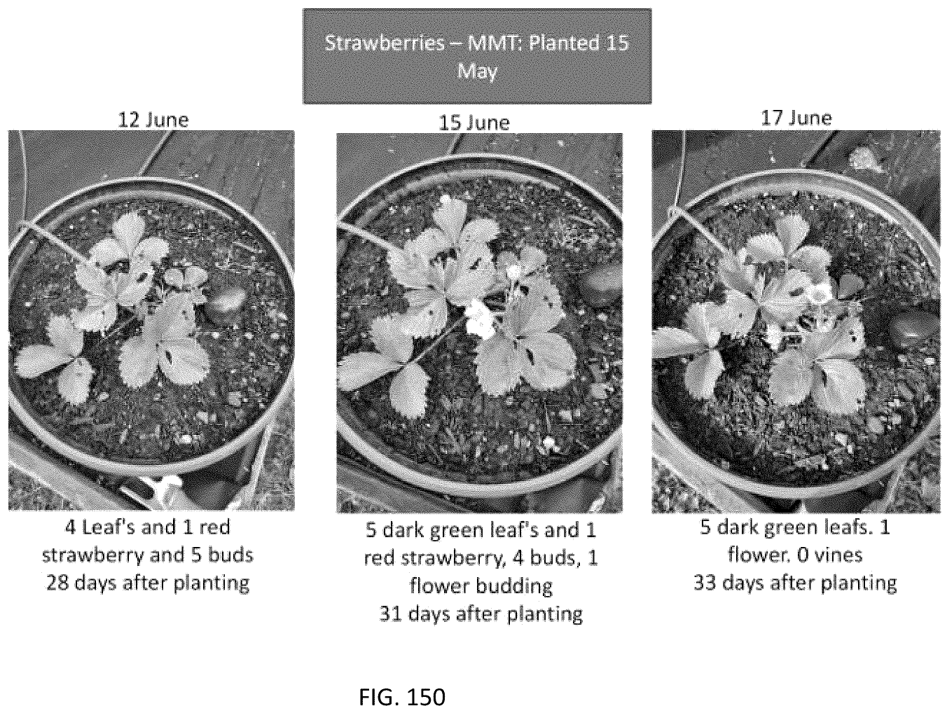

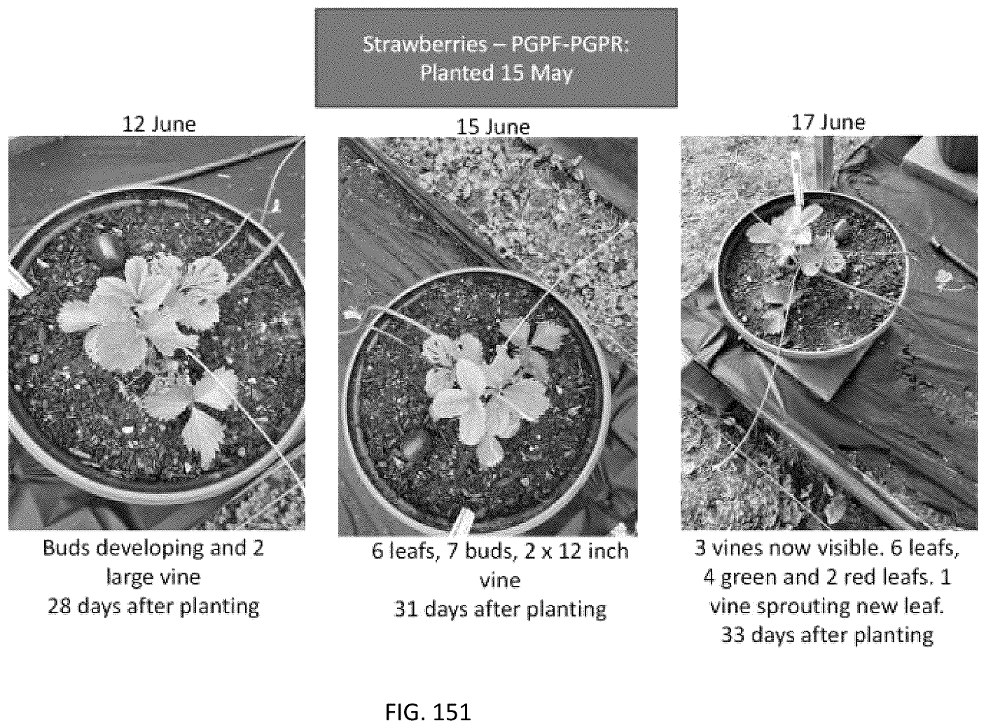

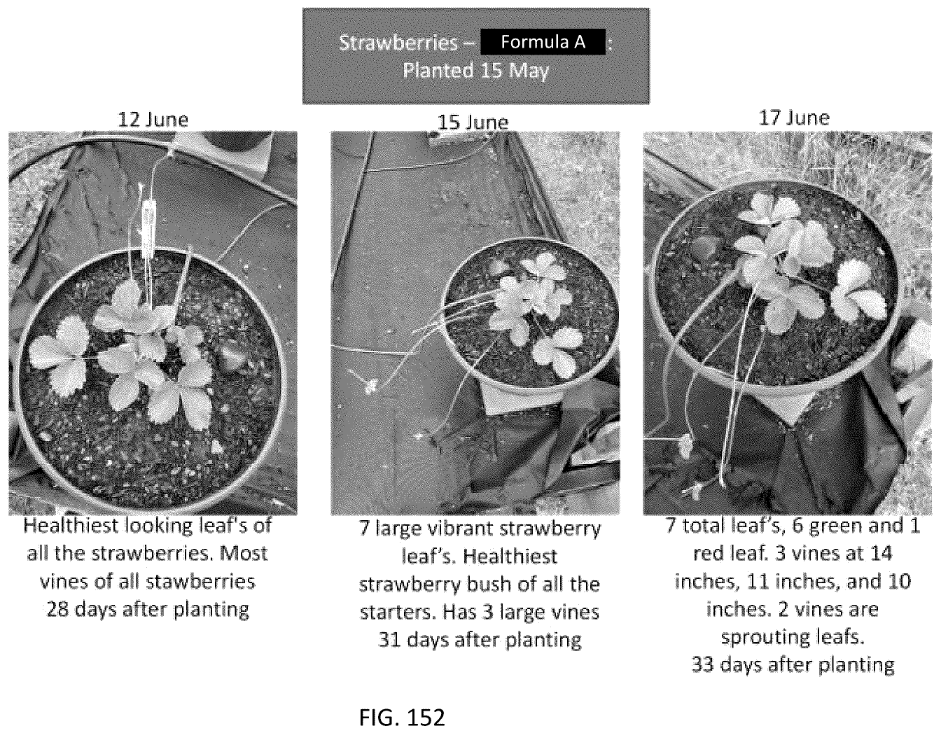

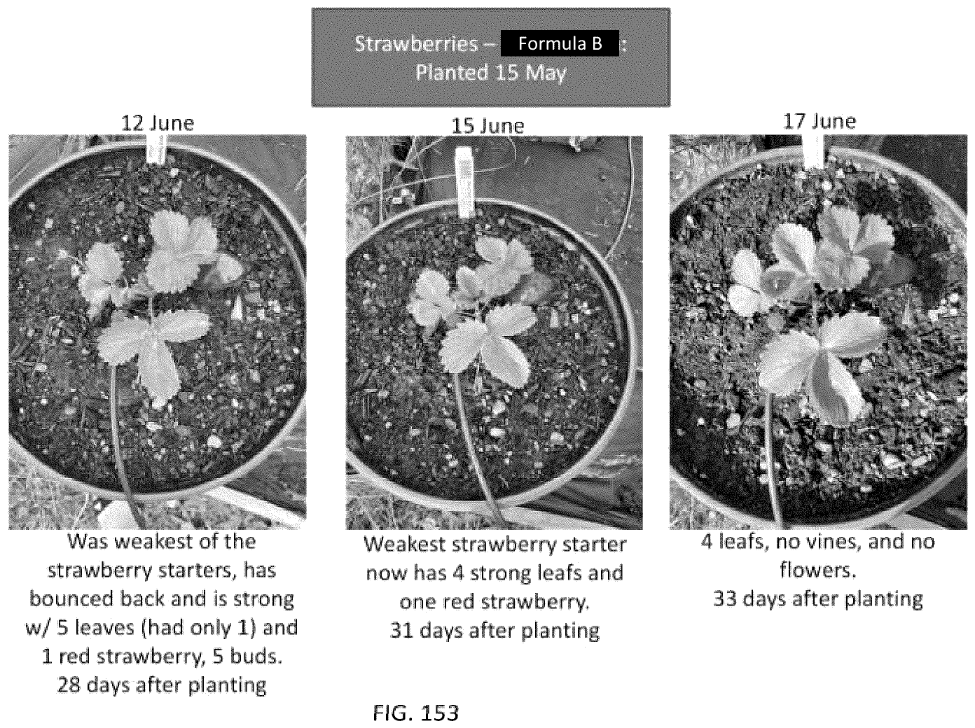

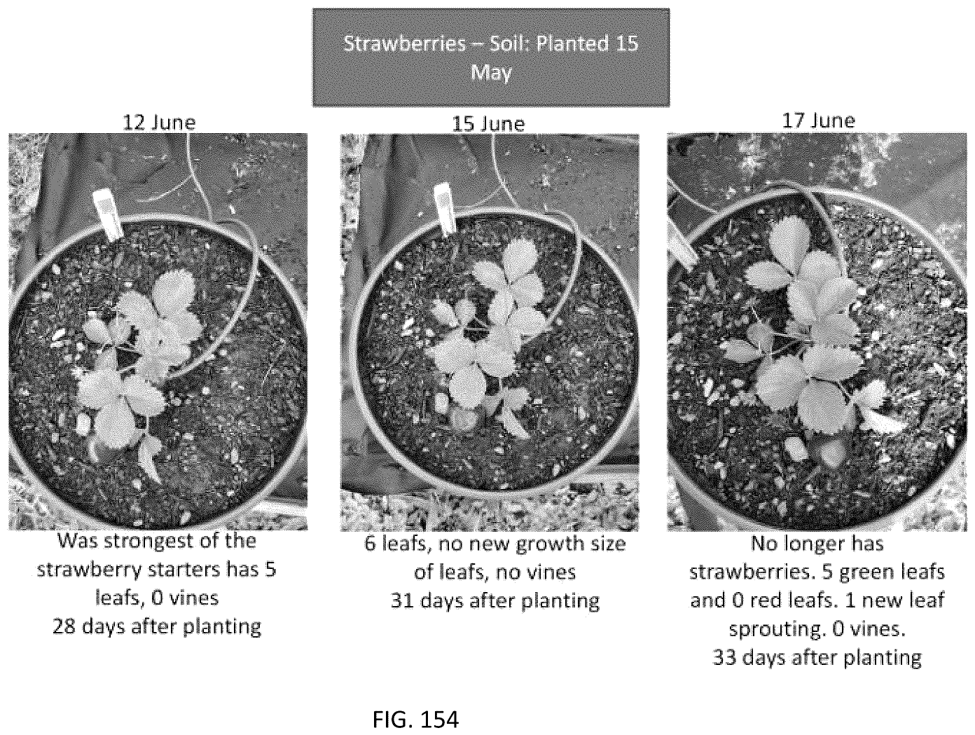

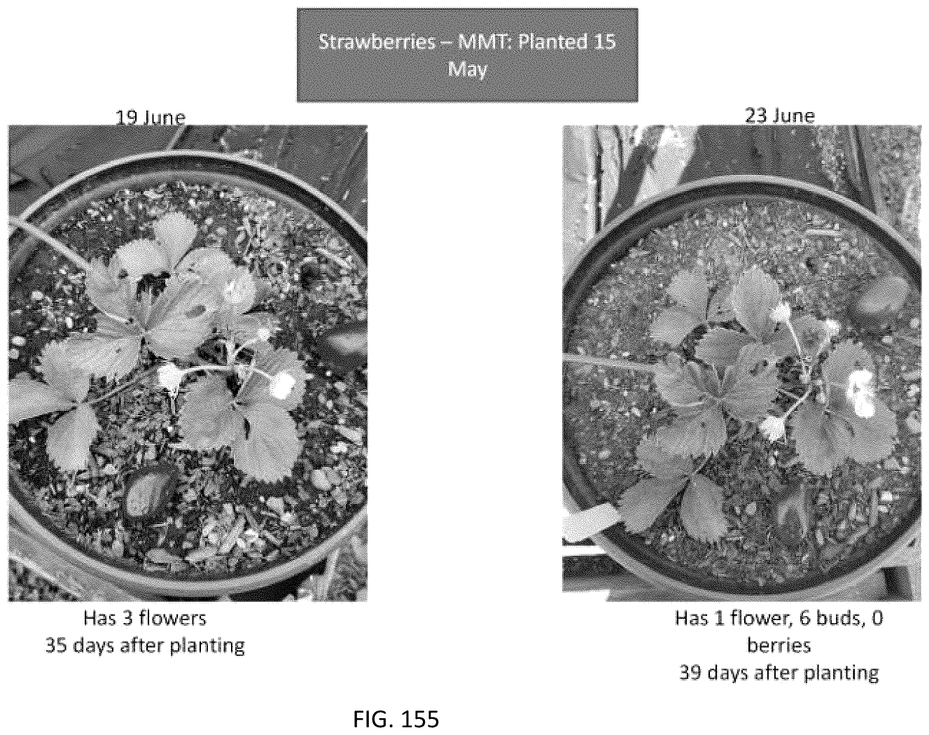

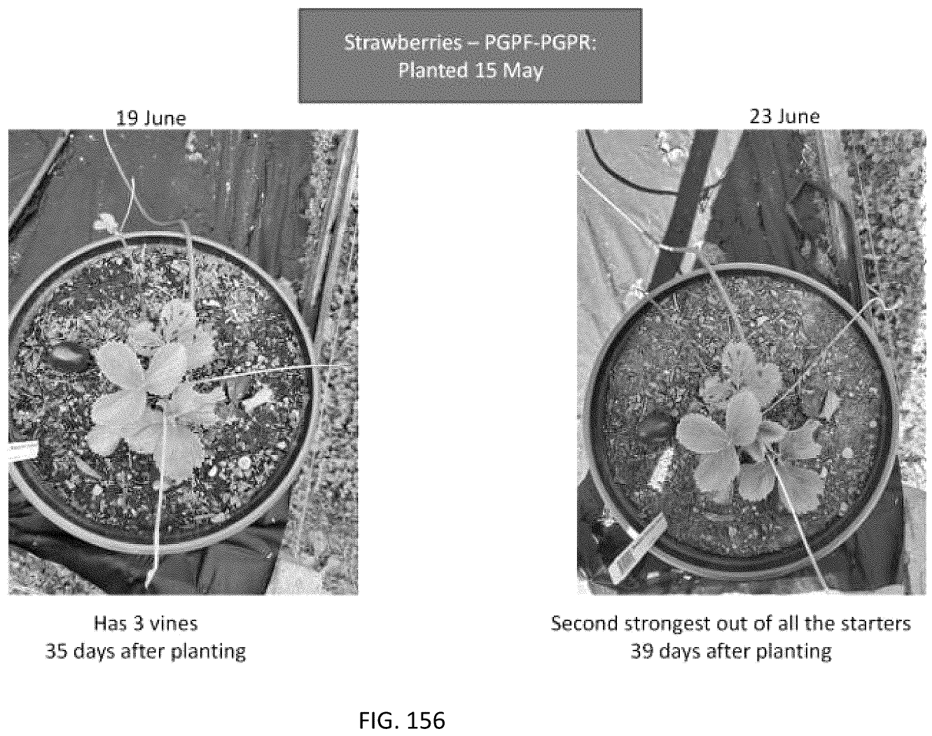

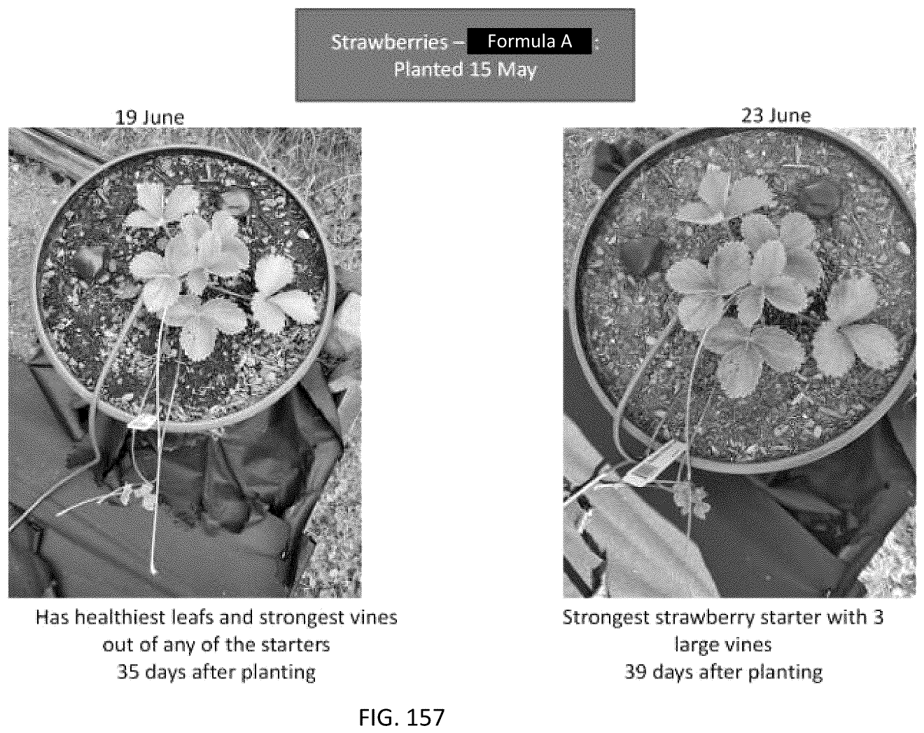

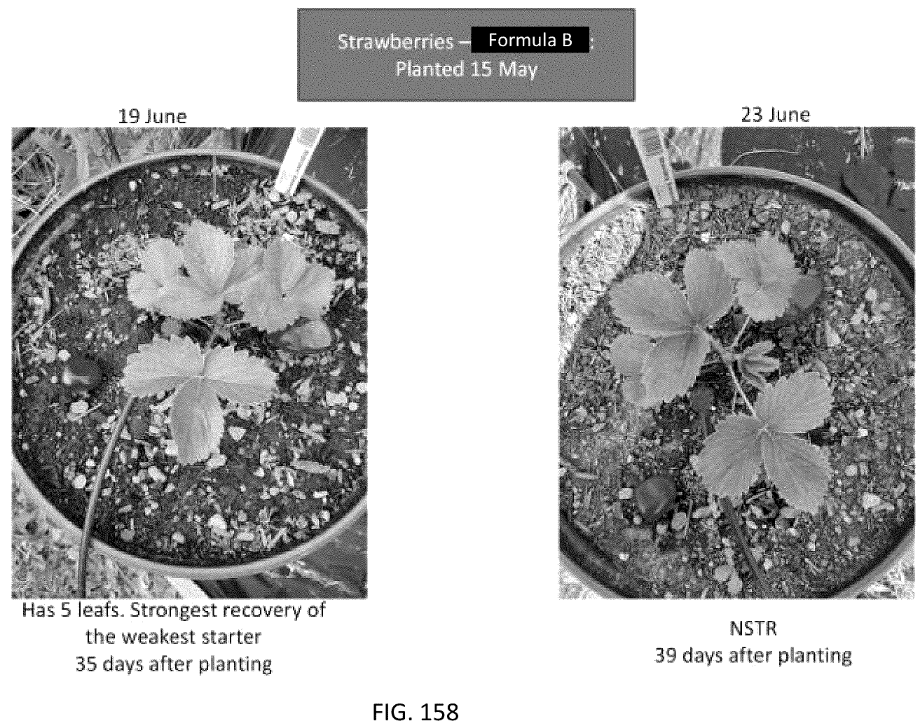

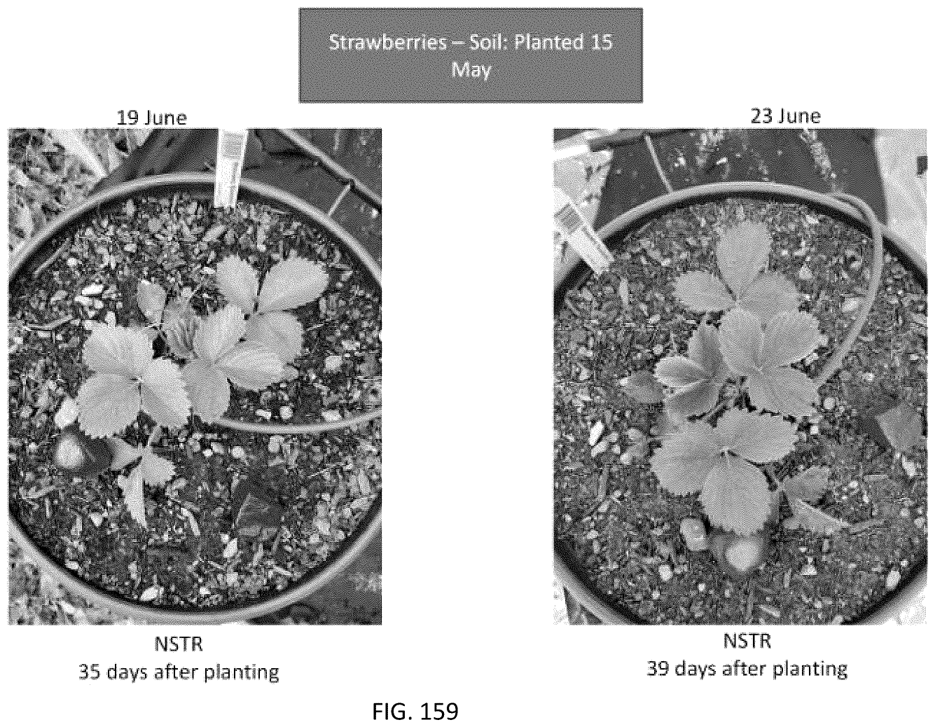

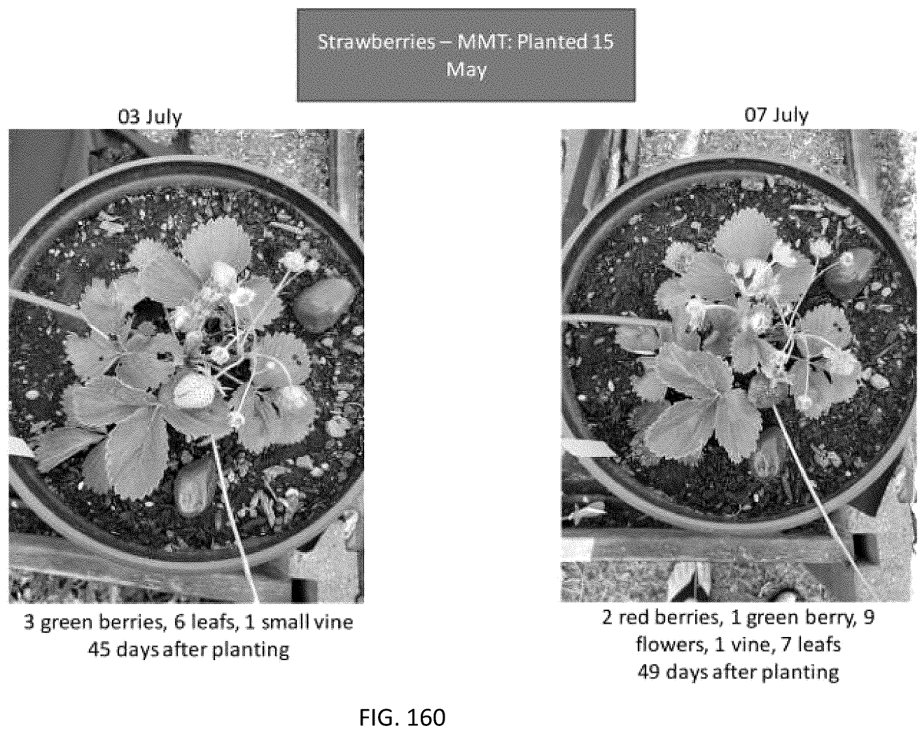

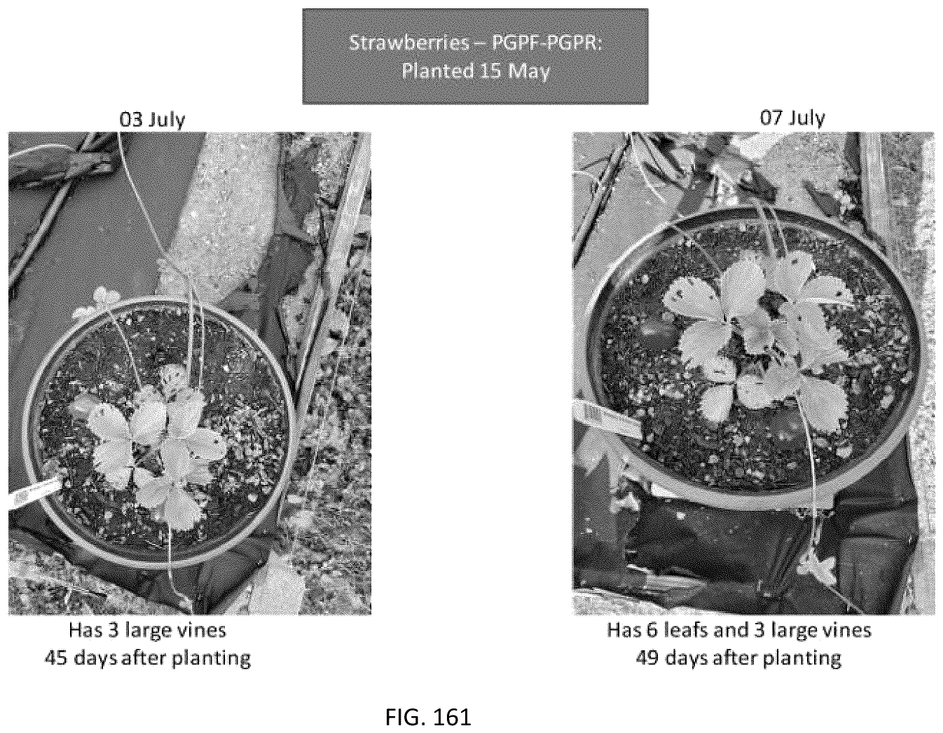

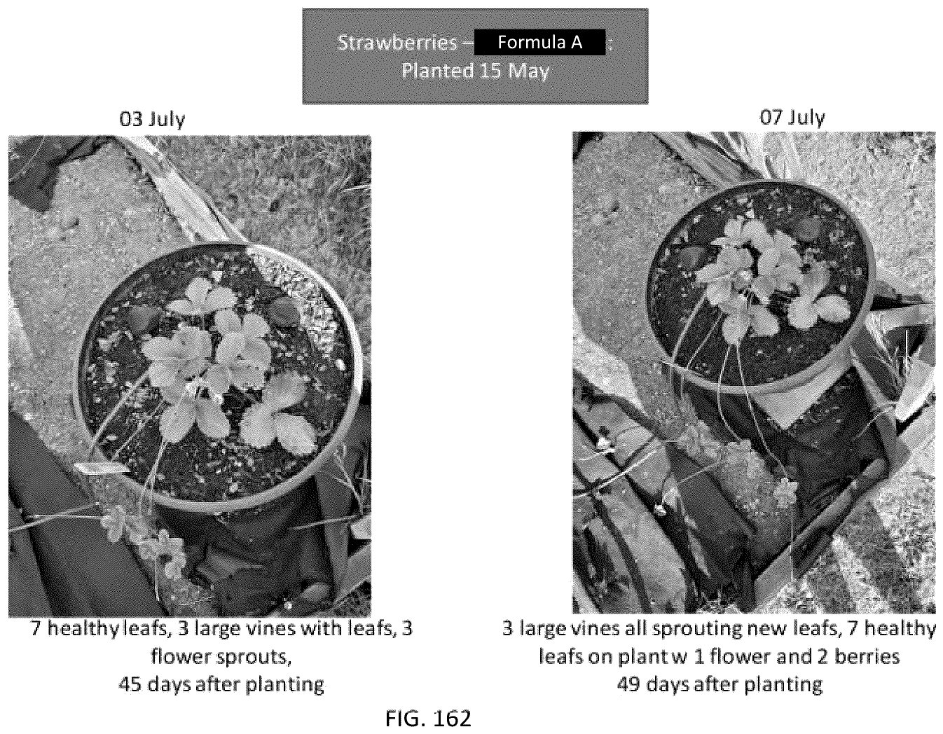

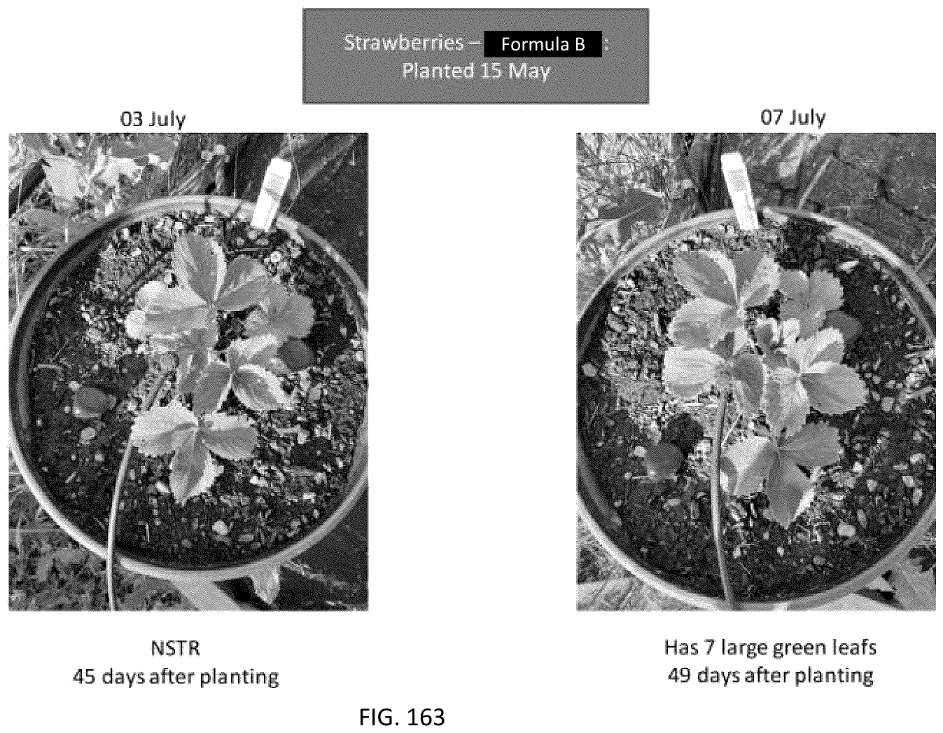

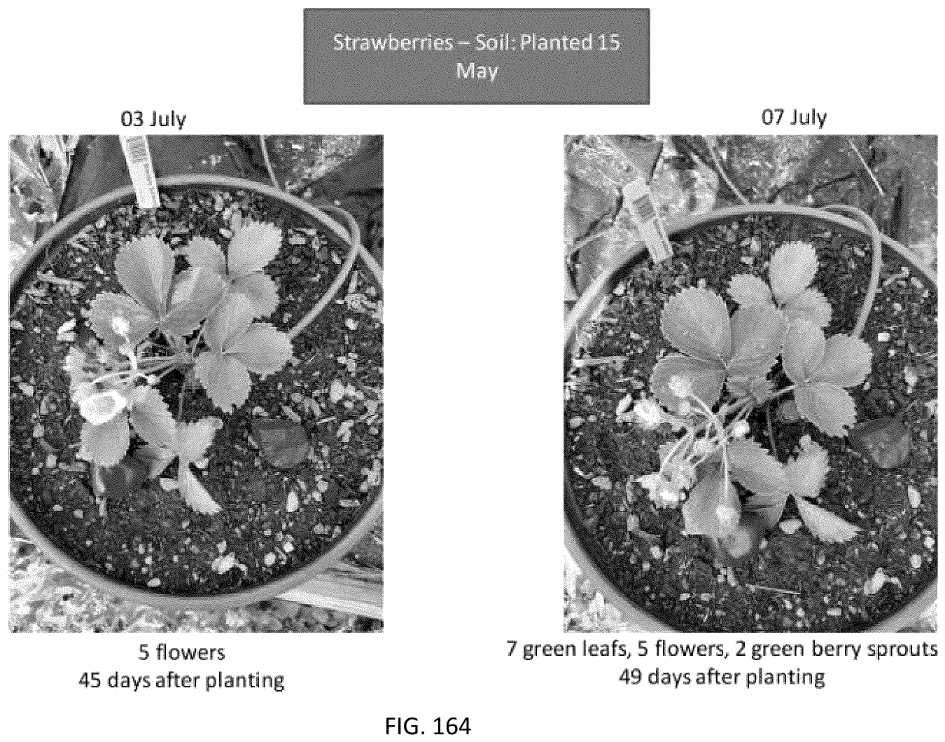

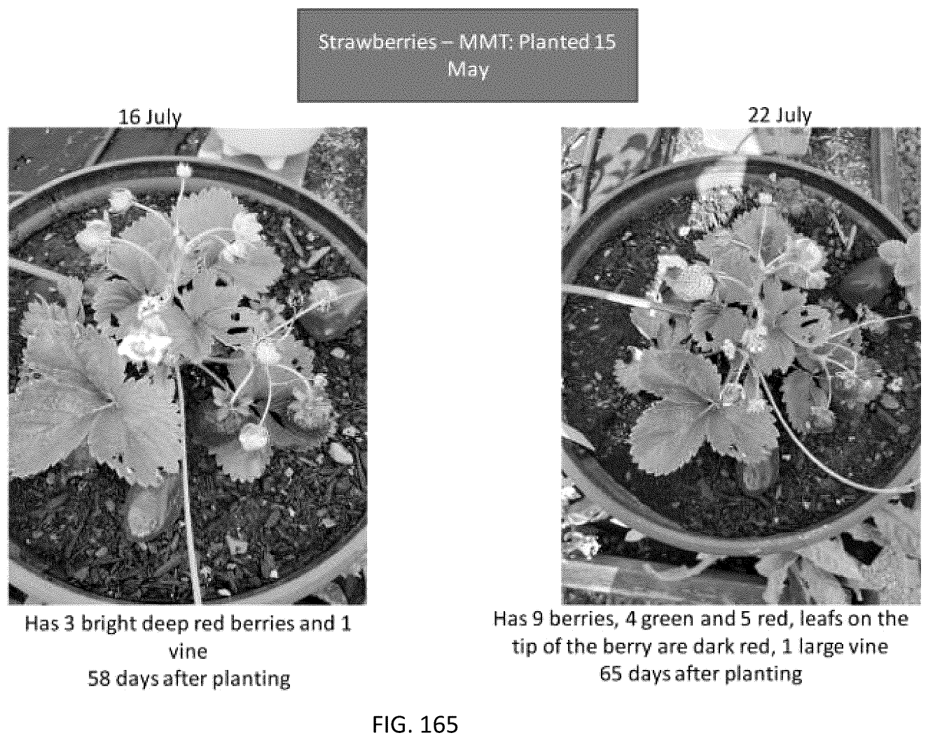

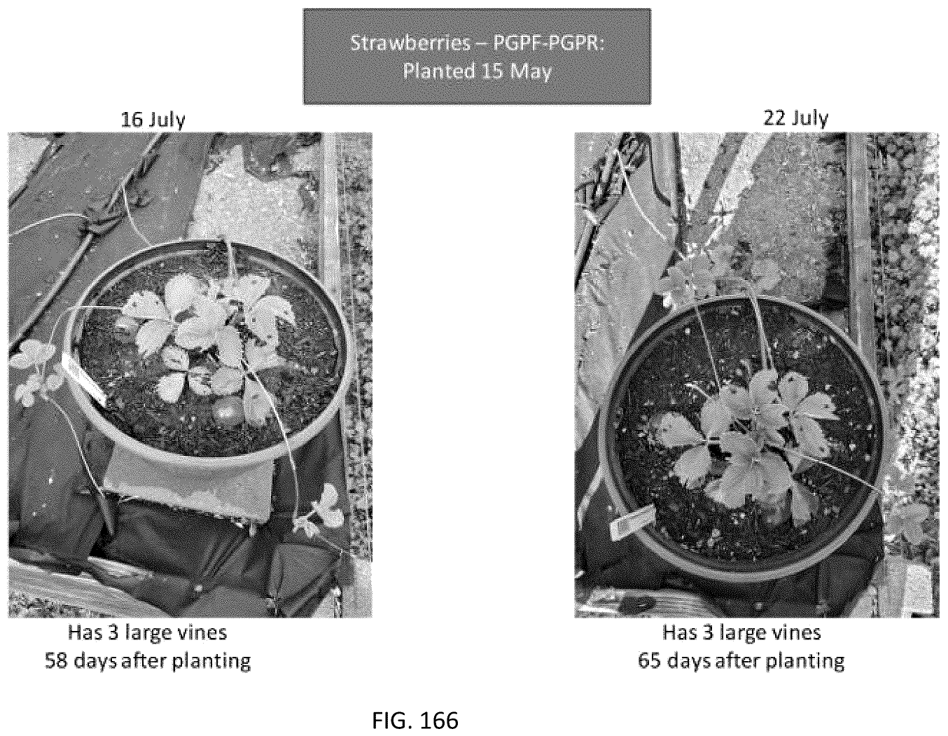

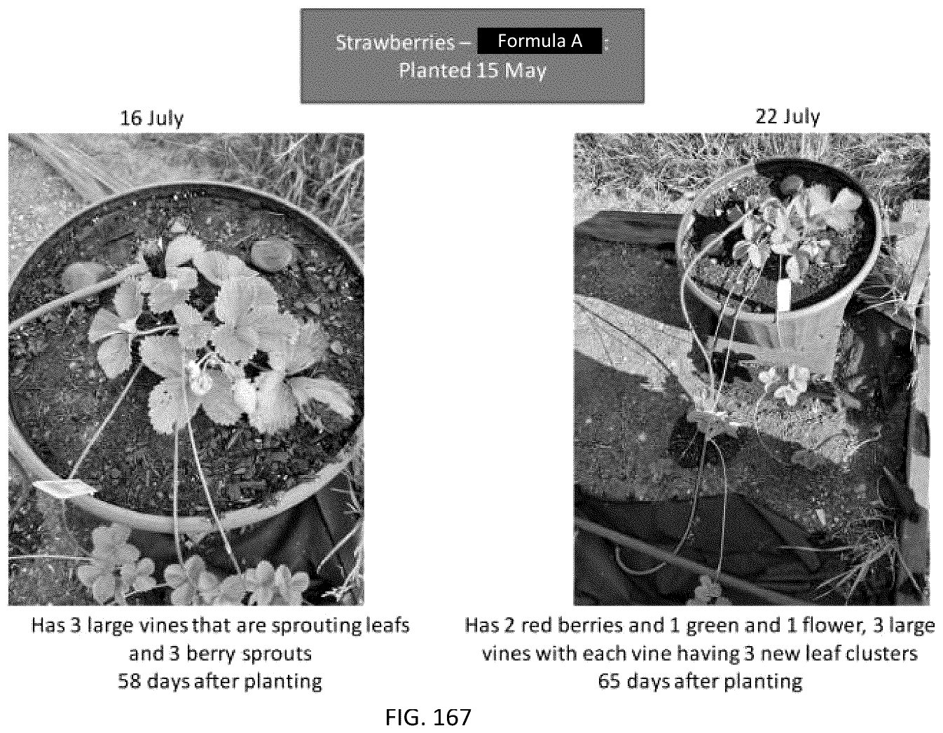

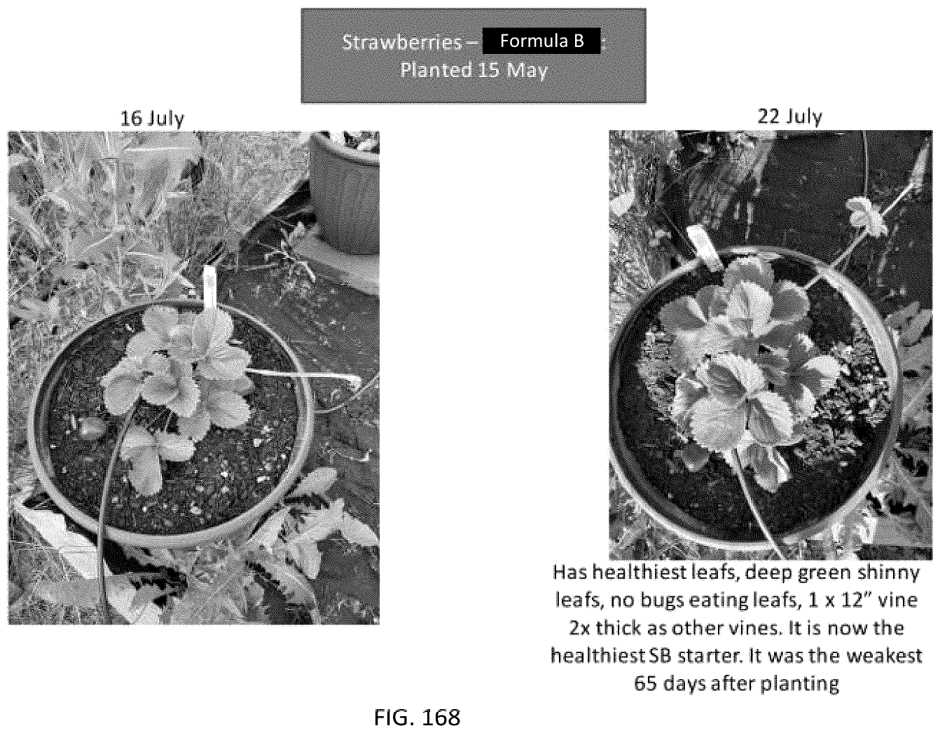

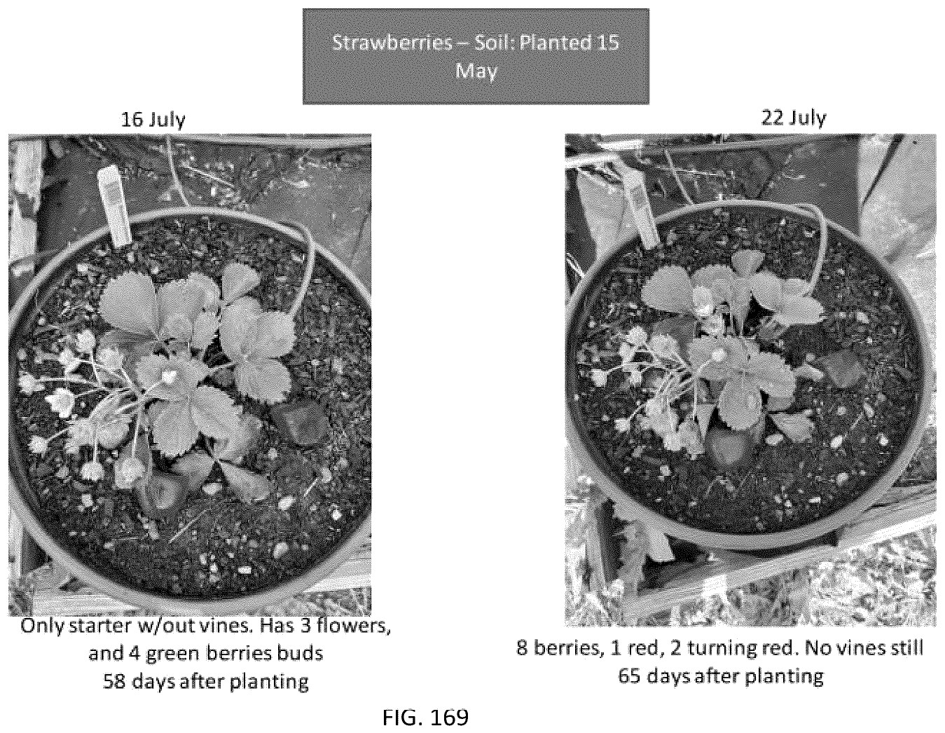

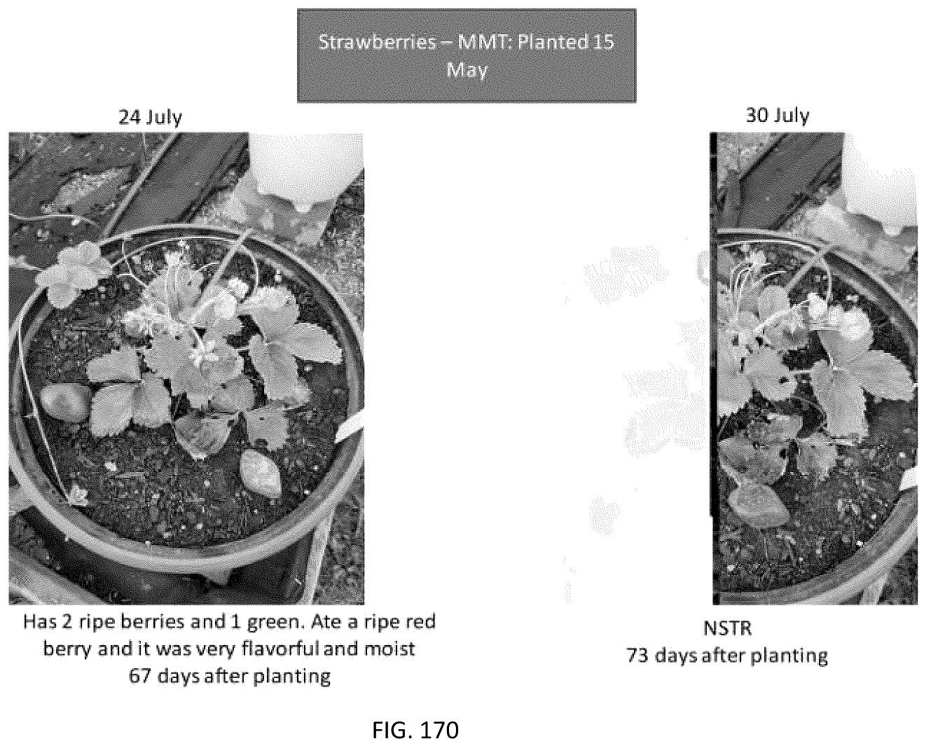

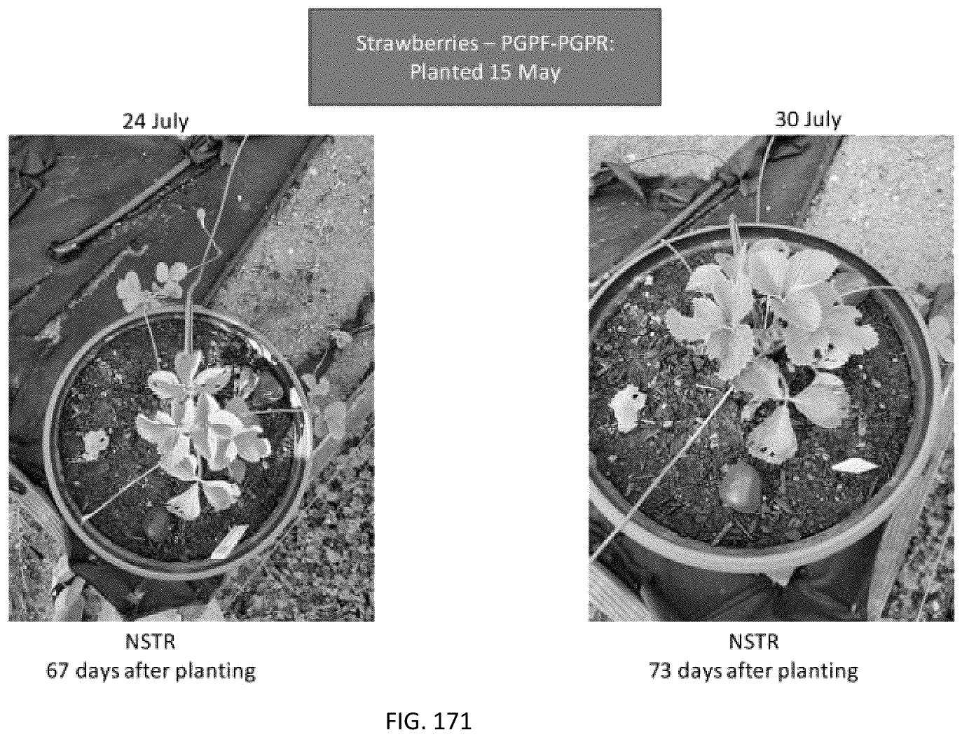

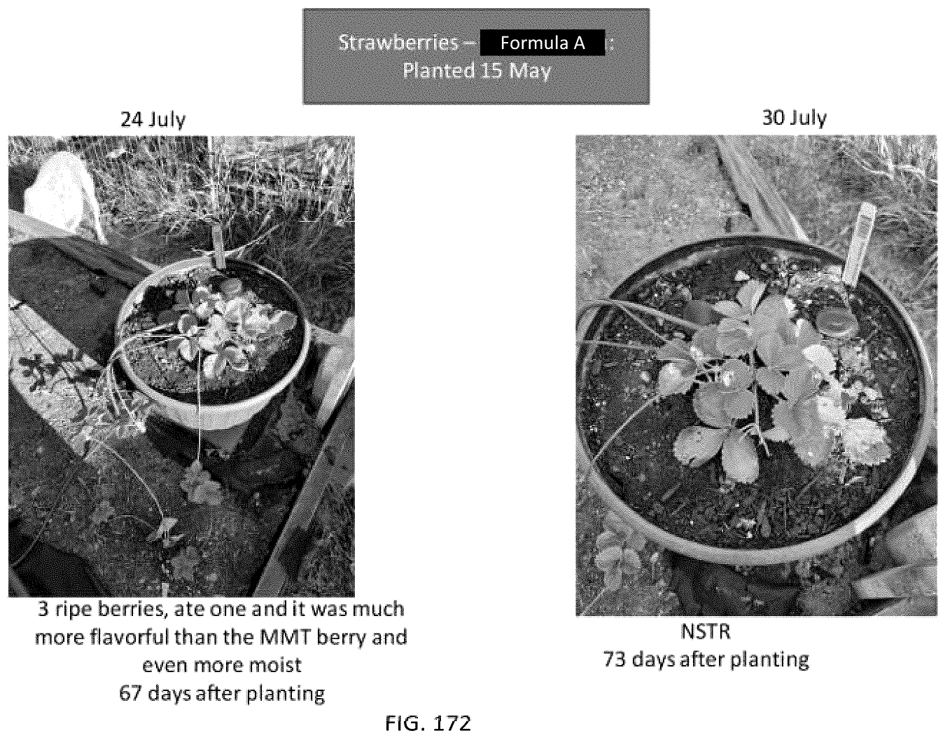

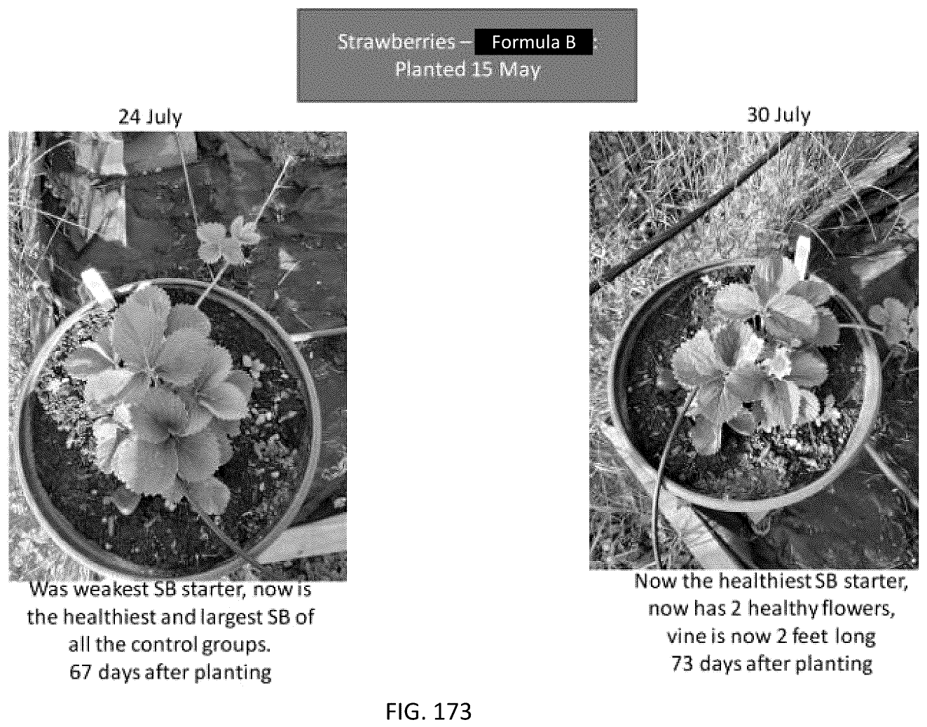

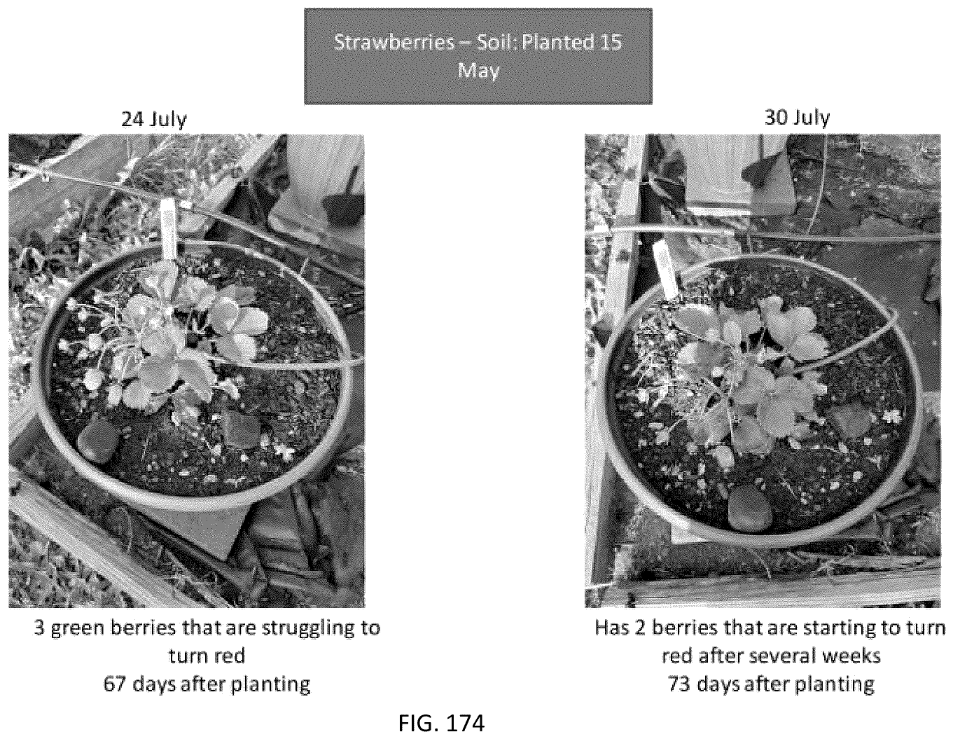

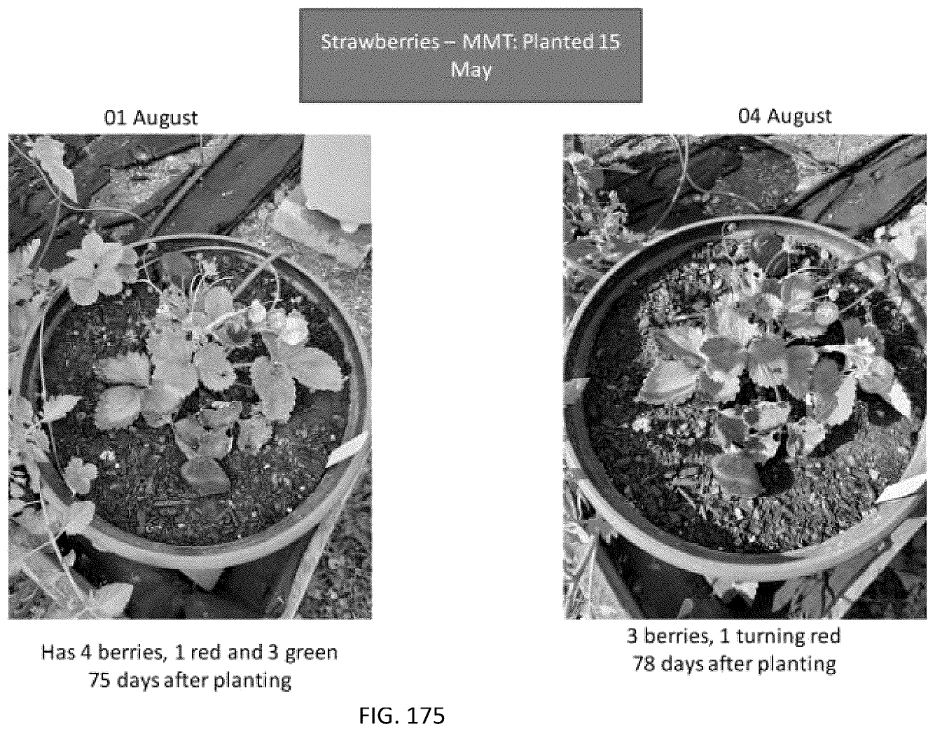

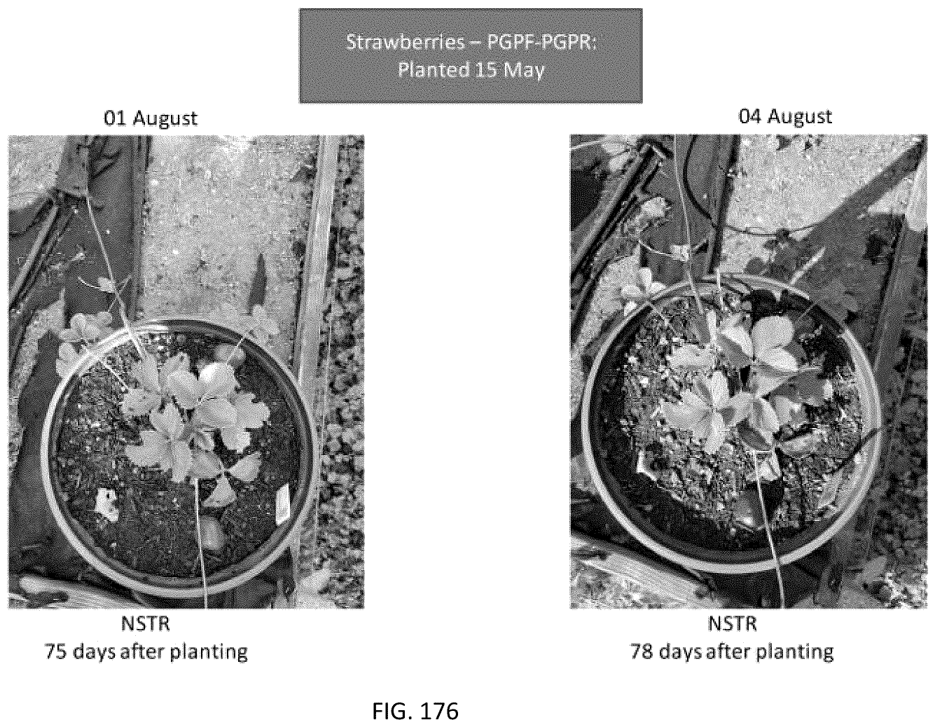

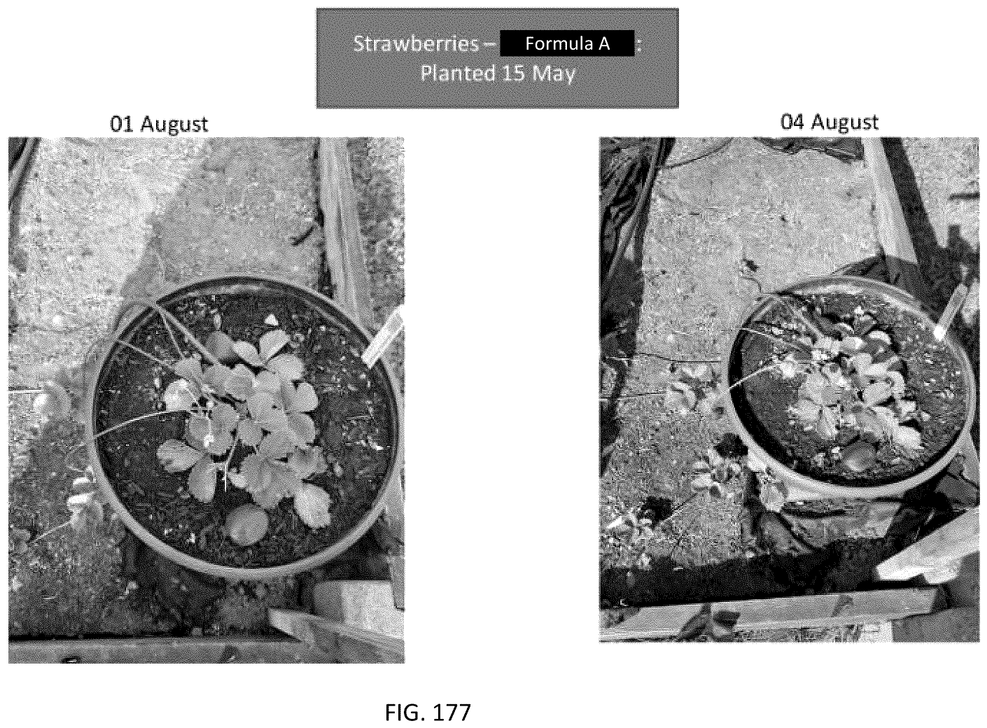

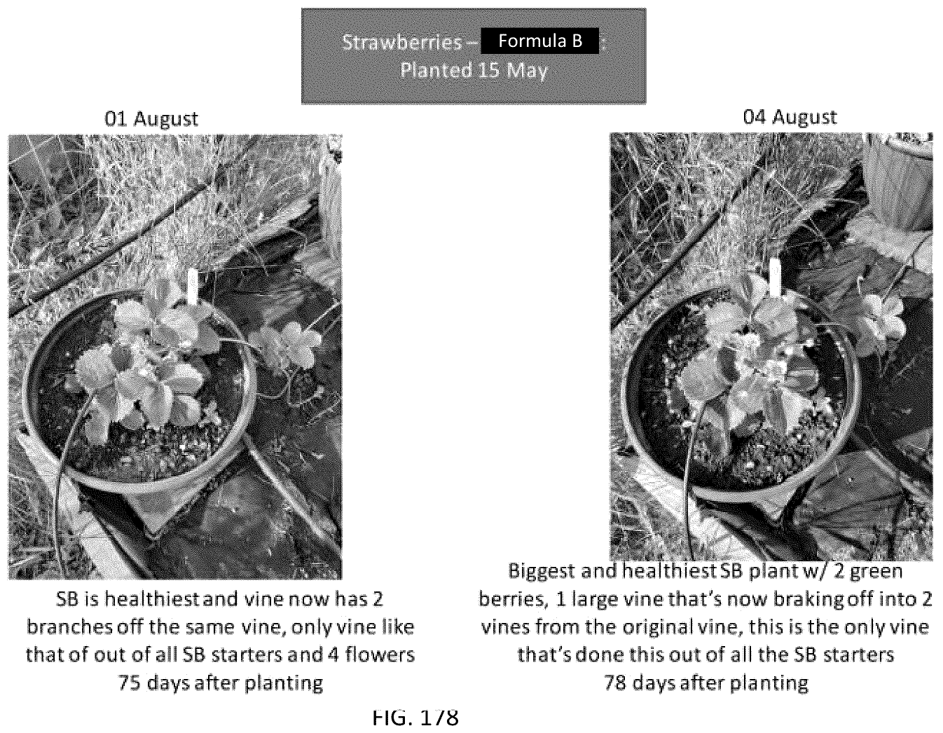

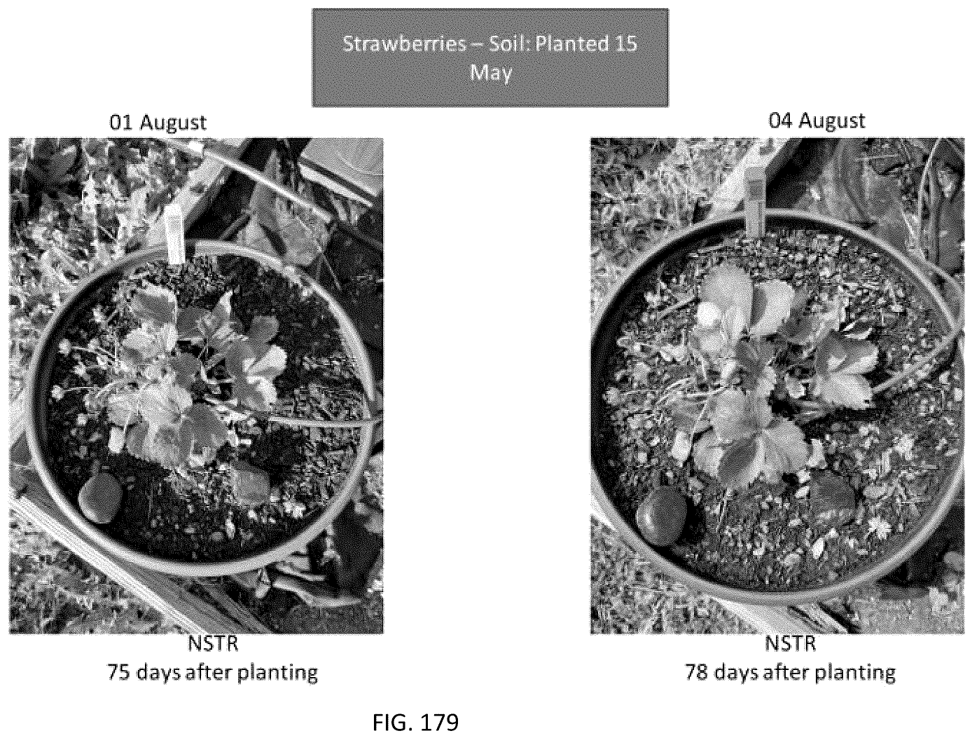

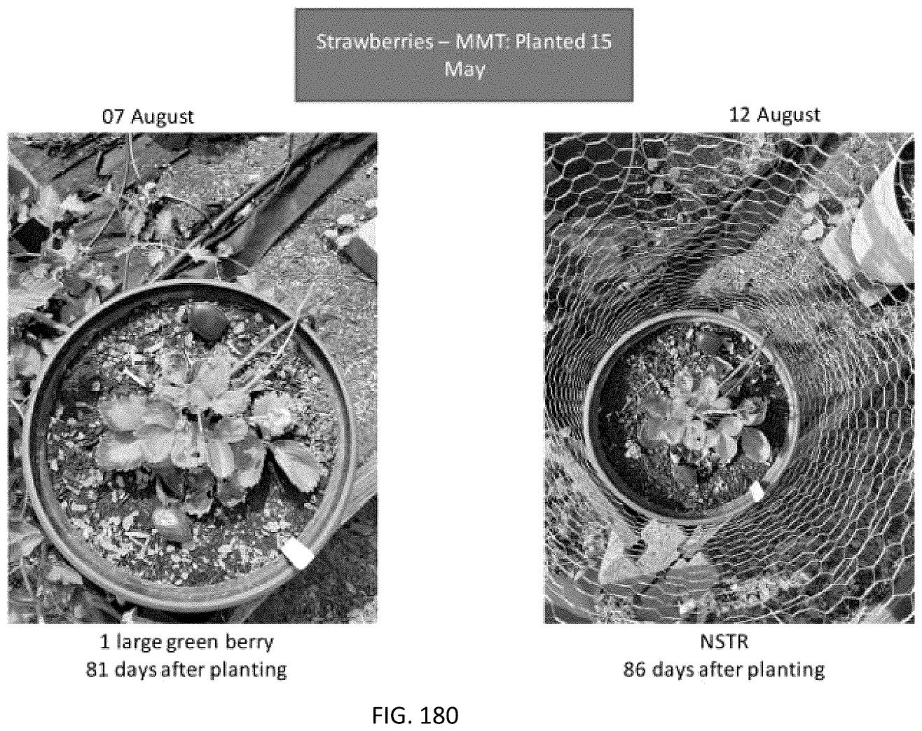

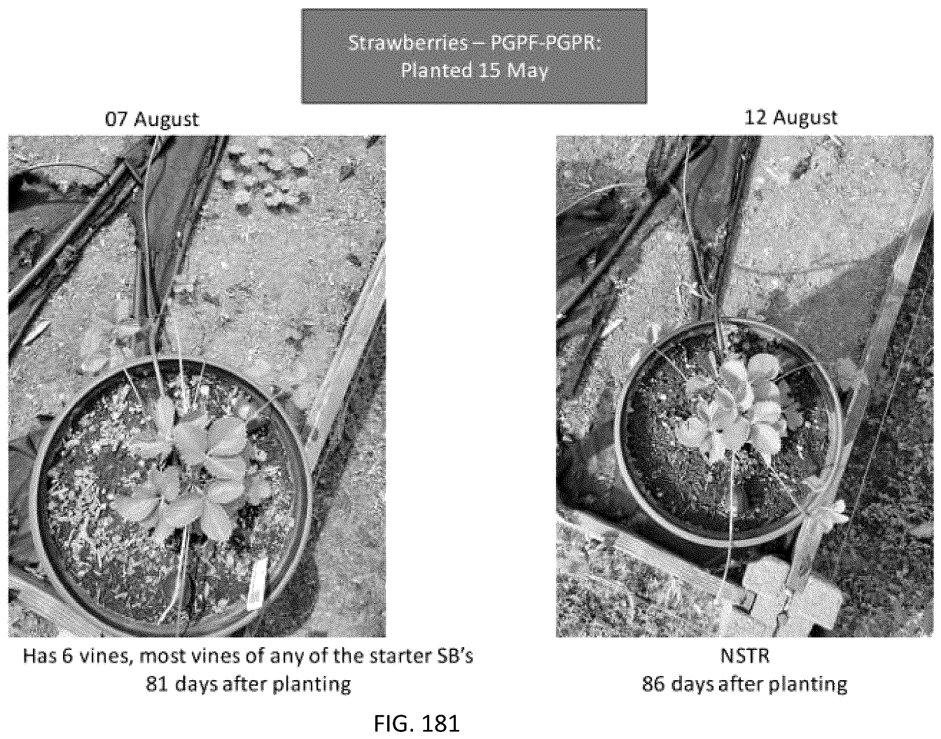

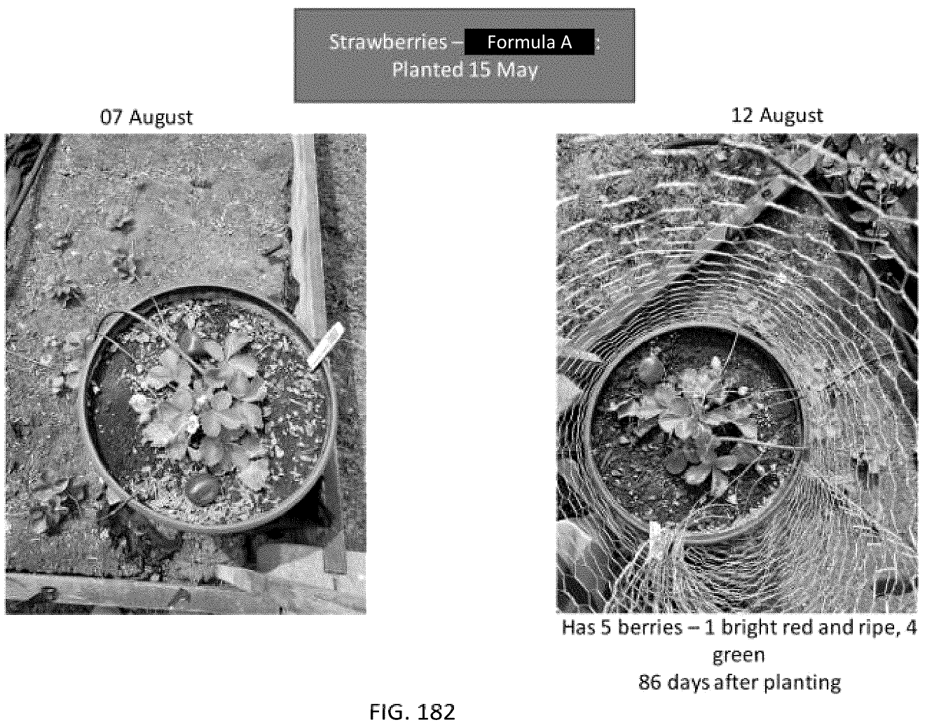

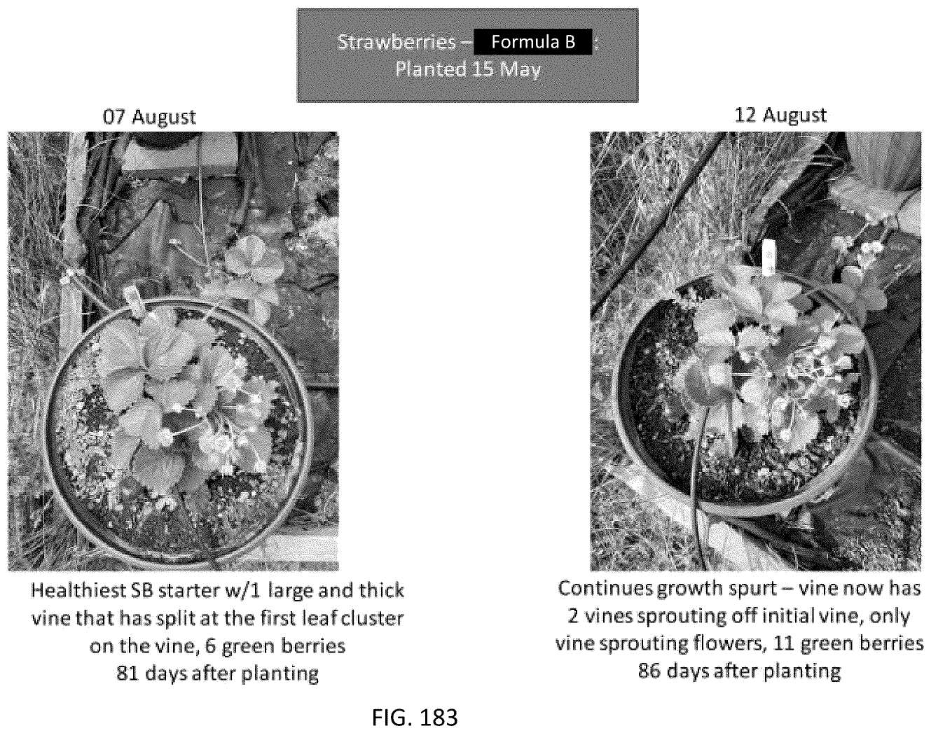

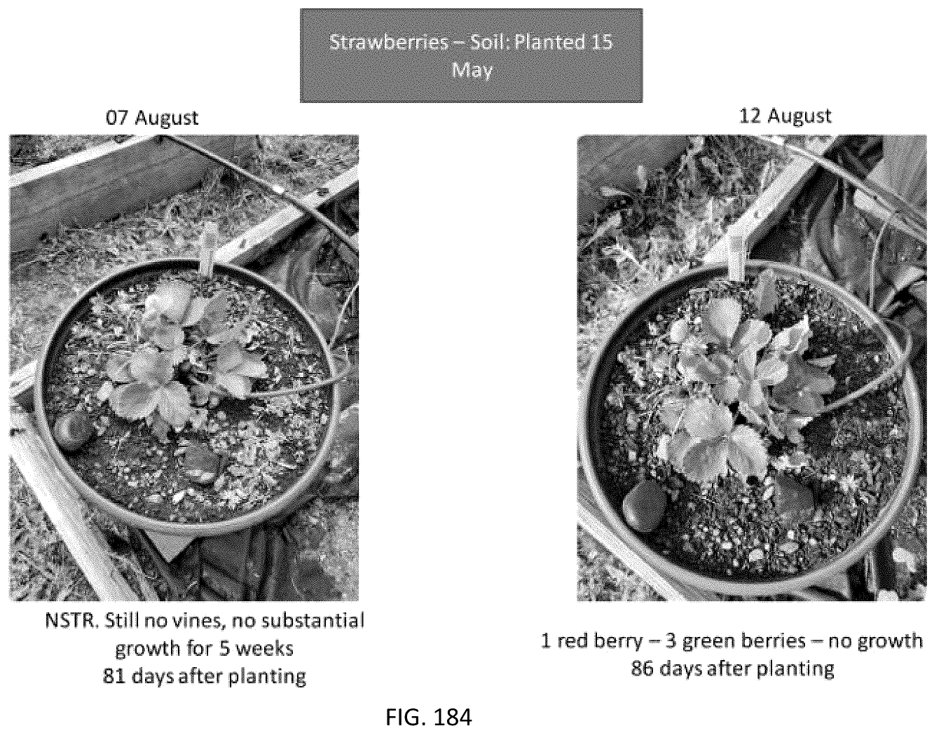

The compositions as prepared in Example 8 were applied to strawberry starters. All test groups were planted on May 15. Strawberry starters were observed to 9 weeks after planting. Images of the strawberries are shown in FIGS. 140-184.

In the MMT group, 4 leaves and 4 green strawberries were observed 13 days after planting. 4 dark green leaves and 1 strawberry turning dark red were seen 19 days after planting. At 20 days after planting, 4 dark green leaves were observed. All strawberries had turned red with one dark red and shiny. 3 new strawberry buds were red in color.

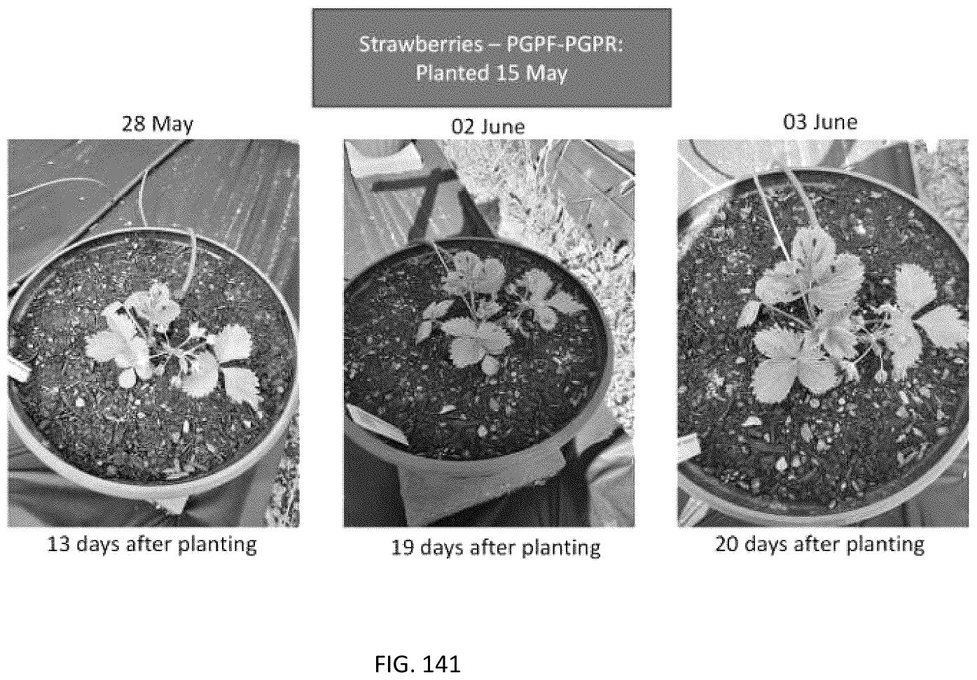

Pictures of the PGPF-PGPR group at 13 days, 19 days, and 20 days after planting are shown in FIG. 141.

In the Formula A group, leaves were the healthiest looking out of all groups tested at 13 days after planting. At 19 days after planting, 5 vibrant strawberry leaves were seen. This group had the healthiest strawberry bush of all groups. At 20 days after planting, there were 6 total leaves and 2 new branches had appeared. This group still had the largest and healthiest leaves of all groups tested.

The Formula B group was the weakest of all groups and had only one leaf but bounced back and was strong with 4 leaves and 1 green strawberry 13 days after planting. At 19 days after planting, there were 4 strong leaves and 1 red strawberry. At 20 days after planting, there were 5 strong leaves, 1 dark red strawberry, and 5 strawberry buds.

The Soil group was the strongest of all groups and had 6 green strawberries 13 days after planting. At 19 days after planting, this group had 6 strawberries, 2 of which were turning red. At 20 days after planting, 7 strawberries were seen, 3 of which were turning red, and 4 green.

The Formula B and Soil groups received about 3 extra hours of sunlight, which may have been a factor in the difference in the growth beds.

TABLE 16
Week 2 Strawberry Observations

| | June 4, 20 days | June 8, 24 days | June 10, 26 days |
|---|---|---|---|
| | after planting | after planting | after planting |
| MMT | 4 leaves, 1 red | 5 dark green leaves, 1 | 5 dark green leaves |
| | strawberry, and 5 buds | red strawberry, 4 buds | |
| PGPF-PGPR | Buds were developing, | 6 leaves, 7 buds, 1 | 2 vines |
| | 1 large vine | vine 12 inches long | |
| Formula A | Healthiest-looking | 6 large vibrant leaves, | 6 total leaves, 3 vines |
| | leaves of all groups | healthiest bush of all | measuring at 14 |
| | | groups, 2 large vines | inches, 11 inches, |
| | | | and 3 inches |
| Formula B | 5 leaves, 1 red | 4 strong leaves, | 5 strong leaves, 1 |
| | strawberry, 5 buds | 1 strawberry | dark red strawberry, |
| | | | 5 strawberry buds |
| Soil | 5 leaves, 0 vines, 1 | 6 leaves, no new | All berries |
| | red berry, 1 berry | growth size of leaves, | were light |
| | turning red, 4 green | no vines, 6 berries | red or red |
| | berries | | |

TABLE 17
Week 3 Strawberry Observations

| | June 12, 28 days | June 15, 31 days | June 17, 33 days |
|---|---|---|---|
| | after planting | after planting | after planting |
| MMT | 4 leaves, 1 red | 5 dark green leaves, | 5 dark green leaves, |
| | strawberry, 5 buds | 1 red strawberry, 4 | 1 flower, 0 vines |
| | | buds, 1 flower budding | |
| PGPF-PGPR | Buds developing, | 6 leaves, 7 buds, 2 | 3 vines, 6 leaves, 4 |
| | 2 large vines | vines 12 inches long | green and 2 red |
| | | | leaves, 1 vine |
| | | | sprouting new leaf |
| Formula A | Healthiest looking | 7 large vibrant leaves, | 7 total leaves, 6 of |
| | leaves of all groups, | healthiest bush of all | which are green and |
| | most number of vines | groups, 3 large vines | 1 red. 3 vines |
| | of all groups | | measuring at 14 |
| | | | inches, 11 inches, |
| | | | and 10 inches. 2 |
| | | | vines are sprouting |
| | | | leaves. |
| Formula B | 5 leaves, 1 red | 4 strong leaves, 1 red | 4 leaves, no bines, |
| | strawberry, 5 buds | strawberry | no flowers |
| Soil | 5 leaves, 0 vines | 6 leaves, no new | No longer had |
| | | growth size of leaves, | strawberries. 5 green |
| | | no vines | leaves and 0 red |
| | | | leaves. 1 new leaf |
| | | | sprouting, 0 vines. |

TABLE 18
Week 4 Strawberry Observations

| | June 19, 35 days | June 23, 39 days |
|---|---|---|
| | after planting | after planting |
| MMT | 3 flowers | 1 flower, 6 buds, 0 berries |
| PGPF-PGPR | 3 vines | Second strongest of all groups |
| Formula A | Healthiest leaves, strongest | Strongest of all groups with 3 |
| | vines of all groups | large vines |
| Formula B | 5 leaves, strongest | Nothing serious |
| | recovery of | to report |
| | weakest starter | |
| Soil | Nothing serious | Nothing serious |
| | to report | to report |

During weeks 3 and 4, the Formula A group had the healthiest-looking fruits out of the three groups that received less sunlight. Growth was stunted during week 4 due to a cold snap where temperatures dropped to 43° F. at night for 4 consecutive days starting June 18. Minimal sunlight was observed during this time with wet and rainy conditions. The temperature ranged between 46° F. and 51° F.

TABLE 19
Week 5 Strawberry Observations

| | July 3, 45 days | July 7, 49 days |
|---|---|---|
| | after planting | after planting |
| MMT | 3 green berries, 6 leaves, 1 | 2 red berries, 1 green berry, 9 |
| | small vine | flowers, 1 vine, 7 leaves |
| PGPF-PGPR | 3 large vines | 6 leaves, 3 large vines |
| Formula A | 7 healthy leaves, 3 large vines | 3 large vines all sprouting new |
| | with leaves, 3 flower sprouts | leaves, 7 healthy leaves on |
| | | plant with 1 flower and 2 |
| | | berries |
| Formula B | Nothing serious | 7 large green leaves |
| | to report | |
| Soil | 5 flowers | 7 green leaves, 5 flowers, 2 |
| | | green berry sprouts |

Growth had picked up from the previous wet and cloudy weather that stunted growth. All MMT, PGPF-PGPR, Formula A, and Formula B groups now had vines growing. The Soil group did not have vines.

TABLE 20
Week 6 Strawberry Observations

| | July 19, 58 days | July 22, 65 days |
|---|---|---|
| | after planting | after planting |
| MMT | 3 bright deep red berries, 1 | 9 berries, 4 of which were |
| | vine | green and 5 red, leaves on the |
| | | tip of the berries were dark red, |
| | | 1 large vine |
| PGPF-PGPR | 3 large vines | 3 large vines |
| Formula A | 3 large vines that were | 2 red berries, 1 green, 1 flower, |
| | sprouting leaves, 3 berry | 3 large vines with each vine |
| | sprouts | having 3 new leaf clusters |
| Formula B | Very healthy, 6 deep green | Healthiest leaves, deep green |
| | leaves, 1 vine | shiny leaves, no bugs eating |
| | | leaves, 1 vine 12 inches long |
| | | and 2x as thick as other vines. |
| | | Was the weakest starter now |
| | | healthiest. |
| Soil | Only group without vines, has 3 | 8 berries, 1 of which was red |
| | flowers and 4 green berries | and 2 of which were turning |
| | buds | red. No vines. |

TABLE 21
Week 7 Strawberry Observations

| | July 24, 67 days | July 30, 73 days |
|---|---|---|
| | after planting | after planting |
| MMT | 2 ripe berries, 1 green berry. 1 | Nothing serious |
| | ripe berry was tested and was | to report |
| | very flavorful and moist. | |
| PGPF-PGPR | Nothing serious to report | Nothing serious |
| | | to report |
| Formula A | 3 ripe berries. 1 ripe berry was | Nothing serious |
| | tested and was more flavorful | to report |
| | and more moist than the MMT | |
| | berry. | |
| Formula B | Healthiest and largest of all | Healthiest of all groups, 2 |
| | groups | healthy flowers, vine 2 |
| | | feet long. |
| Soil | 3 green berries | 2 berries starting to turn red |

All the MMT, PGPF-PGPR, Formula A, and Formula B groups had vines growing. The Soil group still did not have vines. The Formula B plants were noticeably the most abundant, healthy, and vibrant out of all groups tested, followed by the Formula A plants.

TABLE 22
Week 8 Strawberry Observations

| | August 1, 75 days | August 4, 78 days |
|---|---|---|
| | after planting | after planting |
| MMT | 4 berries, 1 of which was red | 3 berries, 1 of which was |
| | and 3 of which were green | turning red |
| PGPF-PGPR | Nothing serious | Nothing serious |
| | to report | to report |
| Formula A | Nothing serious | 3 green berries, 3 flowers, |
| | to report | vines grown larger and |
| | | developed more leaves |
| Formula B | Healthiest, vine has 2 branches | Biggest and healthiest, 2 green |
| | off the same vine and was the | berries, 1 large vine breaking |
| | only group with a vine | off into 2 vines from the original |
| | presenting in this manner, 4 | vine, still was the only group |
| | flowers | with a vine presenting in this |
| | | manner |
| Soil | Nothing serious | Nothing serious |
| | to report | to report |

All MMT, PGPF-PGPR, Formula A, and Formula B groups had vines growing. The Soil group still did not have vines. The Formula B plants were noticeably the most abundant, healthy, and vibrant out of all groups tested, followed by the Formula A plants.

TABLE 23
Week 9 Strawberry Observations

| | August 7, 81 days | August 12, 86 days |
|---|---|---|
| | after planting | after planting |
| MMT | 1 large green berry | Nothing serious |
| | | to report |
| PGPF-PGPR | 6 vines, most number of vines | Nothing serious |
| | out of all groups | to report |
| Formula A | 3 vines with 10 total leaf | 5 berries, 1 of which was bright |
| | clusters on the vine, 4 large | red and ripe and 4 of which |
| | flowers, 3 green berries | were green |
| Formula B | Healthiest, 1 large and thick | Continued growth spurt. Vine |
| | vine that had split at the first leaf | now had 2 vines sprouting off |
| | cluster on the vine, 6 green | initial vine, only vine sprouting |
| | berries | flowers, 11 green berries |
| Soil | Nothing serious to report. Still | 1 red berry, 3 of which were |
| | no vines, no substantial growth | green. No growth. |
| | for 5 weeks | |

All MMT, PGPF-PGPR, Formula A, and Formula B groups had vines growing. The Soil group still did not have vines. The Formula B plants were noticeably most abundant, healthy, and vibrant out of all groups tested, followed by the Formula A plants.

### Example 13: Bell Peppers

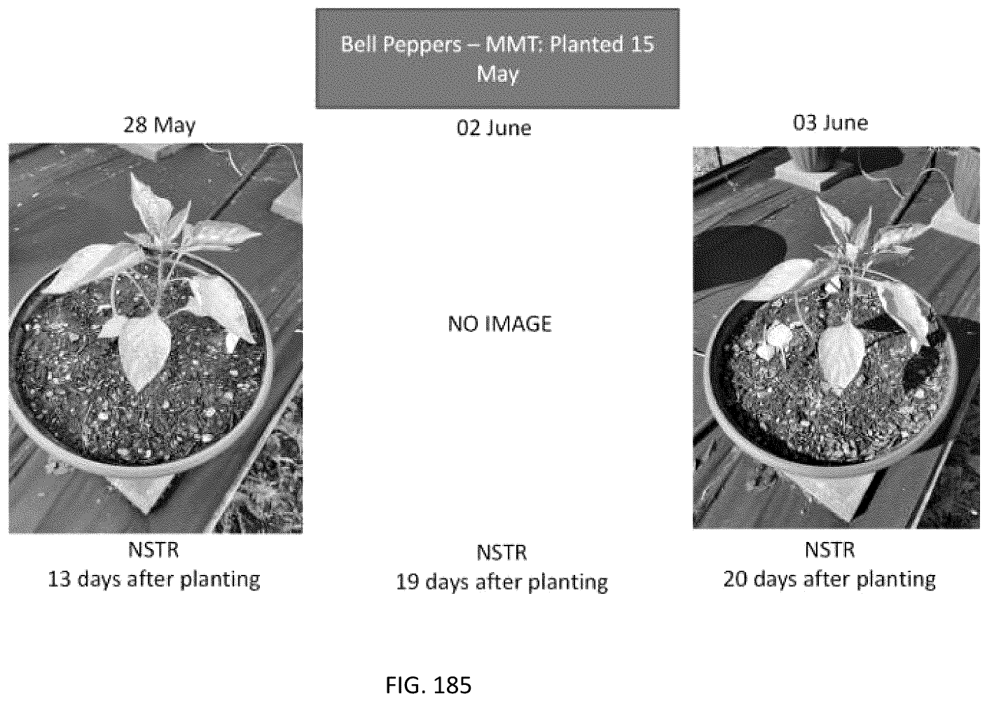

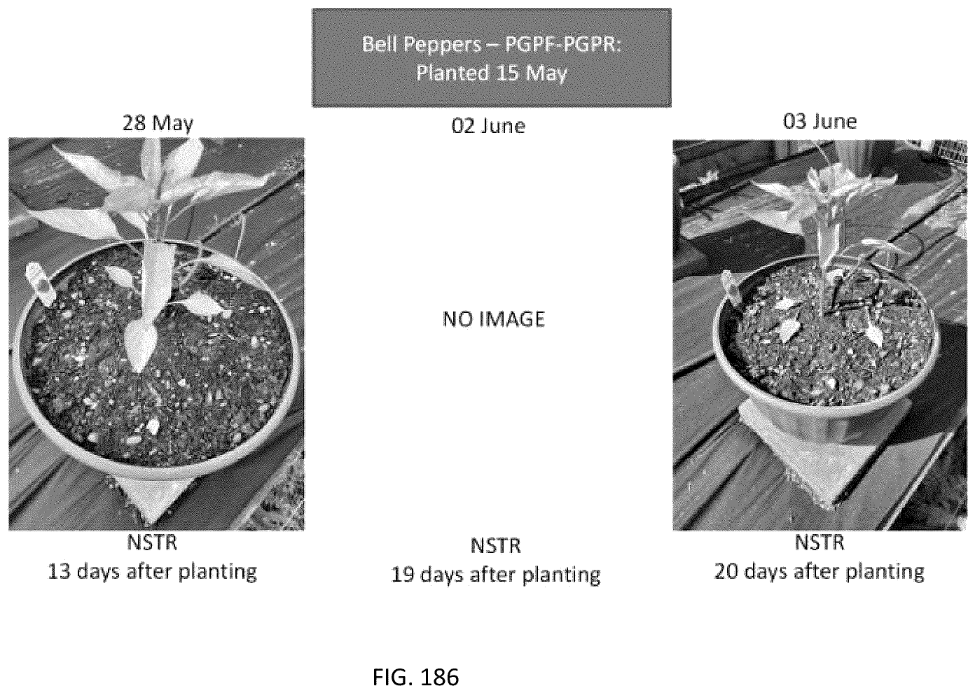

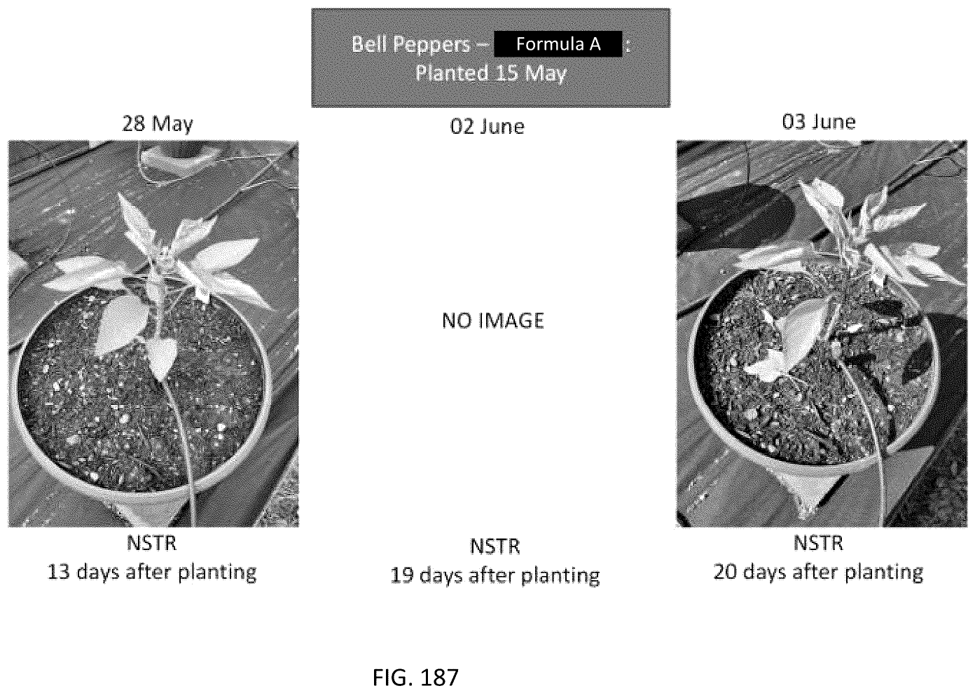

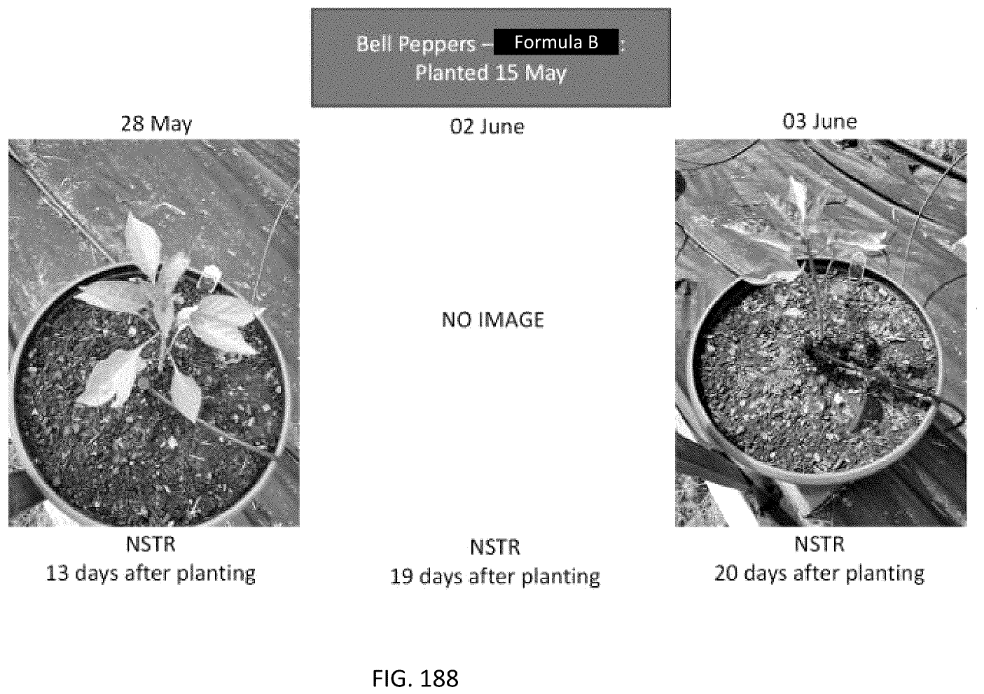

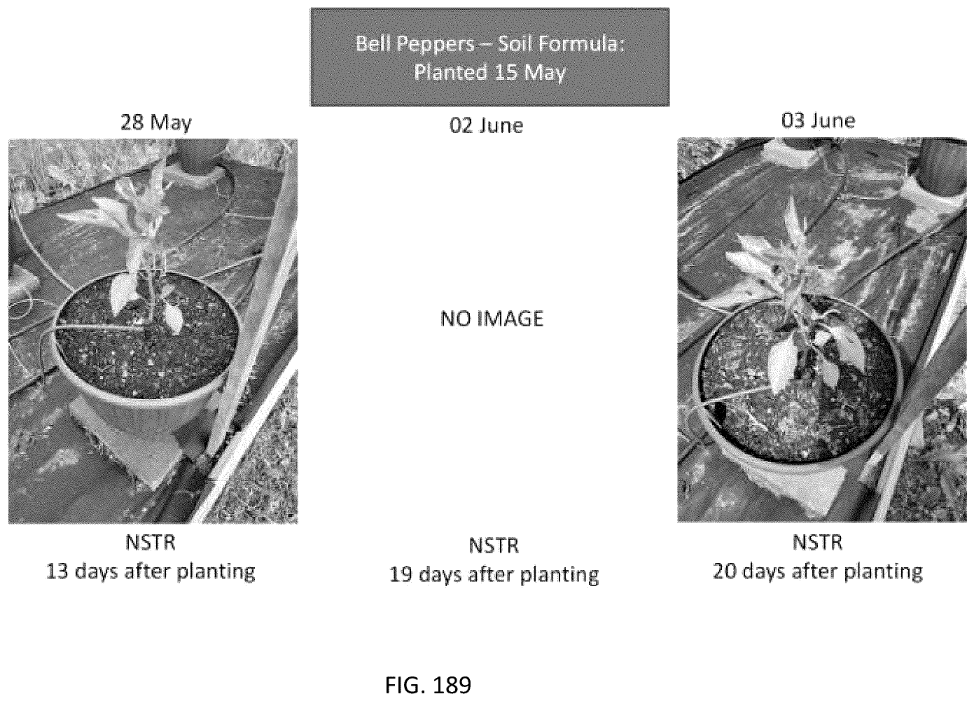

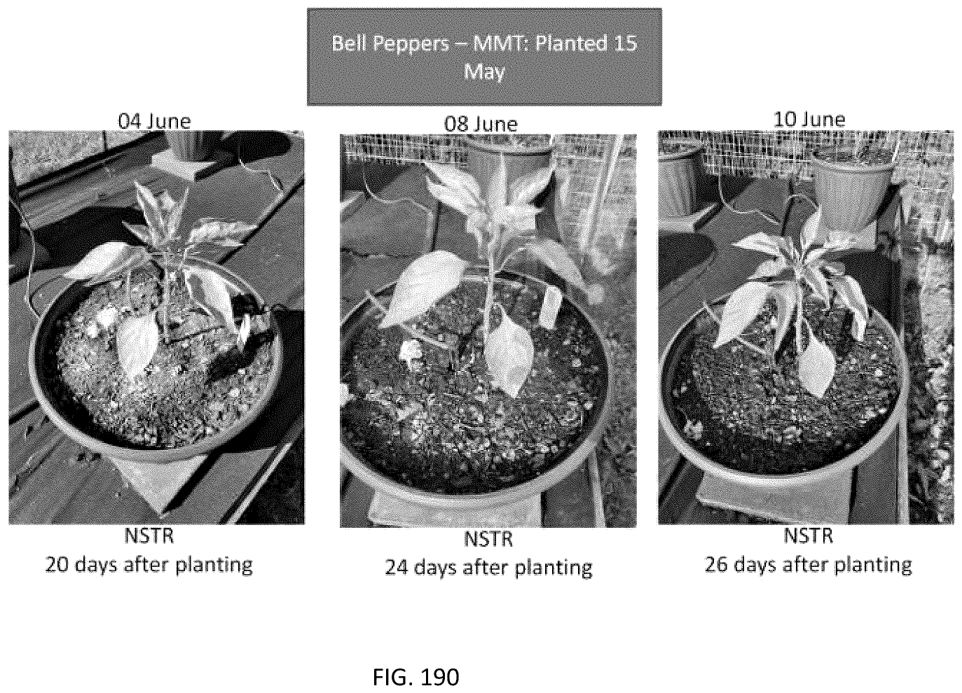

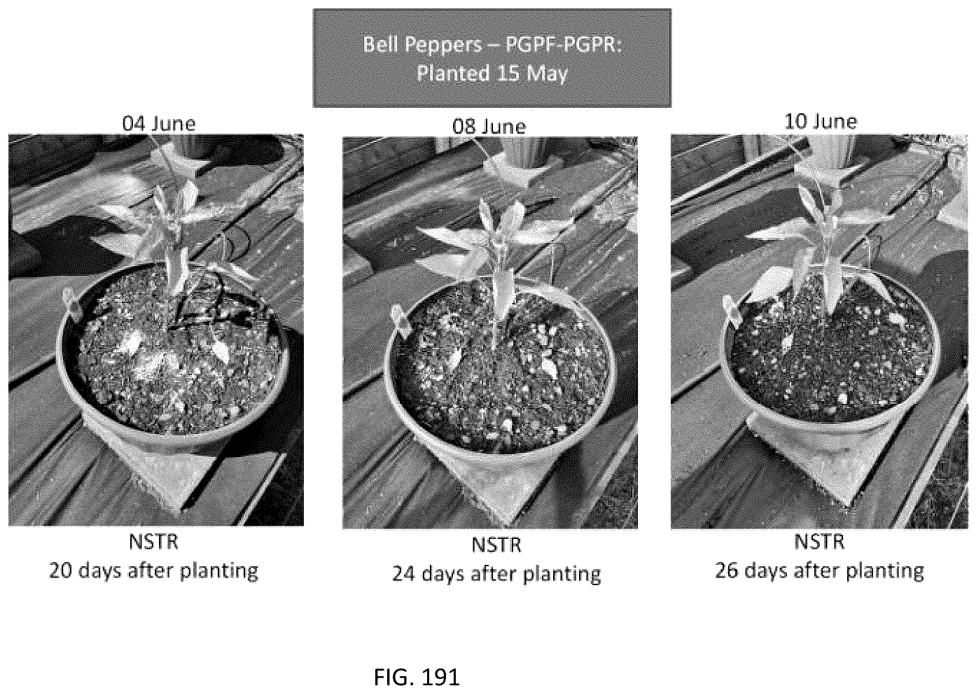

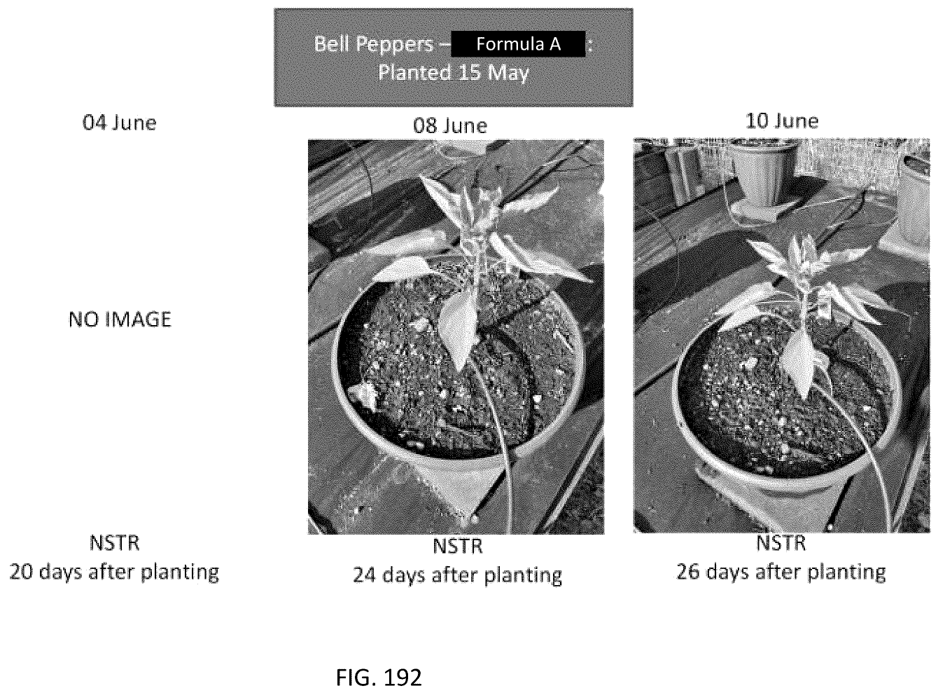

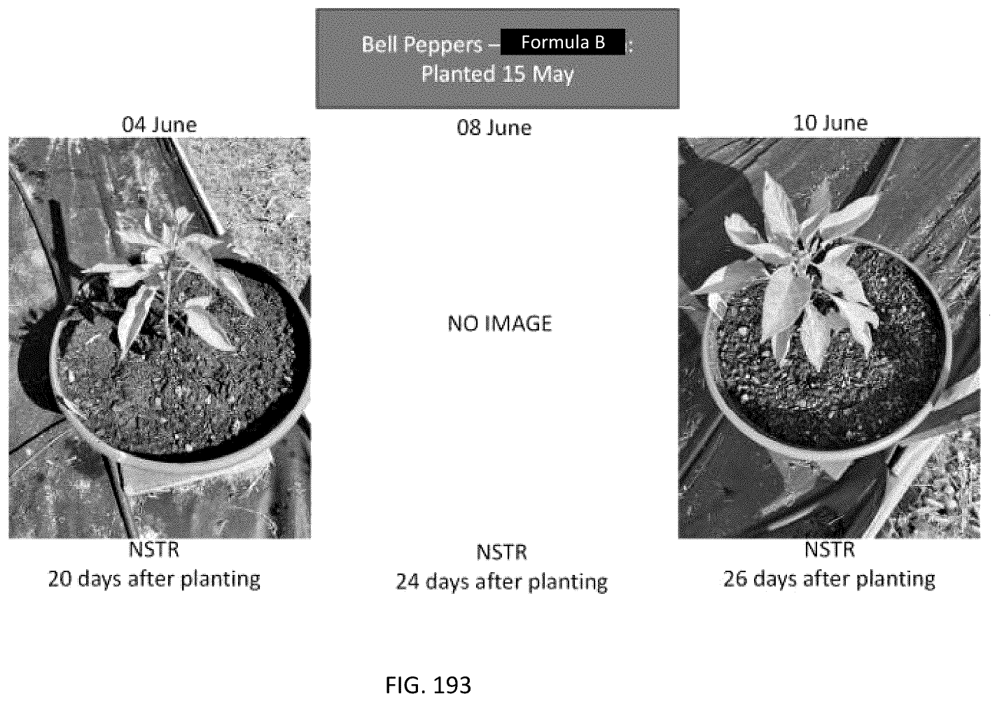

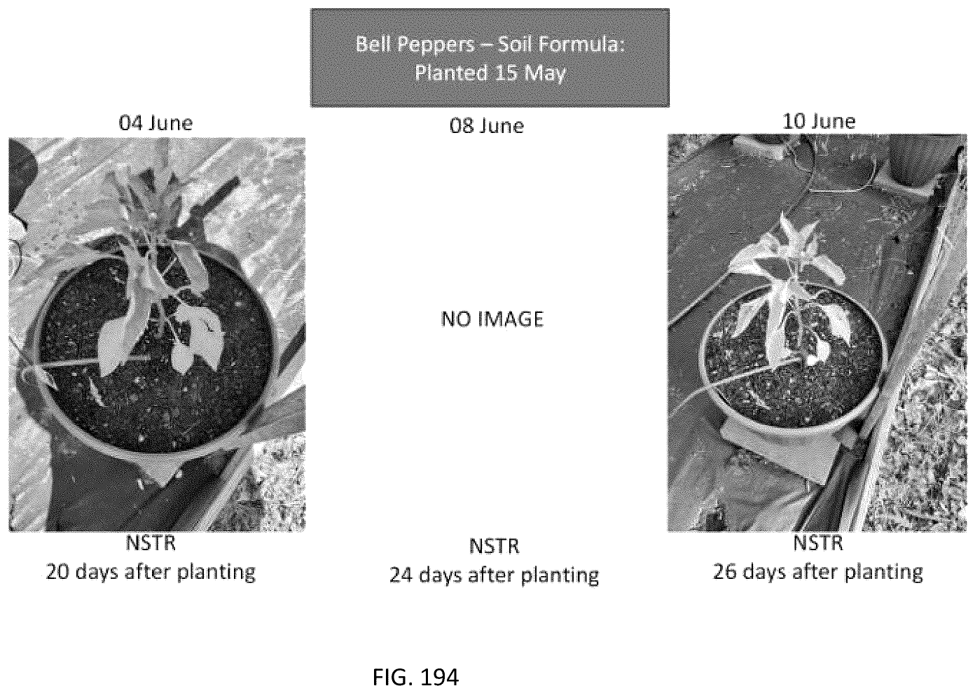

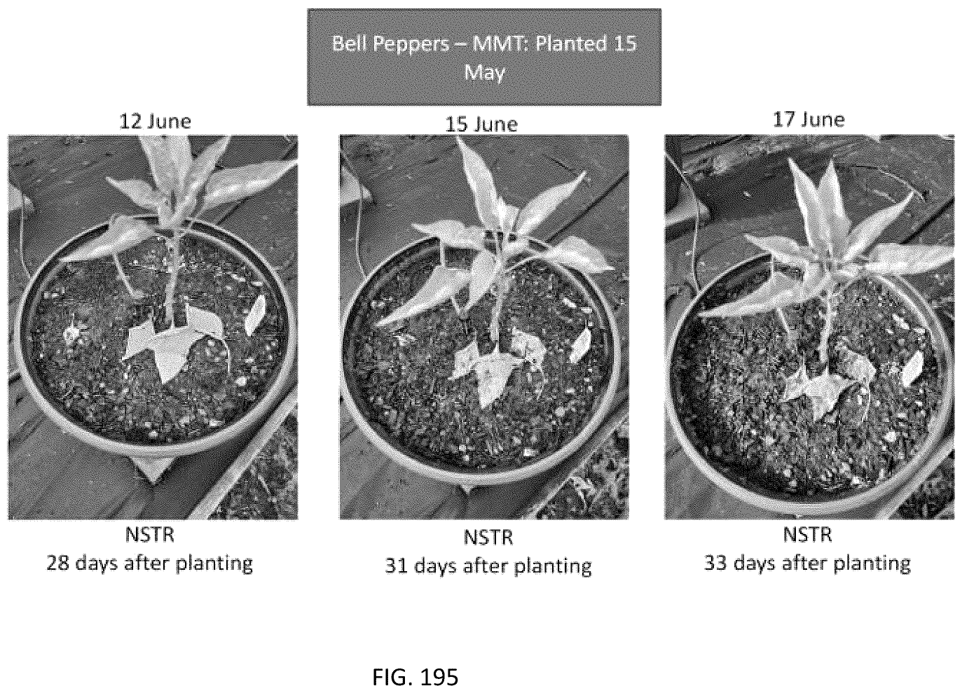

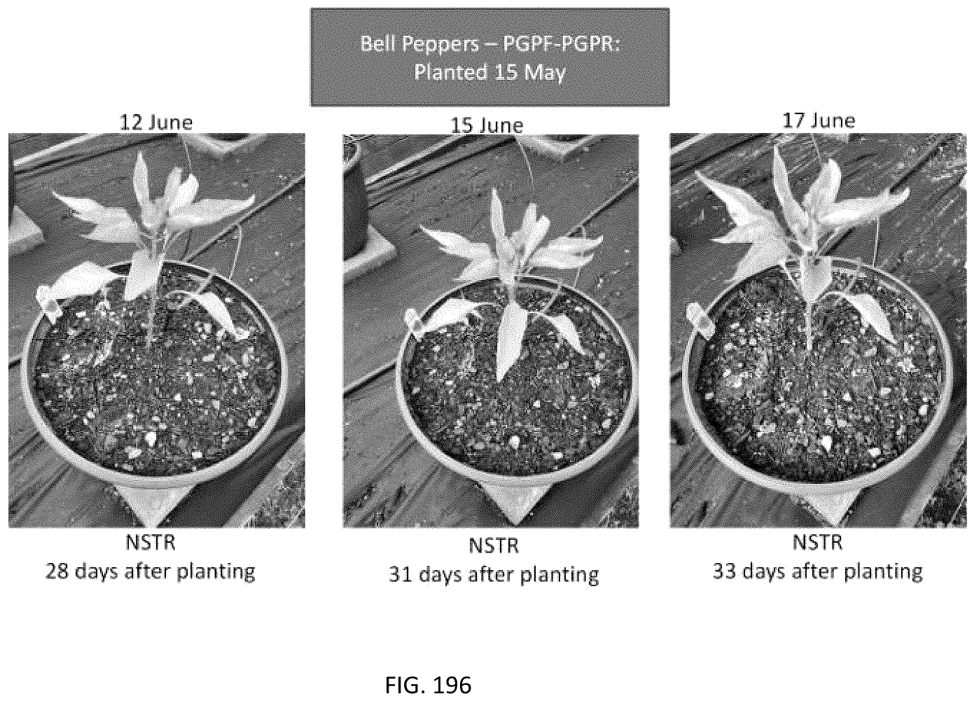

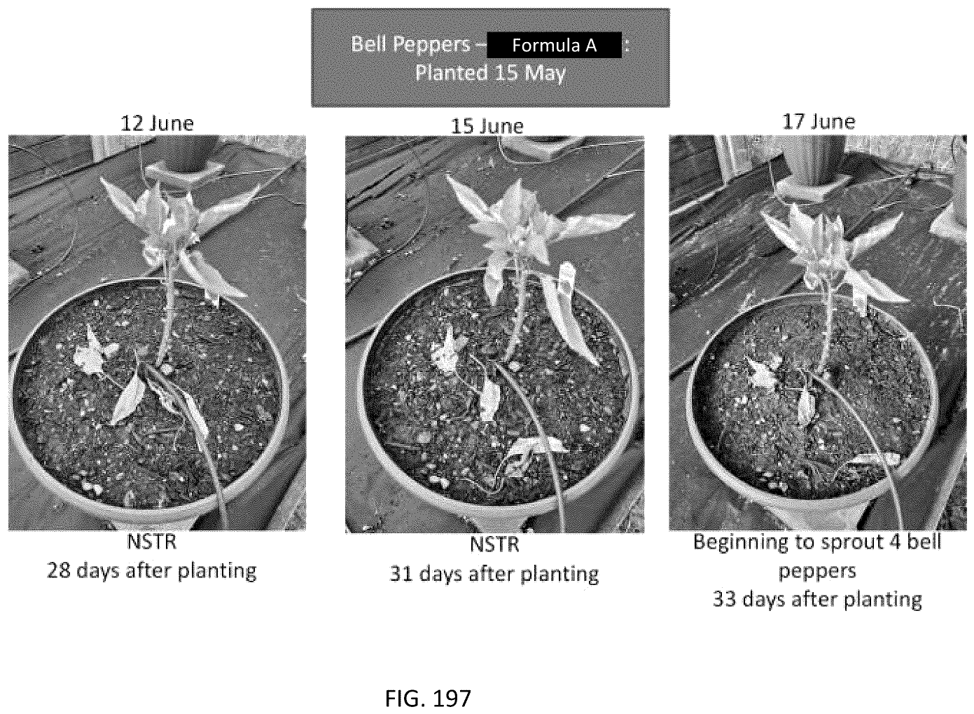

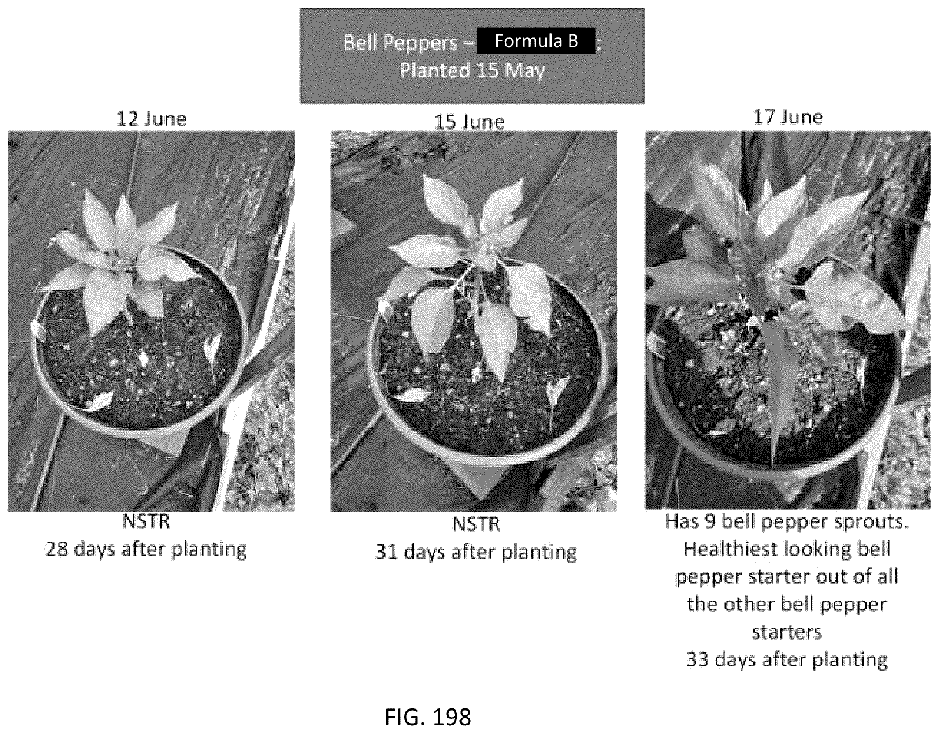

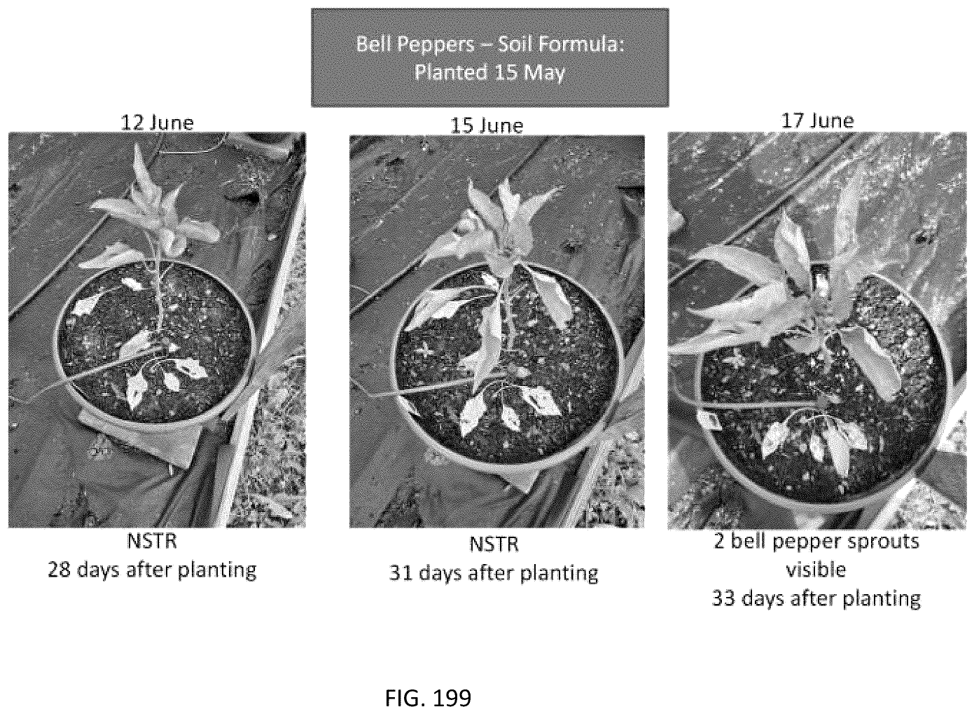

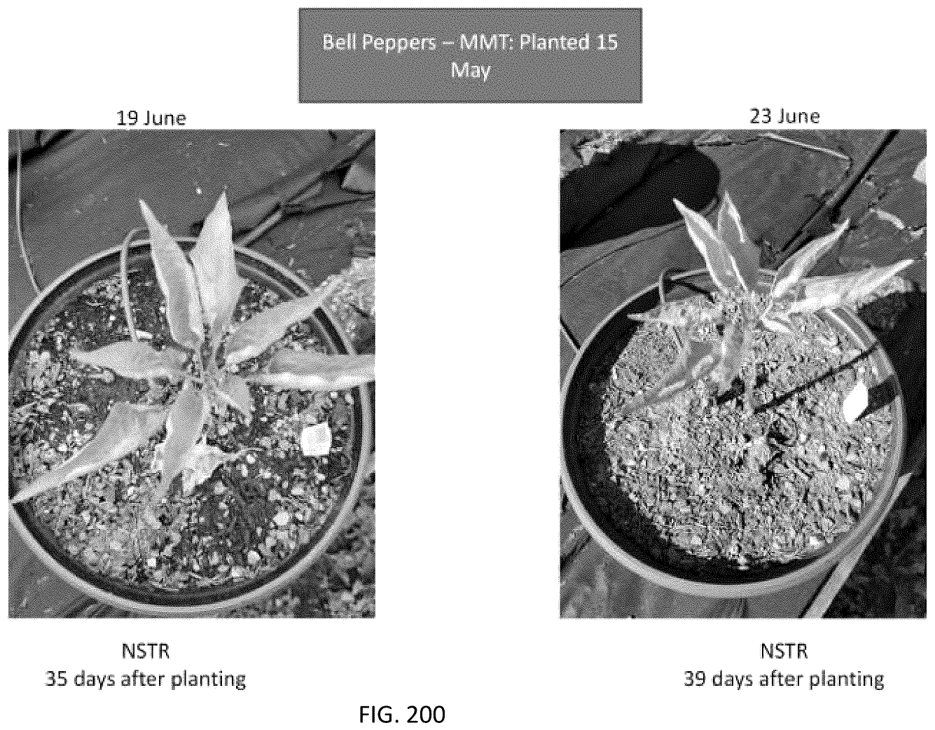

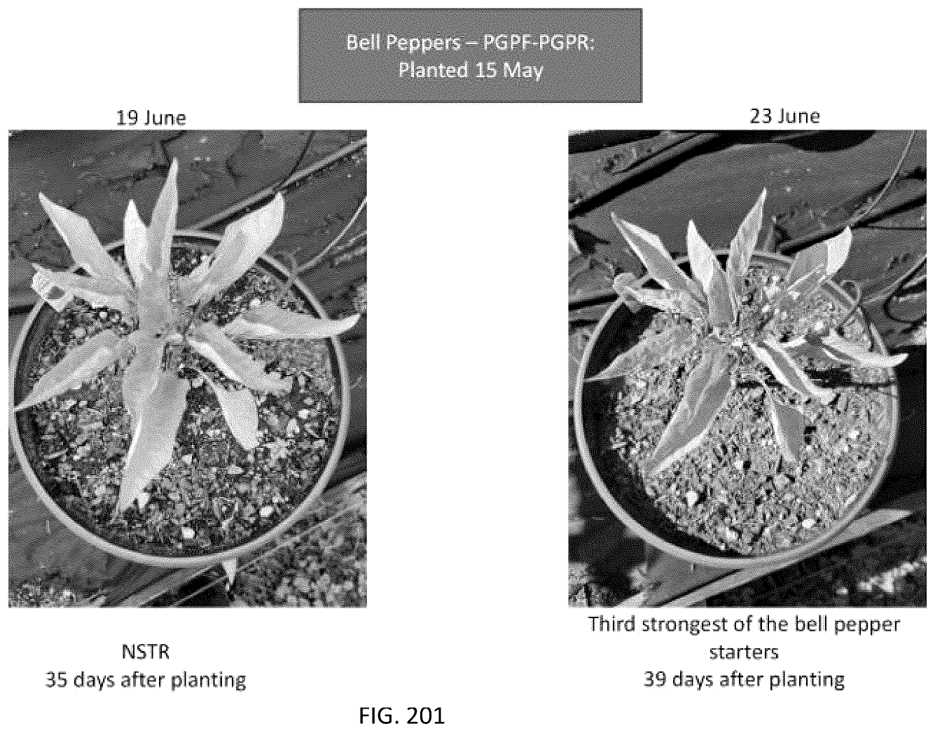

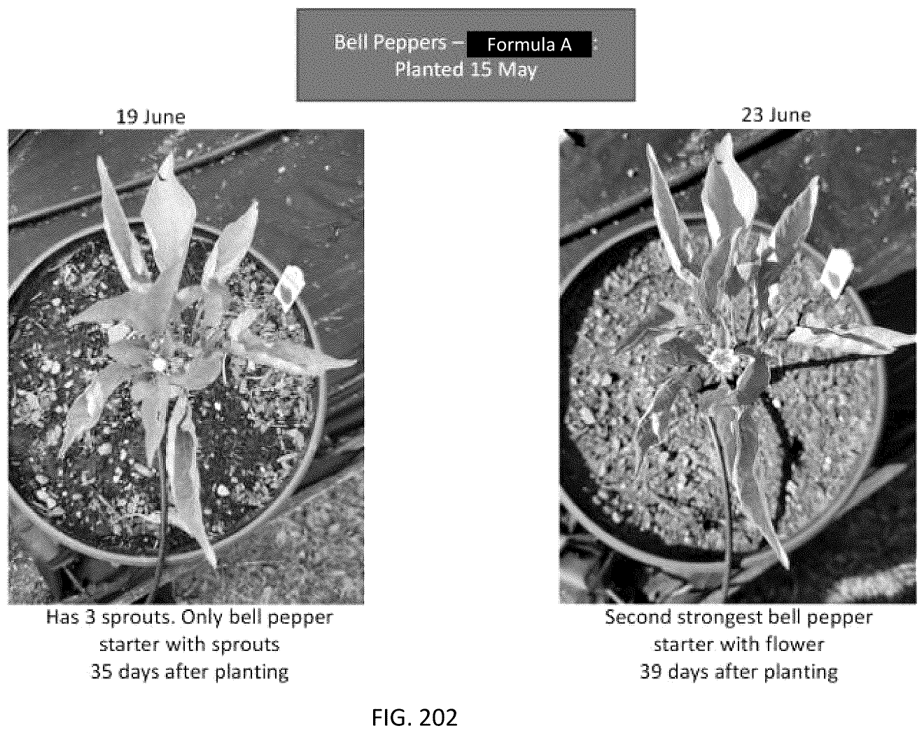

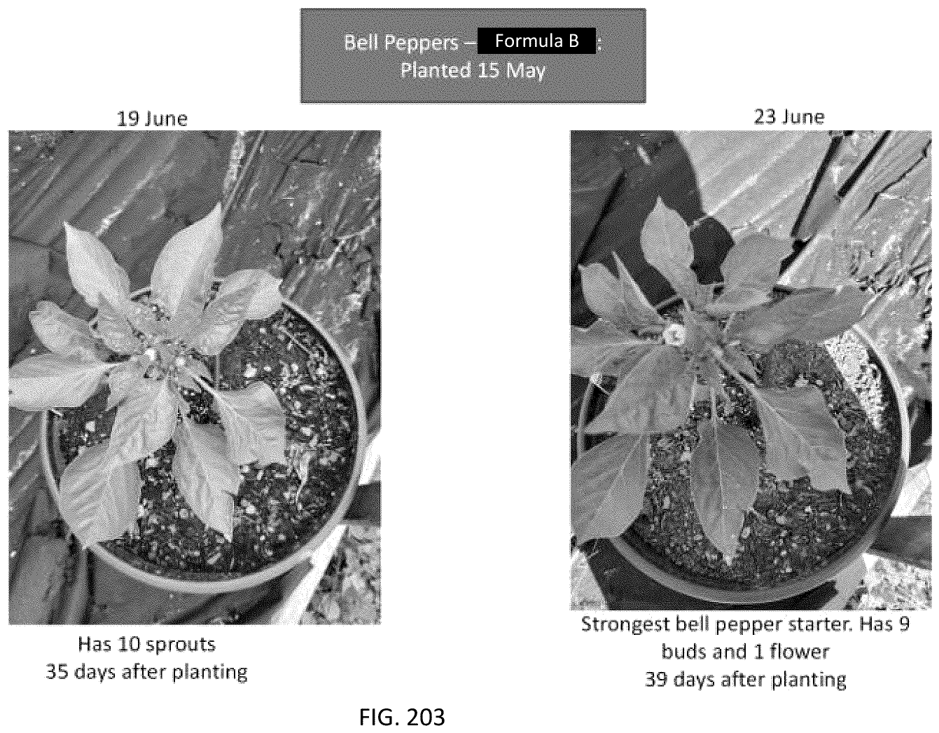

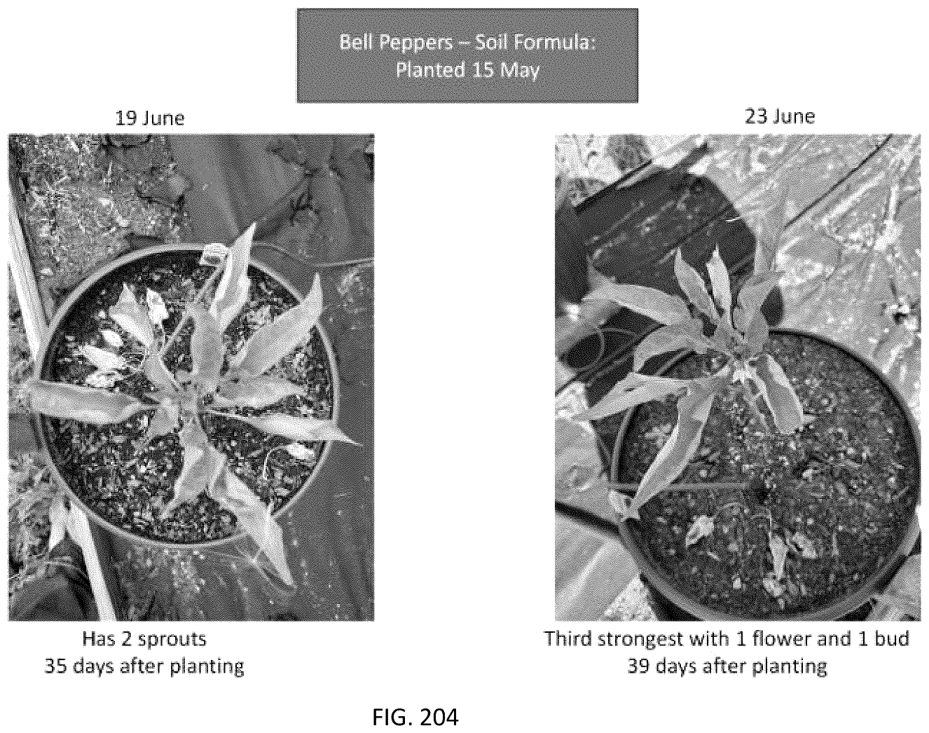

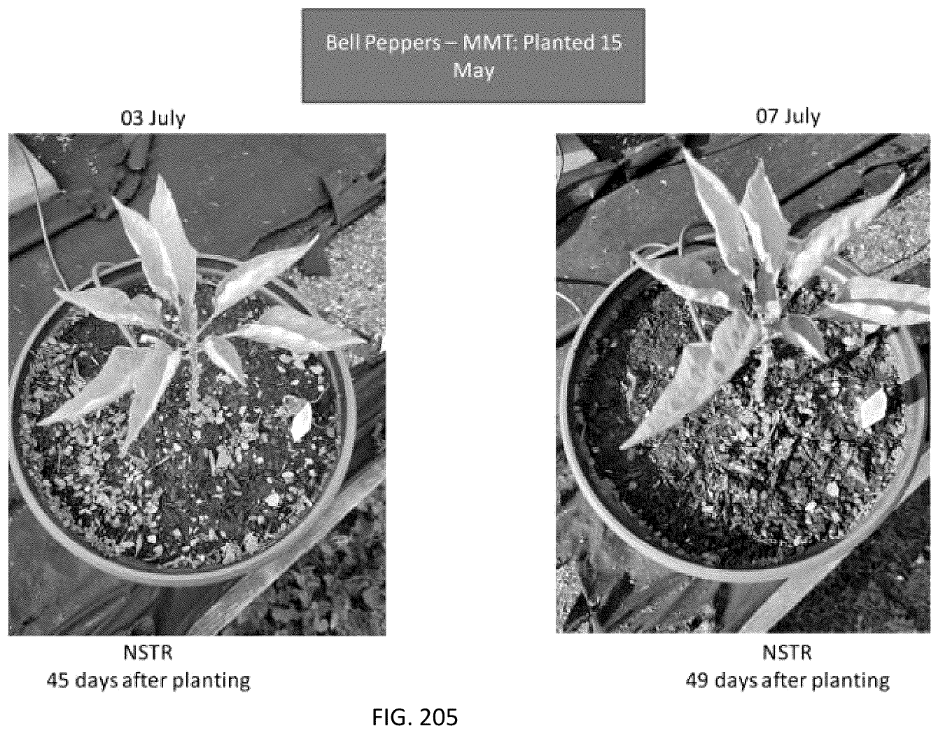

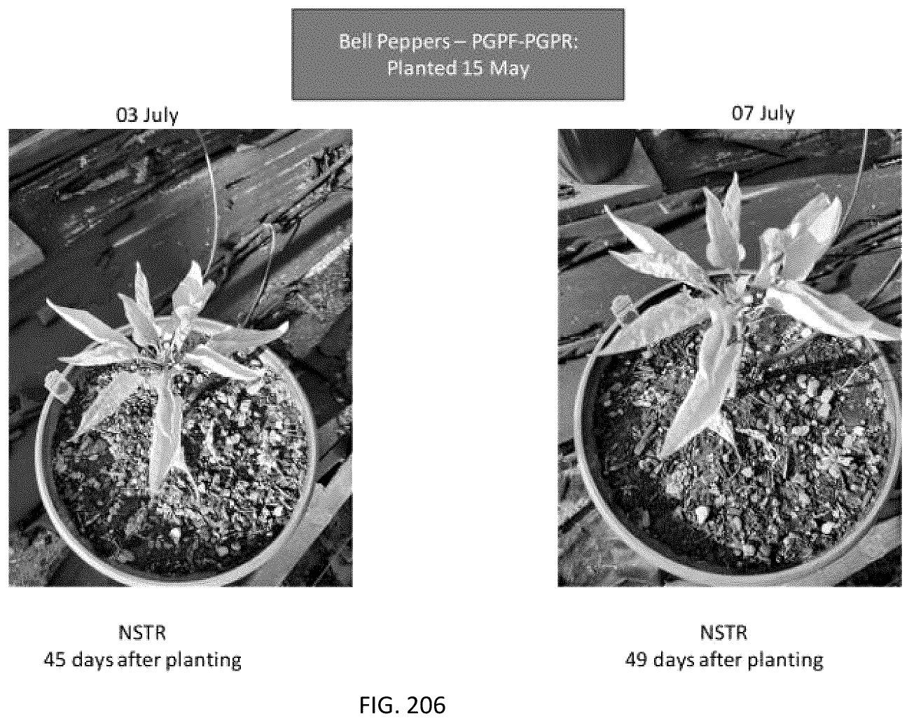

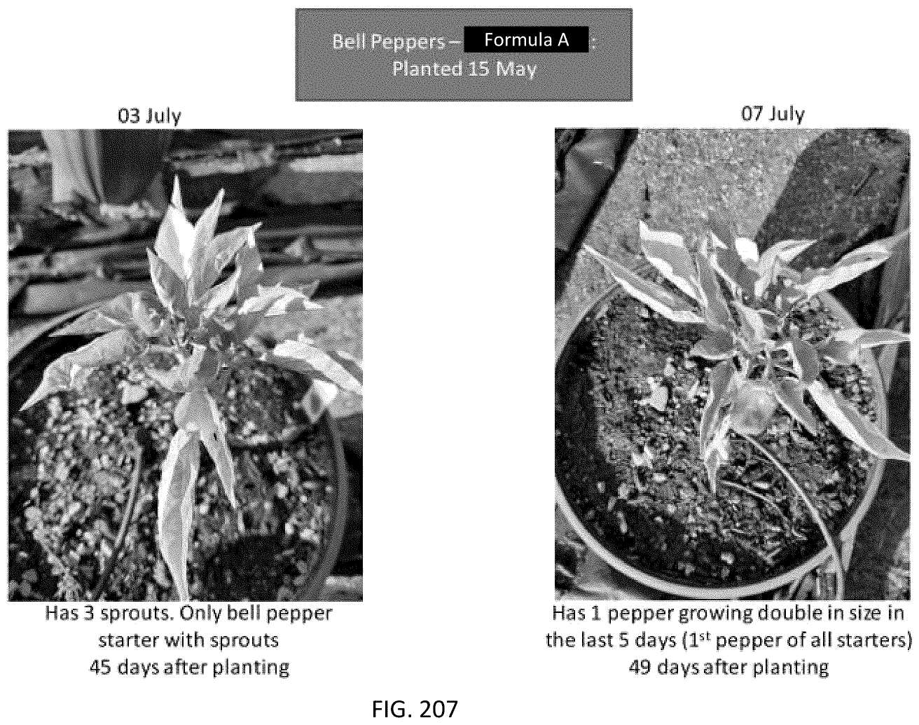

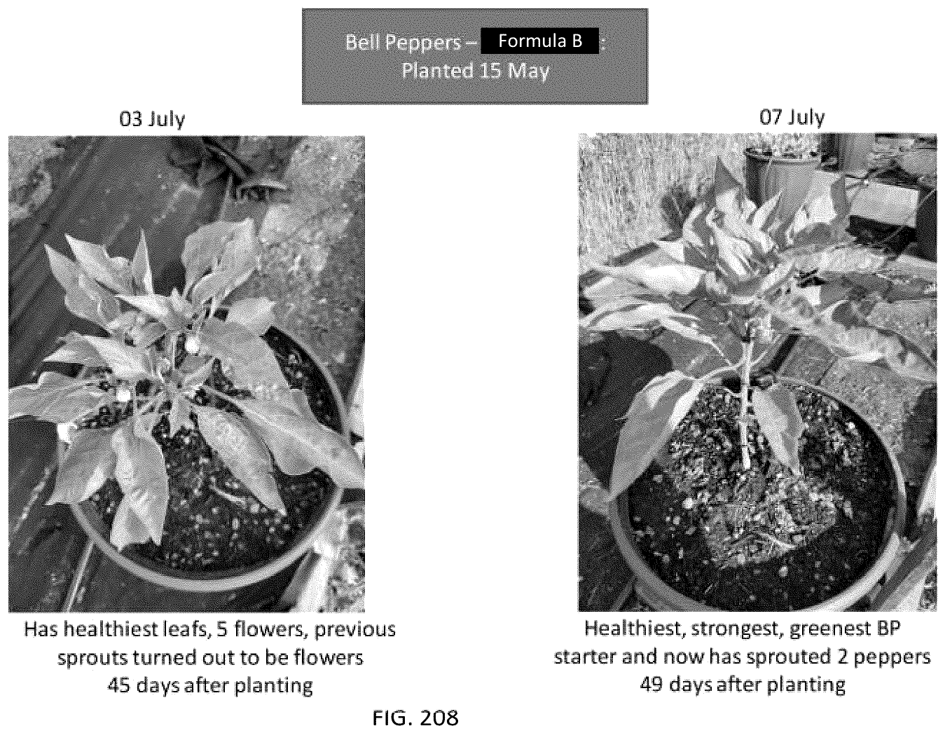

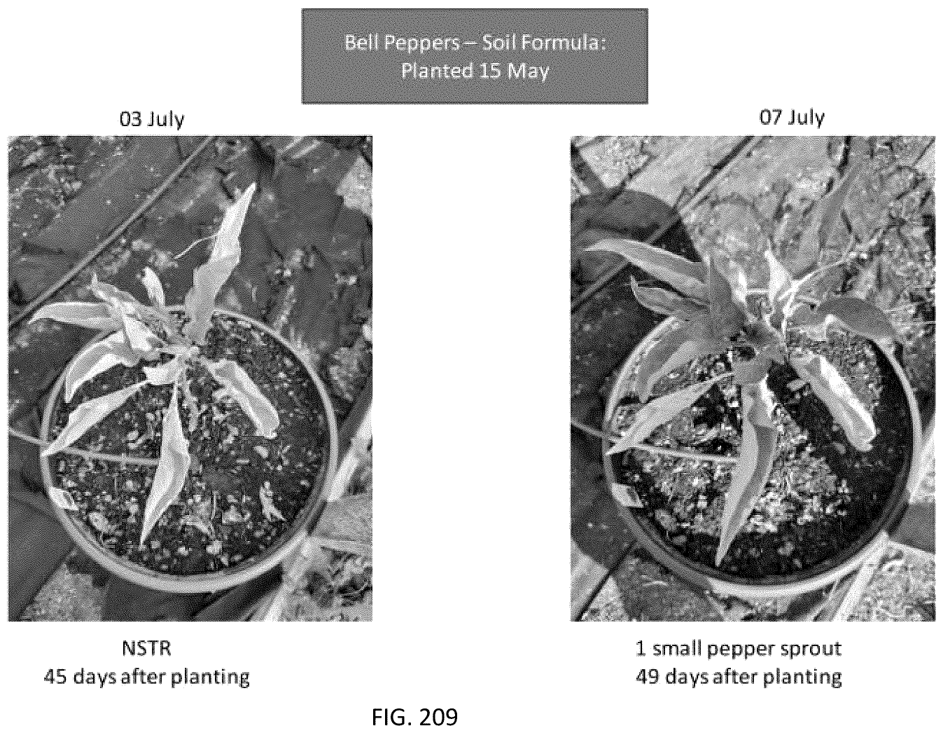

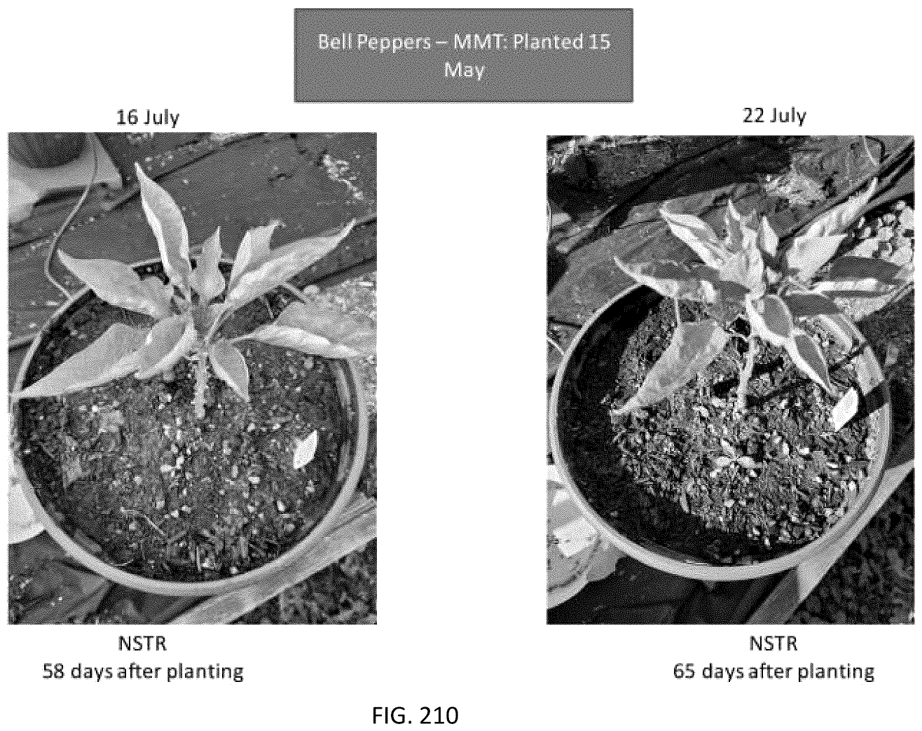

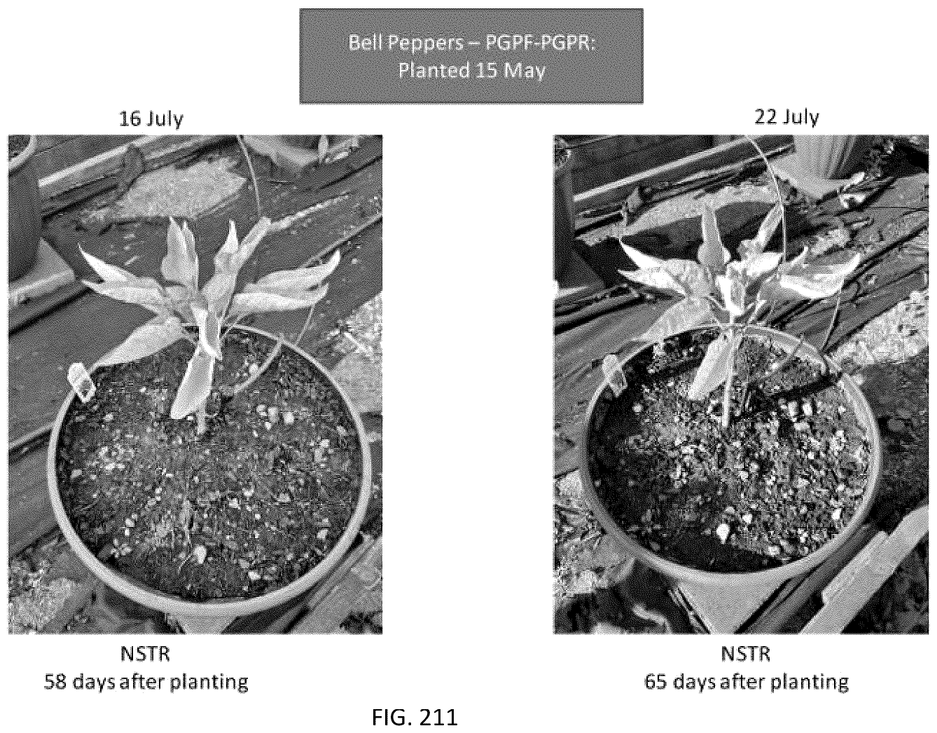

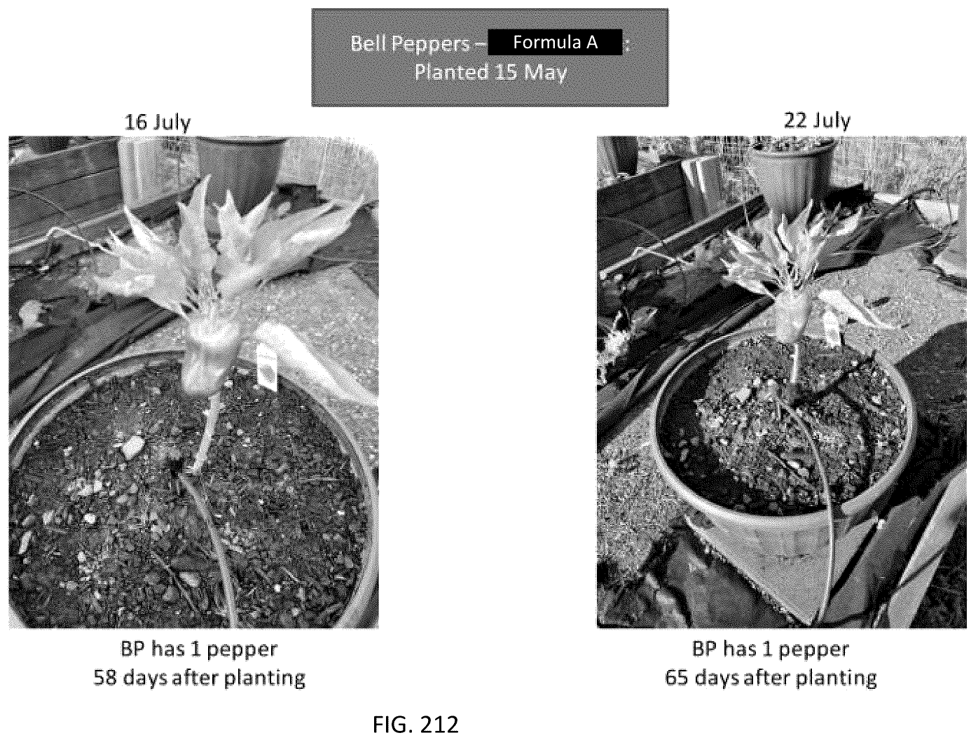

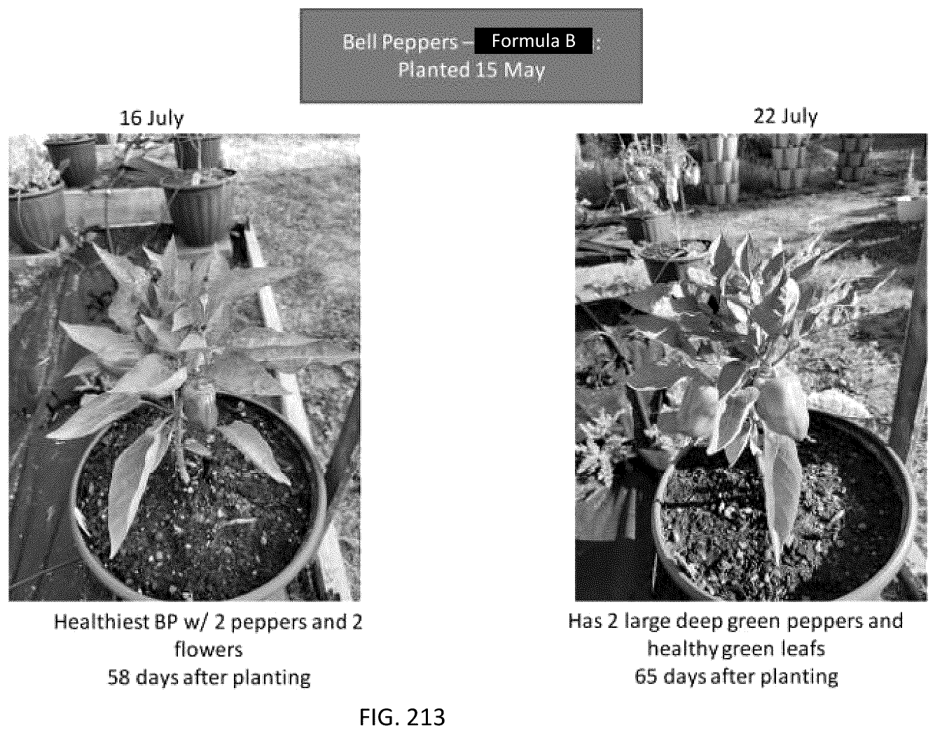

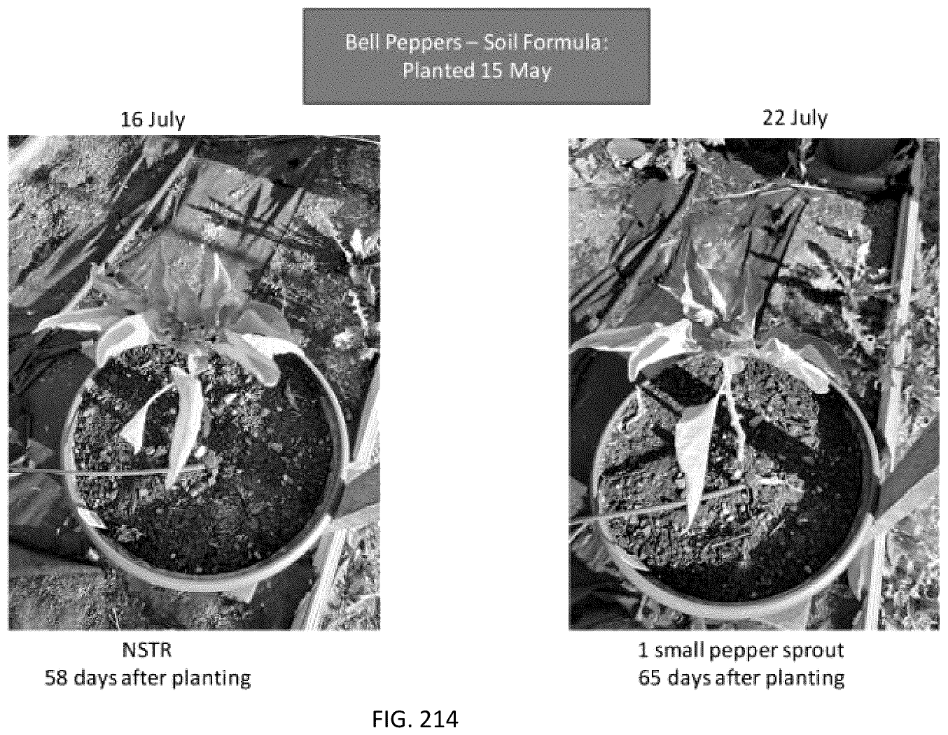

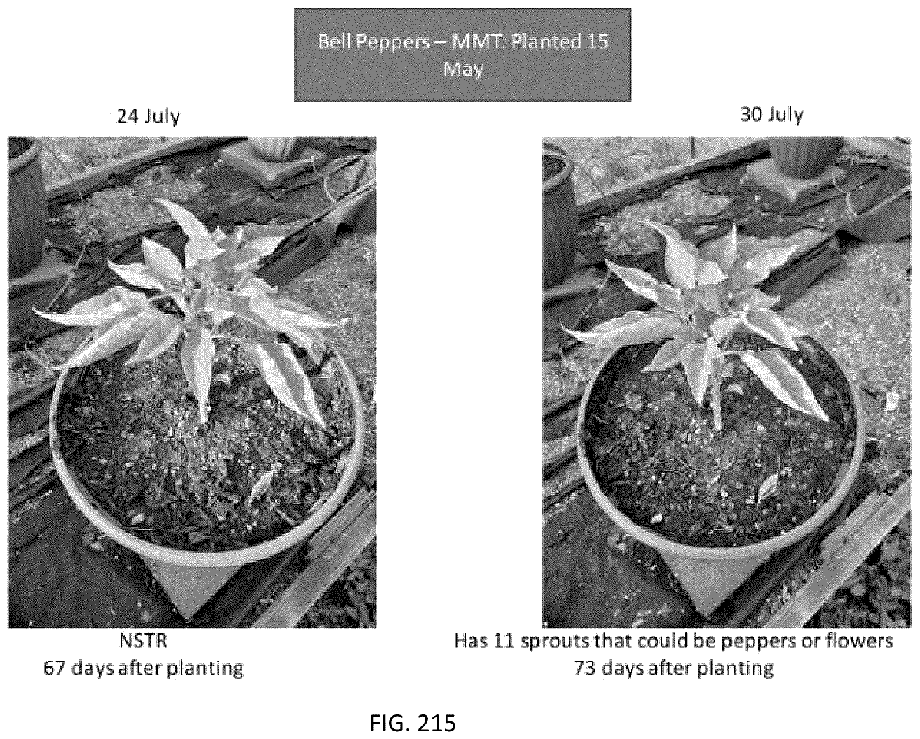

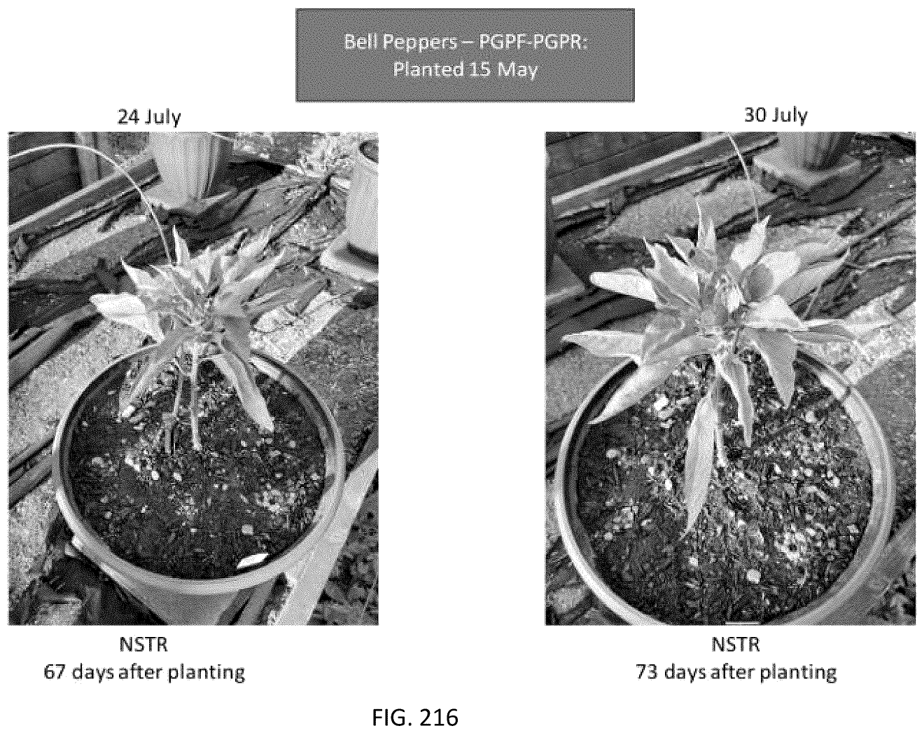

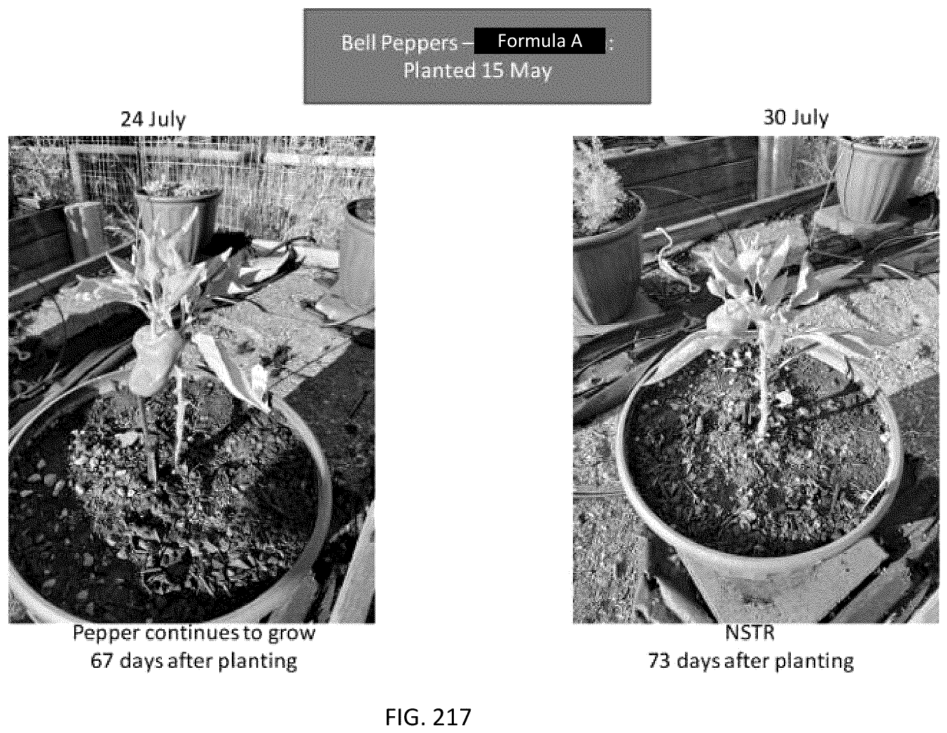

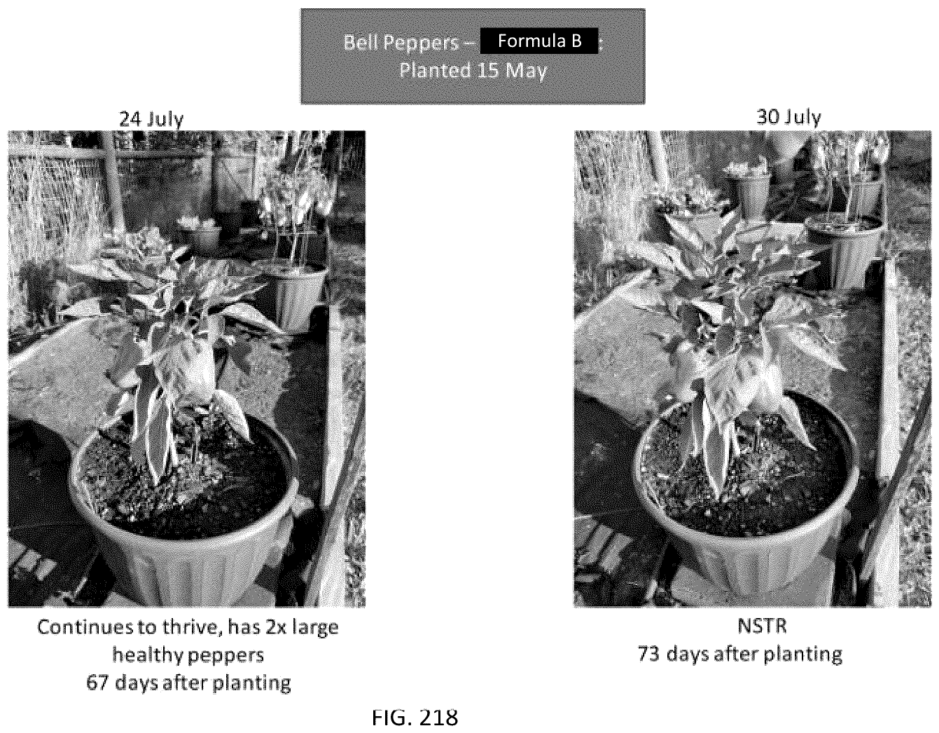

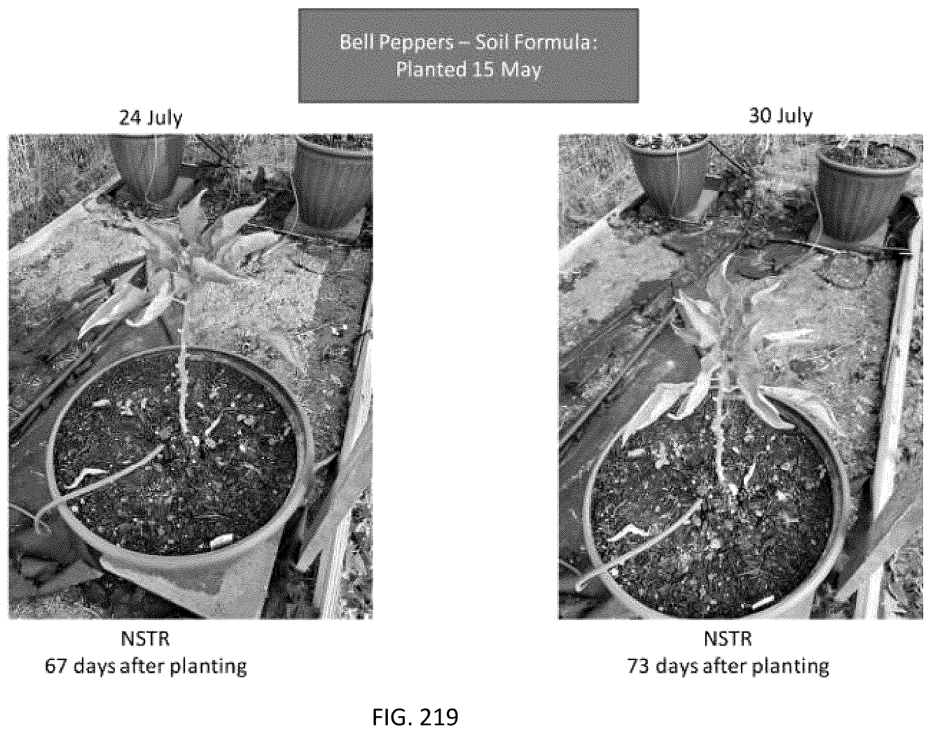

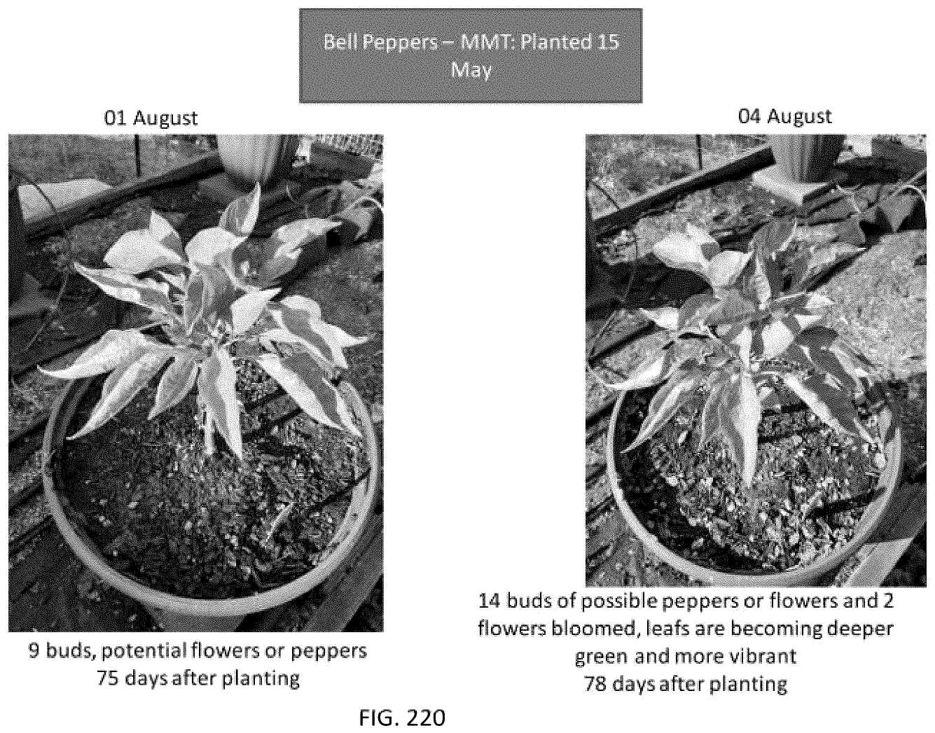

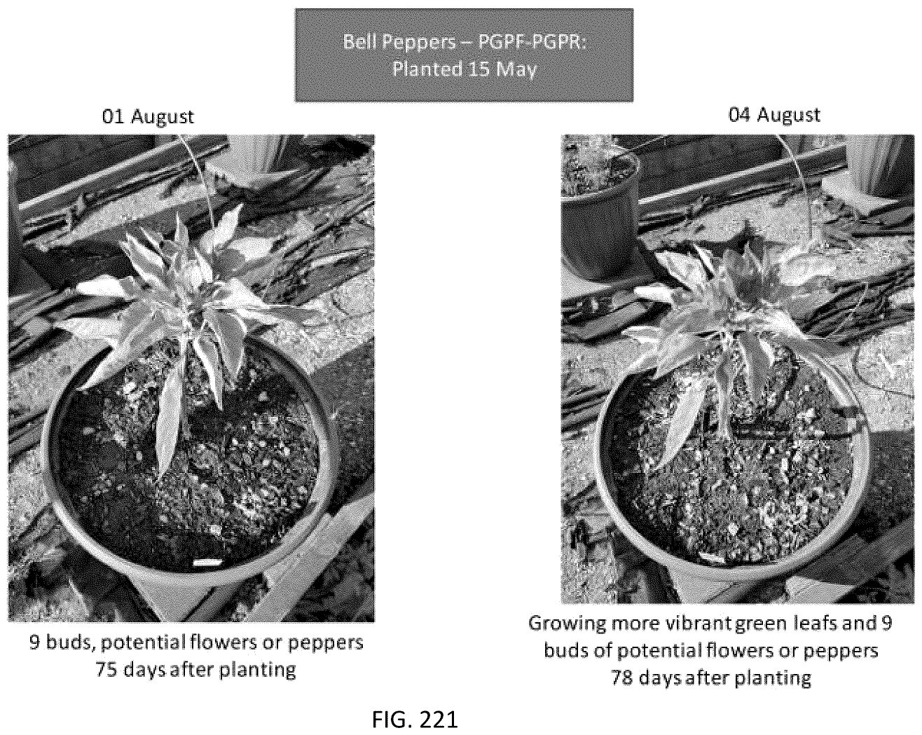

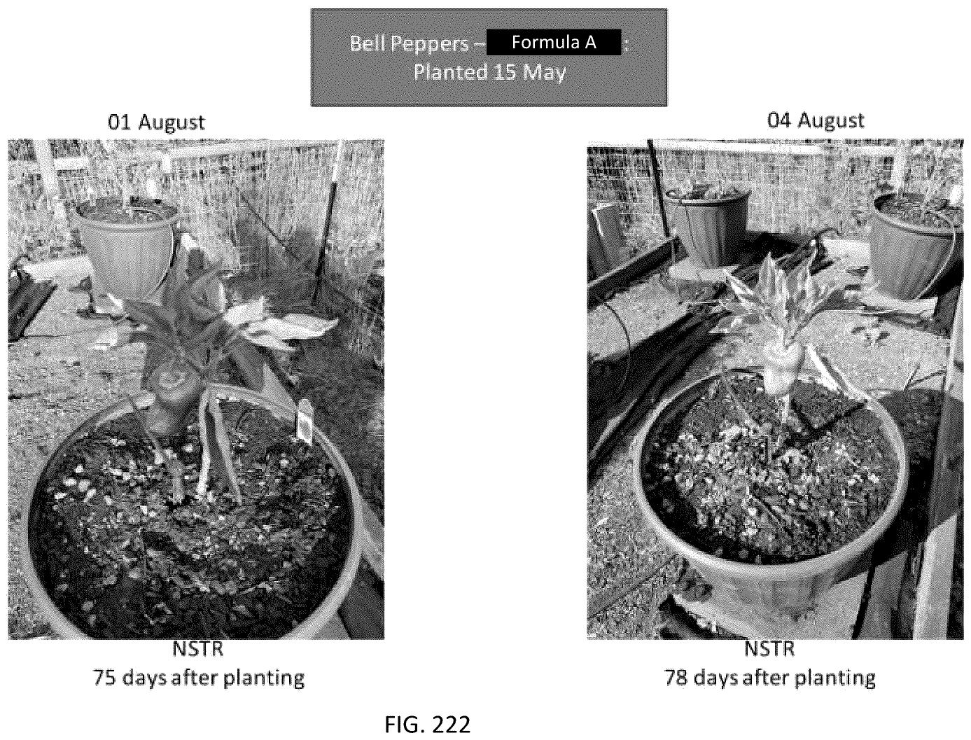

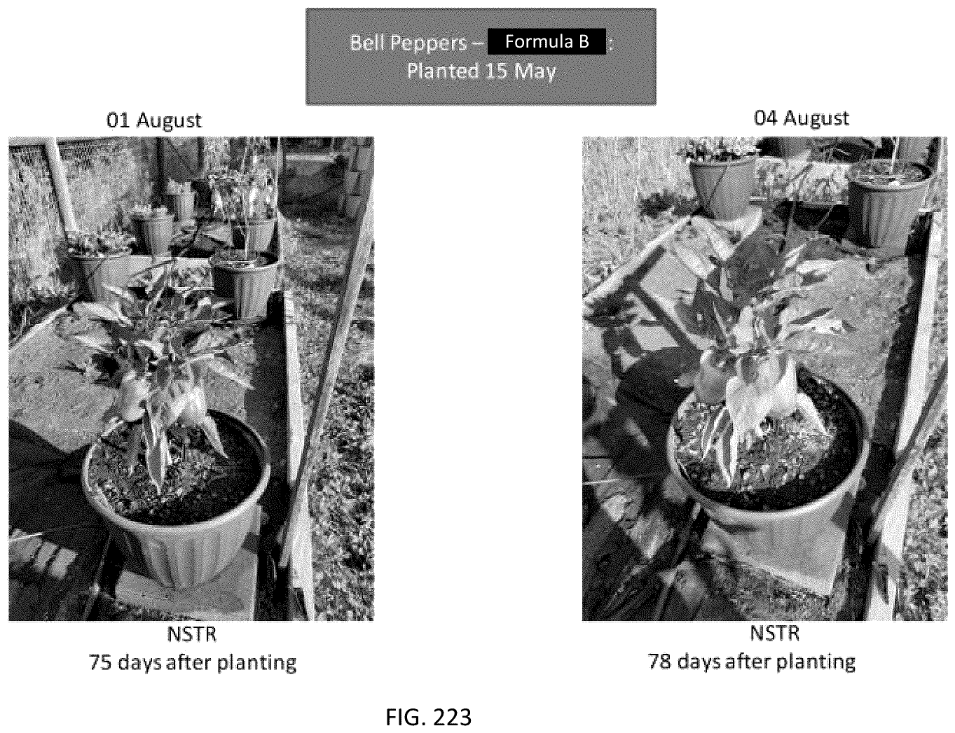

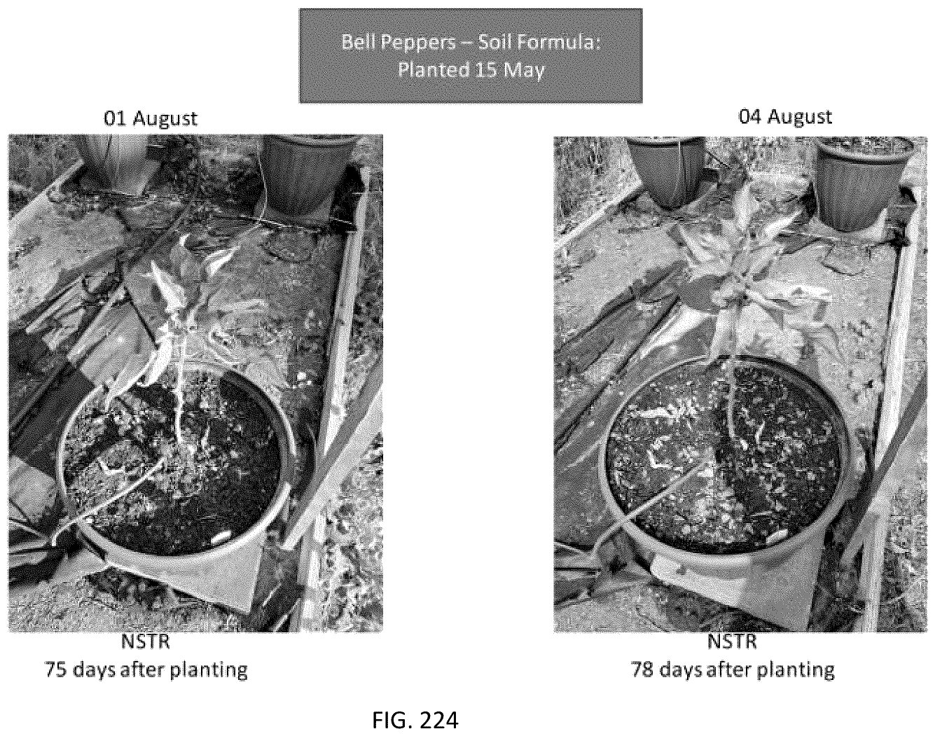

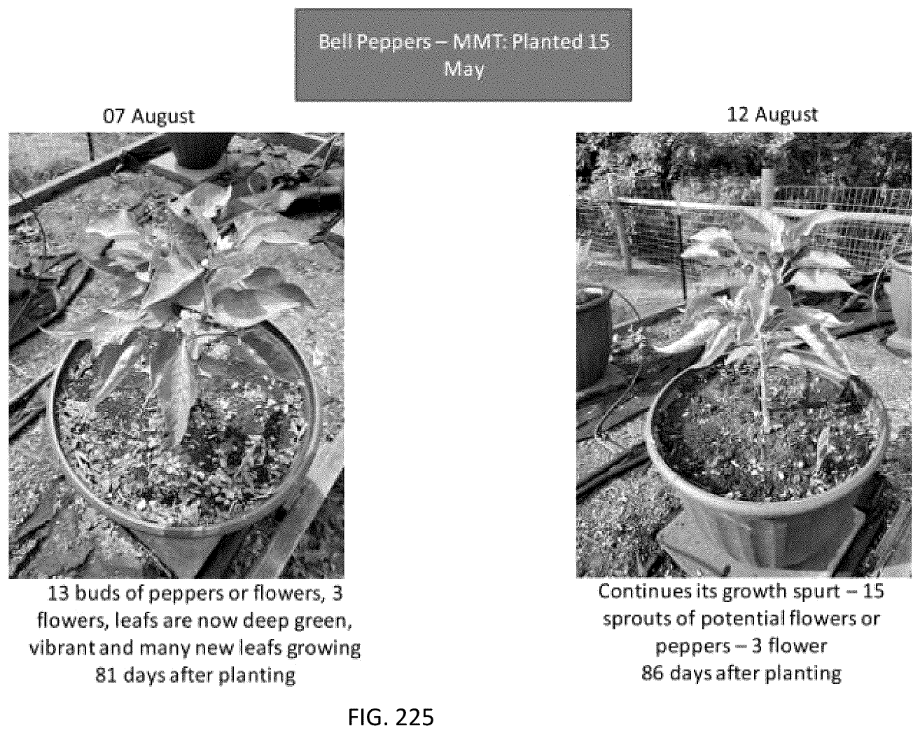

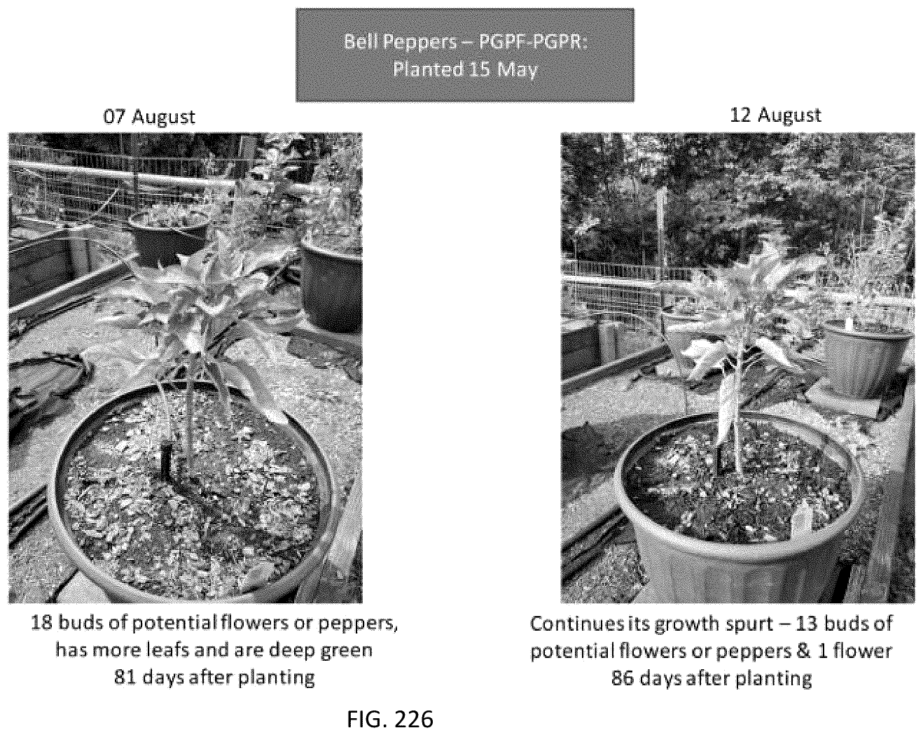

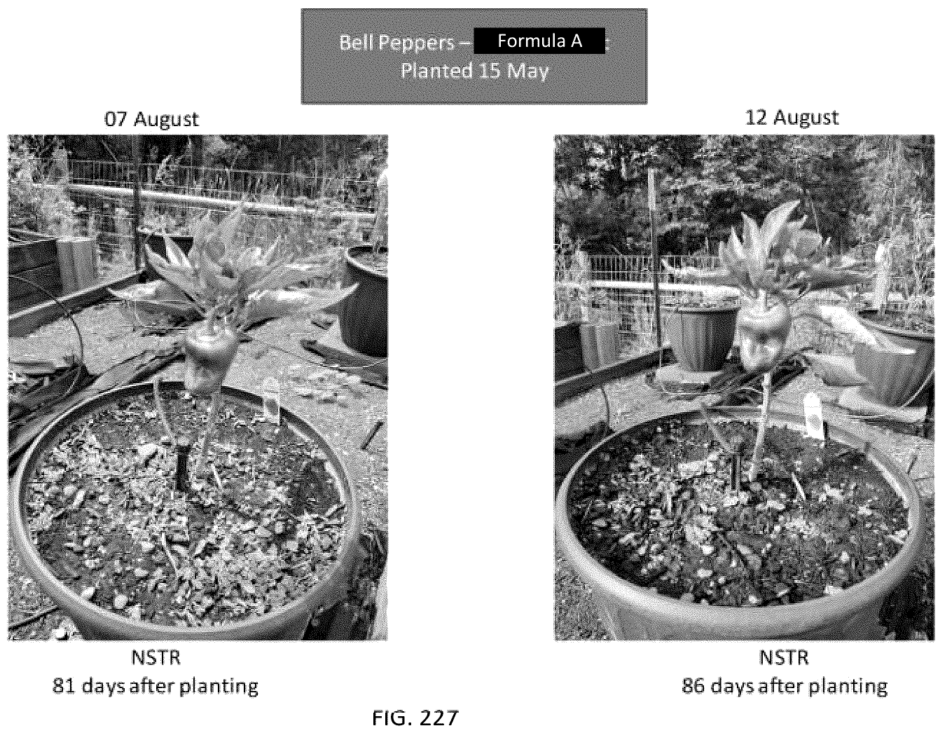

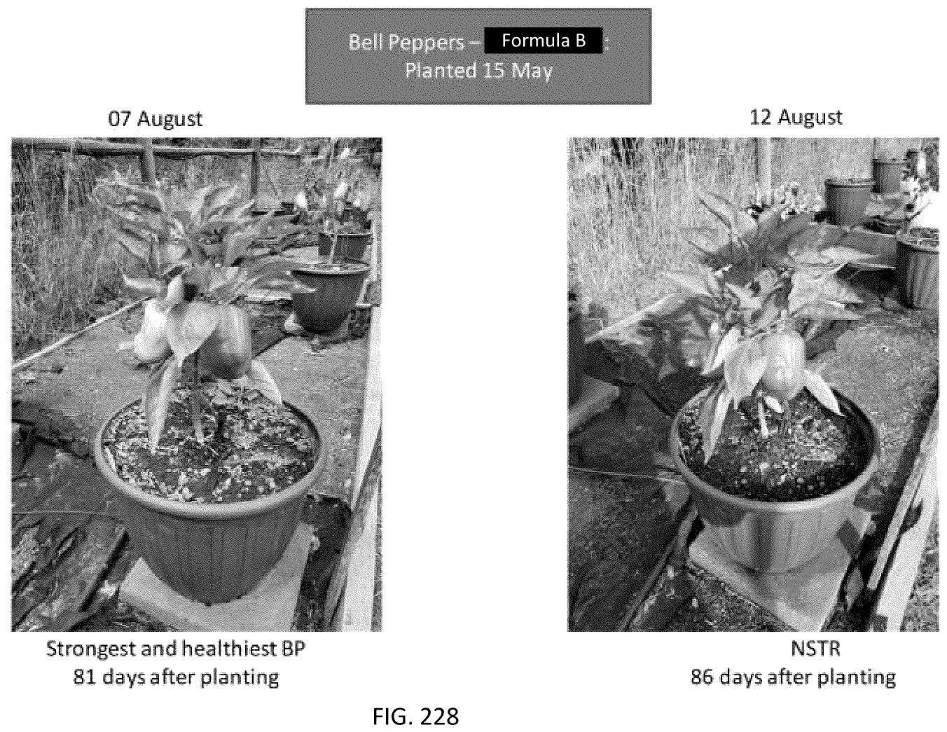

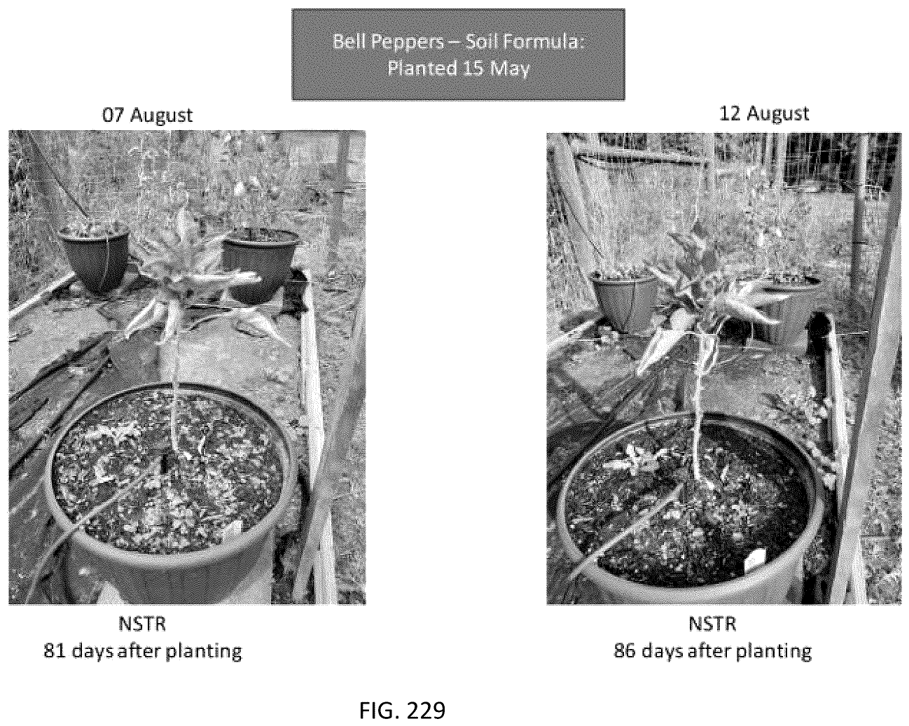

The compositions as prepared in Example 8 were applied to bell pepper starters. All groups were planted on May 15. Bell pepper starters were observed to 9 weeks after planting. Images of the bell peppers are shown in FIGS. 185-229.

Nothing significant was noted in the first 26 days for all test groups.

Between 28-33 days, nothing significant was noted for the MMT and PGPF-PGPR groups.

At 33 days after planting, the Formula A group began to sprout 4 bell peppers, while the Formula B group had 9 bell pepper sprouts and was the healthiest looking of all groups. The Soil group had 2 bell pepper sprouts at that time. The Formula B and Soil groups received about 3 extra hours of sunlight, which may be a factor in the difference in the growth beds.

TABLE 24
Week 4 Bell Pepper Observations

| | June 19, 35 days | June 23, 39 days |
|---|---|---|
| | after planting | after planting |
| MMT | Nothing serious | Nothing serious |
| | to report | to report |
| PGPF-PGPR | Nothing serious | Third strongest of |
| | to report | all groups |
| Formula A | 3 sprouts, the only | Second strongest of all |
| | group with sprouts | groups, has flower |
| Formula B | 10 sprouts | Strongest of all groups, |
| | | has 9 buds and 1 flower |
| Soil | 2 sprouts | Third strongest with 1 |
| | | flower and 1 bud |

During weeks 3 and 4, the Formula A group had the healthiest-looking fruits out of the three groups that received less sunlight. Growth was stunted during week 4 due to a cold snap where temperatures dropped to 43° F. at night for 4 consecutive days starting June 18. Minimal sunlight was observed during this time with wet and rainy conditions. The temperature ranged between 46° F. and 51° F.

TABLE 25
Week 5 Bell Pepper Observations

| | July 3, 45 days | July 7, 49 days |
|---|---|---|
| | after planting | after planting |
| MMT | Nothing serious | Nothing serious |
| | to report | to report |
| PGPF-PGPR | Nothing serious | Nothing serious |
| | to report | to report |
| Formula A | 3 sprouts and was the only | 1 pepper growing double in |
| | group with sprouts | size in the last 5 days, and was |
| | | the first pepper of all test |
| | | groups |
| Formula B | Had the healthiest leaves, 5 | Healthiest, strongest, and |
| | flowers, previous sprouts | greenest group, 2 peppers |
| | turned out to be flowers | |
| Soil | Nothing serious | 1 small pepper sprout |
| | to report | |

Growth had picked up from the previous wet and cloudy weather that stunted growth. Formula B had the largest and healthiest vegetables, while the second strongest groups were PGPF-PGPR and Formula A groups. Formula A group had the first bell pepper sprout on July 3, and then on July 7 the Formula B group showed 2 pepper sprouts.

TABLE 26
Week 6 Bell Pepper Observations

| | July 16, 58 days | July 22, 65 days |
|---|---|---|
| | after planting | after planting |
| MMT | Nothing serious | Nothing serious |
| | to report | to report |
| PGPF-PGPR | Nothing serious | Nothing serious |
| | to report | to report |
| Formula A | 1 pepper | 1 pepper |
| Formula B | Healthiest with 2 | Had 2 large deep green |
| | peppers and | peppers and healthy |
| | 2 flowers | green leaves |
| Soil | Nothing serious | 1 small pepper |
| | to report | sprout |

The Formula B plants were noticeably most abundant, healthy, and vibrant out of all groups tested, followed by the Formula A plants.

TABLE 27
Week 7 Bell Pepper Observations

| | July 24, 67 days | July 30, 73 days |
|---|---|---|
| | after planting | after planting |
| MMT | Nothing serious | 11 sprouts that could be |
| | to report | peppers or flowers |
| PGPF-PGPR | Nothing serious | Nothing serious |
| | to report | to report |
| Formula A | Pepper continues | Nothing serious |
| | to grow | to report |
| Formula B | Continued to thrive, had | Nothing serious |
| | 2 large healthy peppers | to report |
| Soil | Nothing serious | Nothing serious |
| | to report | to report |

The Formula B plants were noticeably most abundant, healthy, and vibrant out of all groups tested, followed by the Formula A plants.

TABLE 28
Week 8 Bell Pepper Observations

| | August 1, 75 days | August 4, 78 days |
|---|---|---|
| | after planting | after planting |
| MMT | 9 buds, potential | 14 buds that were potentially |
| | flowers or | peppers or flowers, 2 flowers |
| | peppers | bloomed, leaves were |
| | | becoming deeper green and |
| | | more vibrant |
| PGPF-PGPR | 9 buds, potential | Was growing more vibrant |
| | flowers or | green leaves, 9 buds |
| | peppers | potentially flowers |
| | | or peppers |
| Formula A | Nothing serious | Nothing serious |
| | to report | to report |
| Formula B | Nothing serious | Nothing serious |
| | to report | to report |
| Soil | Nothing serious | Nothing serious |
| | to report | to report |

The Formula B plants were noticeably most abundant, healthy, and vibrant out of all groups tested, followed by the Formula A plants.

TABLE 29
Week 9 Bell Pepper Observations

| | August 7, 81 days | August 12, 86 days |
|---|---|---|
| | after planting | after planting |
| MMT | 13 buds of peppers or | Continued its growth |
| | flowers, 3 flowers, | spurt, 15 sprouts of |
| | leaves were deep green, | potential flowers or |
| | vibrant and many new | peppers, 3 flowers |
| | leaves had grown | |
| PGPF-PGPR | 18 buds of potential | Continued its growth |
| | flowers or peppers, | spurt, 13 buds of |
| | more leaves and were | potential flowers or |
| | deep green | peppers, 1 flower |
| Formula A | Nothing serious | Nothing serious |
| | to report | to report |
| Formula B | Strongest and healthiest | Nothing serious |
| | of all groups | to report |
| Soil | Nothing serious | Nothing serious |
| | to report | to report |

The Formula B plants were noticeably most abundant, healthy, and vibrant out of all groups tested, followed by the Formula A plants.

### Example 14: Tomatoes

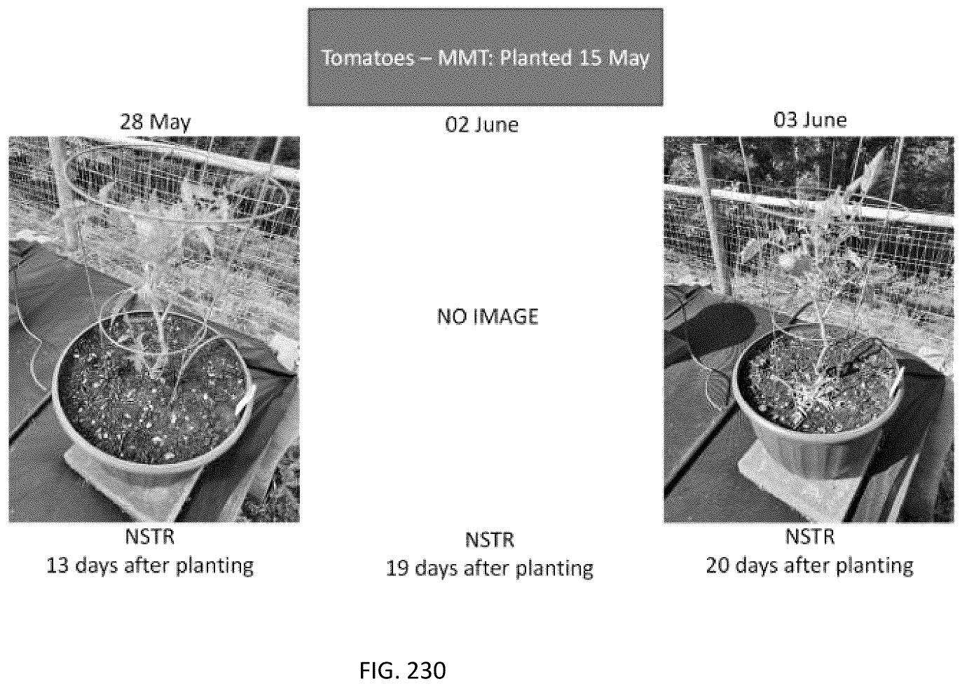

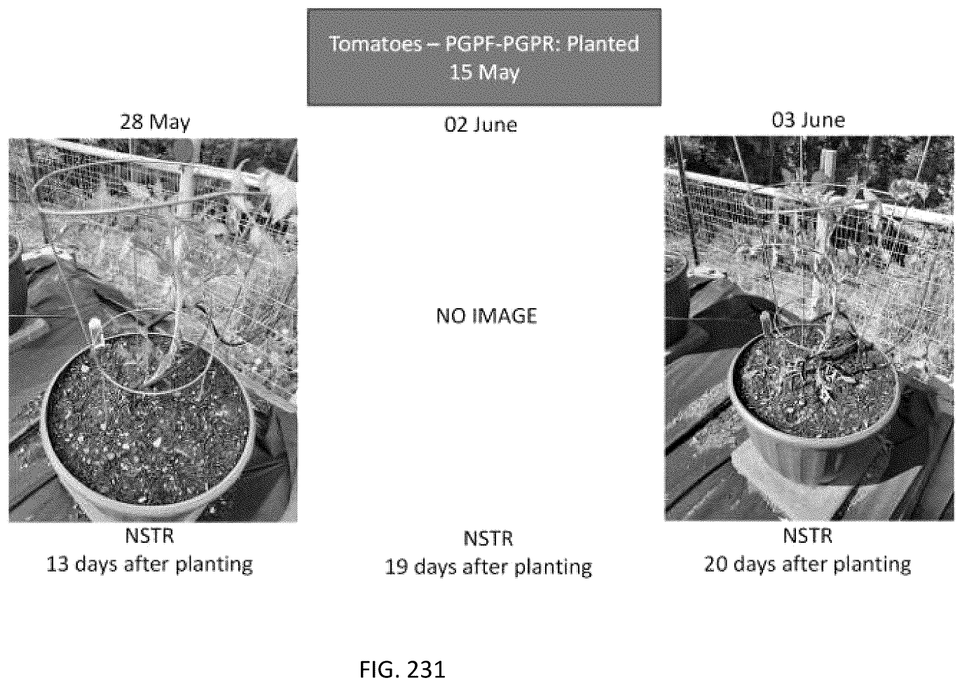

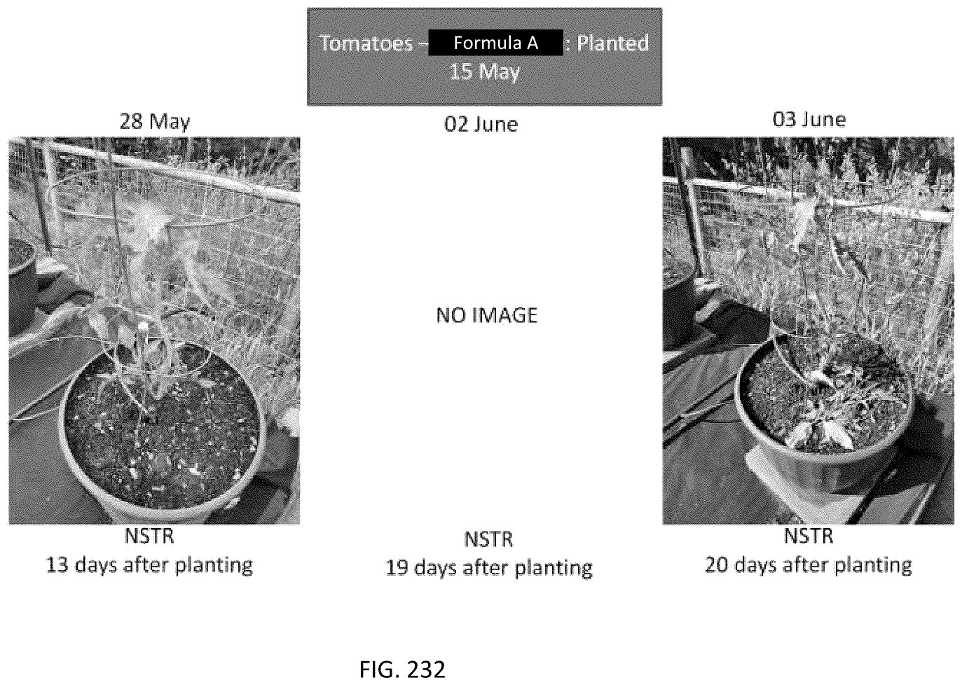

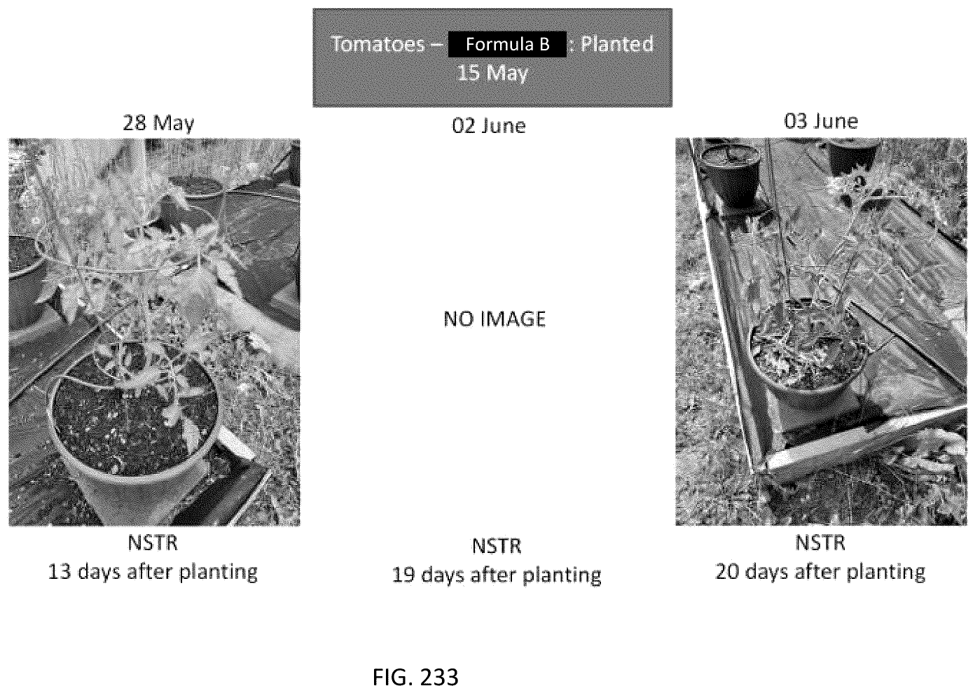

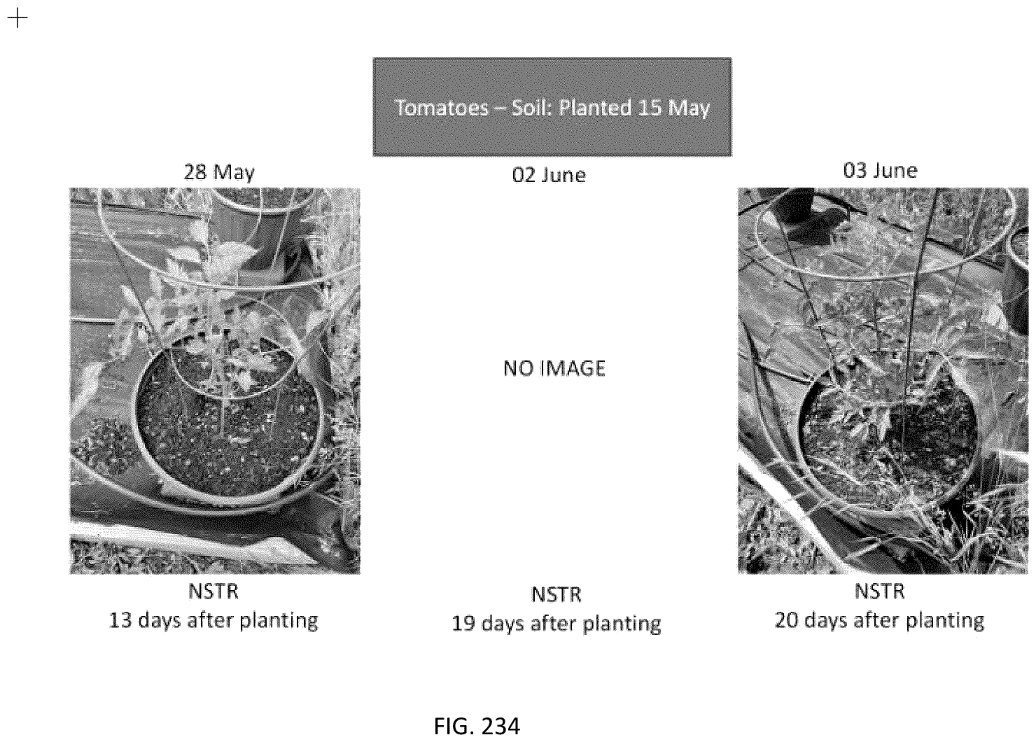

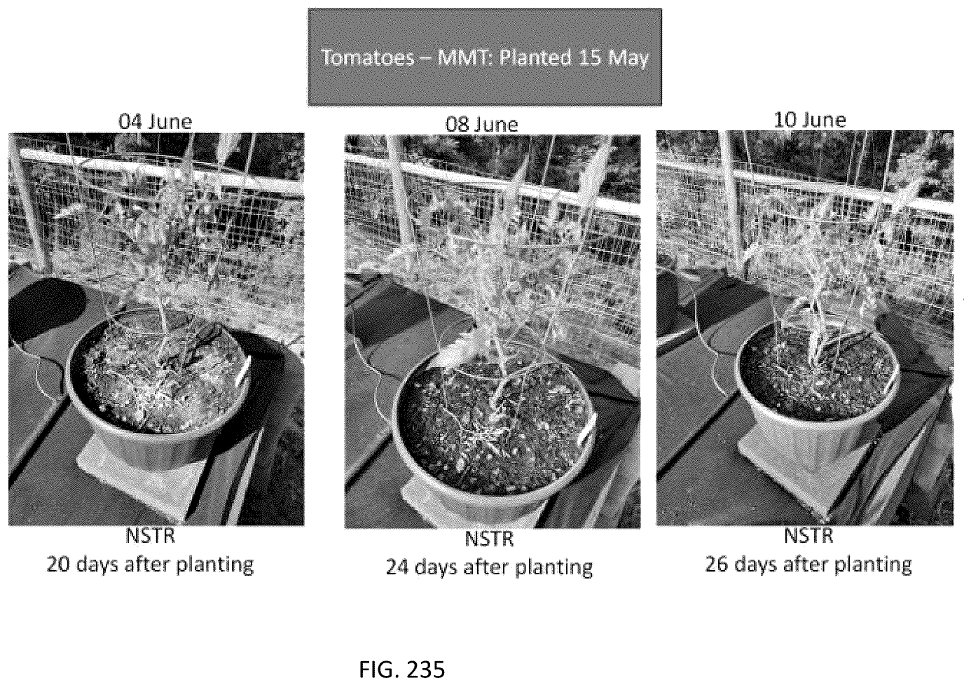

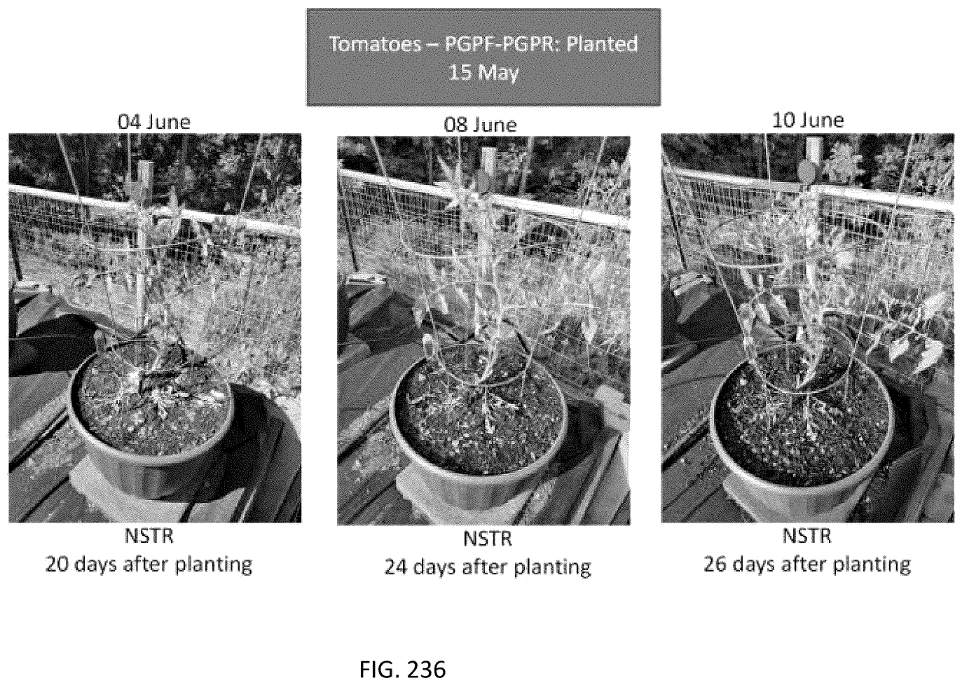

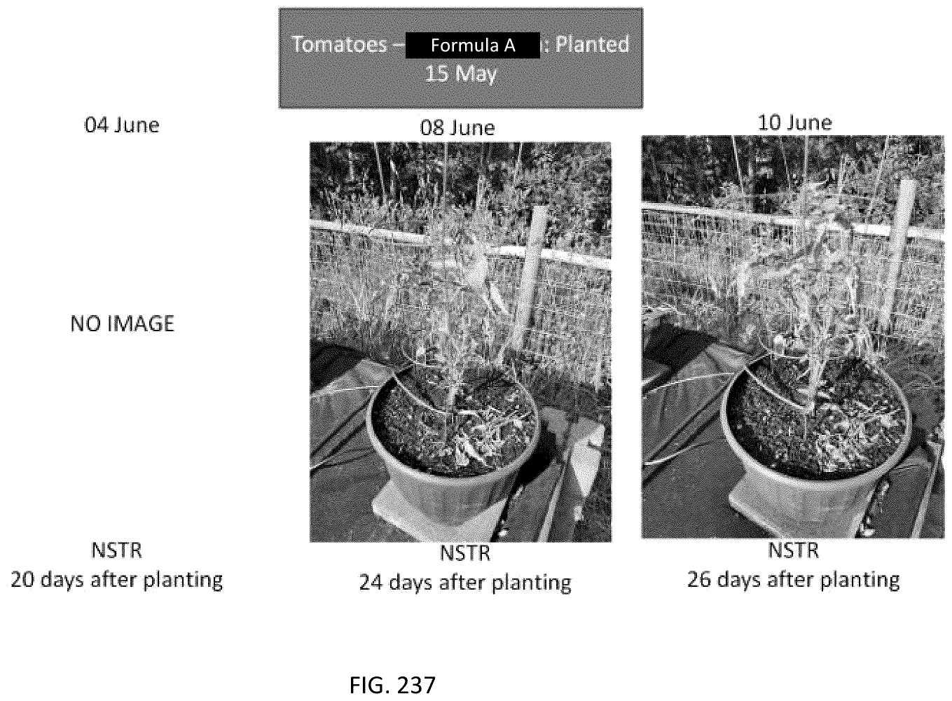

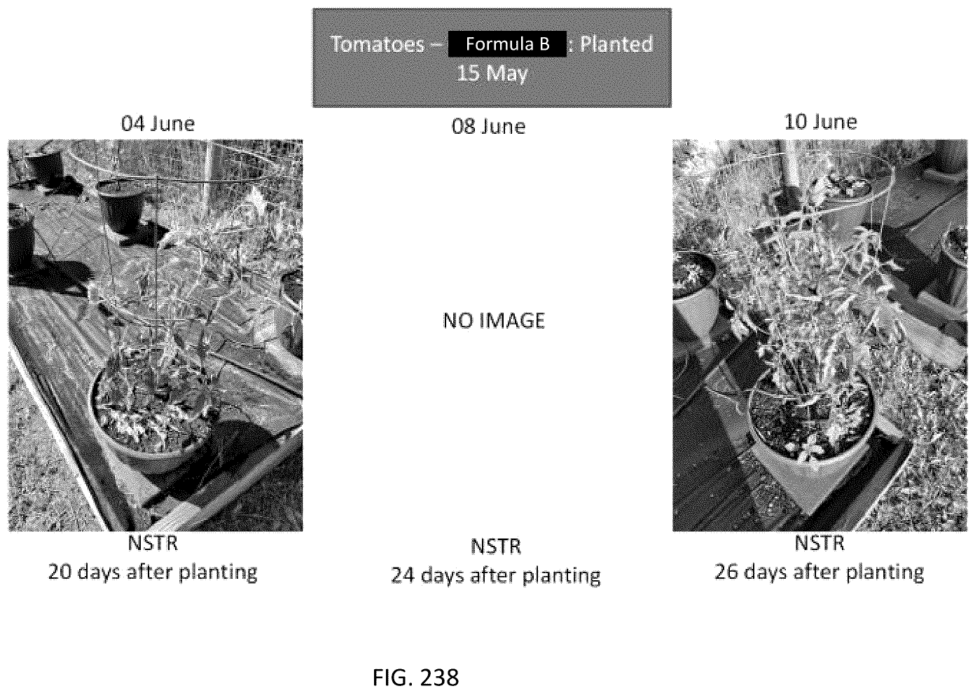

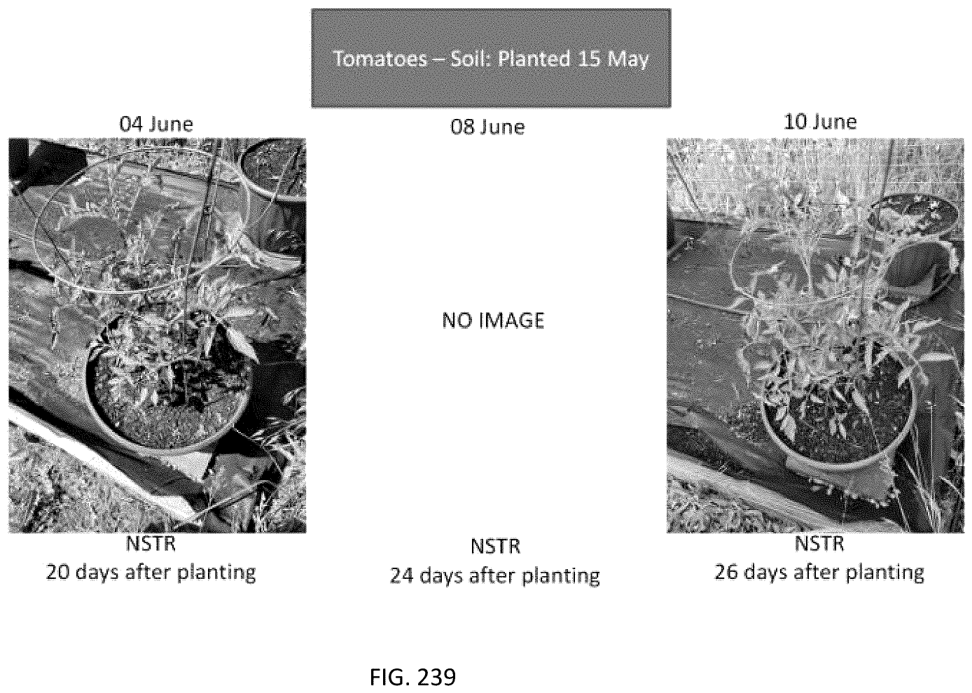

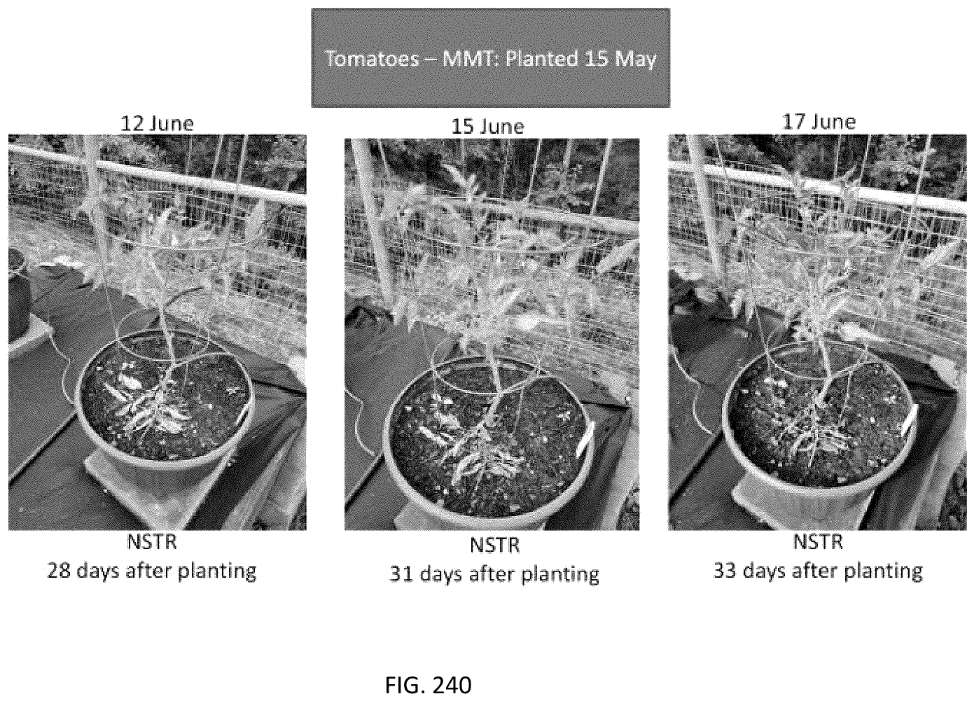

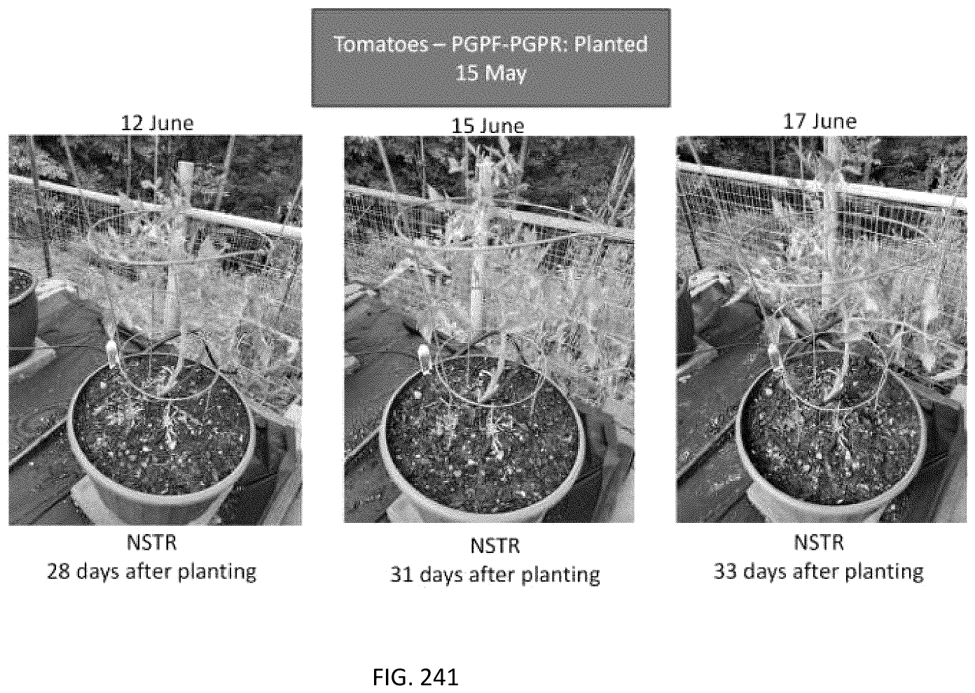

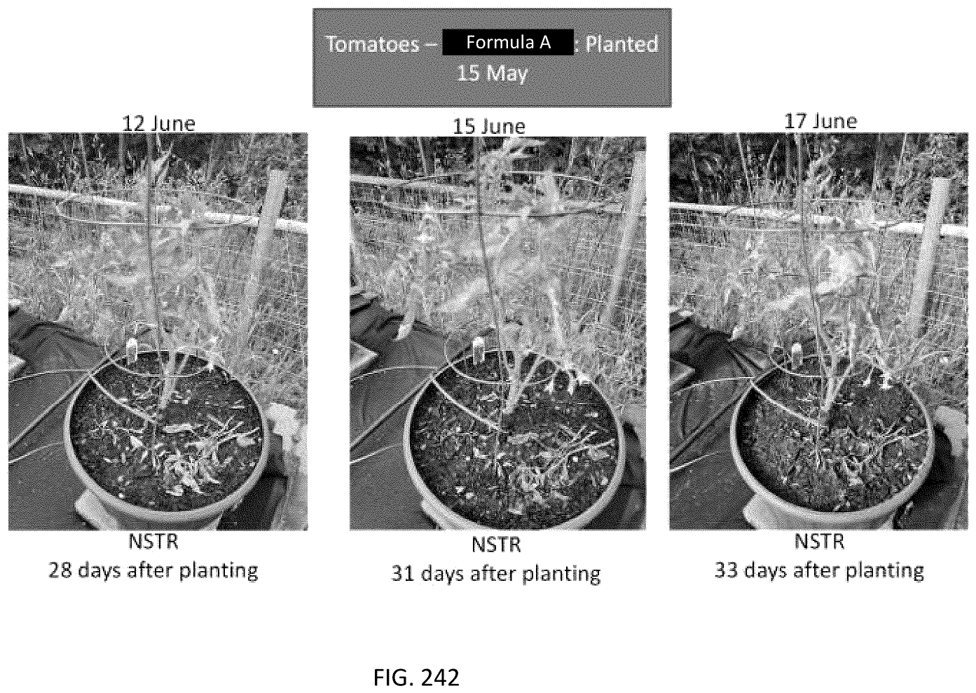

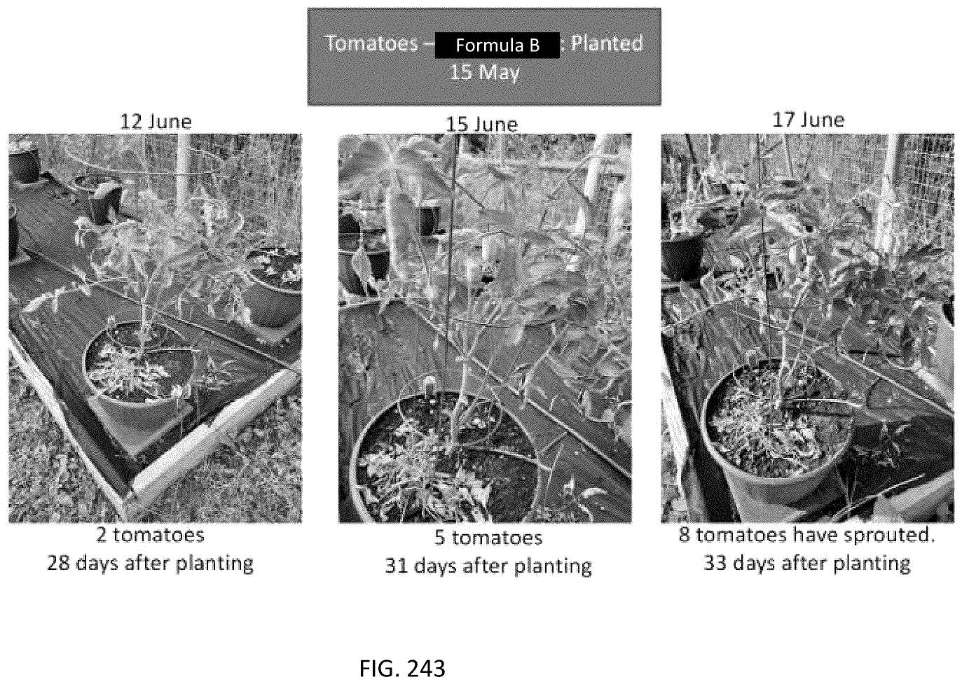

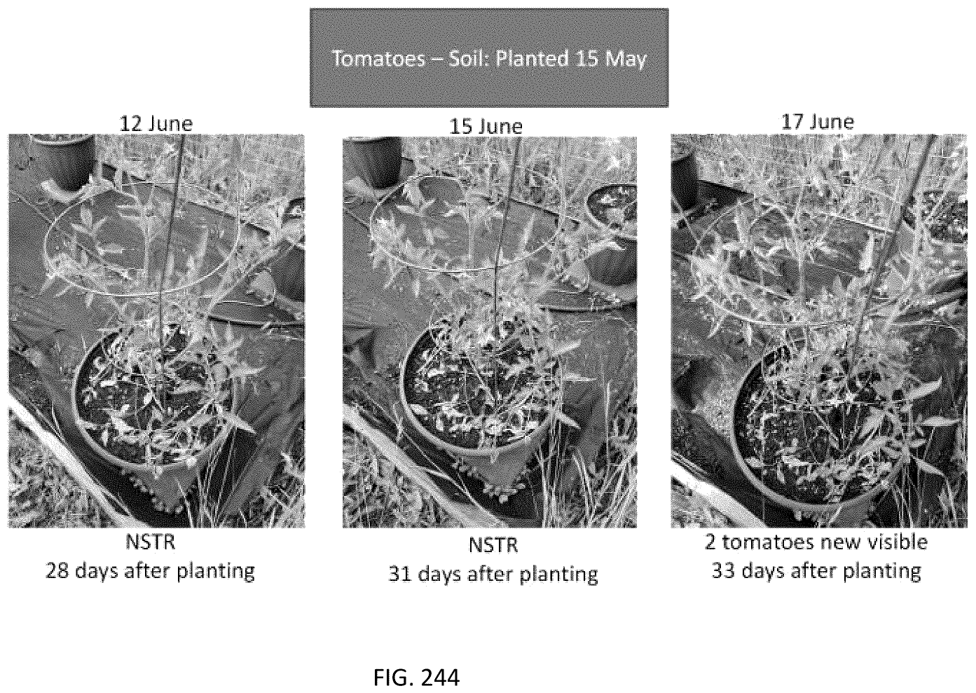

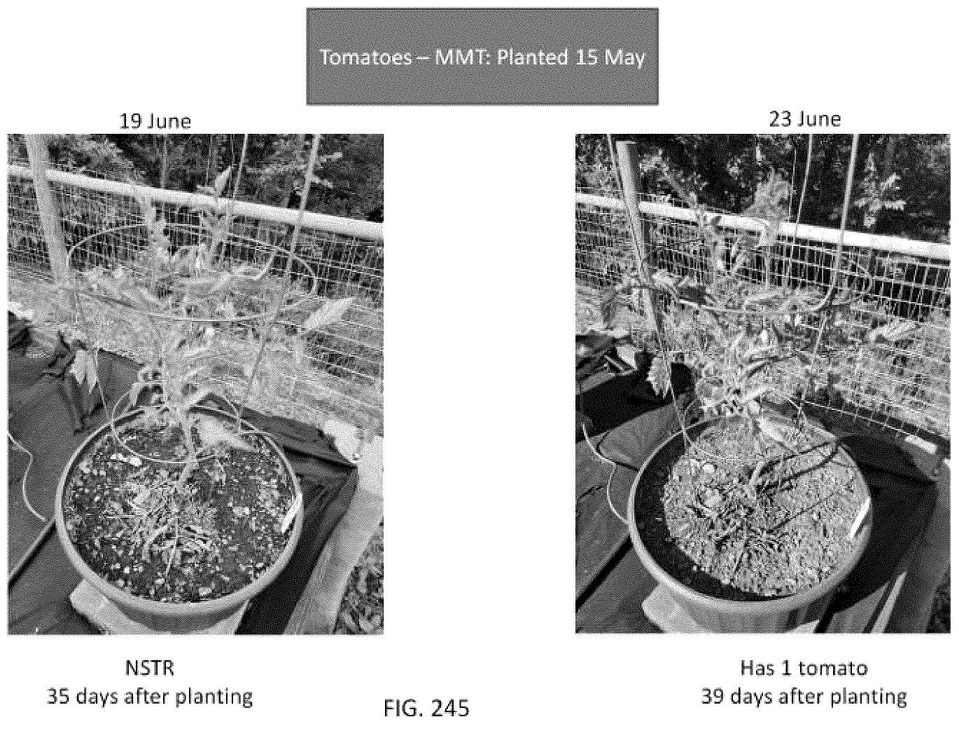

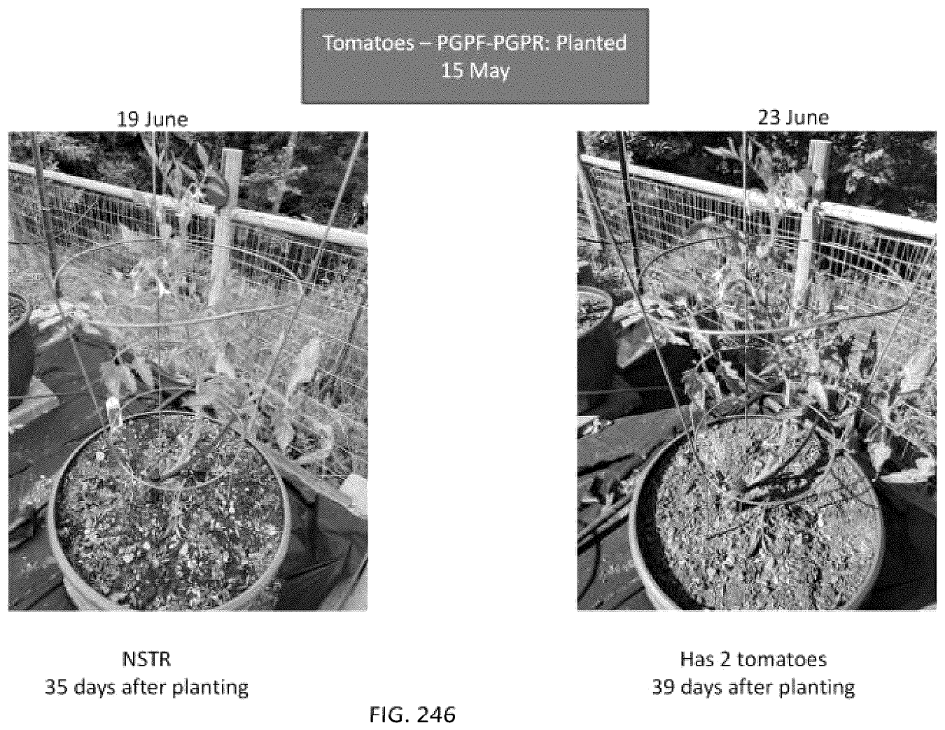

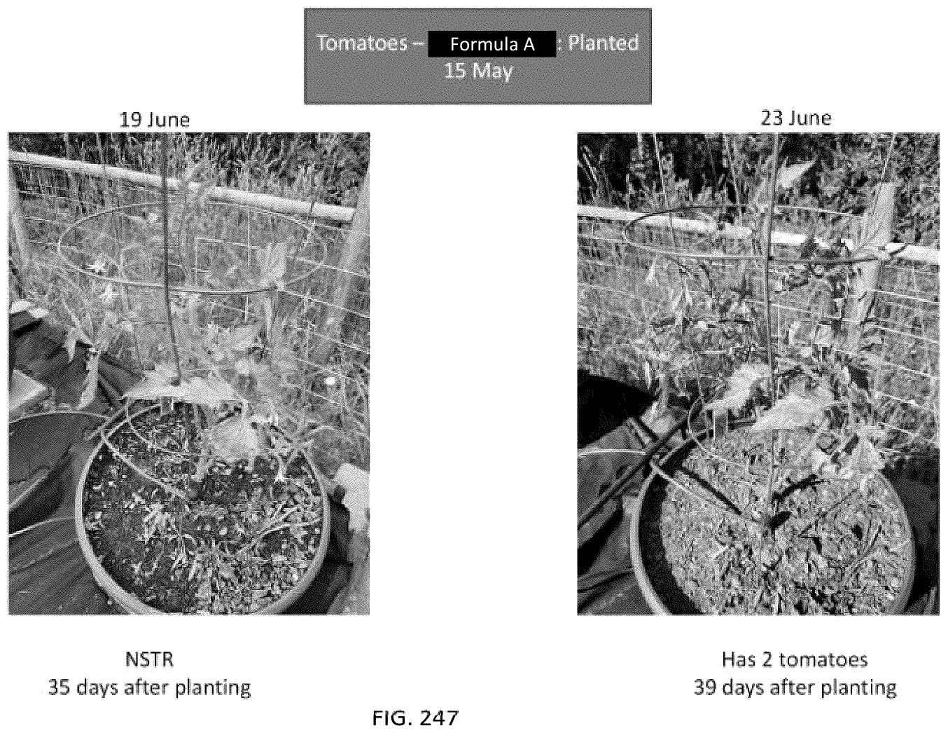

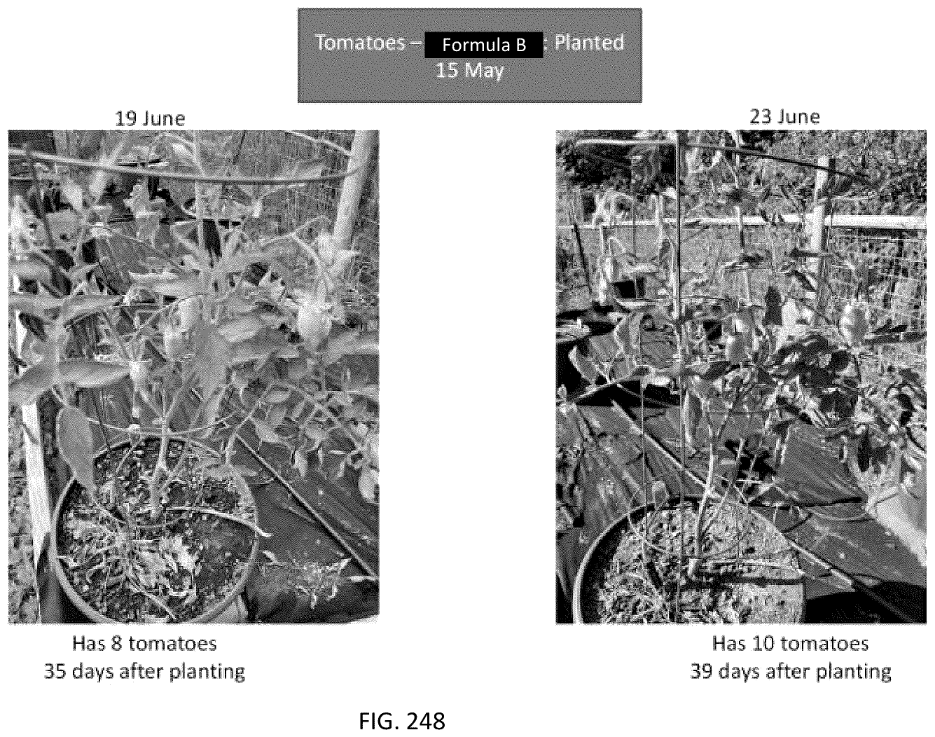

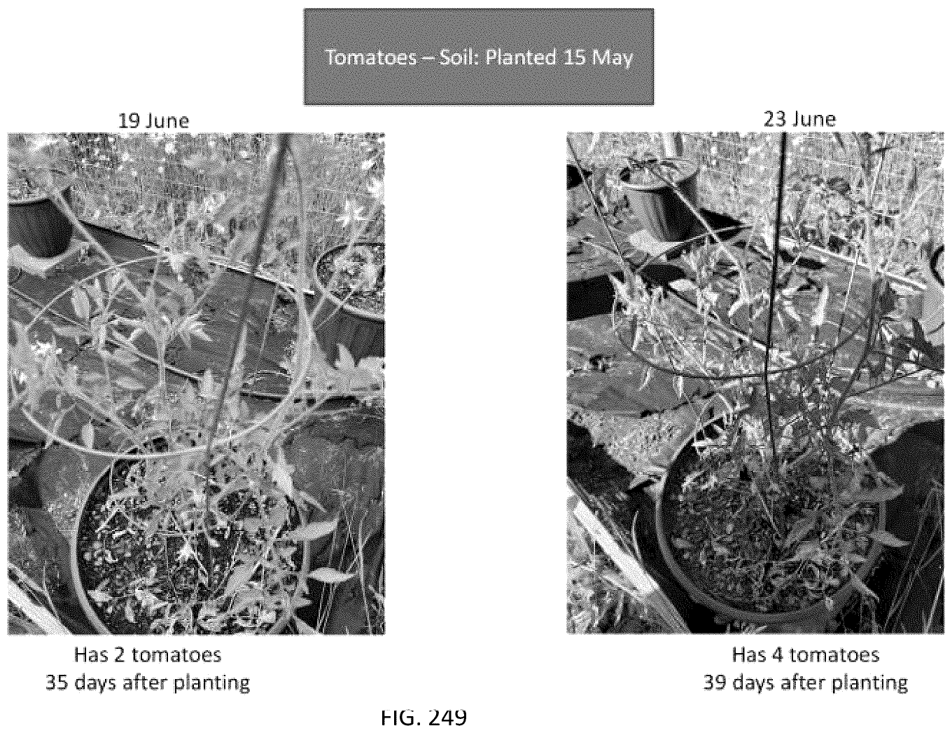

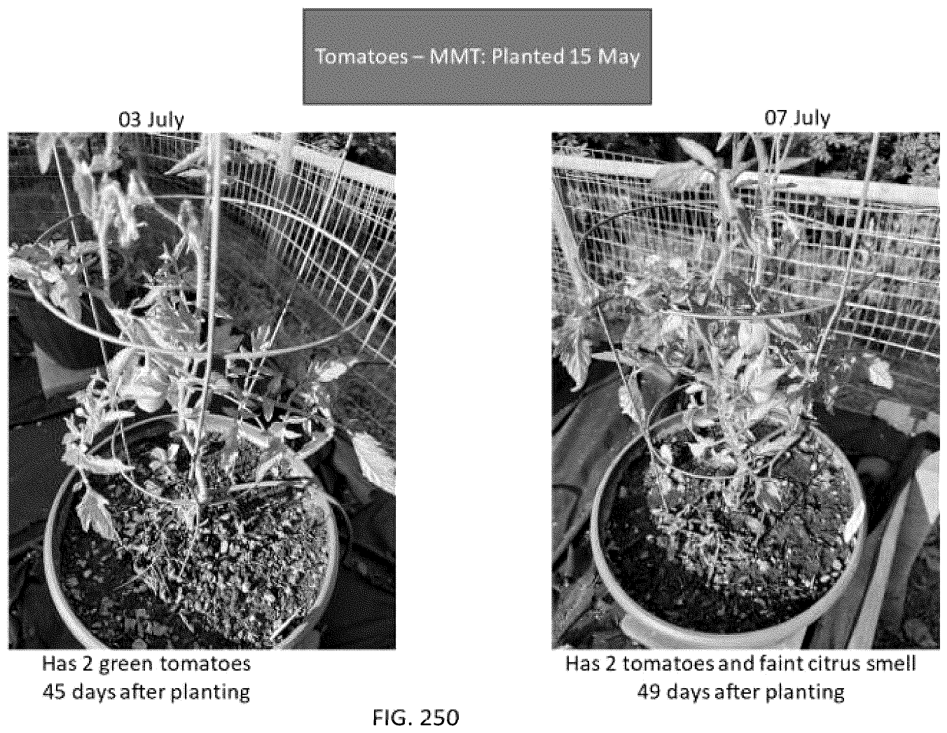

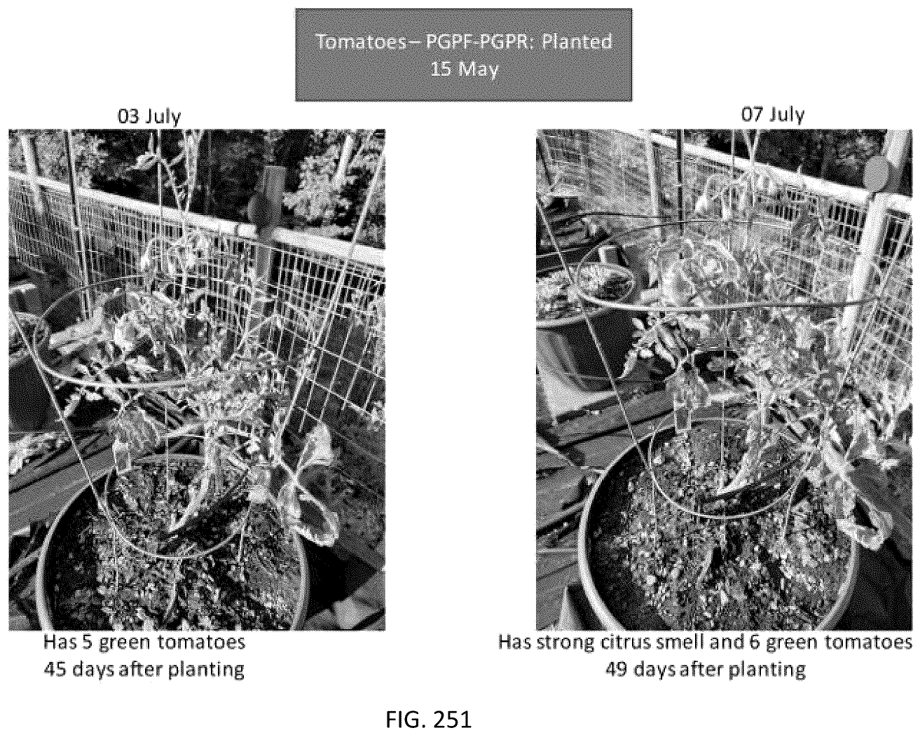

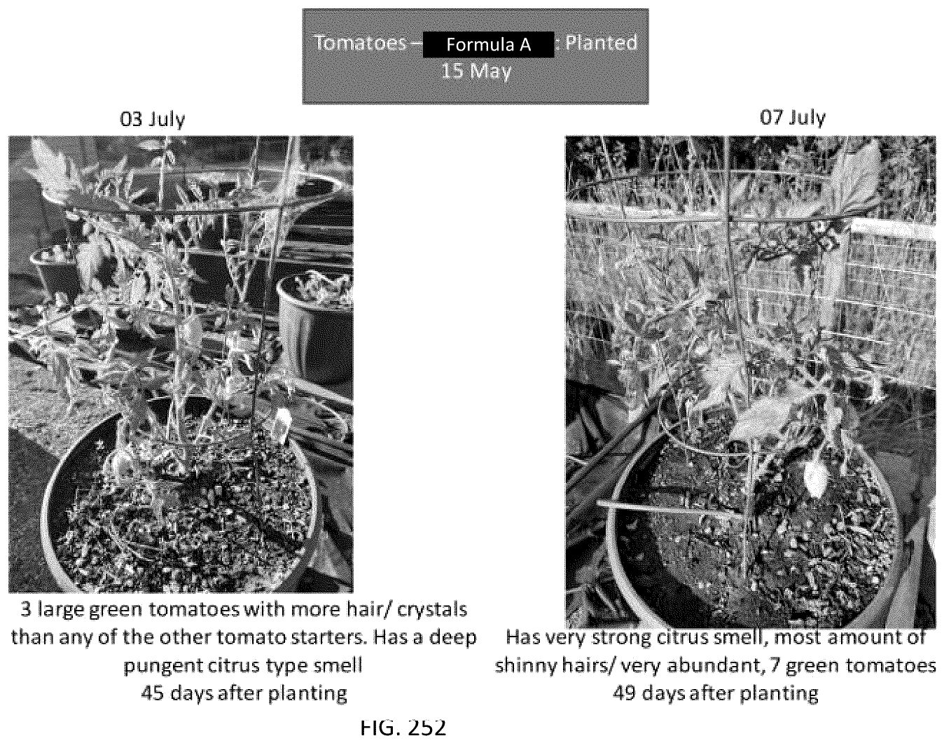

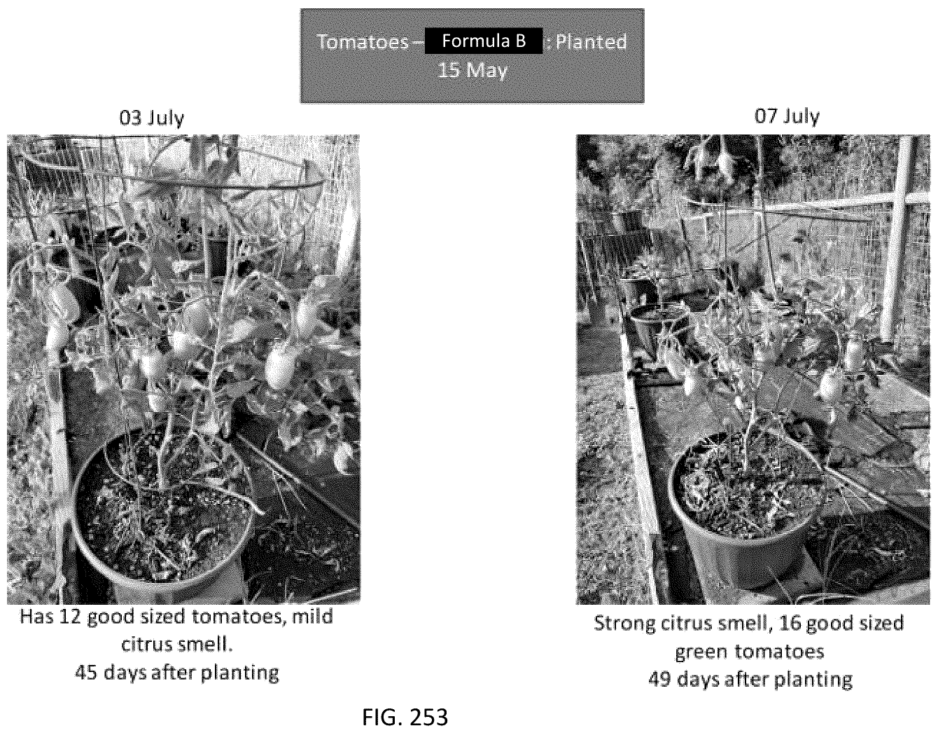

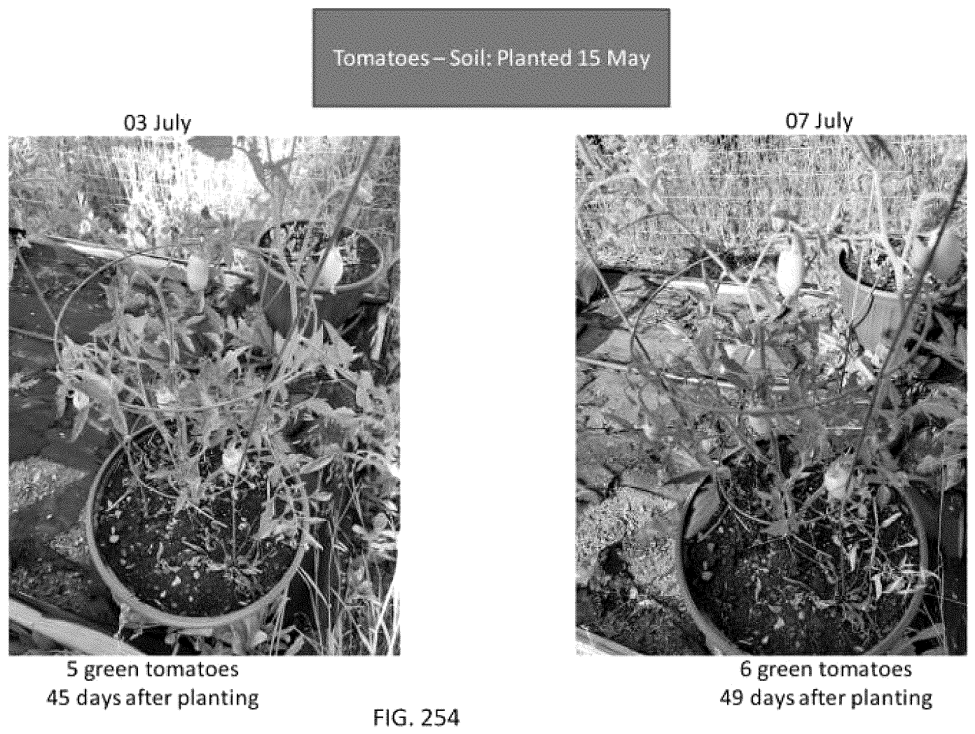

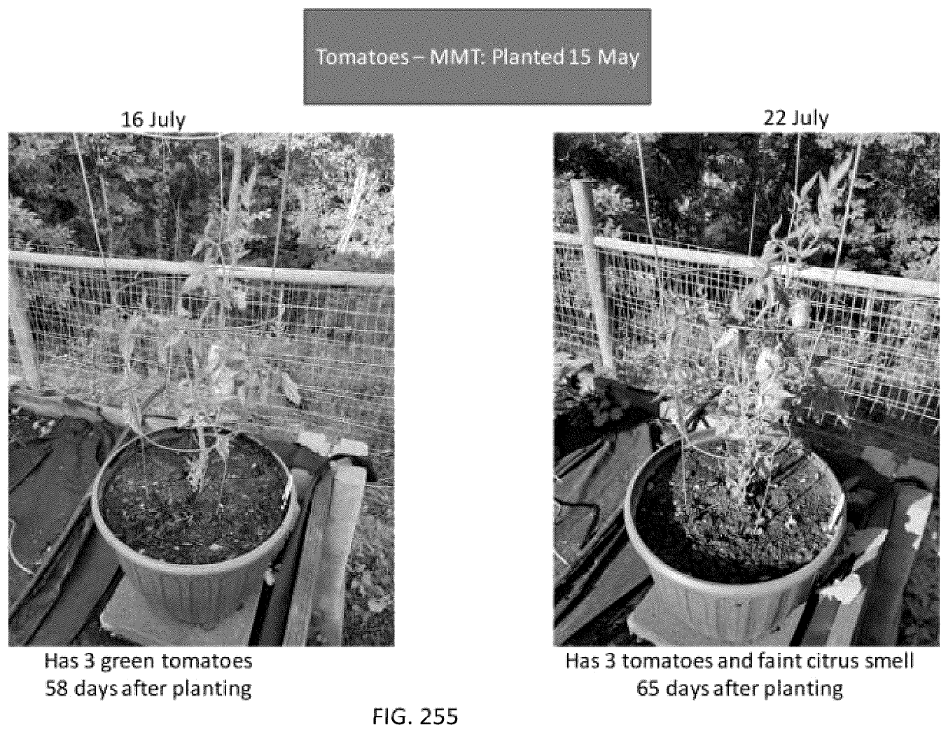

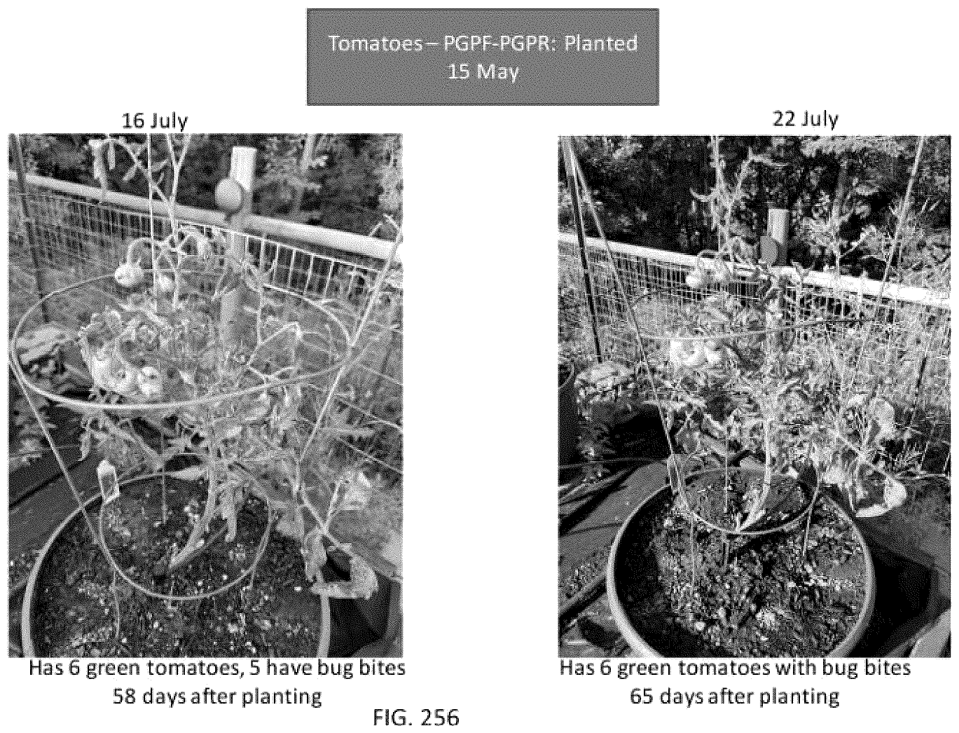

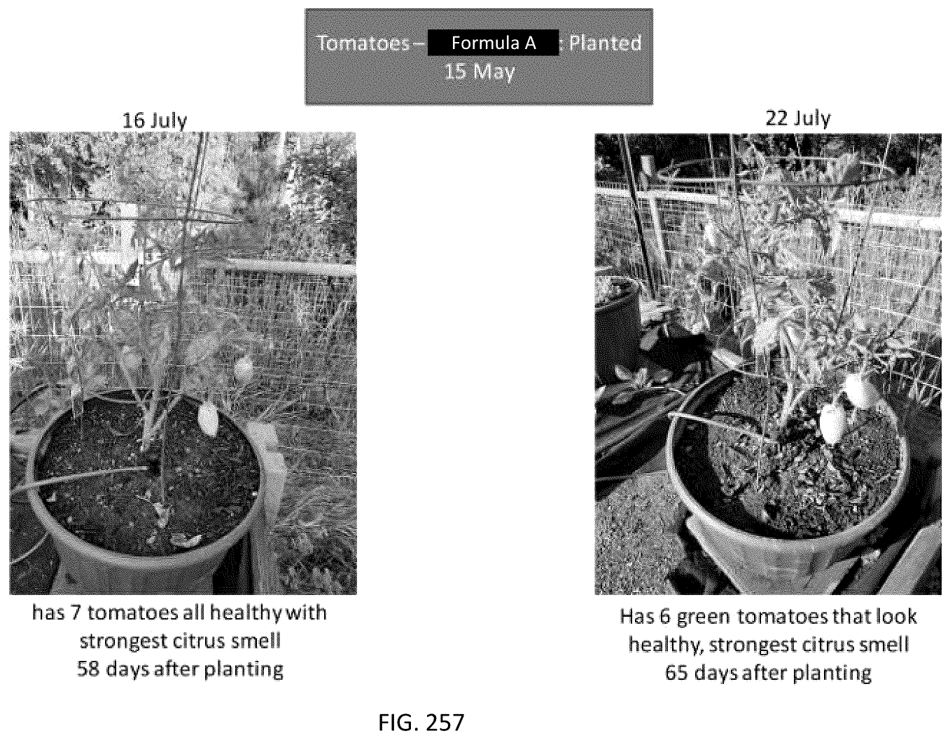

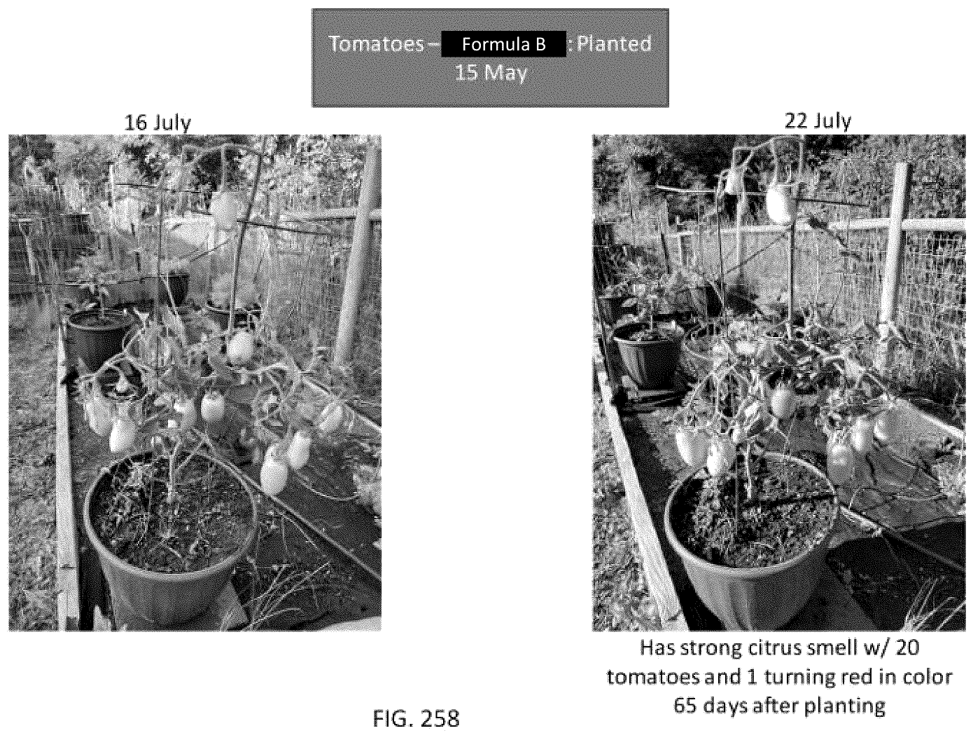

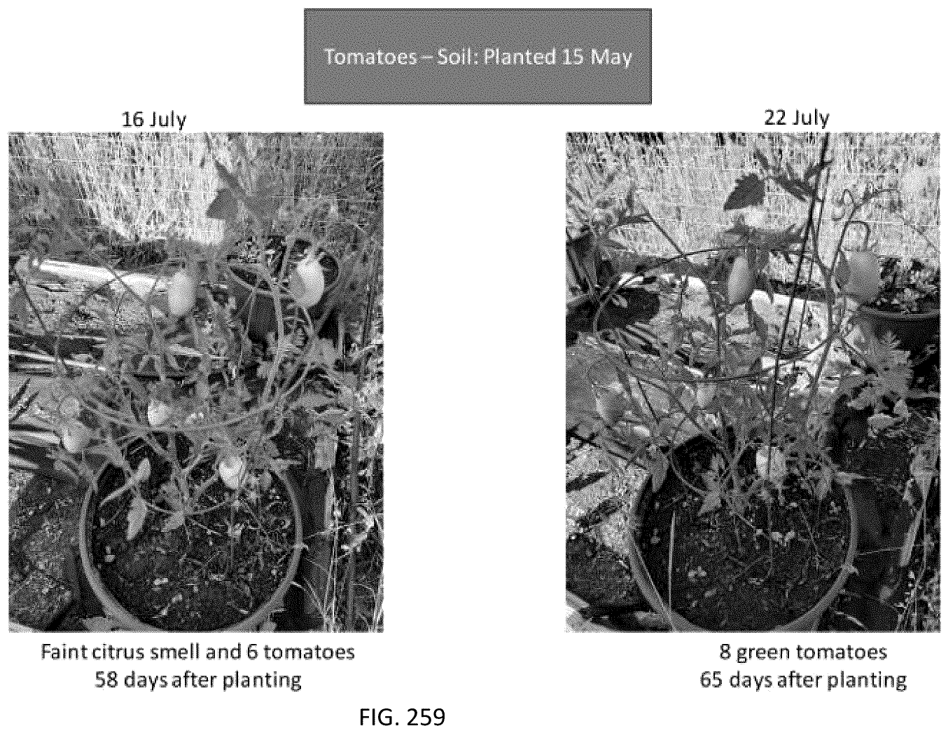

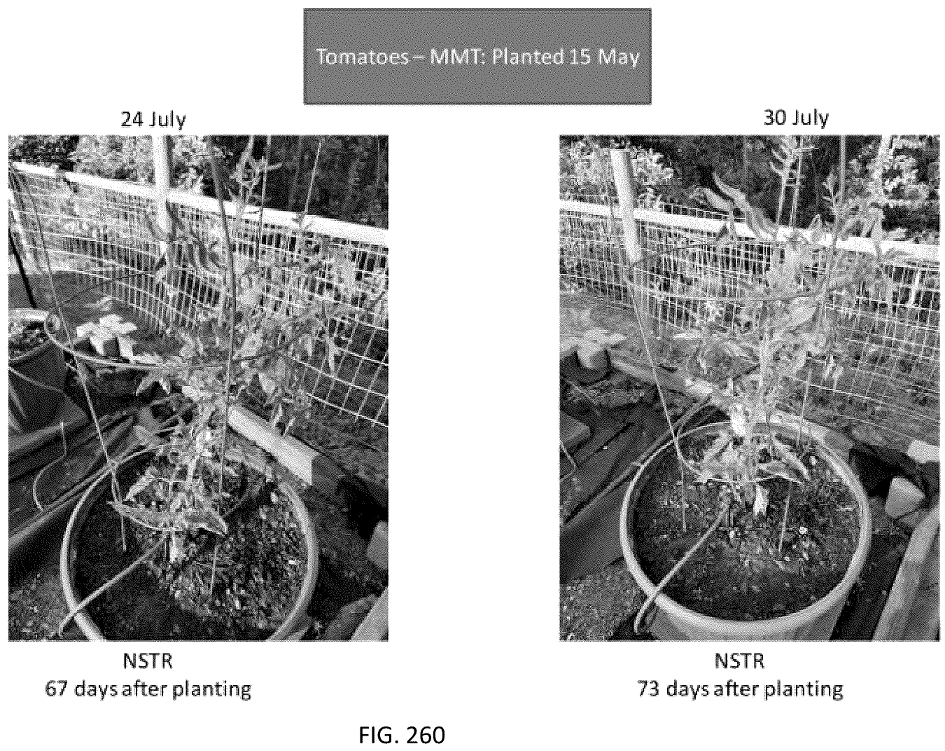

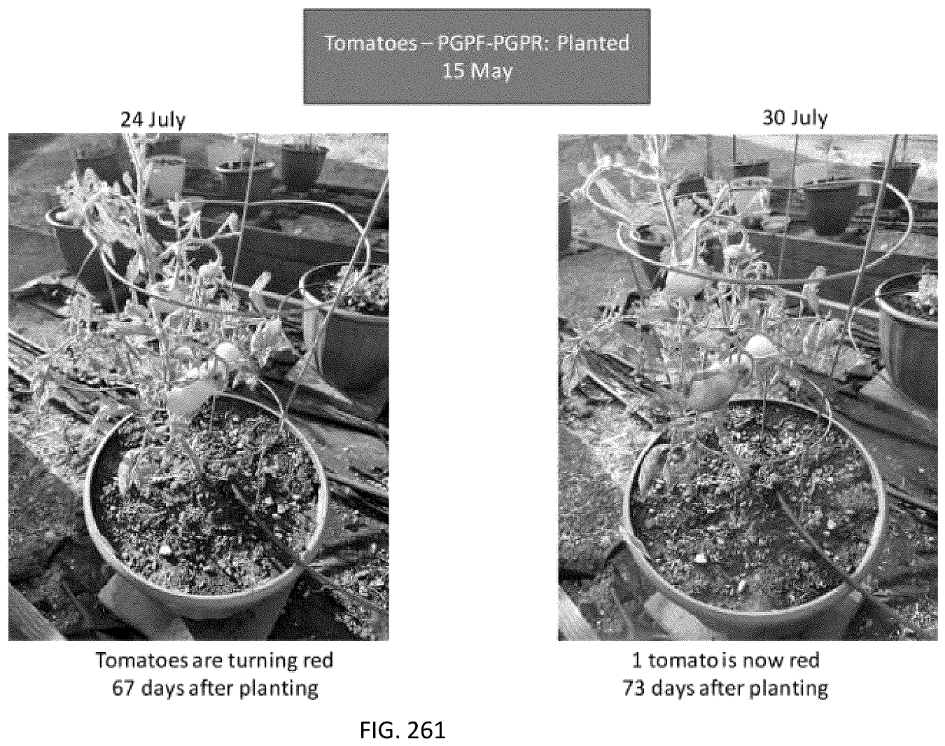

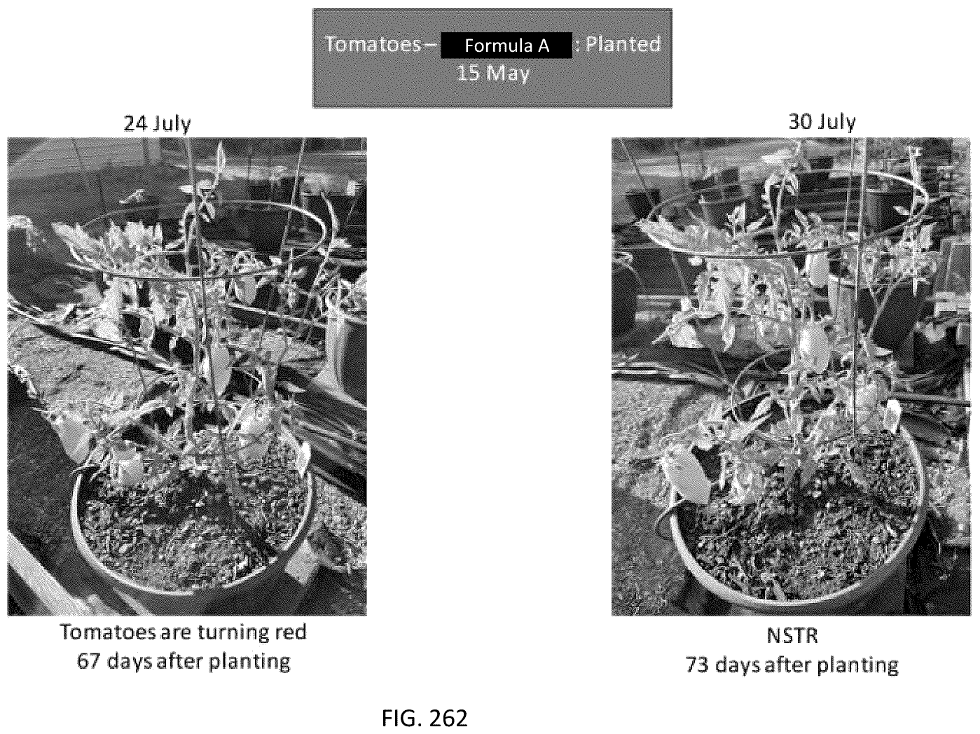

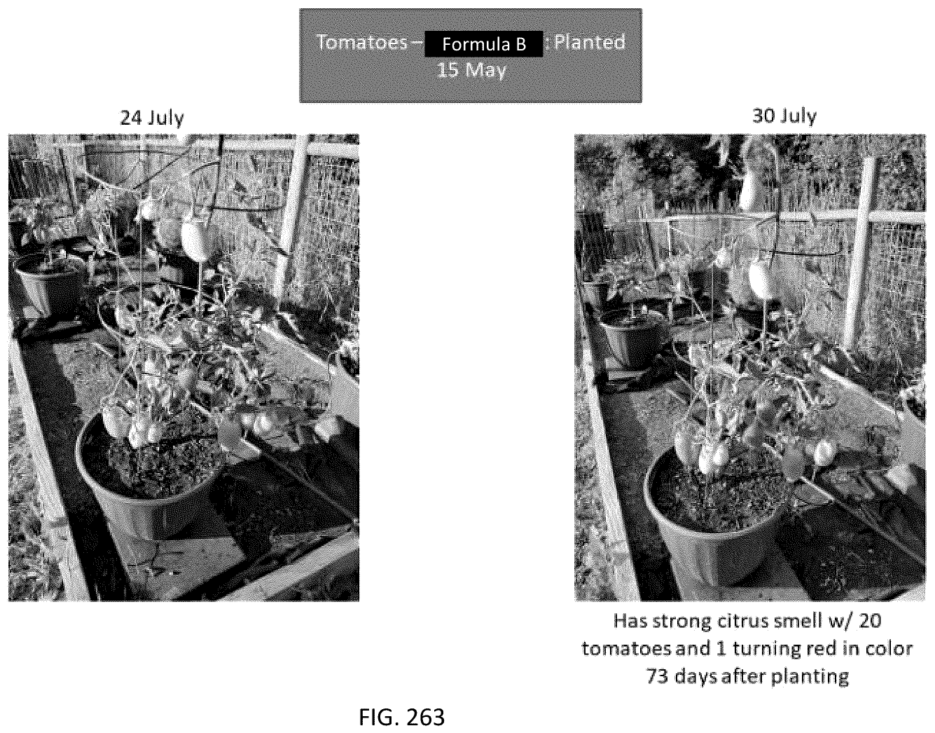

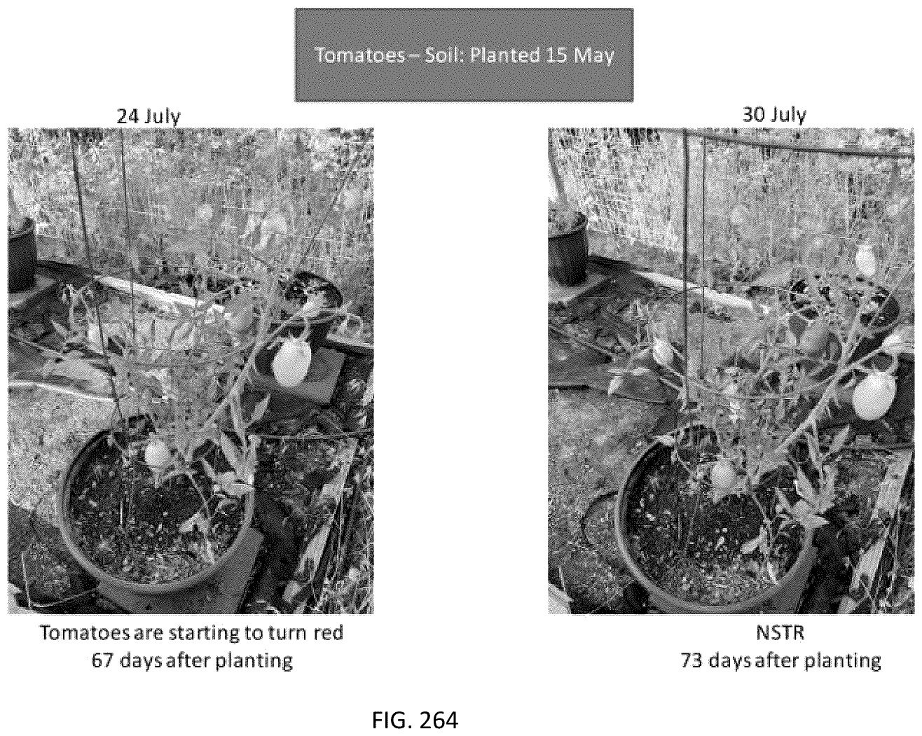

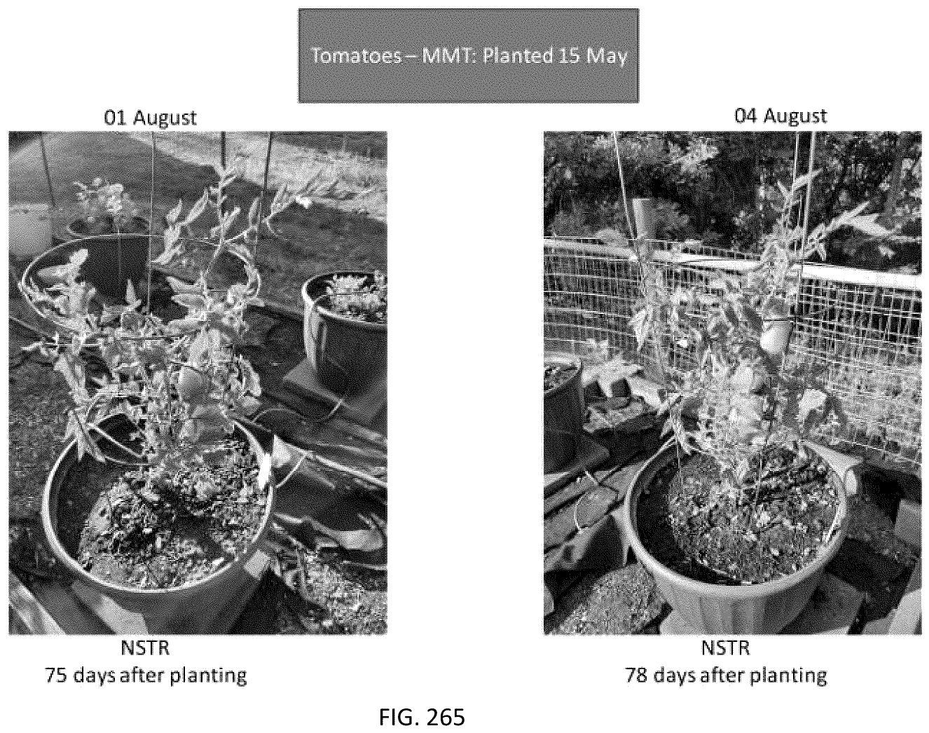

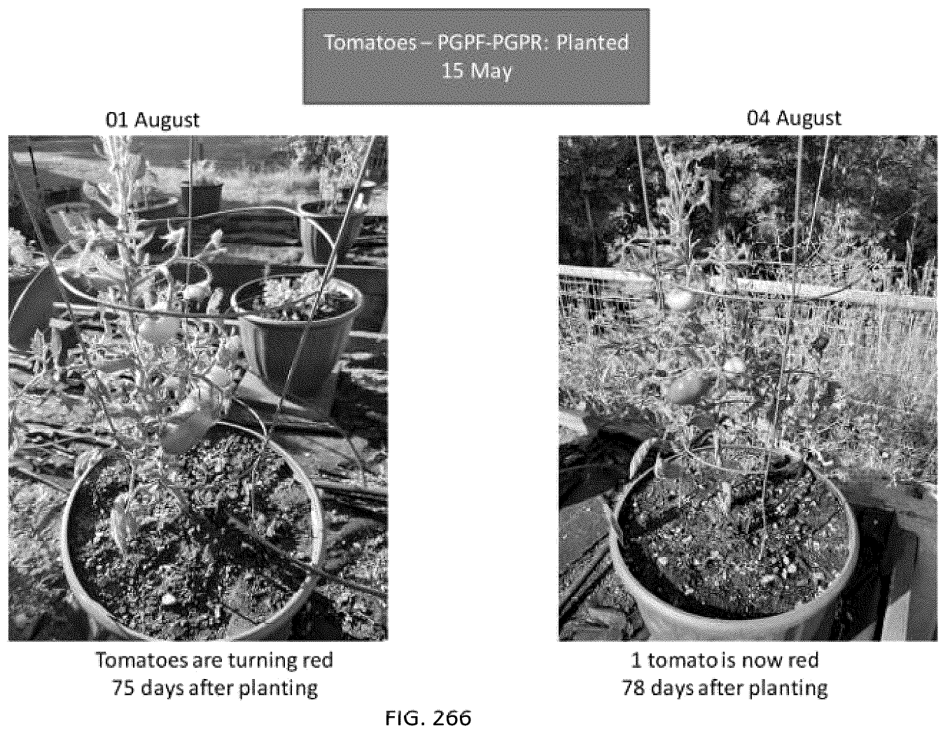

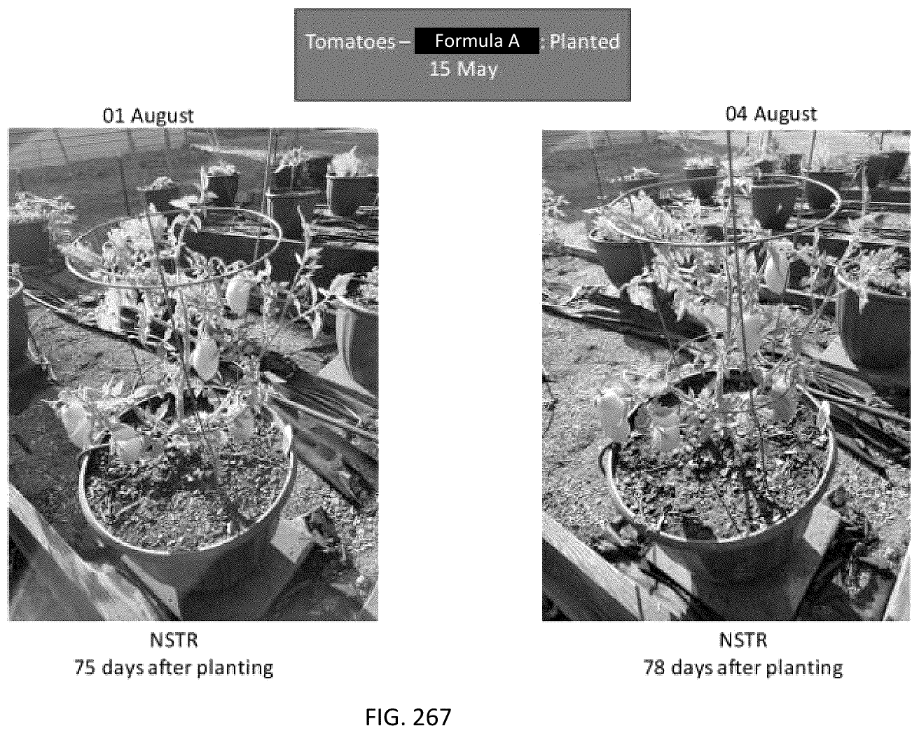

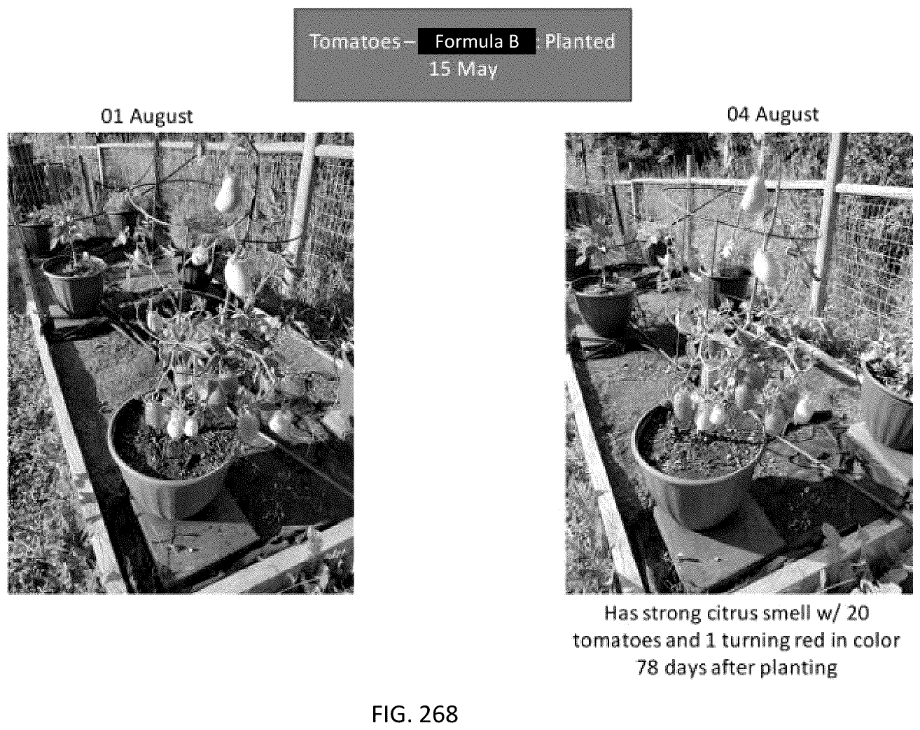

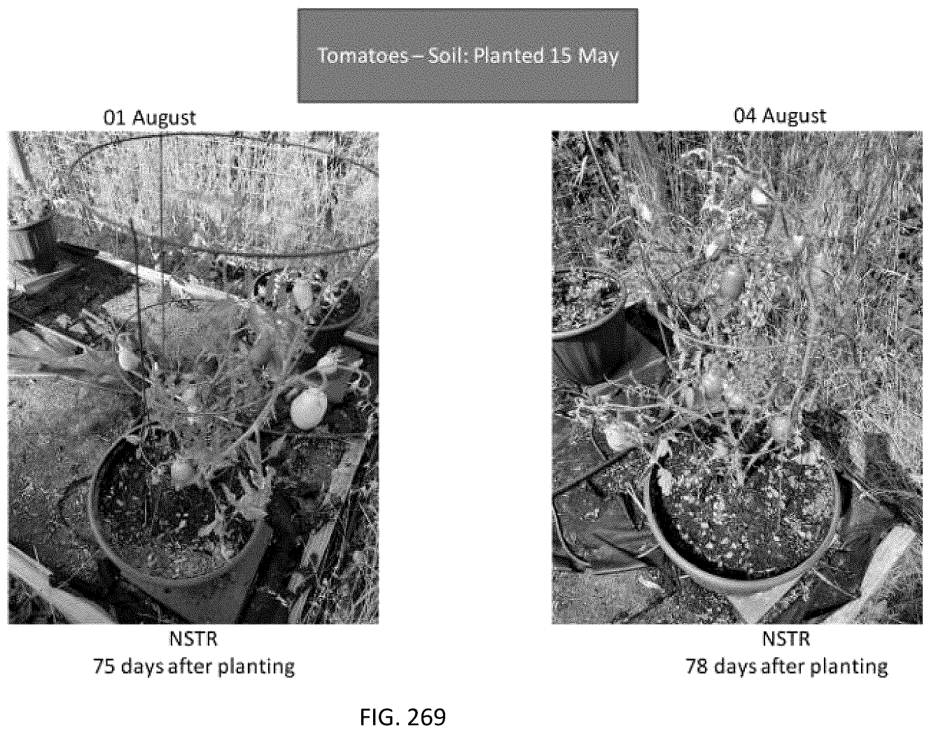

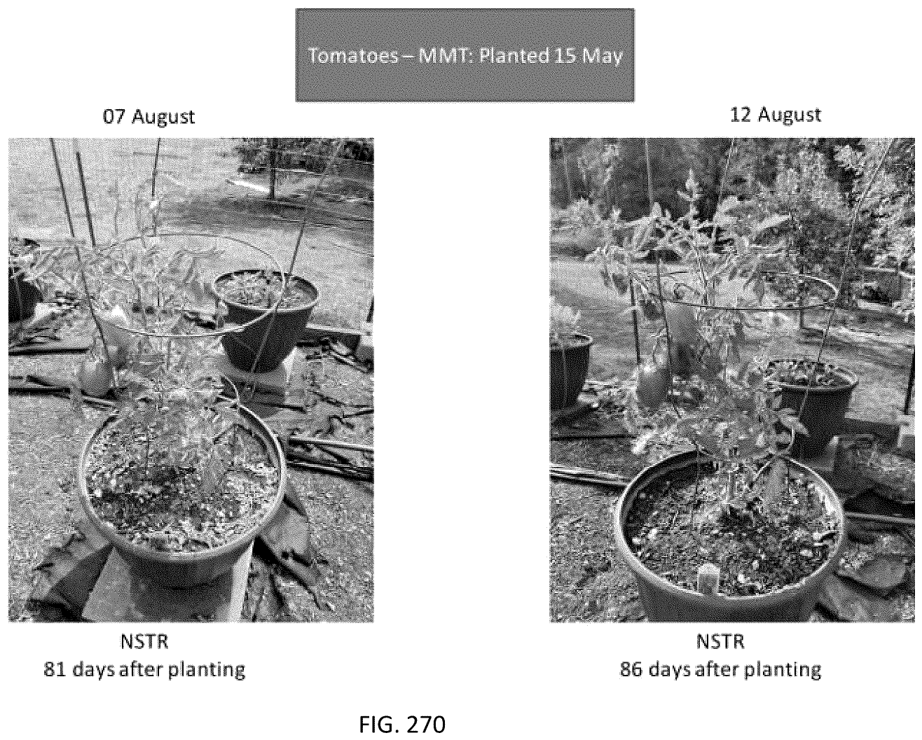

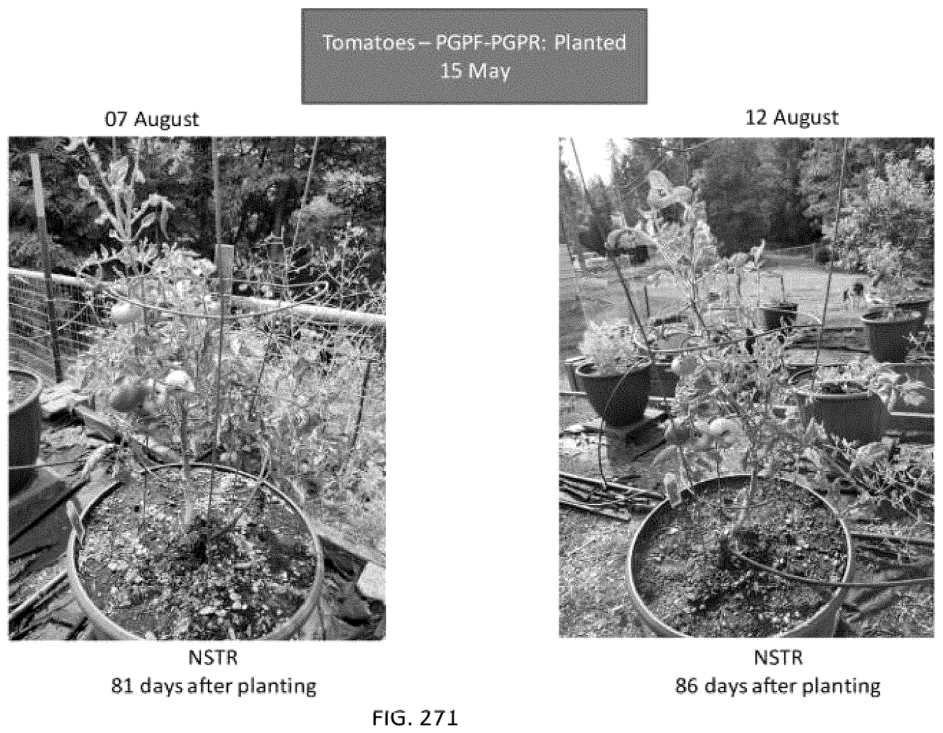

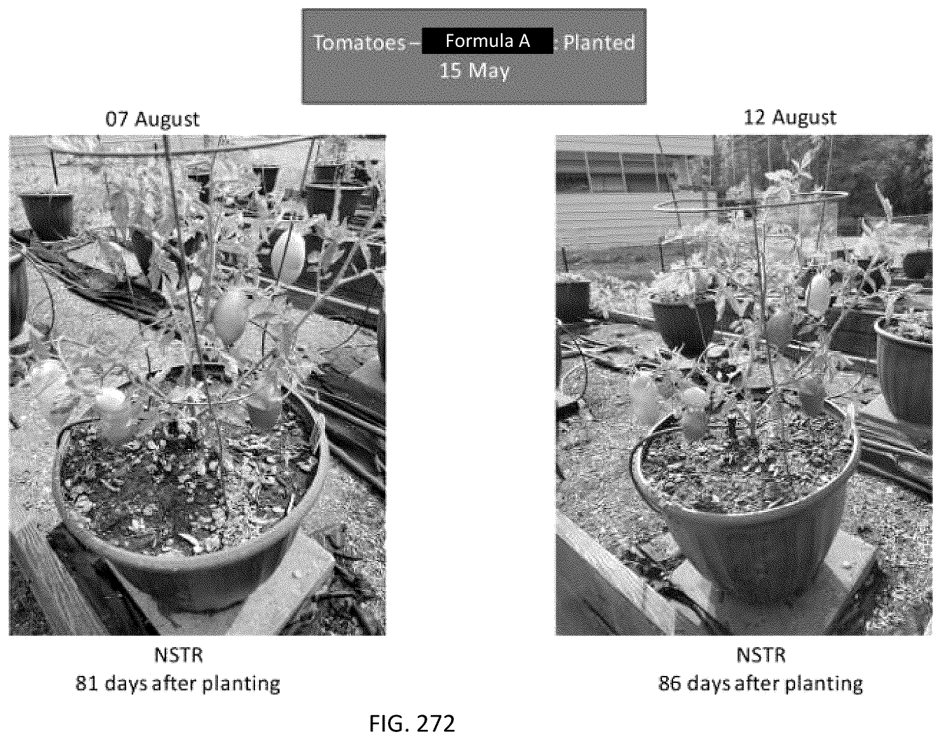

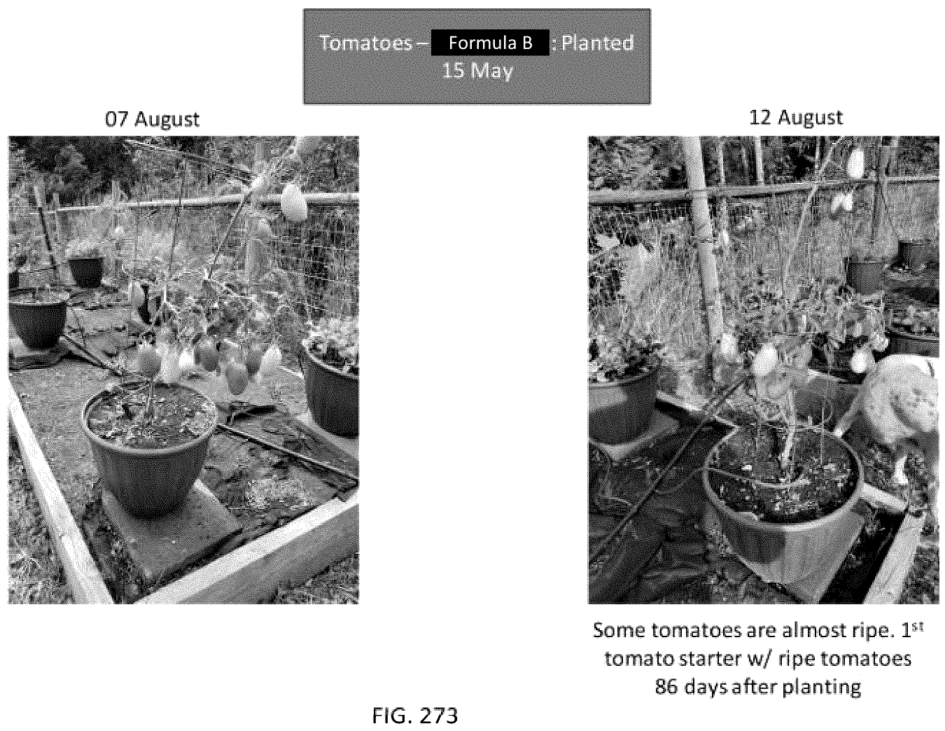

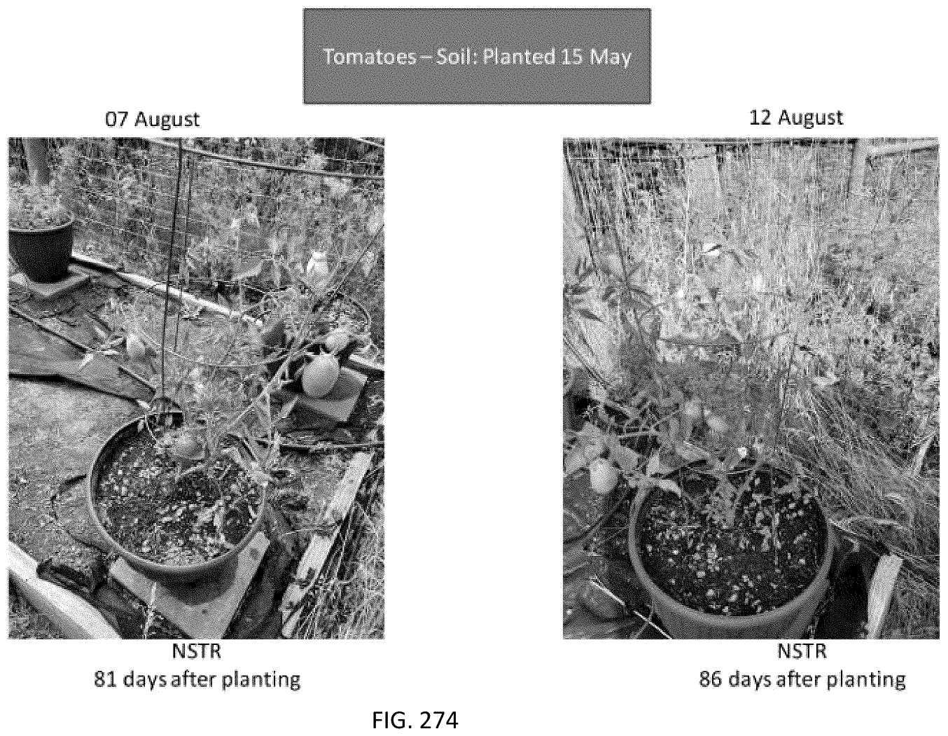

The compositions as prepared in Example 8 were applied to tomato starters. All groups were planted on May 15. Tomato starters were observed to 9 weeks after planting. Images of the tomatoes are shown in FIGS. 230-274.

Nothing significant was noted in the first 26 days for all test groups.

Between 28-33 days, nothing significant was noted for the MMT, PGPF-PGPR, and Formula A groups. In the Formula B group, 2, 5, and 8 tomatoes were seen at 28 days, 31 days, and 33 days after planting, respectively. In the Soil group, nothing significant was noted at 28 days and 31 days after planting, and 2 tomatoes were visible 33 days after planting.

The Formula B and Soil groups received about 3 extra hours of sunlight, which may be a factor in the difference in the growth beds.

TABLE 30
Week 4 Tomato Observations

| | June 19, 35 days | June 23, 39 days |
|---|---|---|
| | after planting | after planting |
| MMT | Nothing serious | 1 tomato |
| | to report | |
| PGPF-PGPR | Nothing serious | 2 tomatoes |
| | to report | |
| Formula A | Nothing serious | 2 tomatoes |
| | to report | |
| Formula B | 8 tomatoes | 10 tomatoes |
| Soil | 2 tomatoes | 4 tomatoes |

During weeks 3 and 4, the Formula A group had the healthiest-looking fruits and vegetables out of the three groups that received less sunlight. Growth was stunted during week 4 due to a cold snap where temperatures dropped to 43° F. at night for 4 consecutive days starting June 18. Minimal sunlight was observed during this time with wet and rainy conditions. The temperature ranged between 46° F. and 51° F.

TABLE 31
Week 5 Tomato Observations

| | July 3, 45 days | July 7, 49 days |
|---|---|---|
| | after planting | after planting |
| MMT | 2 green tomatoes | 2 tomatoes, faint citrus |
| PGPF-PGPR | 5 green tomatoes | smell 6 green tomatoes, |
| | | strong citrus smell |
| Formula A | 3 large green tomatoes with | 7 green tomatoes, very |
| | more hair/crystals than any | strong citrus smell, |
| | other group. Deep pungent | most amount of shiny |
| | citrus-type smell | hairs/very abundant |
| Formula B | 12 good-sized tomatoes, | 16 good-sized green tomatoes, |
| | mild citrus smell | strong citrus smell |
| Soil | 5 green tomatoes | 6 green tomatoes |

Growth had picked up from the previous wet and cloudy weather that stunted growth. Formula B had the largest and healthiest vegetables, while the second strongest groups were PGPF-PGPR and Formula A groups.

TABLE 32
Week 6 Tomato Observations

| | July 16, 58 days | July 22, 65 days |
|---|---|---|
| | after planting | after planting |
| MMT | 3 green tomatoes | 3 tomatoes, faint citrus smell |
| PGPF-PGPR | 6 green tomatoes, | 6 green tomatoes with bug |
| | 5 have bug bites | bites |
| Formula A | 7 tomatoes, all healthy with | 6 green tomatoes that looked |
| | strongest citrus smell | healthy, strongest citrus smell |
| Formula B | 20 tomatoes, second | 20 tomatoes except 1 that was |
| | strongest citrus smell | turning red in color, strong |
| | | citrus smell |
| Soil | 6 tomatoes, faint | 8 green tomatoes |
| | citrus smell | |

The Formula B plants were noticeably most abundant, healthy, and vibrant out of all groups tested, followed by the Formula A plants.

TABLE 33
Week 7 Tomato Observations

| | July 24, 67 days | July 30, 73 days |
|---|---|---|
| | after planting | after planting |
| MMT | Nothing serious | Nothing serious |
| | to report | to report |
| PGPF-PGPR | Tomatoes were turning red | 1 tomato was red in color |
| Formula A | Tomatoes were turning red | Nothing serious to report |
| Formula B | 20 tomatoes, second | 20 tomatoes with 1 that was |
| | strongest citrus | turning red in color, |
| | smell | strong citrus smell |
| Soil | Tomatoes starting | Nothing serious |
| | to turn red | to report |

The Formula B plants were noticeably most abundant, healthy, and vibrant out of all groups tested, followed by the Formula A plants.

TABLE 34
Week 8 Tomato Observations

| | August 1, 75 days | August 4, 78 days |
|---|---|---|
| | after planting | after planting |
| MMT | Nothing serious | Nothing serious |
| | to report | to report |
| PGPF-PGPR | Tomatoes were turning red | 1 tomato was red in color |
| Formula A | Nothing serious to report | Nothing serious to report |
| Formula B | 20 tomatoes, second | 20 tomatoes with 1 that |
| | strongest citrus | was turning red in color, |
| | smell | strong citrus smell |
| Soil | Nothing serious | Nothing serious |
| | to report | to report |

The Formula B plants were noticeably most abundant, healthy, and vibrant out of all groups tested, followed by the Formula A plants.

TABLE 35
Week 9 Tomato Observations

| | August 7, 81 days | August 12, 86 days |
|---|---|---|
| | after planting | after planting |
| MMT | Nothing serious | Nothing serious |
| | to report | to report |
| PGPF-PGPR | Nothing serious | Nothing serious |
| | to report | to report |
| Formula A | Nothing serious | Nothing serious |
| | to report | to report |
| Formula B | Strongest, healthiest, | Some tomatoes were almost |
| | largest of all groups | ripe. First group with |
| | | ripe tomatoes |
| Soil | Nothing serious | Nothing serious |
| | to report | to report |

The Formula B plants were noticeably most abundant, healthy, and vibrant out of all groups tested, followed by the Formula A plants.

### Example 15: Comparison of Various Treatment Groups to Formula B

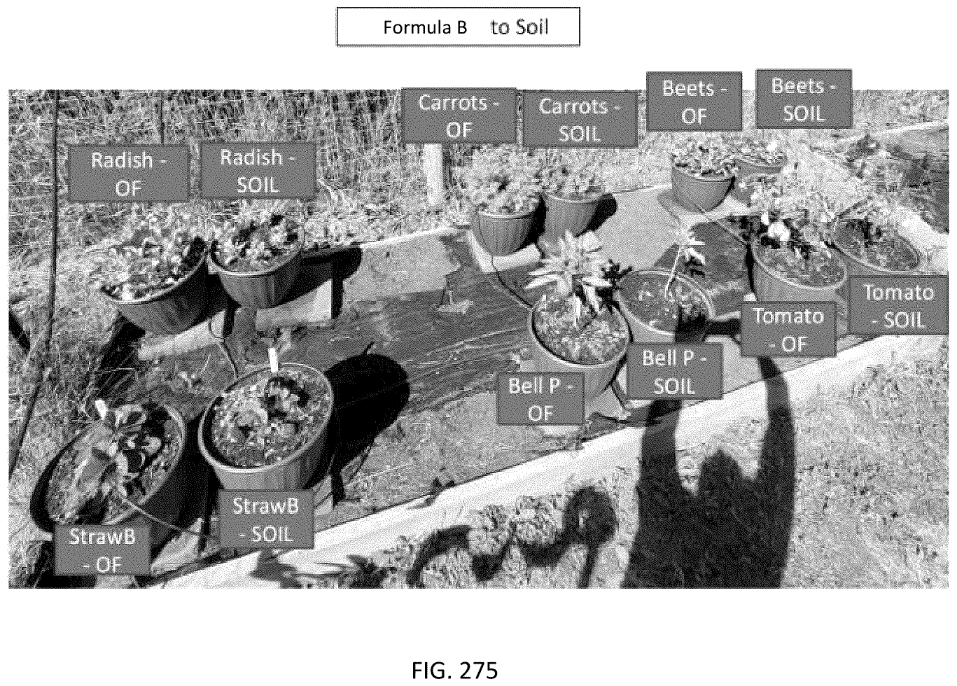

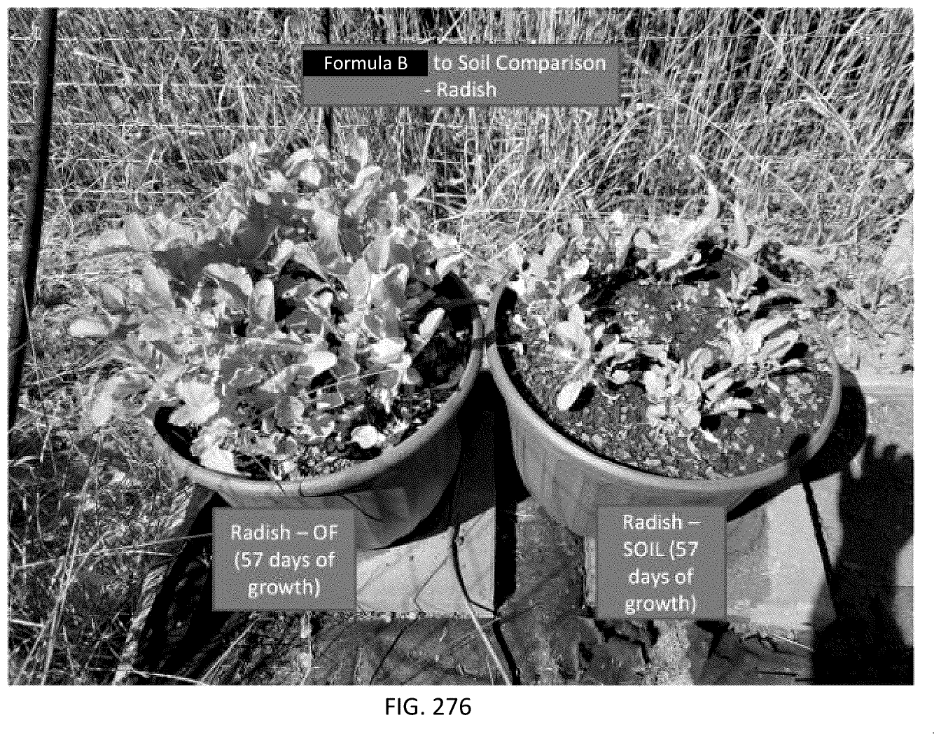

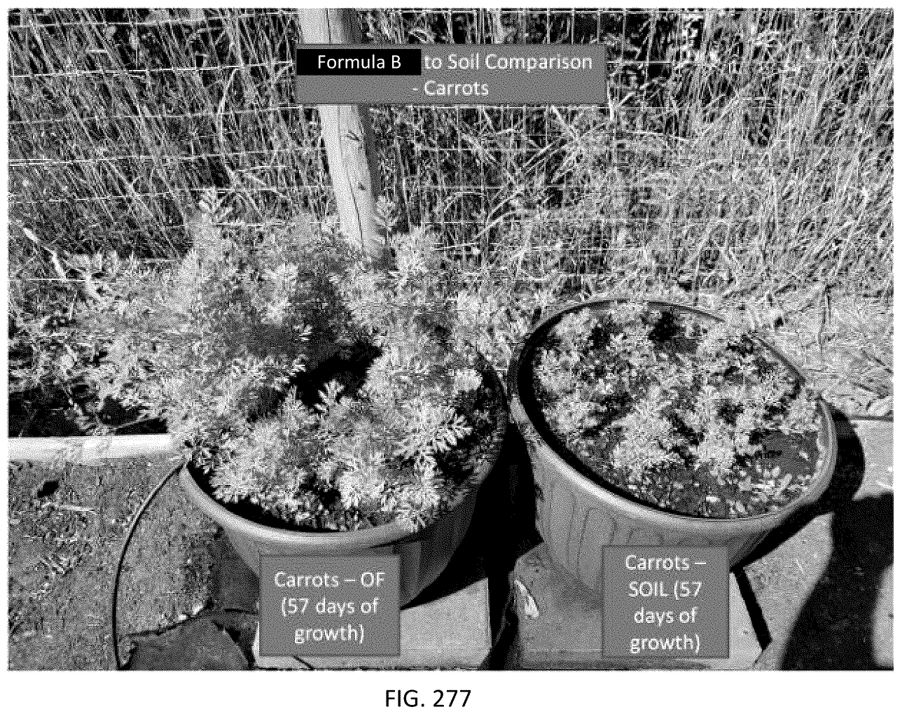

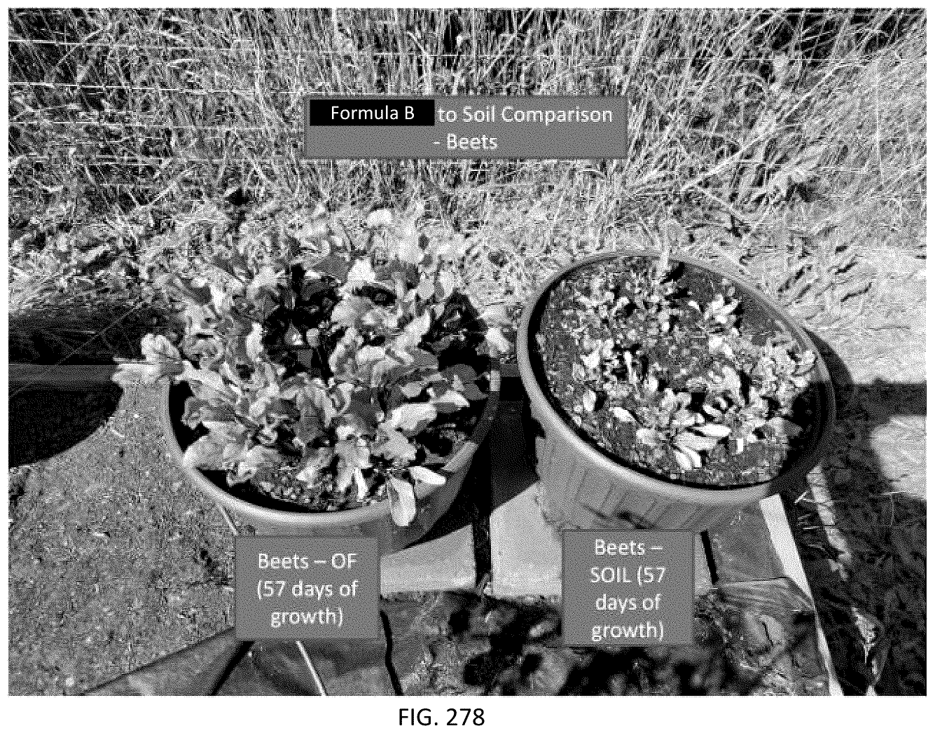

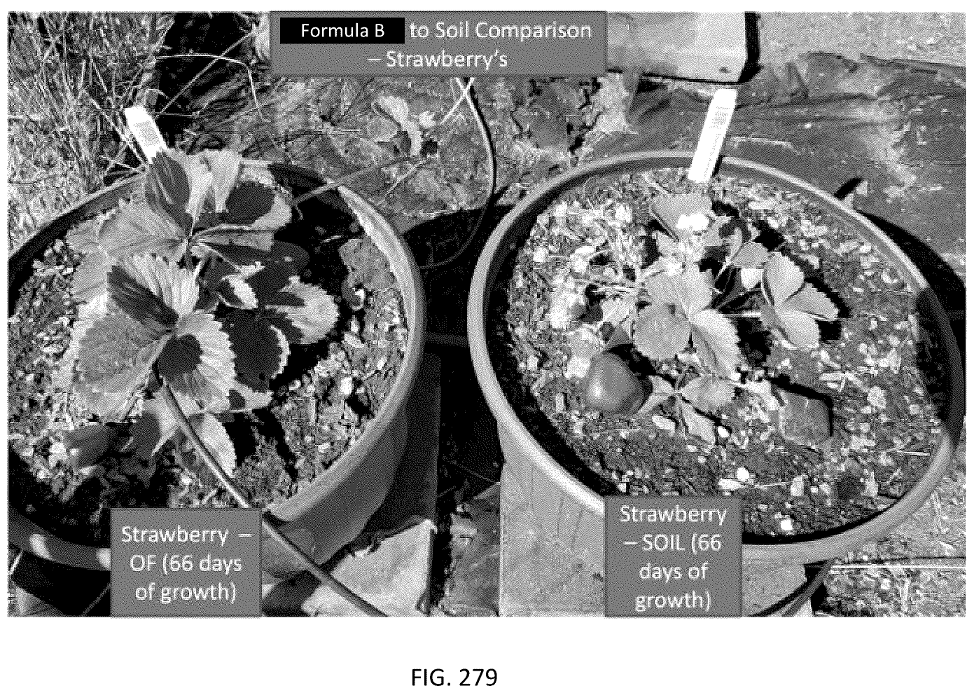

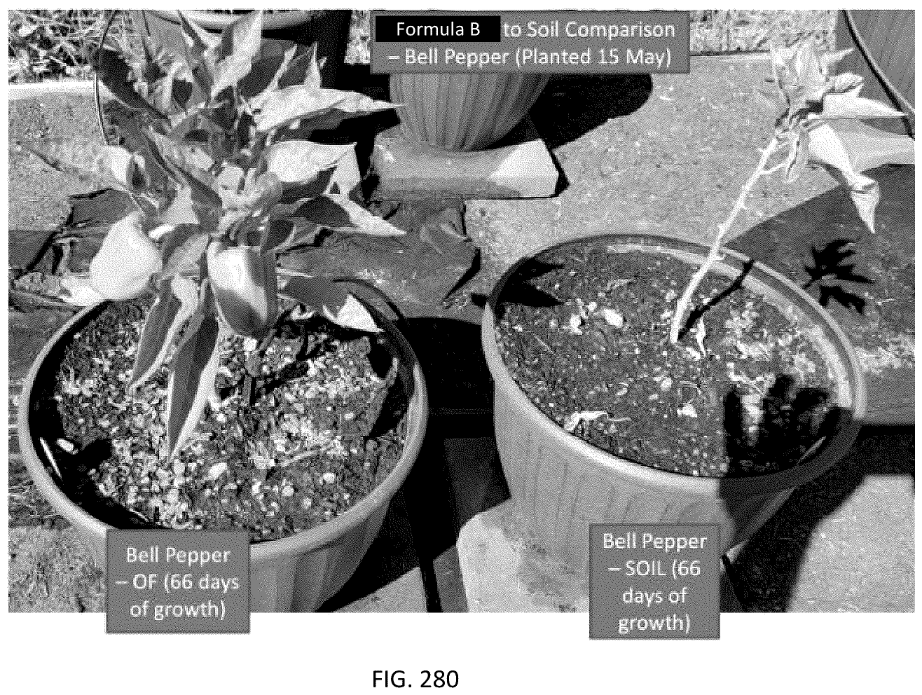

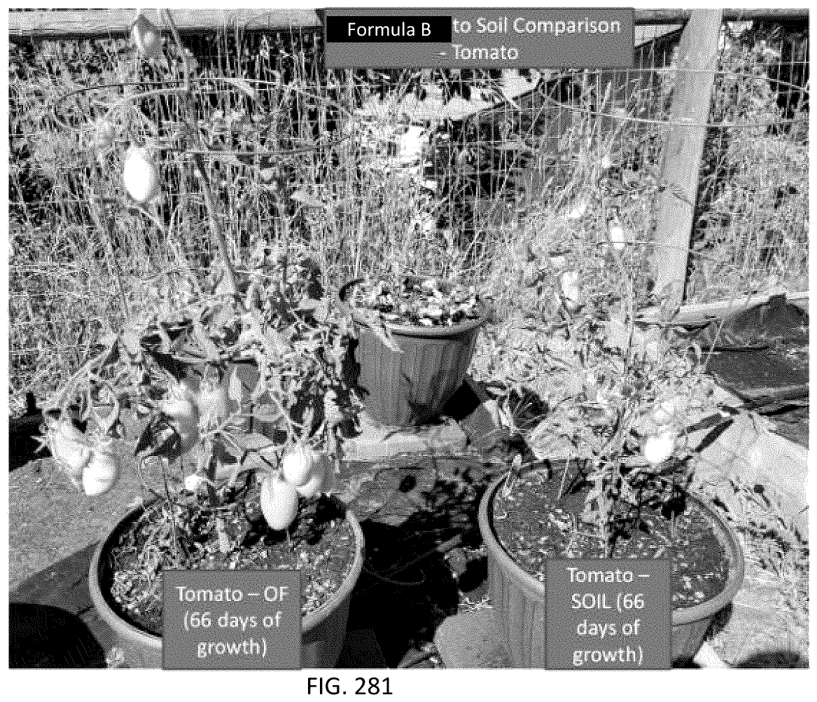

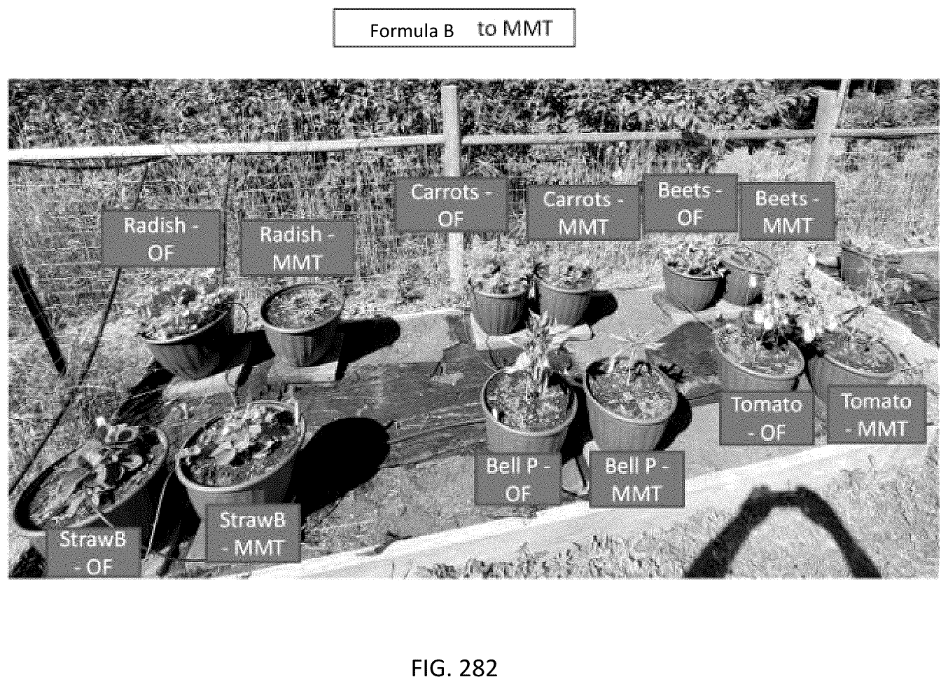

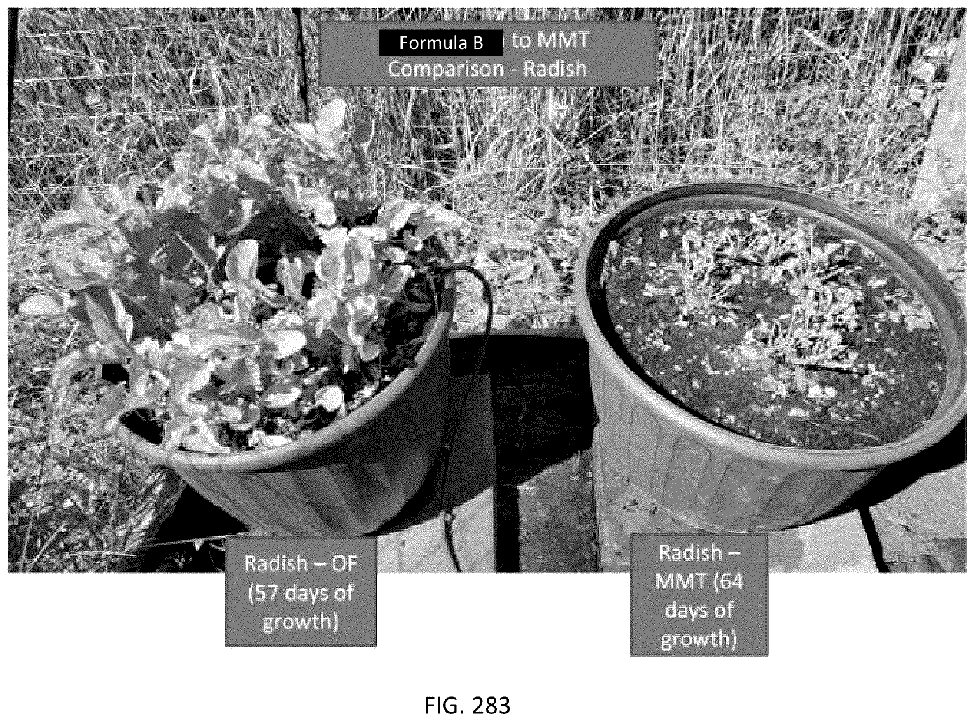

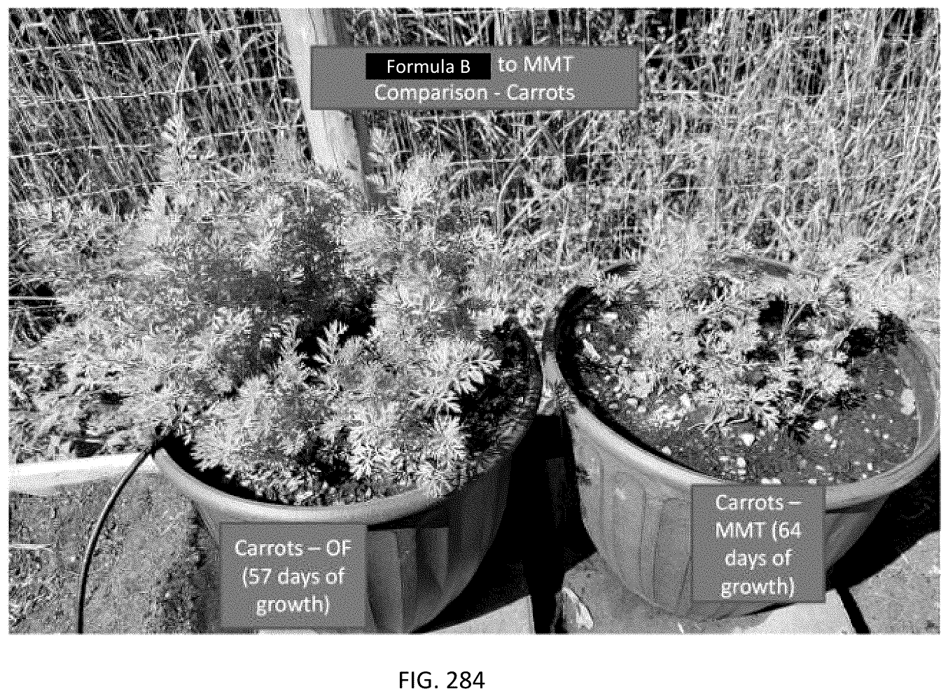

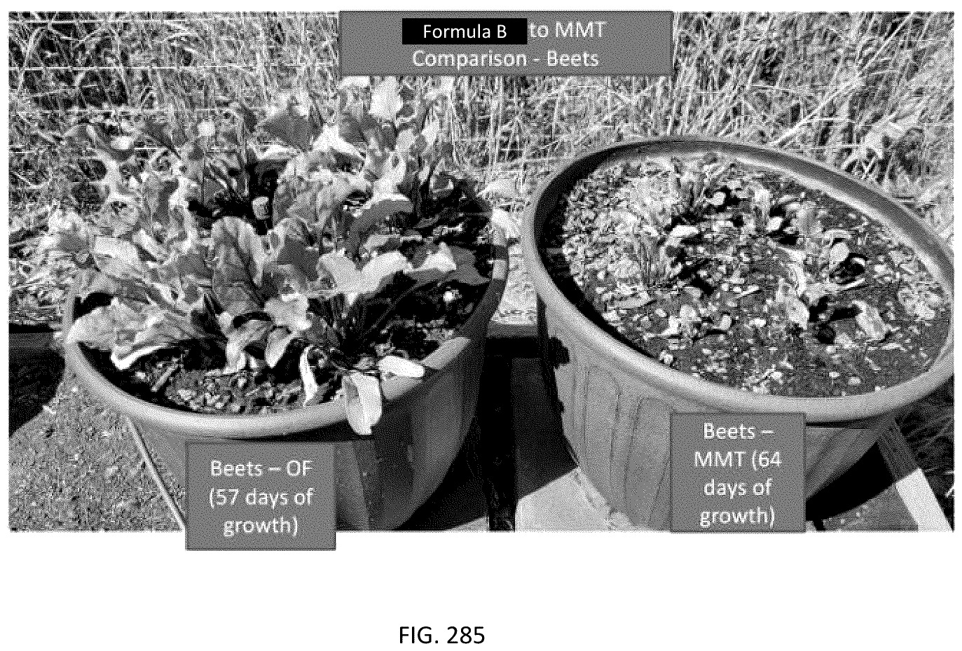

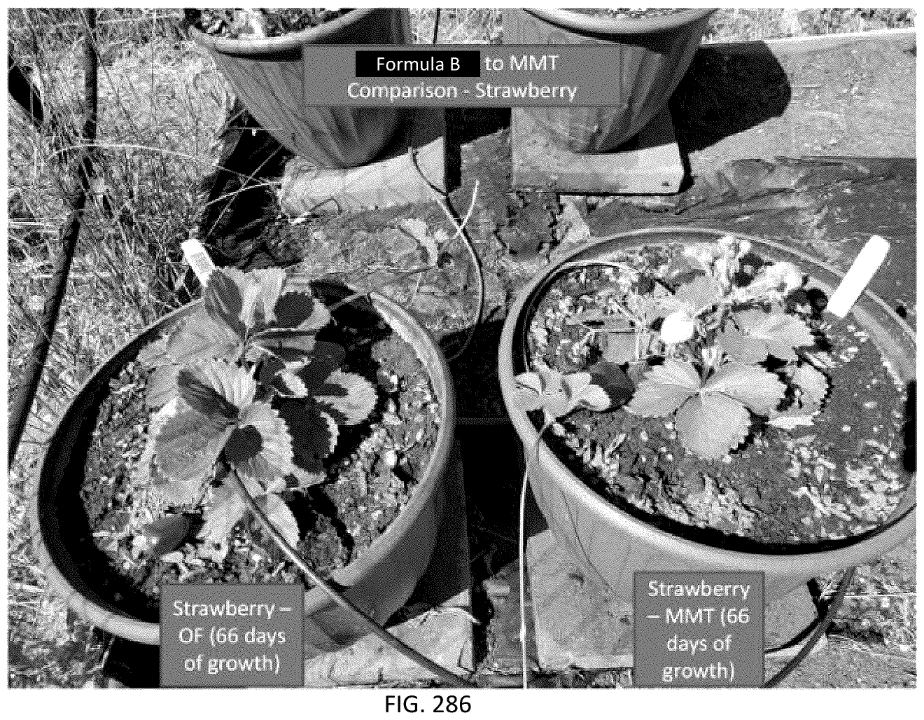

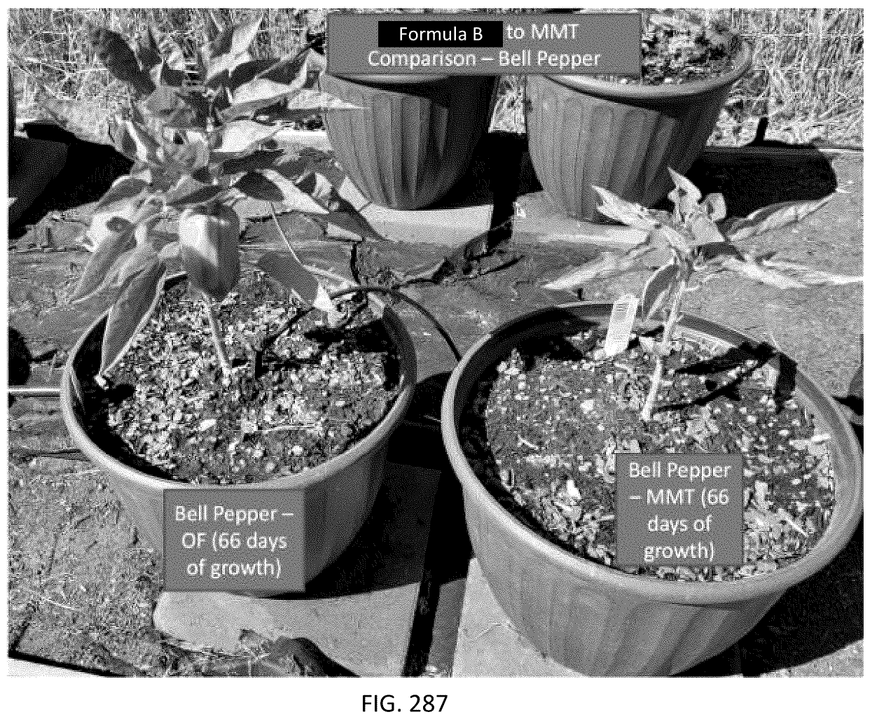

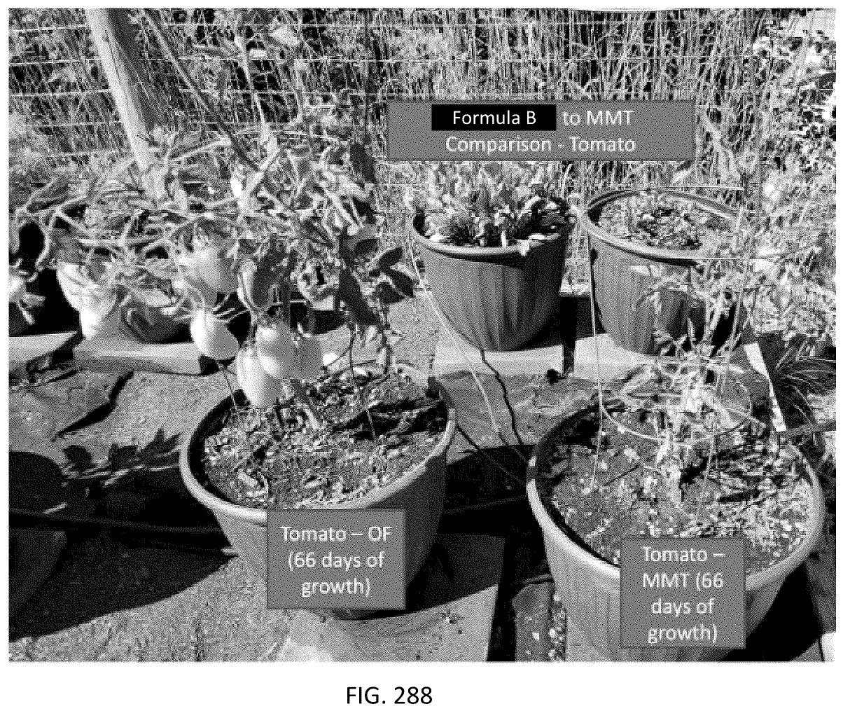

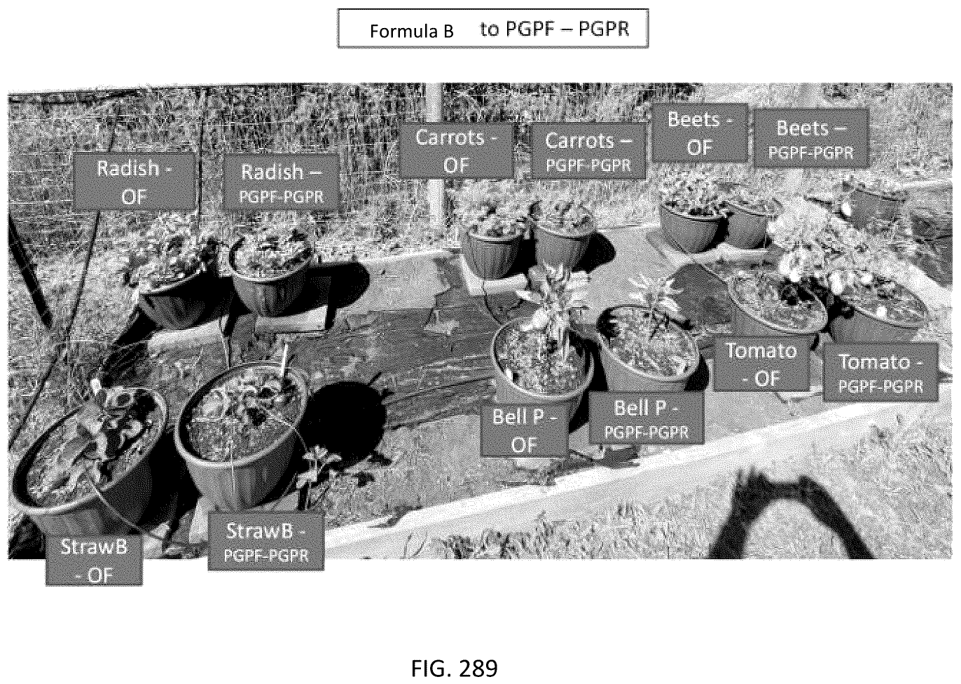

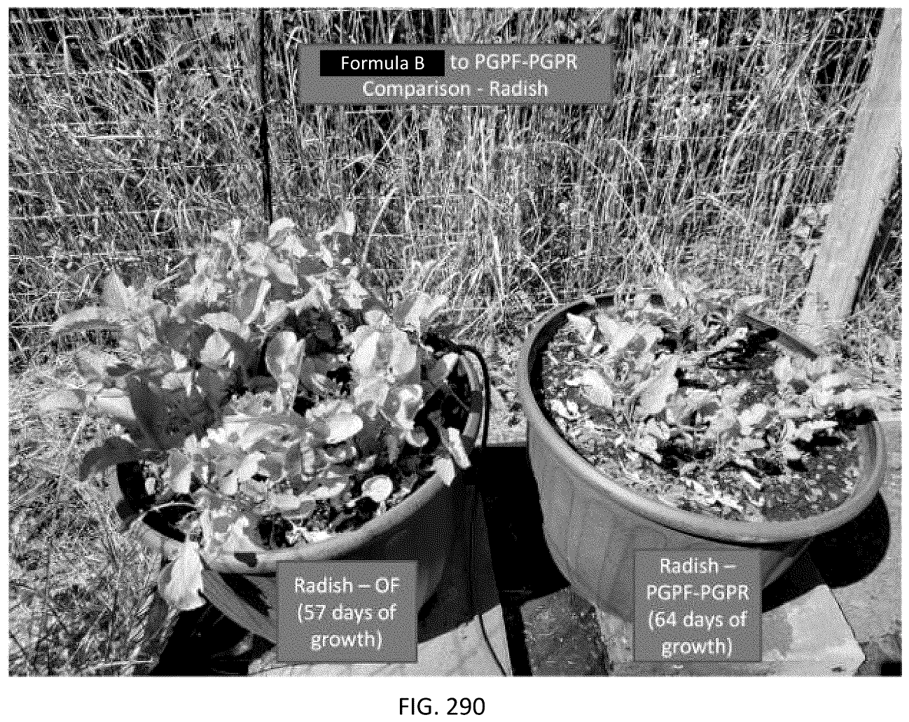

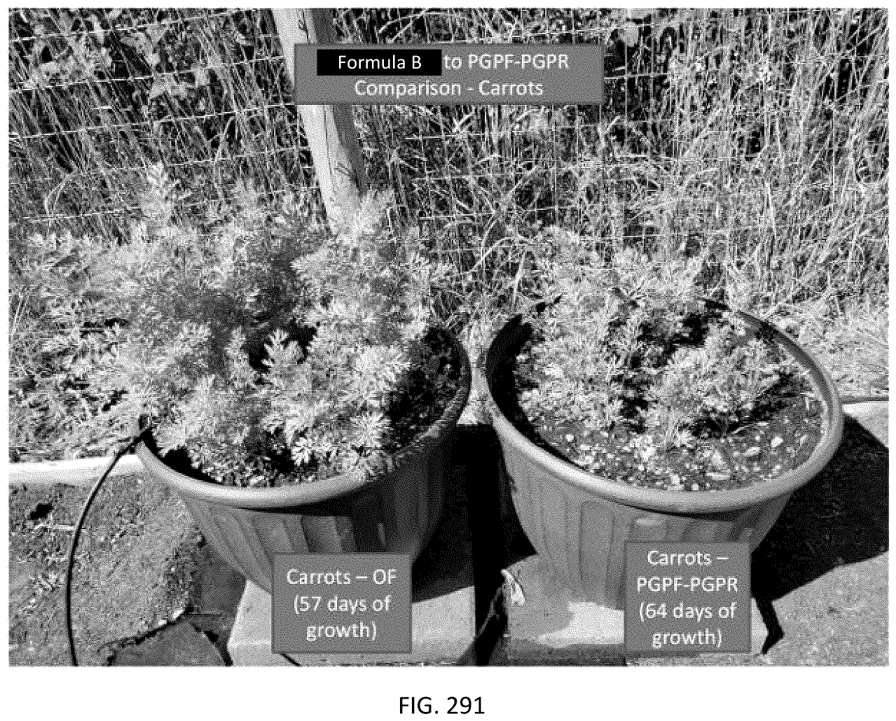

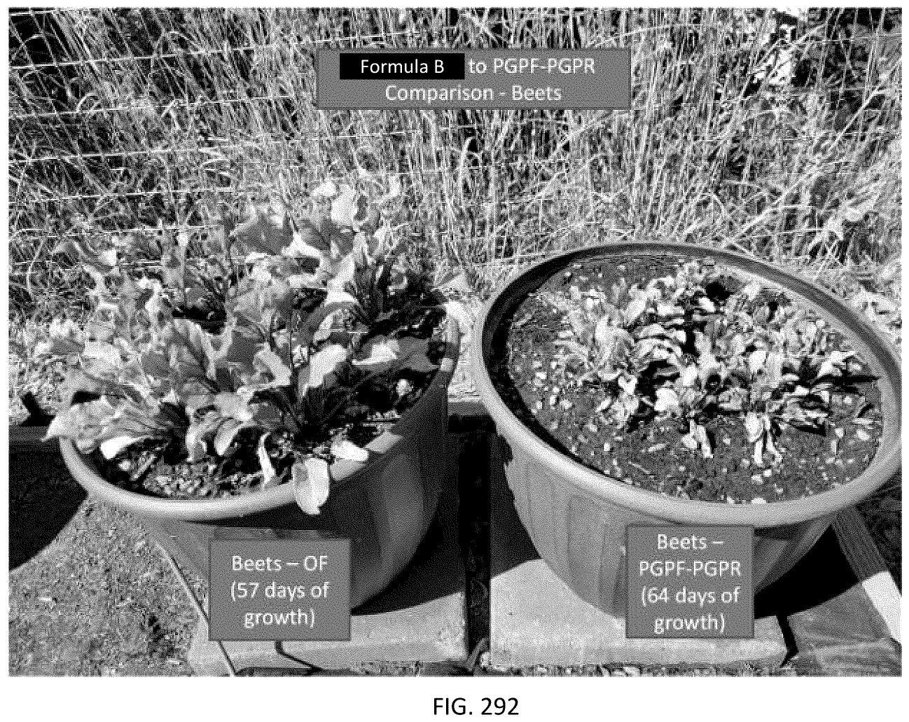

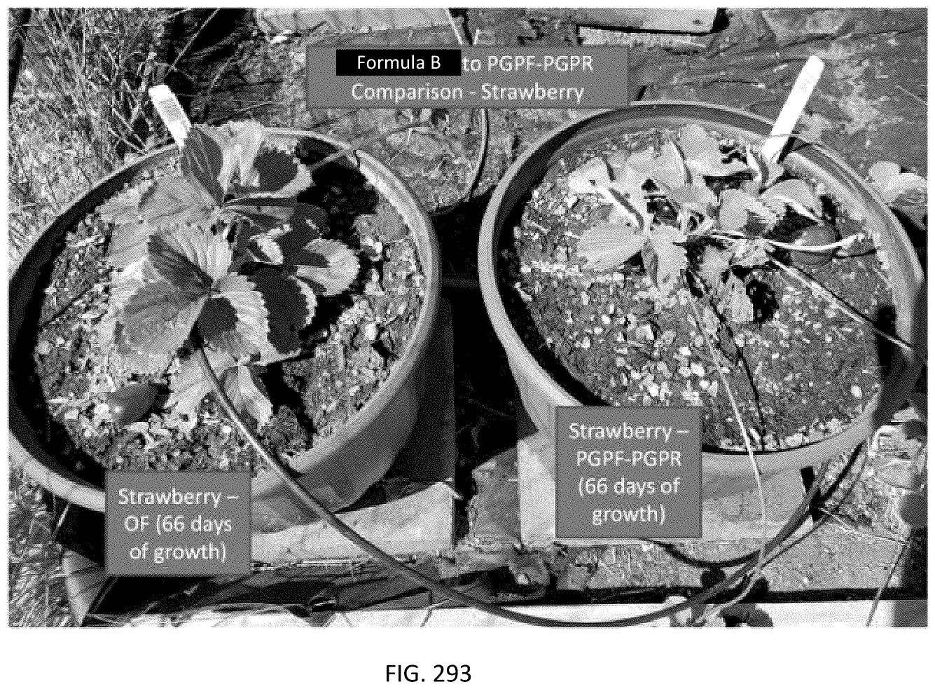

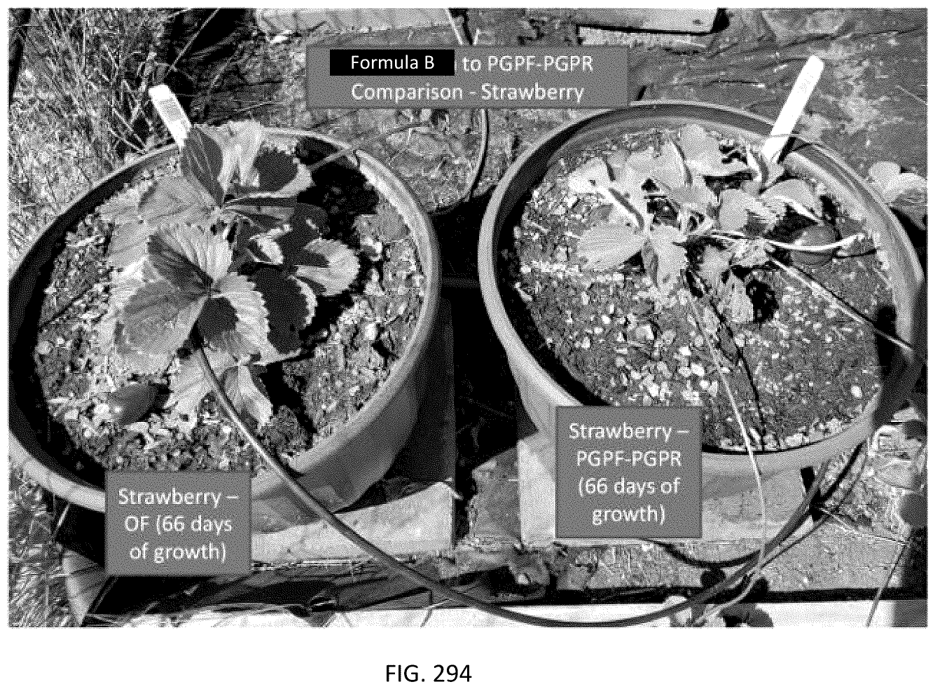

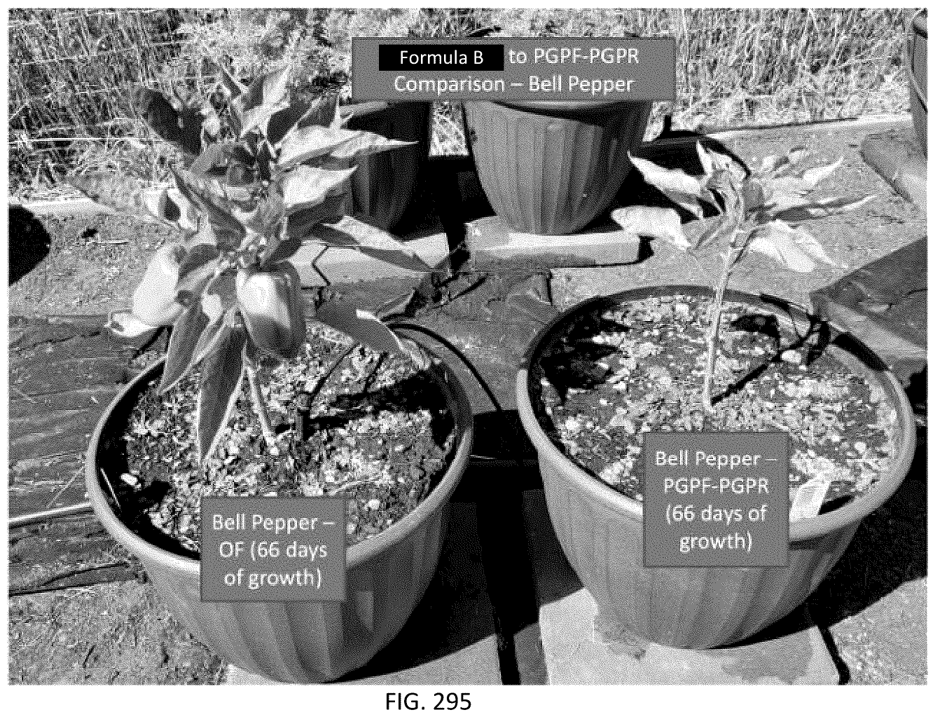

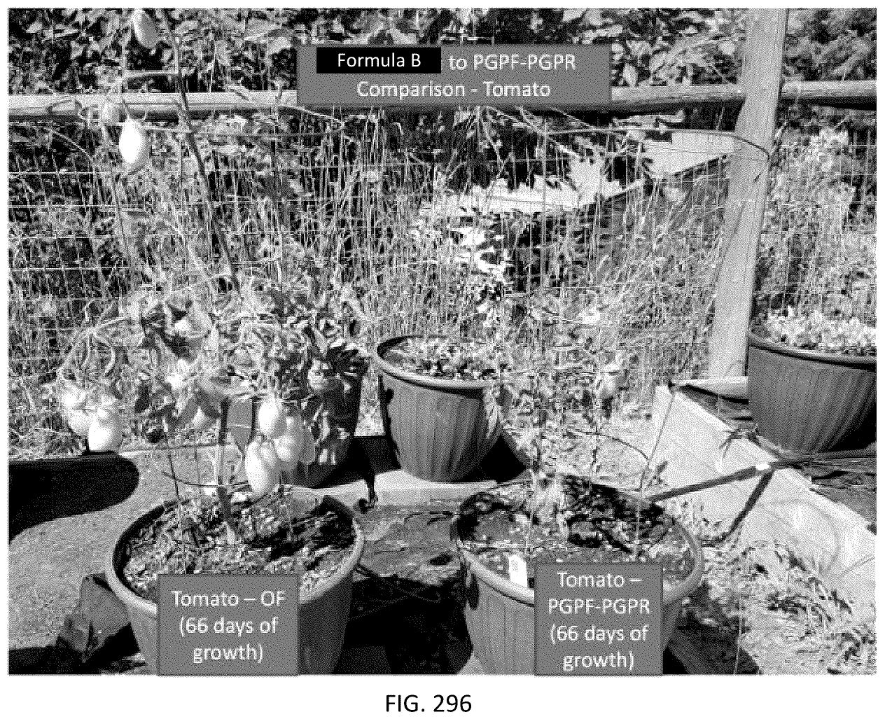

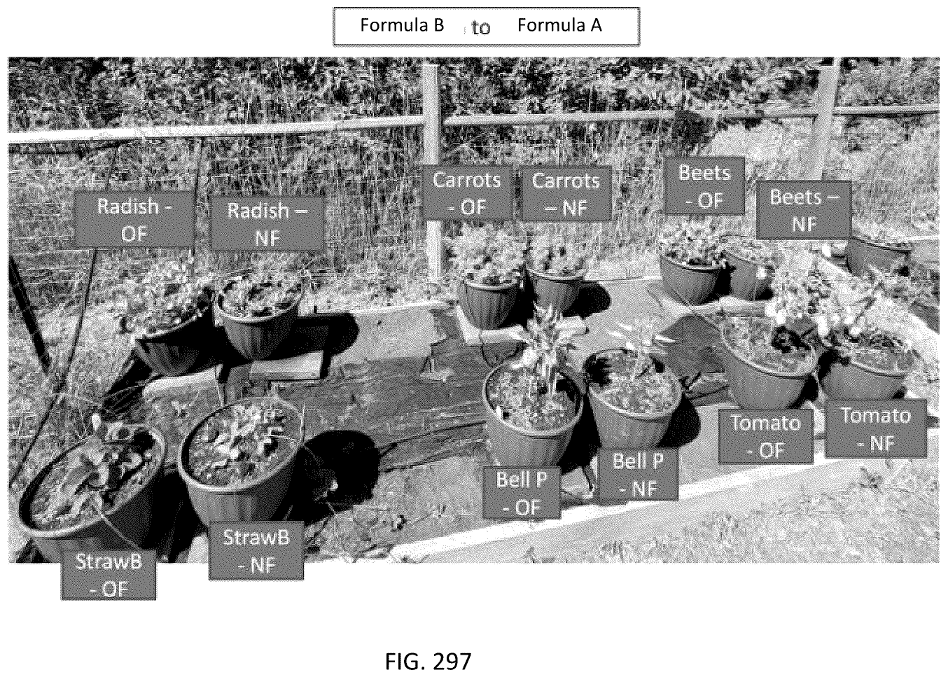

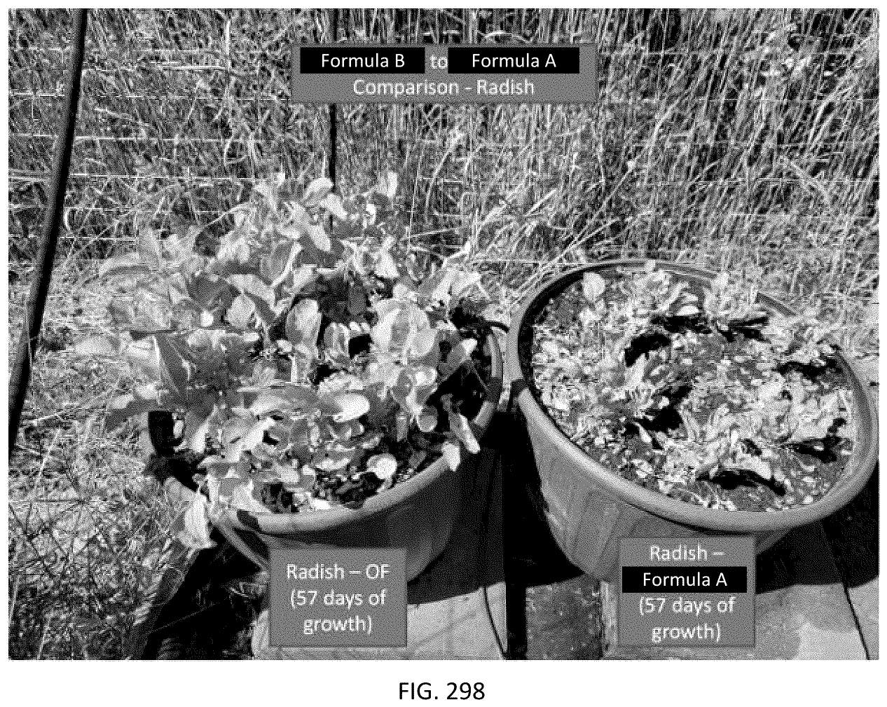

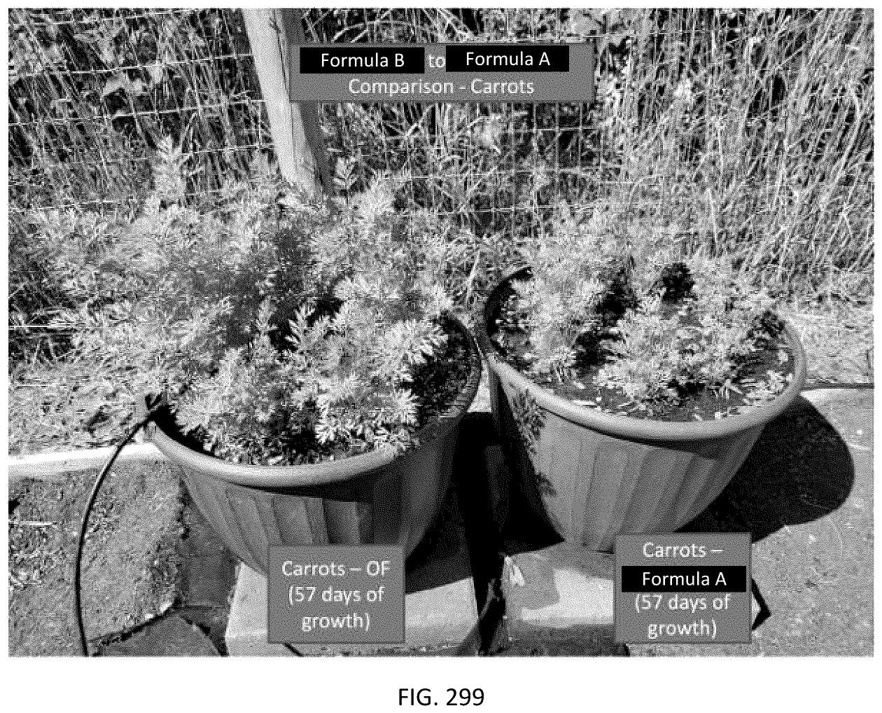

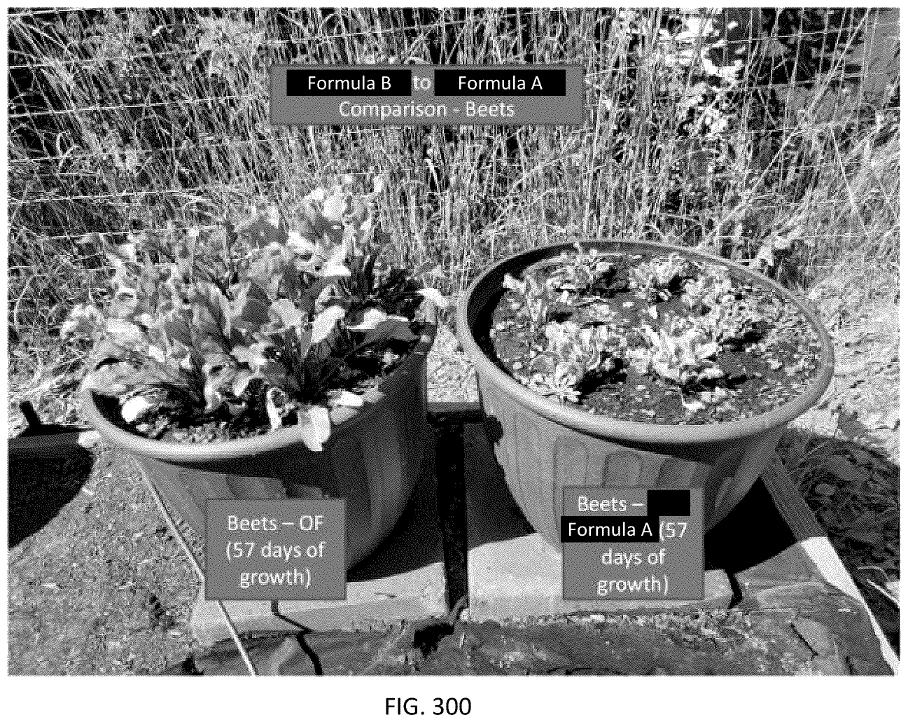

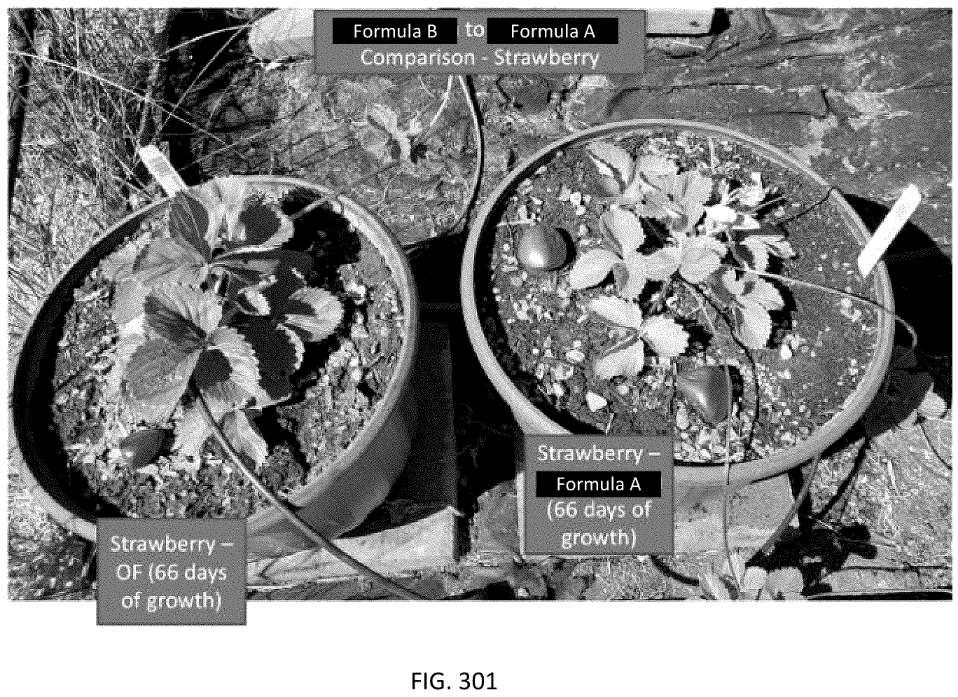

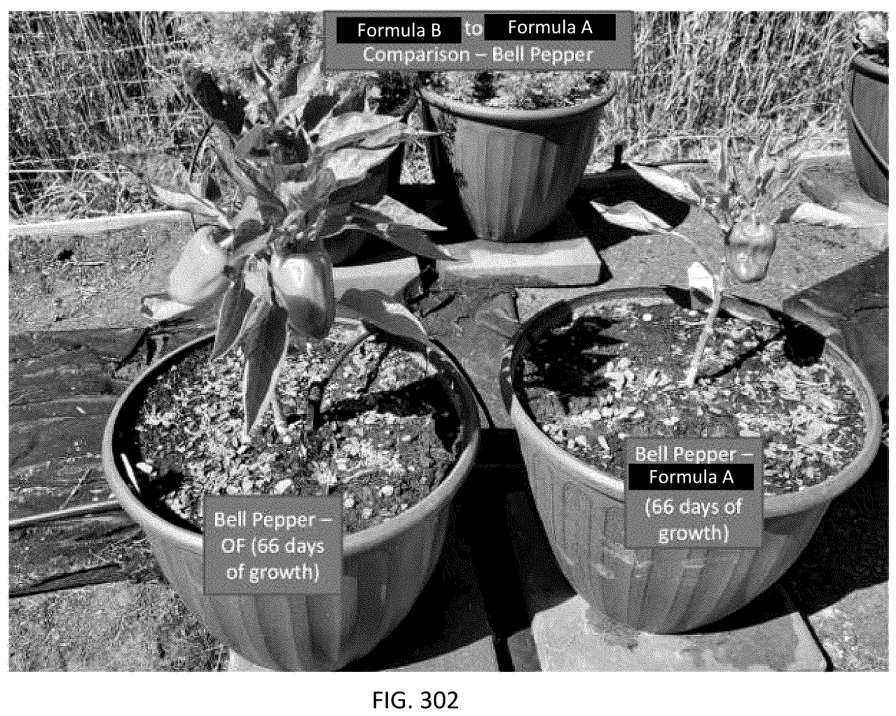

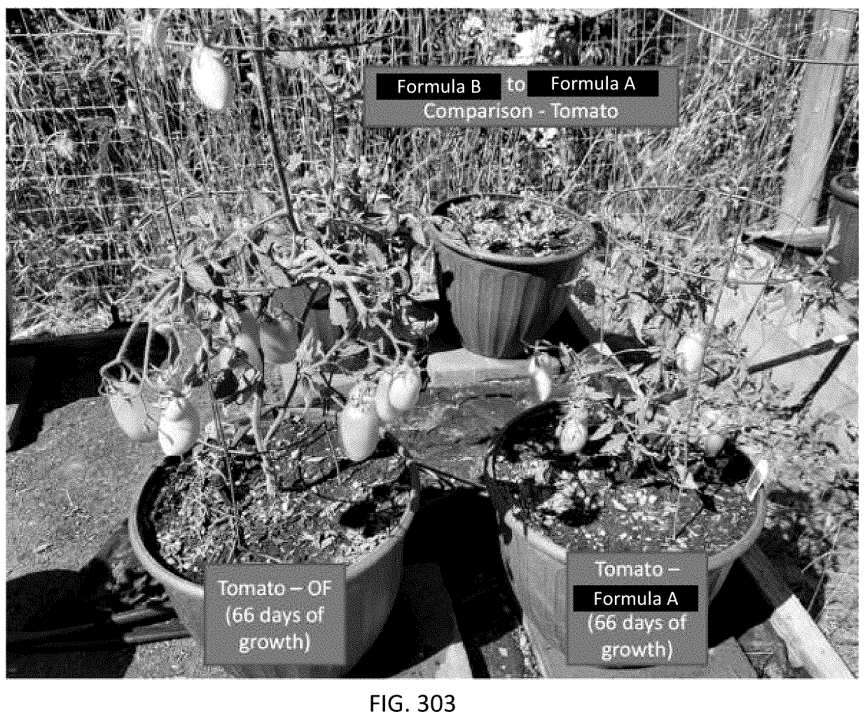

Comparisons were made between Formula B and the treatment groups Soil, MMT, PGPF-PGPR, and Formula A (FIGS. 275-303) on July 23; at the end of week 6. The MMT and PGPR-PGPF groups had minimal growth for beets, carrots, and radishes. The Formula A, Formula B, and Soil beds had increased growth with beets, carrots, and radishes. The Formula B and Soil groups received an extra 3 hours of sunlight, which may have been a large factor in the growth differences. An in-depth nutritional analysis of the various fruits and vegetables could be useful.

Of the MMT, PGPF-PGPR, and Formula A groups, which received less sunlight than the Formula B and Soil groups, the Formula A group had the healthiest-looking fruits and vegetables.

Growth had begun to pick up from the previous week's wet and cloudy weather that had stunted growth. The Formula B group had taken the lead in growth out of all test groups. The Formula B group had the largest and healthiest radishes, carrots, beets, strawberries, bell peppers, and tomatoes out of all test groups. The second strongest groups were PGPF-PGPR and Formula A. All MMT, PGPF-PGPR, Formula A and Formula B groups for strawberries now had vines growing. The only group without vines was the Soil group. The Formula A group had the first bell pepper sprout on July 3 and then on July 7, the Formula B group for bell peppers showed 2 pepper sprouts.

### Example 16: Comparison of Strawberries Grown in Formula B Versus Regular Soil

Strawberries grown in Formula B and regular Soil of Example 12 were harvested on August 13. They were the same species of strawberry plant, grown in the same soil, and received the same watering amount of 10 minutes, twice a day at 6 am and 6 pm. They also received the same amount of sunlight. All inputs were identical except for using Formula B versus regular Soil for the strawberry plants.

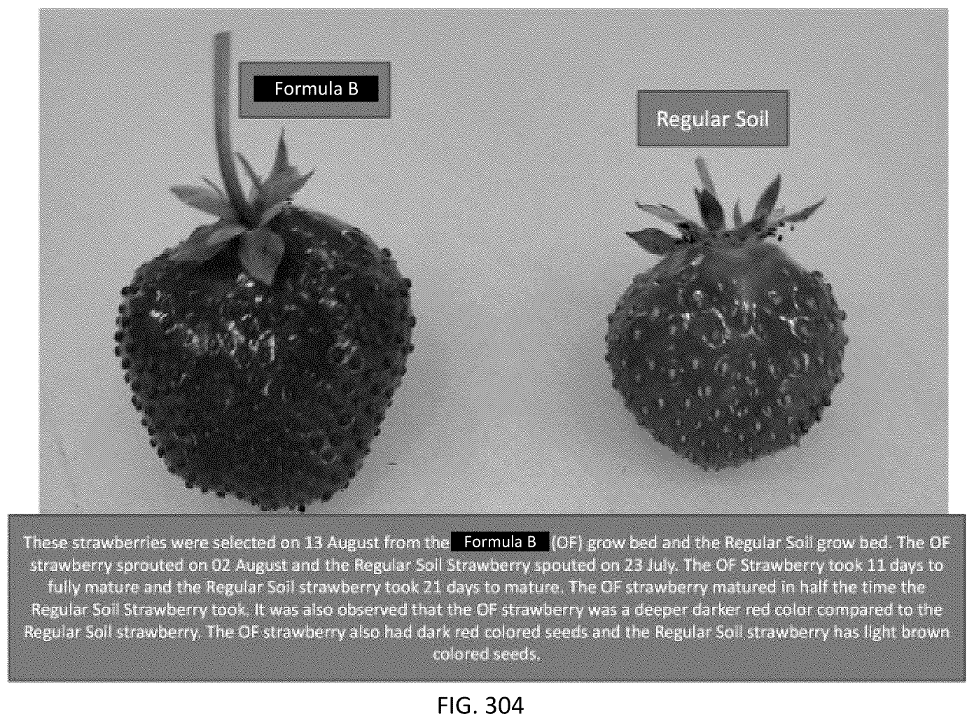

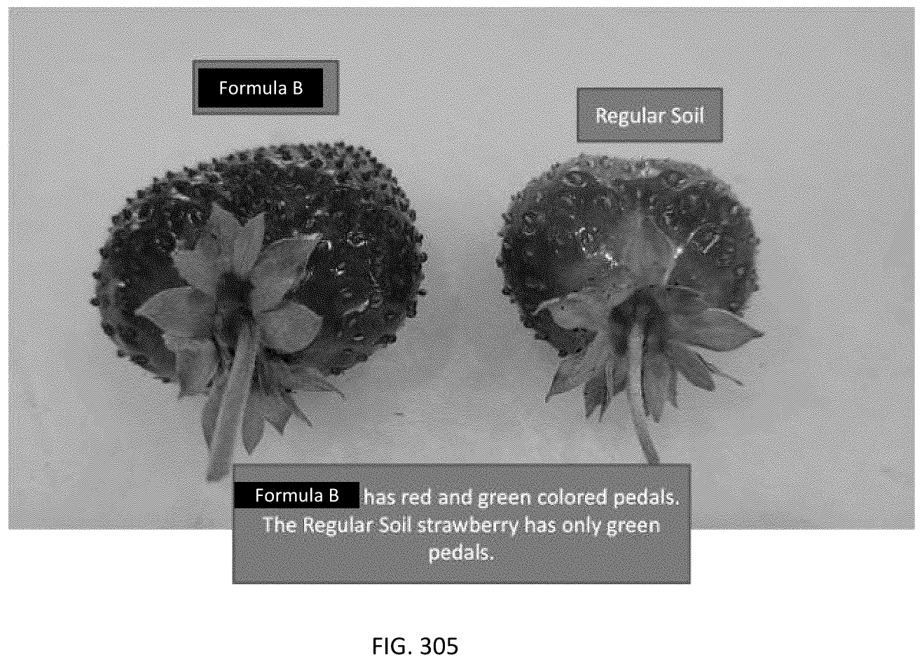

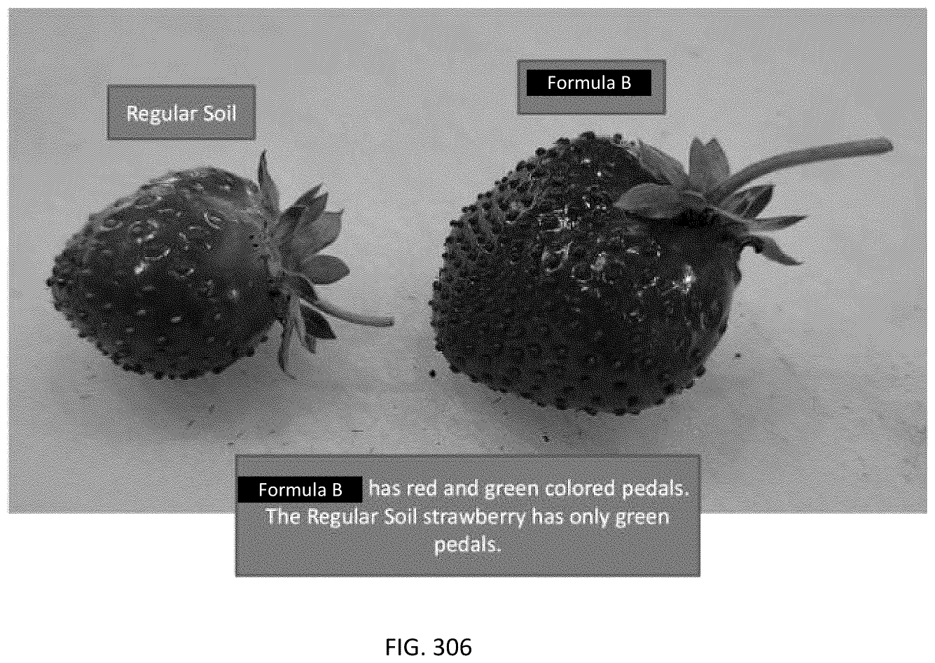

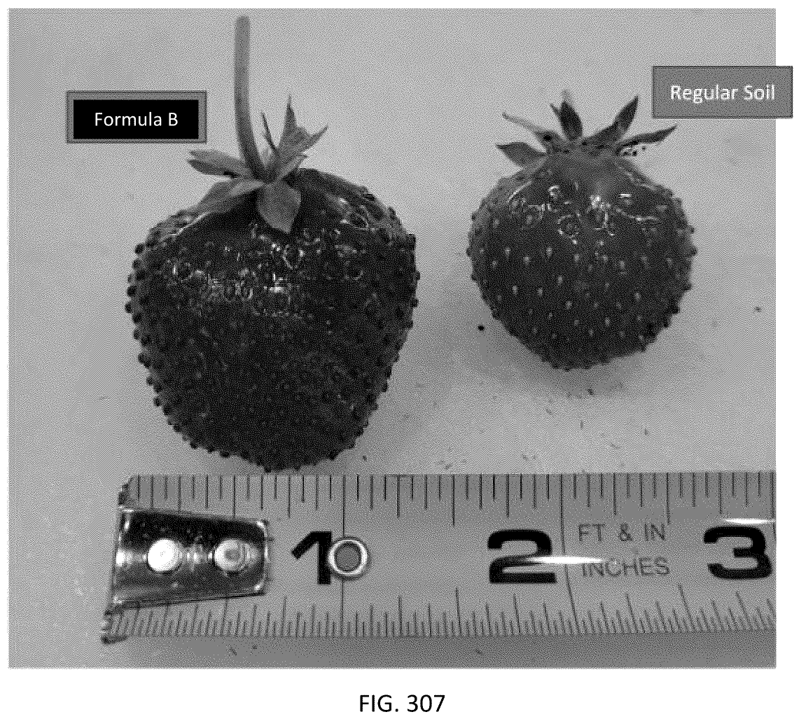

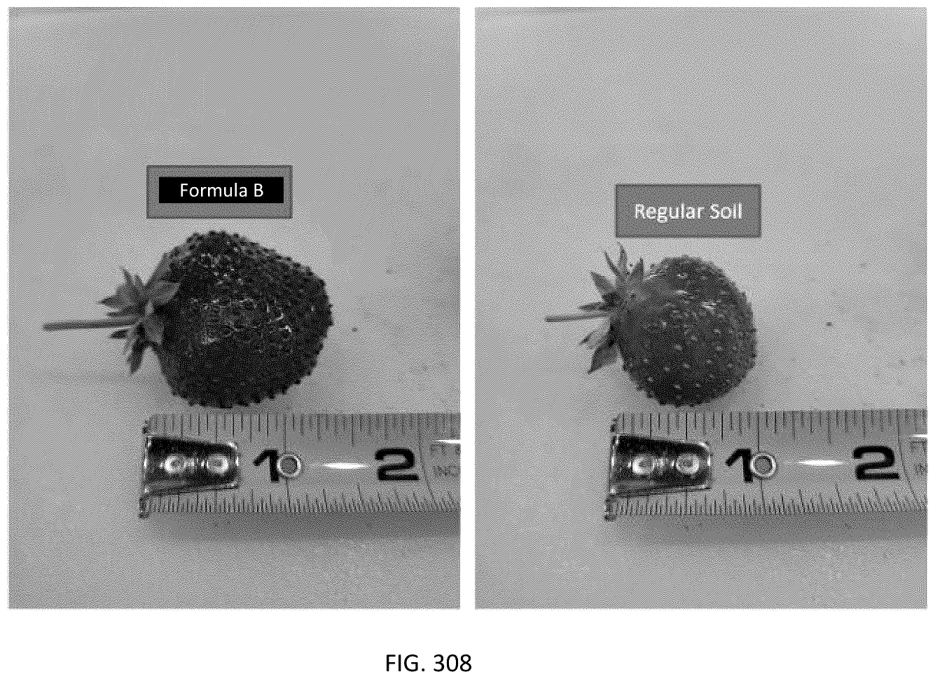

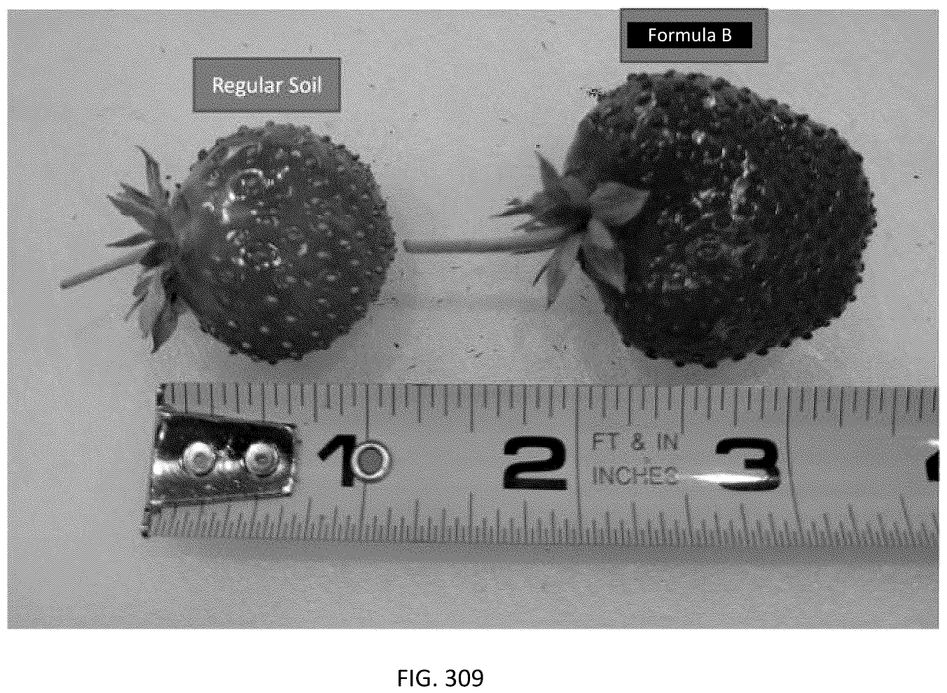

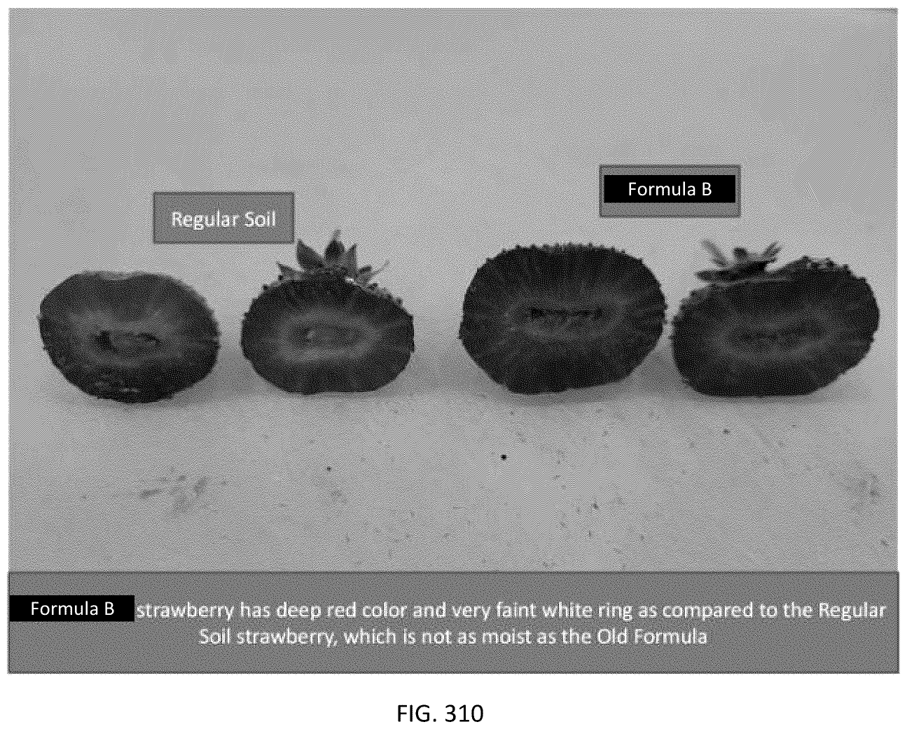

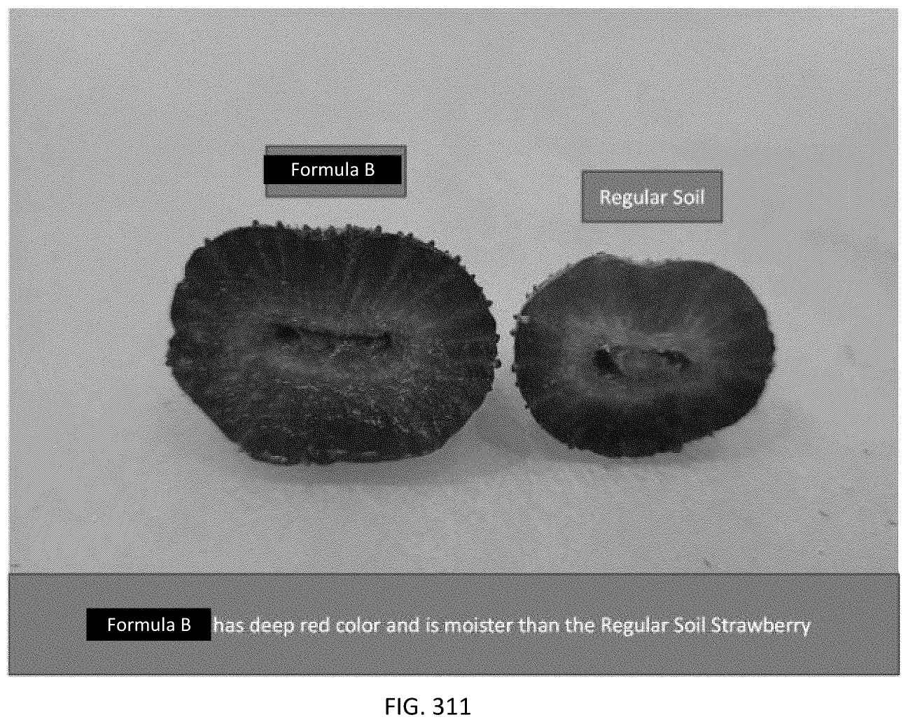

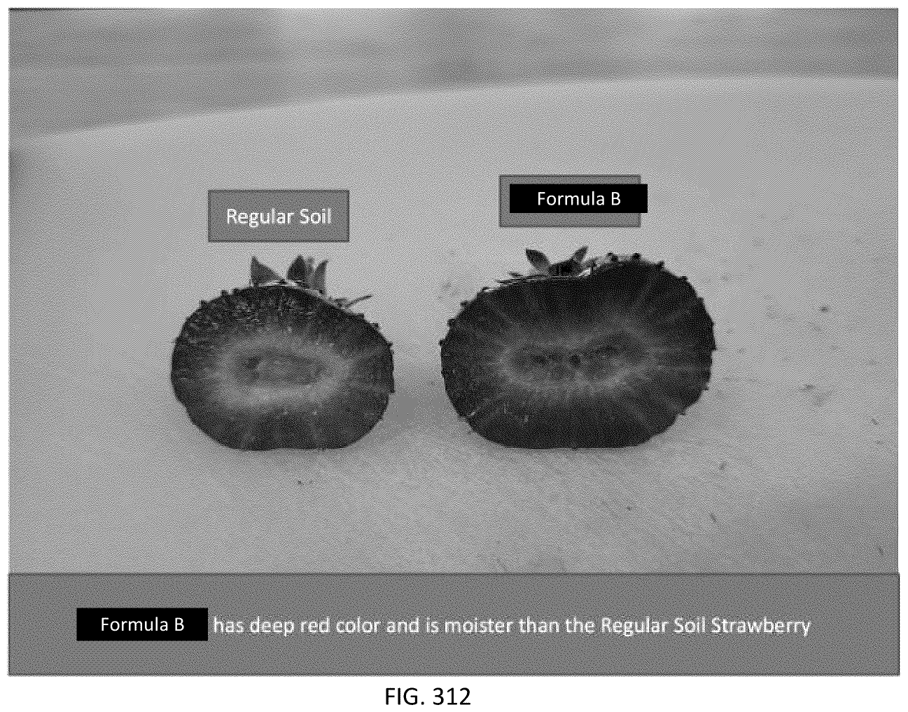

The Formula B strawberry sprouted on August 2 and was ripe to pick on August 13 and the regular Soil strawberry sprouted on July 23. The Formula B strawberry matured in half the time the regular Soil strawberry took to mature; the Formula B strawberry took 11 days to fully mature and the regular Soil strawberry took 21 days to mature. The strawberry that used regular Soil was green in color for 2 weeks until changing to red, while the Formula B strawberry began changing to a red color in about 1 week. The Formula B strawberry was a deeper darker red color compared to the strawberry from regular Soil. The Formula B strawberry had dark red colored seeds and the regular Soil strawberry had light brown colored seeds (FIG. 304). The Formula B strawberry had red and green colored petals, whereas the regular Soil strawberry had only green colored petals (FIGS. 305 and 306). The stem and petals were also larger on the strawberry with Formula B. FIGS. 307-309 show the sizes of the strawberries. The strawberry with Formula B measured 50% larger than the strawberry that used regular Soil. The Formula B strawberry had a deep red color and a very faint white ring as compared to the Regular Soil strawberry, which was not as moist as the Formula B strawberry (FIGS. 310-312). The strawberry with Formula B was much moister and juicier than the strawberry that used regular Soil.

### Example 17: Comparison of Strawberries from Formula A, Formula B, and Regular Soil

Strawberries were harvested on August 18 from the Formula A, Formula B, and regular Soil grow beds. They were the same species of strawberry plant, grown in the same soil, and received the same watering amount of 10 minutes, twice a day at 6 am and 6 pm. They also received the same amount of sunlight. All inputs were identical except for using Formula A, Formula B, and regular Soil for the strawberry plants.

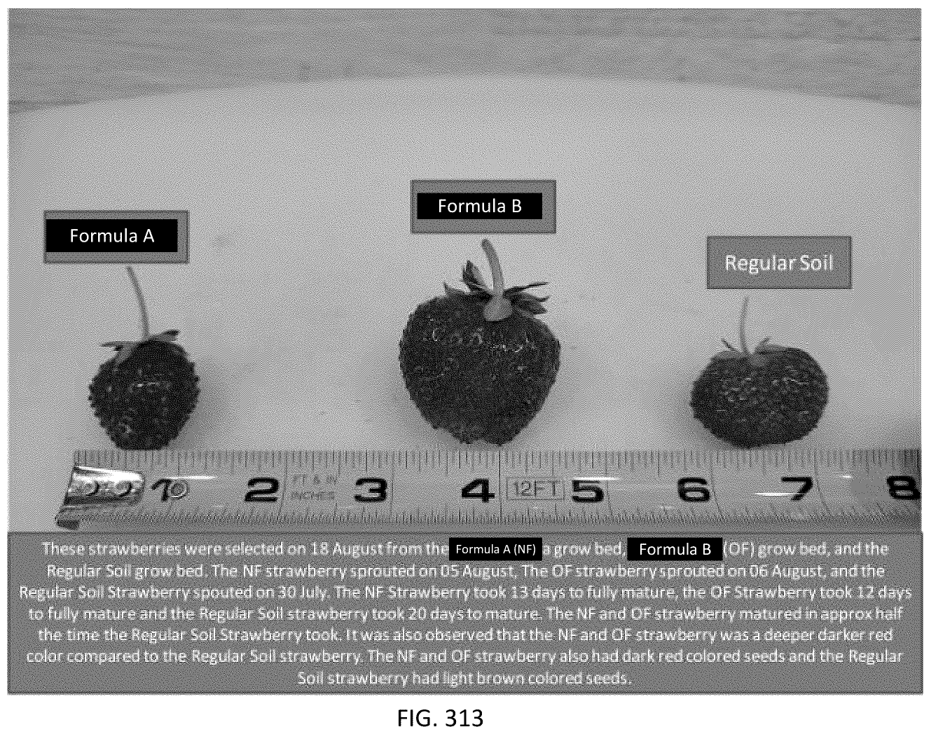

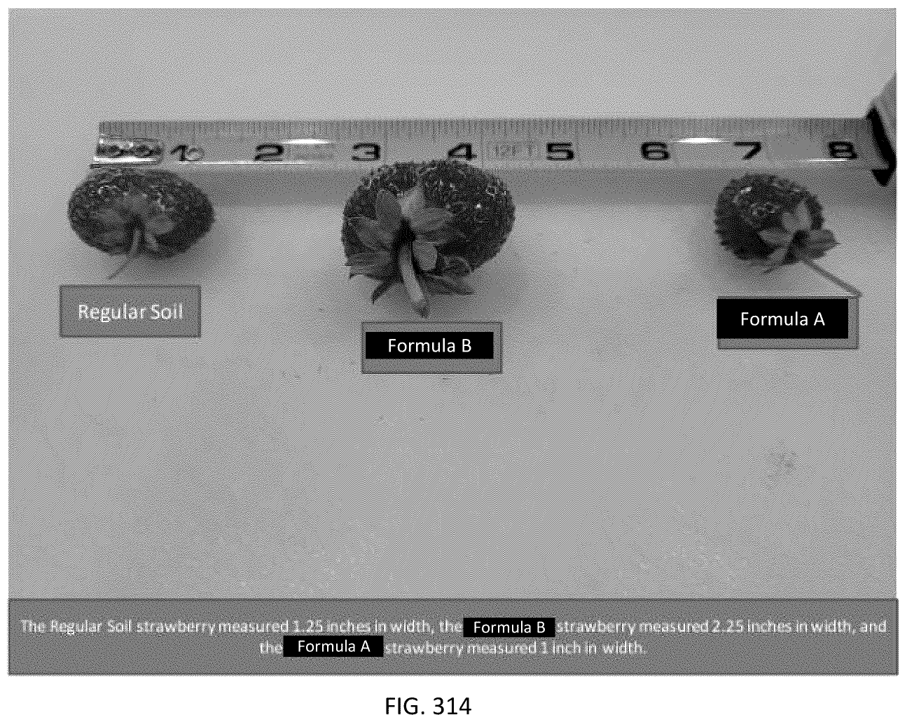

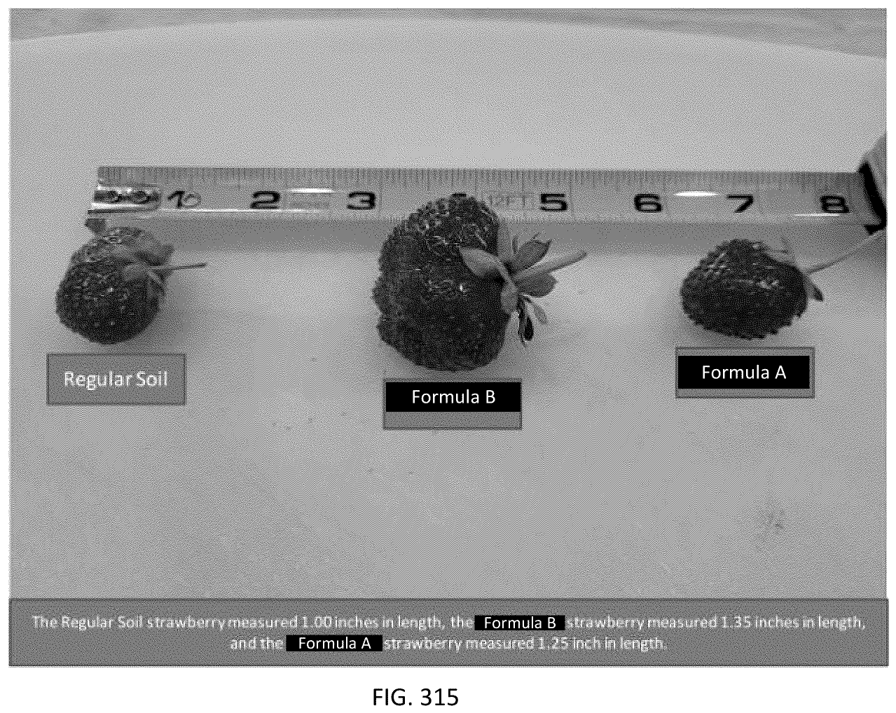

The Formula A strawberry sprouted on August 5, the Formula B strawberry on August 6, and the regular Soil strawberry on July 30. The Formula A strawberry took 13 days to fully mature, the Formula B strawberry 12 days to fully mature, and the regular Soil strawberry 20 days to mature. The New and Formula B strawberries matured in about half the time taken by the regular Soil strawberry. The New and Formula B strawberries had a deeper darker red color compared to the regular Soil strawberry (FIG. 313). The seed color on the New and Formula B strawberries was dark red while the regular Soil strawberry had light brown seeds (FIG. 313). The regular Soil, Formula B, and Formula A strawberries measured 1.25 inches, 2.25 inches, and 1 inch in width, respectively (FIG. 314). For length, the regular Soil, Formula B, and Formula A strawberries measured 1 inch, 1.35 inches, and 1.25 inches, respectively (FIG. 315). The strawberry using Formula B measured 50% larger than the strawberry using regular Soil.

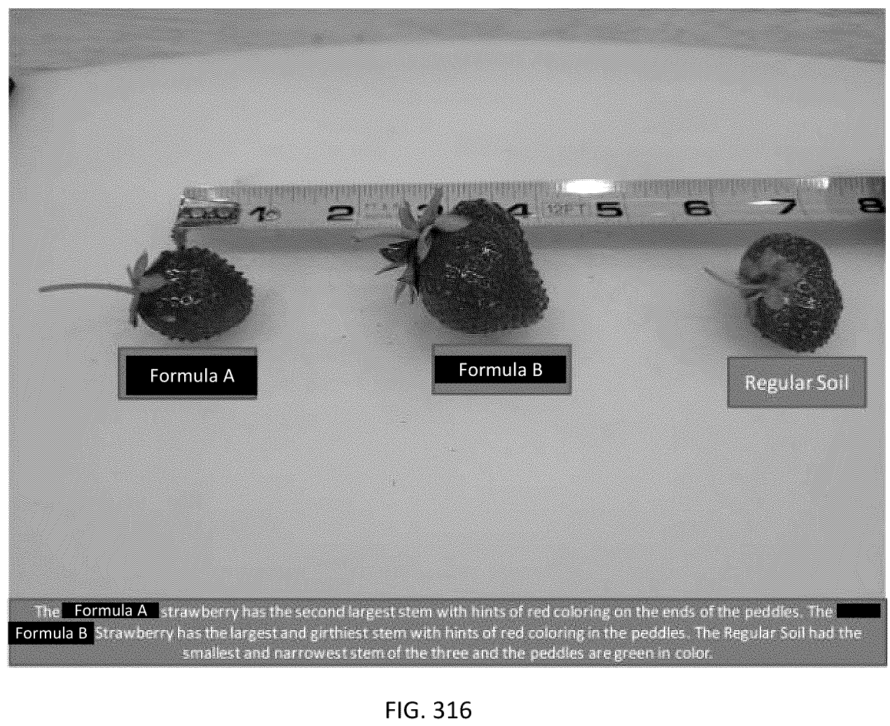

The Formula A strawberry had the second largest stem with hints of red coloring on the ends of the petals. The Formula B strawberry had the largest and girthiest stem with hints of red in the petals. The regular Soil strawberry had the smallest and narrowest stem and the petals were green in color (FIG. 316). The petals were larger on strawberries using Formula A or Formula B than those on strawberries that used regular Soil.

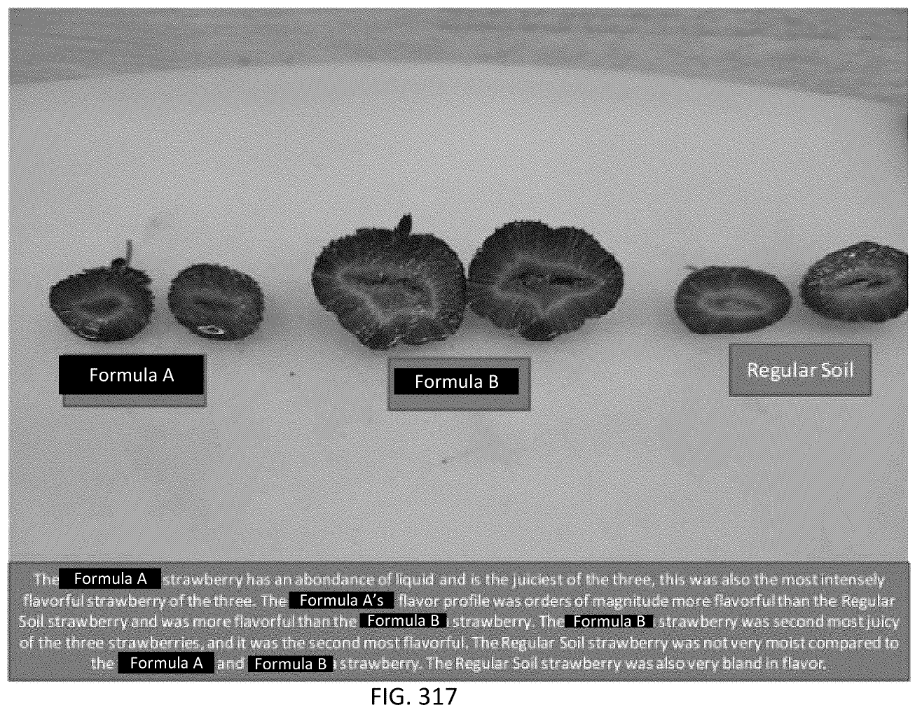

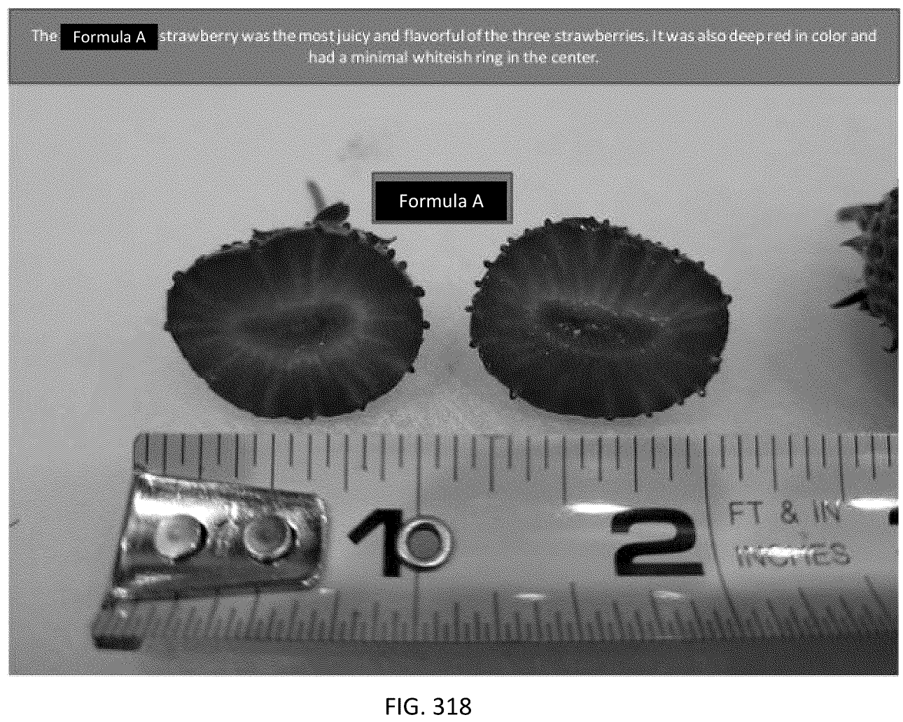

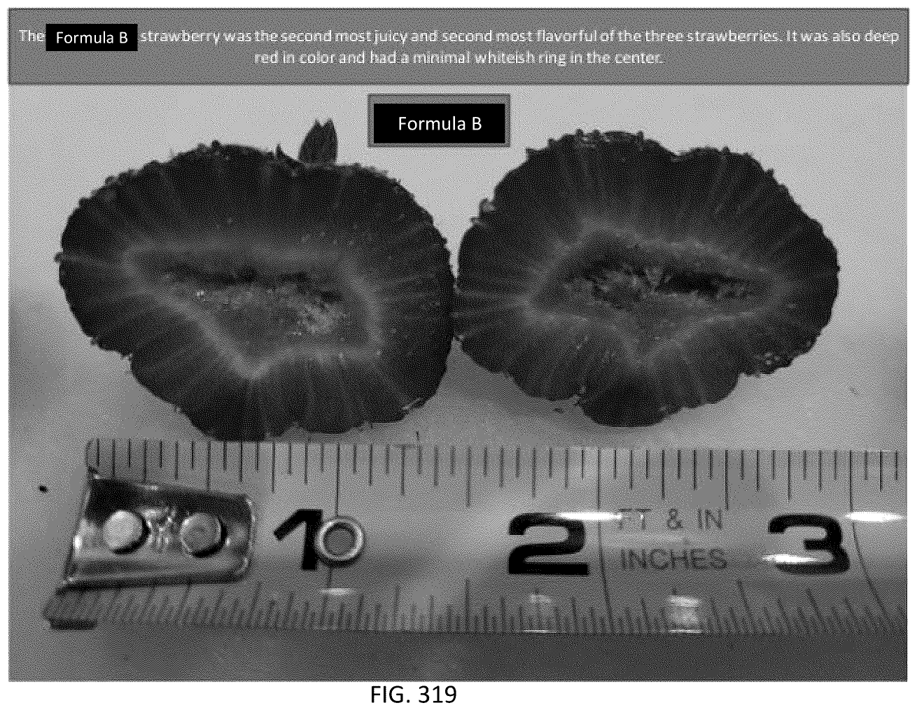

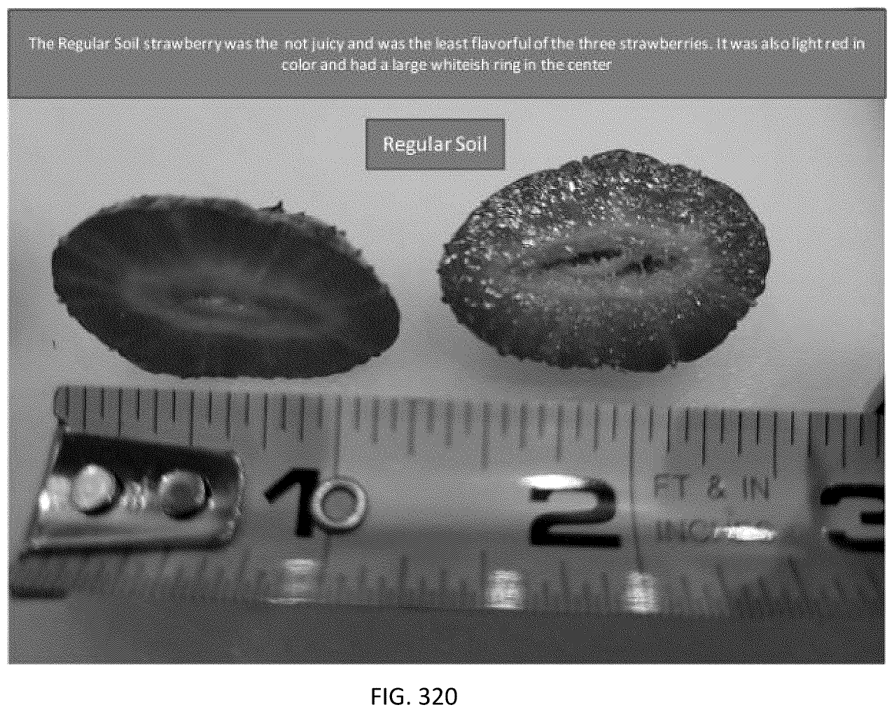

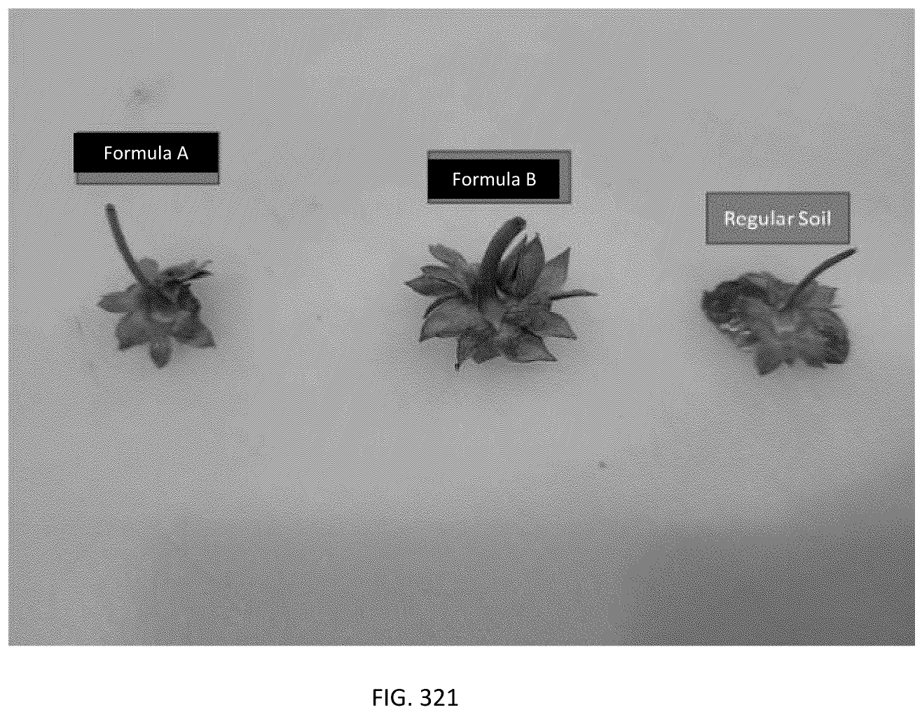

The Formula A strawberry had an abundance of liquid and was the juiciest and most intensely flavorful. The Formula A strawberry flavor profile was orders of magnitude more flavorful than the regular Soil strawberry, and more flavorful than the Formula B strawberry. The Formula B strawberry was the second most juicy and second most flavorful. It was deep red in color and had minimal whiteish ring in the center (FIG. 317). The regular Soil strawberry was not very moist compared to the Formula A and Formula B strawberries. The regular Soil strawberry was very bland in flavor, was light red in color, and had a large whiteish ring in the center (FIG. 317).

### Example 18: Soil Health Assessment

Samples were collected and tested for soil health at Ward Laboratories, Inc.

TABLE 36A

| | 1:1 | WDRF | 1:1 S | | Organic |
|---|---|---|---|---|---|
| | Soil | Buffer | Salts | Excess | Matter |
| Sample ID | pH | pH | mmho/cm | Lime | LOI % |
| BEETS-MMT | 7 | 7.2 | 0.08 | NONE | 23.2 |
| BEETS-PGPG-PGPR | 7 | 7.2 | 0.08 | NONE | 21.9 |
| BEETS-NF | 7 | 7.2 | 0.08 | NONE | 22.2 |
| BEETS-OF | 7.1 | 7.2 | 0.09 | NONE | 19.9 |
| BEETS-SOIL | 7.1 | 7.2 | 0.1 | NONE | 22.8 |
| BELL PEPPERS-MMT | 7.1 | 7.2 | 0.11 | NONE | 22.7 |
| BELL PEPPERS- | 7.2 | 7.2 | 0.1 | NONE | 22 |
| PGPF/PGPR | | | | | |
| BELL PEPPERS-NF | 7.2 | 7.2 | 0.11 | NONE | 20.4 |
| BELL PEPPERS-OF | 7.1 | 7.2 | 0.13 | NONE | 24.1 |
| BELL PEPPERS-SOIL | 7.2 | 7.2 | 0.1 | NONE | 23.1 |
| TOMATO-MMT | 7.1 | 7.2 | 0.13 | NONE | 23 |
| TOMATO-PGPF/PGPR | 7.2 | 7.2 | 0.1 | NONE | 22.3 |
| TOMATO-NF | 7.2 | 7.2 | 0.09 | NONE | 23 |
| TOMATO-OF | 7 | 7.2 | 0.14 | NONE | 20.2 |
| TOMATO-SOIL | 7.2 | 7.2 | 0.13 | NONE | 20 |
| CARROTS-MMT | 7.2 | 7.2 | 0.14 | NONE | 23.9 |
| CARROTS-PGPF/PGPR | 7.1 | 7.2 | 0.13 | NONE | 24.7 |
| CARROTS-NF | 7.1 | 7.2 | 0.13 | NONE | 23.6 |
| CARROTS-OF | 6.9 | 7.2 | 0.14 | NONE | 20.7 |
| CARROTS-SOIL | 7.1 | 7.2 | 0.12 | NONE | 23.4 |

TABLE 36B

| | Olsen P | Potassium | Sulfate-S | Zinc ppm | Iron ppm | Manganese |
|---|---|---|---|---|---|---|
| Sample ID | ppm P | ppm K | ppm S | Zn | Fe | ppm Mn |
| BEETS-MMT | 96.6 | 137 | 9.3 | 11.51 | 142.2 | 8.3 |
| BEETS-PGPG-PGPR | 110.8 | 119 | 9.2 | 12.84 | 140.7 | 8.1 |
| BEETS-NF | 109.3 | 122 | 9.7 | 11.98 | 139.6 | 7.3 |
| BEETS-OF | 96.3 | 136 | 10 | 10.51 | 147.5 | 8.4 |
| BEETS-SOIL | 107.7 | 138 | 9.5 | 11.04 | 146.7 | 7.2 |
| BELL PEPPERS-MMT | 110.9 | 139 | 11.3 | 13.15 | 166 | 9.7 |
| BELL PEPPERS- | 104.5 | 143 | 11.8 | 12.24 | 140.9 | 7.5 |
| PGPF/PGPR | | | | | | |
| BELL PEPPERS-NF | 105.1 | 134 | 21.2 | 11.87 | 148.6 | 8.3 |
| BELL PEPPERS-OF | 114 | 151 | 12.5 | 13.48 | 159.6 | 7.2 |
| BELL PEPPERS-SOIL | 98.5 | 140 | 12.4 | 11.56 | 152.3 | 8.7 |
| TOMATO-MMT | 99.6 | 151 | 17 | 11.37 | 143 | 8.7 |
| TOMATO- | 108.7 | 142 | 11.3 | 15.66 | 148.5 | 8 |
| PGPF/PGPR | | | | | | |
| TOMATO-NF | 97.7 | 131 | 10.6 | 12.45 | 155.3 | 8.1 |
| TOMATO-OF | 107.2 | 111 | 14.9 | 16.77 | 174.5 | 20.4 |
| TOMATO-SOIL | 111.7 | 135 | 10.8 | 11.36 | 143.8 | 7.4 |
| CARROTS-MMT | 101.8 | 124 | 10.9 | 14.3 | 170.6 | 8.7 |
| CARROTS- | 104.3 | 112 | 12.6 | 11.61 | 150 | 7.6 |
| PGPF/PGPR | | | | | | |
| CARROTS-NF | 140.4 | 138 | 15.8 | 12.58 | 156.5 | 8 |
| CARROTS-OF | 91.1 | 97 | 18.7 | 11.06 | 155.5 | 9 |
| CARROTS-SOIL | 107.1 | 111 | 13 | 12.17 | 158 | 8.3 |

TABLE 36C

| | Copper | Calcium | Magnesium | Sodium | CEC/Sum of |
|---|---|---|---|---|---|
| | ppm | ppm | ppm | ppm | Cations |
| Sample ID | Cu | Ca | Mg | Na | me/100 g |
| BEETS-MMT | 1.29 | 2908 | 175 | 24 | 16.5 |
| BEETS-PGPG-PGPR | 1.35 | 2695 | 156 | 22 | 15.2 |
| BEETS-NF | 1.22 | 2638 | 145 | 19 | 14.8 |
| BEETS-OF | 1.23 | 2607 | 142 | 21 | 14.7 |
| BEETS-SOIL | 1.29 | 2922 | 183 | 23 | 16.6 |
| BELL PEPPERS-MMT | 1.47 | 3331 | 195 | 27 | 18.8 |
| BELL PEPPERS-PGPF/PGPR | 1.27 | 3085 | 176 | 23 | 17.4 |
| BELL PEPPERS-NF | 1.44 | 3017 | 200 | 25 | 17.2 |
| BELL PEPPERS-OF | 1.35 | 3075 | 174 | 26 | 17.3 |
| BELL PEPPERS-SOIL | 1.4 | 3401 | 196 | 27 | 19.1 |
| TOMATO-MMT | 1.47 | 2920 | 169 | 23 | 16.5 |
| TOMATO-PGPF/PGPR | 1.42 | 3105 | 180 | 23 | 17.5 |
| TOMATO-NF | 1.3 | 3070 | 184 | 22 | 17.3 |
| TOMATO-OF | 1.67 | 2810 | 165 | 22 | 15.8 |
| TOMATO-SOIL | 1.12 | 3536 | 223 | 28 | 20 |
| CARROTS-MMT | 1.74 | 3055 | 168 | 24 | 17.1 |
| CARROTS-PGPF/PGPR | 1.25 | 2826 | 172 | 24 | 15.9 |
| CARROTS-NF | 1.23 | 3127 | 217 | 31 | 17.9 |
| CARROTS-OF | 1.27 | 2888 | 181 | 41 | 16.4 |
| CARROTS-SOIL | 1.3 | 2725 | 168 | 25 | 15.4 |

TABLE 36D

| | % H | % K | % Ca | % Mg | % Na |
|---|---|---|---|---|---|
| Sample ID | Sat | Sat | Sat | Sat | Sat |
| BEETS-MMT | 0 | 2 | 88 | 9 | 1 |
| BEETS-PGPG-PGPR | 0 | 2 | 88 | 9 | 1 |
| BEETS-NF | 0 | 2 | 89 | 8 | 1 |
| BEETS-OF | 0 | 2 | 89 | 8 | 1 |
| BEETS-SOIL | 0 | 2 | 88 | 9 | 1 |
| BELL PEPPERS-MMT | 0 | 2 | 88 | 9 | 1 |
| BELL PEPPERS-PGPF/PGPR | 0 | 2 | 89 | 8 | 1 |
| BELL PEPPERS-NF | 0 | 2 | 87 | 10 | 1 |
| BELL PEPPERS-OF | 0 | 2 | 89 | 8 | 1 |
| BELL PEPPERS-SOIL | 0 | 2 | 88 | 9 | 1 |
| TOMATO-MMT | 0 | 2 | 88 | 9 | 1 |
| TOMATO-PGPF/PGPR | 0 | 2 | 88 | 9 | 1 |
| TOMATO-NF | 0 | 2 | 88 | 9 | 1 |
| TOMATO-OF | 0 | 2 | 88 | 9 | 1 |
| TOMATO-SOIL | 0 | 2 | 88 | 9 | 1 |
| CARROTS-MMT | 0 | 2 | 89 | 8 | 1 |
| CARROTS-PGPF/PGPR | 0 | 2 | 88 | 9 | 1 |
| CARROTS-NF | 0 | 2 | 87 | 10 | 1 |
| CARROTS-OF | 0 | 2 | 88 | 9 | 1 |
| CARROTS-SOIL | 0 | 2 | 88 | 9 | 1 |

TABLE 36E

| | Nitrogen | P2O5 | K2O | Sulfur | Zinc | Magnesium | Iron | Manganese |
|---|---|---|---|---|---|---|---|---|
| Sample ID | Rec | Rec | Rec | Rec | Rec | Rec | Rec | Rec |
| BEETS-MMT | 45 | 0 | 40 | 0 | 0 | 0 | 0 | 0 |
| BEETS-PGPG-PGPR | 35 | 0 | 50 | 0 | 0 | 0 | 0 | 0 |
| BEETS-NF | 50 | 0 | 45 | 0 | 0 | 0 | 0 | 0 |
| BEETS-OF | 40 | 0 | 40 | 0 | 0 | 0 | 0 | 0 |
| BEETS-SOIL | 45 | 0 | 40 | 0 | 0 | 0 | 0 | 0 |
| BELL PEPPERS-MMT | 35 | 0 | 35 | 0 | 0 | 0 | 0 | 0 |
| BELL PEPPERS- | 40 | 0 | 35 | 0 | 0 | 0 | 0 | 0 |
| PGPF/PGPR | | | | | | | | |
| BELL PEPPERS-NF | 35 | 0 | 40 | 0 | 0 | 0 | 0 | 0 |
| BELL PEPPERS-OF | 20 | 0 | 30 | 0 | 0 | 0 | 0 | 0 |
| BELL PEPPERS-SOIL | 15 | 0 | 35 | 0 | 0 | 0 | 0 | 0 |
| TOMATO-MMT | 5 | 0 | 30 | 0 | 0 | 0 | 0 | 0 |
| TOMATO- | 30 | 0 | 35 | 0 | 0 | 0 | 0 | 0 |
| PGPF/PGPR | | | | | | | | |
| TOMATO-NF | 40 | 0 | 40 | 0 | 0 | 0 | 0 | 0 |
| TOMATO-OF | 35 | 0 | 55 | 0 | 0 | 0 | 0 | 0 |
| TOMATO-SOIL | 25 | 0 | 40 | 0 | 0 | 0 | 0 | 0 |
| CARROTS-MMT | 40 | 0 | 45 | 0 | 0 | 0 | 0 | 0 |
| CARROTS- | 40 | 0 | 55 | 0 | 0 | 0 | 0 | 0 |
| PGPF/PGPR | | | | | | | | |
| CARROTS-NF | 25 | 0 | 40 | 0 | 0 | 0 | 0 | 0 |
| CARROTS-OF | 25 | 0 | 65 | 0 | 0 | 0 | 0 | 0 |
| CARROTS-SOIL | 35 | 0 | 55 | 0 | 0 | 0 | 0 | 0 |

TABLE 36F

| | | | | | | | | Water |
|---|---|---|---|---|---|---|---|---|
| | | | Organic | Organic | Organic | | | Stable |
| | Copper | H2O | C H2O | N H2O | C:N | H2O | CO2 Soil | Aggregates |
| Sample ID | Rec | NO3—N | ppm | ppm | H2O | NH4—N | Respiration | (Mod) |
| BEETS-MMT | 0 | 2.22 | 259 | 13.9 | 18.6 | 1.1 | 503.7 | 98 |
| BEETS-PGPG-PGPR | 0 | 1.13 | 247 | 17.9 | 13.8 | 1.8 | 520 | 98 |
| BEETS-NF | 0 | 0.8 | 231 | 13.8 | 16.7 | 0.9 | 555 | 99 |
| BEETS-OF | 0 | 1.7 | 287 | 16.4 | 17.5 | 1.4 | 629 | 97 |
| BEETS-SOIL | 0 | 1.61 | 226 | 14.1 | 16 | 1.4 | 489.6 | 99 |
| BELL PEPPERS- | 0 | 0.8 | 303 | 19.4 | 15.6 | 1.9 | 656.5 | 97 |
| MMT | | | | | | | | |
| BELL PEPPERS- | 0 | 0.82 | 275 | 18.1 | 15.1 | 1.3 | 654.9 | 98 |
| PGPF/PGPR | | | | | | | | |
| BELL PEPPERS-NF | 0 | 0.69 | 305 | 19.2 | 15.9 | 1.4 | 558.2 | 97 |
| BELL PEPPERS-OF | 0 | 1.06 | 419 | 25.1 | 16.7 | 1.4 | 699.4 | 98 |
| BELL PEPPERS-SOIL | 0 | 1.54 | 290 | 25.6 | 11.3 | 1.6 | 615.6 | 97 |
| TOMATO-MMT | 0 | 2.61 | 307 | 27.6 | 11.1 | 2.7 | 644.5 | 98 |
| TOMATO- | 0 | 1.3 | 280 | 20.3 | 13.8 | 2.4 | 530.5 | 97 |
| PGPF/PGPR | | | | | | | | |
| TOMATO-NF | 0 | 0.8 | 281 | 16.4 | 17.1 | 2.9 | 527 | 96 |
| TOMATO-OF | 0 | 2.11 | 273 | 17.7 | 15.5 | 1.8 | 637.4 | 98 |
| TOMATO-SOIL | 0 | 1.43 | 278 | 22 | 12.6 | 1.6 | 567.8 | 98 |
| CARROTS-MMT | 0 | 0.62 | 275 | 17.2 | 16 | 1.1 | 594.3 | 96 |
| CARROTS- | 0 | 4.04 | 304 | 11.8 | 25.7 | 2.5 | 698.5 | 98 |
| PGPF/PGPR | | | | | | | | |
| CARROTS-NF | 0 | 0.6 | 429 | 23.8 | 18 | 1.6 | 797.1 | 98 |
| CARROTS-OF | 0 | 0.63 | 462 | 23.4 | 19.8 | 1.3 | 825.5 | 98 |
| CARROTS-SOIL | 0 | 0.79 | 314 | 19.5 | 16.1 | 1.9 | 787.3 | 97 |

TABLE 36G

| | Total | | | | | | |
|---|---|---|---|---|---|---|---|
| | N | | Microbially | Organic | Organic | | |
| | H2O | Soil | Active | Nitrogen | Nitrogen | | |
| | ppm | Health | Carbon | Release | Reserve | B | |
| Sample ID | N | Score | (% MA | ppm N | ppm N | Depth | E Depth |
| BEETS-MMT | 17.3 | 34.45 | 194.2 | 13.9 | 0 | 0 | 8 |
| BEETS-PGPG-PGPR | 20.8 | 34.99 | 210.4 | 17.9 | 0 | 0 | 8 |
| BEETS-NF | 15.5 | 35.06 | 240.4 | 13.8 | 0 | 0 | 8 |
| BEETS-OF | 19.5 | 37.93 | 219.3 | 16.4 | 0 | 0 | 8 |
| BEETS-SOIL | 17.1 | 33.44 | 217 | 14.1 | 0 | 0 | 8 |
| BELL PEPPERS- | 22.1 | 39.08 | 216.5 | 19.4 | 0 | 0 | 8 |
| MMT | | | | | | | |
| BELL PEPPERS- | 20.2 | 38.34 | 238.6 | 18.1 | 0 | 0 | 8 |
| PGPF/PGPR | | | | | | | |
| BELL PEPPERS-NF | 21.3 | 37.15 | 183 | 19.2 | 0 | 0 | 8 |
| BELL PEPPERS-OF | 27.5 | 42.69 | 167.1 | 25.1 | 0 | 0 | 8 |
| BELL PEPPERS-SOIL | 28.7 | 38.66 | 212.6 | 25.6 | 0 | 0 | 8 |
| TOMATO-MMT | 32.9 | 39.74 | 210.2 | 27.6 | 0 | 0 | 8 |
| TOMATO- | 24 | 36.13 | 189.7 | 20.3 | 0 | 0 | 8 |
| PGPF/PGPR | | | | | | | |
| TOMATO-NF | 20.1 | 35.68 | 187.7 | 16.4 | 0 | 0 | 8 |
| TOMATO-OF | 21.6 | 37.95 | 233.2 | 17.7 | 0 | 0 | 8 |
| TOMATO-SOIL | 25 | 37.1 | 204.2 | 22 | 0 | 0 | 8 |
| CARROTS-MMT | 18.9 | 37.1 | 216.4 | 17.2 | 0 | 0 | 8 |
| CARROTS- | 18.3 | 39.06 | 229.8 | 11.8 | 0 | 0 | 8 |
| PGPF/PGPR | | | | | | | |
| CARROTS-NF | 26 | 44.25 | 185.8 | 23.8 | 0 | 0 | 8 |
| CARROTS-OF | 25.3 | 45.25 | 178.8 | 23.4 | 0 | 0 | 8 |
| CARROTS-SOIL | 22.2 | 41.39 | 250.5 | 19.5 | 0 | 0 | 8 |

### Example 19: Biological Phospholipid Fatty Acid (PLFA) Reports

Samples were collected and tested for biological phospholipid fatty acids at Ward Laboratories, Inc.

TABLE 37A
PLFA Report for Beets, Carrots, Tomatoes, and Bell Peppers

| | | | | Total | | |
|---|---|---|---|---|---|---|
| | Total | Diversity | Bacteria | Bacteria | Actinomycetes | Actinomycetes |
| Sample ID | Biomass | Index | % | Biomass | % | Biomass |
| BEETS-MMT | 2623.92 | 1.525 | 50.91 | 1335.85 | 6.5 | 170.52 |
| BEETS-PGPF/PGPR | 3600.05 | 1.556 | 49.99 | 1799.81 | 8.24 | 296.5 |
| BEETS-NF | 1959.18 | 1.506 | 44.86 | 878.85 | 6.13 | 120.04 |
| BEETS-OF | 2764.42 | 1.488 | 47.31 | 1307.96 | 5.89 | 162.82 |
| BEETS-SOIL | 3685.15 | 1.54 | 50.09 | 1845.91 | 7.75 | 285.76 |
| BELL PEPPERS-MMT | 2130.15 | 1.473 | 44.67 | 951.59 | 5.91 | 125.84 |
| BELL PEPPERS- | 2921.82 | 1.567 | 48.12 | 1405.94 | 6.83 | 199.57 |
| PGPF/PGPR | | | | | | |
| BELL PEPPERS-NF | 3033.2 | 1.551 | 48.93 | 1484.12 | 8.17 | 247.73 |
| BELL PEPPERS-OF | 3707.85 | 1.566 | 46.02 | 1706.51 | 6.88 | 255.22 |
| BELL PEPPERS-SOIL | 2767.97 | 1.515 | 45.82 | 1268.33 | 6.7 | 185.35 |
| TOMATO-MMT | 2684.51 | 1.542 | 45.16 | 1212.34 | 6.39 | 171.54 |
| TOMATO- | 3884.51 | 1.578 | 44.7 | 1736.32 | 6.69 | 259.82 |
| PGPF/PGPR | | | | | | |
| TOMATO-NF | 3685.82 | 1.579 | 46.7 | 1721.34 | 7.46 | 274.9 |
| TOMATO-OF | 3296.68 | 1.531 | 48.77 | 1607.91 | 8.09 | 266.75 |
| TOMATO-SOIL | 3613.18 | 1.515 | 46.48 | 1679.45 | 7.5 | 270.87 |
| CARROTS-MMT | 2477.05 | 1.517 | 44.17 | 1094.05 | 6.66 | 165.07 |
| CARROTS- | 3099.19 | 1.547 | 47.35 | 1467.41 | 6.67 | 206.83 |
| PGPF/PGPR | | | | | | |
| CARROTS-NF | 3537.55 | 1.607 | 41.37 | 1463.62 | 6.14 | 217.34 |
| CARROTS-OF | 1666.89 | 1.525 | 47.36 | 789.49 | 6.53 | 108.92 |
| CARROTS-SOIL | 1491.33 | 1.458 | 44.19 | 658.95 | 6.22 | 92.75 |

TABLE 37B
PLFA Report for Beets, Carrots, Tomatoes, and Bell Peppers

| | Gram (−) | Gram (−) | | Rhizobia | Total | Total Fungi |
|---|---|---|---|---|---|---|
| Sample ID | % | Biomass | Rhizobia % | Biomass | Fungi % | Biomass |
| BEETS-MMT | 28.67 | 752.38 | 0.53 | 13.98 | 17.39 | 456.42 |
| BEETS-PGPF/PGPR | 23.68 | 852.46 | 0 | 0 | 21.12 | 760.44 |
| BEETS-NF | 22.88 | 448.2 | 0 | 0 | 14.24 | 279.04 |
| BEETS-OF | 26.49 | 732.2 | 0 | 0 | 16.64 | 460.01 |
| BEETS-SOIL | 24.39 | 898.64 | 0.37 | 13.46 | 20.42 | 752.65 |
| BELL PEPPERS-MMT | 22.8 | 485.78 | 0 | 0 | 16.42 | 349.82 |
| BELL PEPPERS- | 25.43 | 742.91 | 0.51 | 14.93 | 20.19 | 589.89 |
| PGPF/PGPR | | | | | | |
| BELL PEPPERS-NF | 22.88 | 694.03 | 0.41 | 12.38 | 20.03 | 607.6 |
| BELL PEPPERS-OF | 23.47 | 870.18 | 0.28 | 10.45 | 26.81 | 994.11 |
| BELL PEPPERS-SOIL | 23.12 | 640.06 | 0 | 0 | 15.75 | 436.05 |
| TOMATO-MMT | 22.9 | 614.62 | 0 | 0 | 19.54 | 524.58 |
| TOMATO- | 22.89 | 889.14 | 0.39 | 14.97 | 21.68 | 842.07 |
| PGPF/PGPR | | | | | | |
| TOMATO-NF | 22.21 | 818.52 | 0.35 | 12.8 | 20.43 | 753.06 |
| TOMATO-OF | 23.37 | 770.3 | 0.34 | 11.37 | 17.2 | 567.09 |
| TOMATO-SOIL | 22.22 | 802.72 | 0 | 0 | 19.04 | 687.97 |
| CARROTS-MMT | 20.99 | 520.01 | 0 | 0 | 14.77 | 365.76 |
| CARROTS- | 25.65 | 794.91 | 0.42 | 13.13 | 20.22 | 626.63 |
| PGPF/PGPR | | | | | | |
| CARROTS-NF | 20.58 | 727.98 | 0.31 | 10.88 | 25.78 | 911.84 |
| CARROTS-OF | 21.23 | 353.94 | 0 | 0 | 16.4 | 273.43 |
| CARROTS-SOIL | 21.9 | 326.66 | 0 | 0 | 14.62 | 217.99 |

TABLE 37C
PLFA Report for Beets, Carrots, Tomatoes, and Bell Peppers

| | Arbusular | Arbuscular | | | | |
|---|---|---|---|---|---|---|
| | Mycorrhizal | Mycorrhizal | Saprophytic | Saprophytes | Protozoan | Protozoa |
| Sample ID | % | Biomass | % | Biomass | % | Biomass |
| BEETS-MMT | 6.88 | 180.65 | 10.51 | 275.77 | 0.68 | 17.72 |
| BEETS-PGPF/PGPR | 8.71 | 313.54 | 12.41 | 446.9 | 0.48 | 17.25 |
| BEETS-NF | 5.52 | 108.06 | 8.73 | 170.98 | 0.71 | 13.87 |
| BEETS-OF | 6.81 | 188.25 | 9.83 | 271.76 | 0.57 | 15.66 |
| BEETS-SOIL | 8.31 | 306.09 | 12.12 | 446.56 | 0 | 0 |
| BELL PEPPERS-MMT | 5.84 | 124.4 | 10.58 | 225.41 | 0 | 0 |
| BELL PEPPERS- | 7.78 | 227.21 | 12.41 | 362.68 | 0.59 | 17.38 |
| PGPF/PGPR | | | | | | |
| BELL PEPPERS-NF | 7.75 | 234.99 | 12.28 | 372.61 | 0 | 0 |
| BELL PEPPERS-OF | 8.39 | 311.17 | 18.42 | 682.94 | 0.49 | 18.14 |
| BELL PEPPERS-SOIL | 6.14 | 169.88 | 9.62 | 266.17 | 0.51 | 14.24 |
| TOMATO-MMT | 6.88 | 184.58 | 12.67 | 340.01 | 0.7 | 18.88 |
| TOMATO- | 6.84 | 265.65 | 14.84 | 576.42 | 0.74 | 28.74 |
| PGPF/PGPR | | | | | | |
| TOMATO-NF | 7.3 | 269.21 | 13.13 | 483.85 | 0.53 | 19.7 |
| TOMATO-OF | 7.12 | 234.57 | 10.09 | 332.52 | 0 | 0 |
| TOMATO-SOIL | 7.09 | 256.18 | 11.95 | 431.79 | 0 | 0 |
| CARROTS-MMT | 5.67 | 140.46 | 9.1 | 225.3 | 0.44 | 10.98 |
| CARROTS- | 6.73 | 208.44 | 13.49 | 418.19 | 0.52 | 16.06 |
| PGPF/PGPR | | | | | | |
| CARROTS-NF | 9.8 | 346.85 | 15.97 | 565 | 0.85 | 29.98 |
| CARROTS-OF | 6.09 | 101.5 | 10.31 | 171.93 | 0.71 | 11.77 |
| CARROTS-SOIL | 4.4 | 65.64 | 10.22 | 152.35 | 0 | 0 |

TABLE 37D
PLFA Report for Beets, Carrots, Tomatoes, and Bell Peppers

| | Gram | Gram | Undiffer- | Undiffer- | |
|---|---|---|---|---|---|
| | (+) | (+) | entiated | entiated | |
| Sample ID | Biomass | % | % | Biomass | Fungi:Bacteria |
| BEETS-MMT | 583.47 | 22.24 | 31.02 | 813.94 | 0.3417 |
| BEETS-PGPF/PGPR | 947.36 | 26.32 | 28.4 | 1022.55 | 0.4225 |
| BEETS-NF | 430.65 | 21.98 | 40.19 | 787.42 | 0.3175 |
| BEETS-OF | 575.76 | 20.83 | 35.48 | 980.8 | 0.3517 |
| BEETS-SOIL | 947.27 | 25.71 | 29.49 | 1086.58 | 0.4077 |
| BELL PEPPERS-MMT | 465.81 | 21.87 | 38.91 | 828.75 | 0.3676 |
| BELL PEPPERS-PGPF/PGPR | 663.03 | 22.69 | 31.1 | 908.61 | 0.4196 |
| BELL PEPPERS-NF | 790.09 | 26.05 | 31.04 | 941.48 | 0.4094 |
| BELL PEPPERS-OF | 836.33 | 22.56 | 26.68 | 989.09 | 0.5825 |
| BELL PEPPERS-SOIL | 628.26 | 22.7 | 37.91 | 1049.36 | 0.3438 |
| TOMATO-MMT | 597.71 | 22.27 | 34.6 | 928.71 | 0.4327 |
| TOMATO-PGPF/PGPR | 847.17 | 21.81 | 32.88 | 1277.39 | 0.485 |
| TOMATO-NF | 902.82 | 24.49 | 32.33 | 1191.72 | 0.4375 |
| TOMATO-OF | 837.61 | 25.41 | 34.02 | 1121.69 | 0.3527 |
| TOMATO-SOIL | 876.74 | 24.26 | 34.48 | 1245.74 | 0.4096 |
| CARROTS-MMT | 574.04 | 23.17 | 40.62 | 1006.26 | 0.3343 |
| CARROTS-PGPF/PGPR | 672.5 | 21.7 | 31.91 | 989.1 | 0.427 |
| CARROTS-NF | 735.64 | 20.8 | 32 | 1132.11 | 0.623 |
| CARROTS-OF | 435.55 | 26.13 | 35.53 | 592.21 | 0.3463 |
| CARROTS-SOIL | 332.29 | 22.28 | 41.2 | 614.39 | 0.3308 |

TABLE 37E
PLFA Report for Beets, Carrots, Tomatoes, and Bell Peppers

| Sample ID | Predator:Prey | Gram(+):Gram(−) | Sat:Unsat | Mono:Poly |
|---|---|---|---|---|
| BEETS-MMT | 0.0133 | 0.7755 | 1.168 | 52.8791 |
| BEETS-PGPF/PGPR | 0.0096 | 1.1113 | 1.2383 | 8.0051 |
| BEETS-NF | 0.0158 | 0.9608 | 1.4986 | 21.8911 |
| BEETS-OF | 0.012 | 0.7863 | 1.2227 | 34.9718 |
| BEETS-SOIL | ALL PREY | 1.0541 | 1.2582 | 8.315 |
| BELL PEPPERS-MMT | ALL PREY | 0.9589 | 1.5384 | ALL MONO |
| BELL PEPPERS-PGPF/PGPR | 0.0124 | 0.8925 | 1.1548 | 6.6703 |
| BELL PEPPERS-NF | ALL PREY | 1.1384 | 1.3375 | 7.9026 |
| BELL PEPPERS-OF | 0.0106 | 0.9611 | 1.0313 | 1.9531 |
| BELL PEPPERS-SOIL | 0.0112 | 0.9816 | 1.3791 | 9.5741 |
| TOMATO-MMT | 0.0156 | 0.9725 | 1.2472 | 6.3237 |
| TOMATO-PGPF/PGPR | 0.0166 | 0.9528 | 1.1497 | 4.4813 |
| TOMATO-NF | 0.0114 | 1.103 | 1.2782 | 5.9094 |
| TOMATO-OF | ALL PREY | 1.0874 | 1.5125 | 13.4134 |
| TOMATO-SOIL | ALL PREY | 1.0922 | 1.3171 | 7.2587 |
| CARROTS-MMT | 0.01 | 1.1039 | 1.5715 | 28.4474 |
| CARROTS-PGPF/PGPR | 0.0109 | 0.846 | 1.1284 | 6.2426 |
| CARROTS-NF | 0.0205 | 1.0105 | 1.0564 | 3.409 |
| CARROTS-OF | 0.0149 | 1.2306 | 1.5367 | 6.2721 |
| CARROTS-SOIL | ALL PREY | 1.0172 | 1.6791 | 25.089 |

TABLE 37F
PLFA Report for Beets, Carrots, Tomatoes, and Bell Peppers

| | Pre | Pre | Beginning | Ending |
|---|---|---|---|---|
| Sample ID | 16:1w7c:cy17:0 | 18:1w7c:cy19:0 | Depth | Depth |
| BEETS-MMT | 3.0419 | 2.1321 | 0 | 8 |
| BEETS-PGPF/PGPR | 2.7097 | 1.6307 | 0 | 8 |
| BEETS-NF | 1 | 1.4736 | 0 | 8 |
| BEETS-OF | 1 | 1.8118 | 0 | 8 |
| BEETS-SOIL | 1 | 1.5654 | 0 | 8 |
| BELL PEPPERS-MMT | 1 | 1.4952 | 0 | 8 |
| BELL PEPPERS-PGPF/PGPR | 1 | 1.8471 | 0 | 8 |
| BELL PEPPERS-NF | 1 | 1.3211 | 0 | 8 |
| BELL PEPPERS-OF | 1 | 1.77 | 0 | 8 |
| BELL PEPPERS-SOIL | 1 | 1.4422 | 0 | 8 |
| TOMATO-MMT | 1 | 1.628 | 0 | 8 |
| TOMATO-PGPF/PGPR | 1 | 1.6195 | 0 | 8 |
| TOMATO-NF | 1 | 1.367 | 0 | 8 |
| TOMATO-OF | 1 | 1.1712 | 0 | 8 |
| TOMATO-SOIL | 1 | 1.4013 | 0 | 8 |
| CARROTS-MMT | 1 | 1.2076 | 0 | 8 |
| CARROTS-PGPF/PGPR | 1 | 1.8646 | 0 | 8 |
| CARROTS-NF | 1 | 1.7916 | 0 | 8 |
| CARROTS-OF | 1 | 1.6955 | 0 | 8 |
| CARROTS-SOIL | 1 | 1.2834 | 0 | 8 |

TABLE 38A
PFLA Report for Radish

| | | | | Total | | |
|---|---|---|---|---|---|---|
| | Total | Diversity | | Bacteria | Actinomycetes | Actinomycetes |
| Sample ID | Biomass | Index | Bacteria % | Biomass | % | Biomass |
| RADISH-MMT | 4909.62 | 1.58 | 46.56 | 2286.04 | 6.74 | 330.7 |
| RADISH- | 4666.6 | 1.577 | 47.99 | 2239.38 | 6.53 | 304.93 |
| PGPF/PGPR | | | | | | |
| RADISH-NF | 4292.58 | 1.575 | 47.17 | 2024.82 | 6.94 | 297.75 |
| RADISH-OF | 3865.61 | 1.583 | 46.56 | 1799.9 | 6.9 | 266.74 |
| RADISH-SOIL | 5250.45 | 1.539 | 47.23 | 2479.61 | 6.62 | 347.48 |

TABLE 38B
PFLA Report for Radish

| | Gram (−) | Gram (−) | | Rhizobia | Total Fungi | Total Fungi |
|---|---|---|---|---|---|---|
| Sample ID | % | Biomass | Rhizobia % | Biomass | % | Biomass |
| RADISH-MMT | 19.98 | 981.08 | 0.31 | 15.07 | 22.46 | 1102.85 |
| RADISH- | 22.4 | 1045.46 | 0.39 | 18.42 | 23.45 | 1094.26 |
| PGPF/PGPR | | | | | | |
| RADISH-NF | 20.66 | 886.9 | 0.35 | 14.93 | 20.17 | 865.73 |
| RADISH-OF | 21.01 | 812.24 | 0.34 | 13.2 | 18.81 | 727.17 |
| RADISH-SOIL | 21.99 | 1154.74 | 0.3 | 15.53 | 20.43 | 1072.82 |

TABLE 38C
PFLA Report for Radish

| | Arbusular | Arbuscular | | | | |
|---|---|---|---|---|---|---|
| | Mycorrhizal | Mycorrhizal | Saprophytic | Saprophytes | Protozoan | Protozoa |
| Sample ID | % | Biomass | % | Biomass | % | Biomass |
| RADISH-MMT | 9.49 | 466 | 12.97 | 636.85 | 0.39 | 19.21 |
| RADISH- | 9.43 | 439.96 | 14.02 | 654.3 | 0.44 | 20.37 |
| PGPF/PGPR | | | | | | |
| RADISH-NF | 8.35 | 358.45 | 11.82 | 507.28 | 0.43 | 18.53 |
| RADISH-OF | 8.29 | 320.35 | 10.52 | 406.82 | 0.66 | 25.47 |
| RADISH-SOIL | 8.93 | 468.95 | 11.5 | 603.87 | 0 | 0 |

TABLE 38D
PFLA Report for Radish

| | Gram | | | | | |
|---|---|---|---|---|---|---|
| | (+) | Gram | Undifferentiated | Undifferentiated | | |
| Sample ID | Biomass | (+) % | % | Biomass | Fungi:Bacteria | Predator:Prey |
| RADISH-MMT | 1304.96 | 26.58 | 30.58 | 1501.53 | 0.4824 | 0.0084 |
| RADISH- | 1193.92 | 25.58 | 28.13 | 1312.61 | 0.4886 | 0.0091 |
| PGPF/PGPR | | | | | | |
| RADISH-NF | 1137.92 | 26.51 | 32.23 | 1383.5 | 0.4276 | 0.0092 |
| RADISH-OF | 987.66 | 25.55 | 33.97 | 1313.05 | 0.404 | 0.0142 |
| RADISH-SOIL | 1324.88 | 25.23 | 32.34 | 1698.02 | 0.4327 | ALL PREY |

TABLE 38E
PFLA Report for Radish

| | | | | Pre | Pre |
|---|---|---|---|---|---|
| Sample ID | Gram(+):Gram(−) | Sat:Unsat | Mono:Poly | 16:1w7c:cy17:0 | 18:1w7c:cy19:0 |
| RADISH-MMT | 1.3301 | 1.3021 | 5.1071 | 2.2119 | 1.6307 |
| RADISH-PGPF/PGPR | 1.142 | 1.2053 | 5.755 | 2.2692 | 1.858 |
| RADISH-NF | 1.283 | 1.3838 | 6.102 | 2.1248 | 1.5371 |
| RADISH-OF | 1.216 | 1.391 | 7.2454 | 1.9993 | 1.5568 |
| RADISH-SOIL | 1.1473 | 1.2974 | 6.8123 | 2.282 | 1.6383 |

TABLE 38F
PFLA report for radish

| | Beginning | Ending |
|---|---|---|
| Sample ID | Depth | Depth |
| RADISH-MMT | 0 | 8 |
| RADISH-PGPF/PGPR | 0 | 8 |
| RADISH-NF | 0 | 8 |
| RADISH-OF | 0 | 8 |
| RADISH-SOIL | 0 | 8 |

### Example 20: P2 Plant Analysis Report

Samples were collected and plant analysis was conducted at Ward Laboratories, Inc.

TABLE 39A

| Field ID | Sample ID | % N | % P | % K | % S | % Ca | % Mg |
|---|---|---|---|---|---|---|---|
| CARROTS | MMT | 0.76 | 0.402 | 2.75 | 0.286 | 1.397 | 0.228 |
| CARROTS | PGPF/PGPR | 0.784 | 0.271 | 2.23 | 0.097 | 0.604 | 0.149 |
| CARROTS | NF | 0.725 | 0.208 | 1.9 | 0.08 | 0.703 | 0.183 |
| CARROTS | OF | 0.906 | 0.249 | 1.87 | 0.15 | 1.773 | 0.188 |
| CARROTS | SOIL | 0.828 | 0.198 | 1.83 | 0.096 | 0.781 | 0.179 |
| BELLPEPPERS | MMT | 2.098 | 1.188 | 5.16 | 0.837 | 1.719 | 0.456 |
| BELLPEPPERS | PGPF/PGPR | 2.106 | 0.916 | 4.37 | 0.757 | 1.263 | 0.4 |
| BELLPEPPERS | NF | 2.284 | 0.751 | 3.95 | 0.595 | 1.255 | 0.299 |
| BELLPEPPERS | OF | 2.117 | 0.471 | 3.52 | 0.332 | 0.772 | 0.259 |
| BELLPEPPERS | SOIL | 1.902 | 0.78 | 4.17 | 0.654 | 1.261 | 0.307 |
| TOMATO | MMT | 1.349 | 0.808 | 3.24 | 0.369 | 0.722 | 0.351 |
| TOMATO | PGPF/PGPR | 1.731 | 0.78 | 3.51 | 0.41 | 1.235 | 0.303 |
| TOMATO | NF | 1.433 | 0.813 | 2.95 | 0.469 | 1.645 | 0.545 |
| TOMATO | OF | 1.647 | 0.448 | 2.89 | 0.299 | 1.029 | 0.231 |
| TOMATO | SOIL | 1.271 | 0.562 | 2.56 | 0.522 | 1.602 | 0.34 |
| BEETS | MMT | 0.889 | 1.524 | 3.62 | 0.271 | 2.958 | 0.69 |
| BEETS | PGPF/PGPR | 0.847 | 0.791 | 2.44 | 0.203 | 2.847 | 0.544 |
| BEETS | NF | 0.77 | 0.421 | 1.21 | 0.105 | 1.362 | 0.487 |
| BEETS | OF | 1.042 | 0.351 | 2.16 | 0.171 | 0.984 | 0.334 |
| BEETS | SOIL | 1.172 | 0.542 | 2.21 | 0.191 | 2.979 | 0.541 |

TABLE 39B

| Field ID | Sample ID | ppm Zn | ppm Fe | ppm Mn | ppm Cu | ppm B | ppm Mo |
|---|---|---|---|---|---|---|---|
| CARROTS | MMT | 38 | 1900 | 85 | 9 | 25.2 | 0.61 |
| CARROTS | PGPF/PGPR | 32 | 570 | 33 | 4.6 | 24 | 0.2 |
| CARROTS | NF | 39 | 1176 | 60 | 6.4 | 29.3 | 0.06 |
| CARROTS | OF | 25 | 952 | 70 | 4.8 | 22.7 | 0.28 |
| CARROTS | SOIL | 40 | 949 | 55 | 5.4 | 31.1 | 0.14 |
| BELLPEPPERS | MMT | 46 | 353 | 37 | 14.4 | 42.5 | 0.56 |
| BELLPEPPERS | PGPF/PGPR | 27 | 96 | 17 | 11.6 | 28.7 | 0.35 |
| BELLPEPPERS | NF | 38 | 86 | 21 | 8.6 | 26.8 | 1.22 |
| BELLPEPPERS | OF | 37 | 129 | 21 | 7.2 | 28.3 | 0.64 |
| BELLPEPPERS | SOIL | 44 | 166 | 22 | 9.1 | 33.8 | 0.51 |
| TOMATO | MMT | 21 | 64 | 15 | 6.8 | 18.3 | 1.01 |
| TOMATO | PGPF/PGPR | 35 | 105 | 15 | 8.8 | 26.4 | 1.09 |
| TOMATO | NF | 66 | 103 | 28 | 8.8 | 25.1 | 1.56 |
| TOMATO | OF | 18 | 60 | 21 | 4.5 | 18.6 | 0.69 |
| TOMATO | SOIL | 25 | 72 | 16 | 5.3 | 20 | 1.24 |
| BEETS | MMT | 38 | 1134 | 103 | 8.7 | 22.3 | 0.72 |
| BEETS | PGPF/PGPR | 51 | 4358 | 201 | 14.8 | 24.6 | 0.81 |
| BEETS | NF | 35 | 4712 | 119 | 8 | 18.9 | 0.09 |
| BEETS | OF | 36 | 1516 | 75 | 7.3 | 18.1 | 0.29 |
| BEETS | SOIL | 46 | 1774 | 136 | 8.3 | 22.1 | 0.08 |

In summary, Tables 36A-39B suggest that the 2-year-old Formula B soil was very high quality with microbial life as compared to the other 5 groups that were grown for only one growing season.

It is to be understood that the embodiments and examples of the disclosure disclosed herein are illustrative of the principles of the present disclosure. Other modifications that may be employed are within the scope of the disclosure. Thus, by way of example, but not of limitation, alternative configurations of the present disclosure may be utilized in accordance with the teachings herein. Accordingly, the present disclosure is not limited to that precisely as shown and described.

The particulars shown herein are by way of example and for purposes of illustrative discussion of the preferred embodiments of the present disclosure only and are presented in the cause of providing what is believed to be the most useful and readily understood description of the principles and conceptual aspects of various embodiments of the disclosure. In this regard, no attempt is made to show structural details of the disclosure in more detail than is necessary for the fundamental understanding of the disclosure, the description taken with the drawings and/or examples making apparent to those skilled in the art how the several forms of the disclosure may be embodied in practice.

1. A composition for promoting plant health and growth, the composition comprising:
montmorillonite clay (MMT); and
an enzyme blend;
wherein the enzyme blend comprises plant growth-promoting fungi (PGPF) or the enzyme blend comprises PGPF and plant growth-promoting rhizobacteria (PGPR); and
optionally, wherein the MMT and enzyme blend are present in a weight ratio of MMT:
enzyme blend from 95:5 to 5:95.

2. The composition of claim 1, wherein the MMT is in the form of a micronized solid, and optionally, wherein the micronized solid has a mean particle size diameter equal to or less than 40 microns (≤40 μm).

3. The composition of claim 1, wherein the MMT comprises one or more of nitrogen (N), phosphorus (P), potassium K), calcium (Ca), magnesium (Mg), iron (Fe), oxygen (O₂), and additional trace minerals, and optionally, wherein the MMT comprises:
500-800 ppm of N;
100-300 ppm of P;
25,000-35,000 ppm of K;
16,000-24,000 ppm of Ca;
4,000-8,000 ppm of Mg;
11,000-16,000 ppm of Fe; or
400,000-700,000 ppm of O₂.

4. The composition of claim 1, wherein the enzyme blend further comprises one or more vitamins, minerals, enzymes, and amino acids.

5. The composition of claim 4, wherein the one or more minerals of the enzyme blend comprise zinc, magnesium, selenium, copper, cobalt, manganese, iron, iodine, phosphorus, sulfur, potassium, and sodium, and optionally, wherein amount of the minerals in the enzyme blend by weight in grams per kilogram of the enzyme blend comprises:
7.0-11.0 g of zinc (Zn);
5.0-7.0 g of magnesium (Mg);
0.005-0.015 g of selenium (Se);
0.8-1.6 g of copper (Cu);
0.10-0.20 g of cobalt (Co);
1.0-2.0 g of manganese (Mn);
1.0-2.0 g of iron (Fe);
0.25-0.40 g of iodine (I);
13.0-14.5 g of phosphorus (P)
0.3-1.1 g of sulfur(S);
0.05-0.15 g of potassium (K); or
0.002-0.010 g of sodium (Na).

6. The composition of claim 4, wherein the one or more vitamins of the enzyme blend comprise vitamin A, vitamin D₃, and/or vitamin E, and optionally, wherein amount of vitamins in the enzyme blend in international units (iu) per kilogram of the enzyme blend comprises:
650,000-710,000 international units (iu) of vitamin A;
80,000-115,00 iu of vitamin D₃; or
300-350 iu of vitamin E.

7. The composition of claim 4, wherein the one or more amino acids of the enzyme blend comprise glutamine (Gln), alanine (Ala), threonine (Thr), valine (Val), serine (Ser), proline (Pro), isoleucine (Ile), leucine (Ile), leucine (Leu), histidine (His), phenylalanine (Phe), glutamic acid (Glu), aspartic acid (Asp), cysteine (Cys), tyrosine (Tyr), and tryptophan (Trp), and optionally, wherein amount of amino acids in the enzyme blend by weight in milligrams per gram of the enzyme blend comprises:
40.0-43.0 mg of Gln;
44.5-47.0 mg of Ala;
3.0-5.0 mg of Thr;
2.8-4.0 mg of Val;
0.3-1.3 mg of Ser;
0.3-1.3 mg of Pro;
0.10-1.0 mg of Ile;
14.5-16.0 mg of Leu;
0.1-0.5 mg of His;
0.08-0.6 mg of Phe;
0.3-1.2 mg of Glu;
0.2-1.4 mg of Asp;
0.2-1.2 mg of Cys;
1.0-2.0 mg of Tyr; or
0.005-0.015 mg of Trp.

8. The composition of claim 4, wherein the one or more enzymes of the enzyme blend comprise cellulase, hemicellulase, and pectinase, and optionally, wherein amount of enzymes in the enzyme blend in international units (iu) per kilogram of the blend comprises:
700-1300 international units (iu) of cellulase;
700-1300 iu of hemicellulase; or
700-1300 iu of pectinase.

9. The composition of claim 8, wherein:
the cellulase enzyme is derived from organisms selected from the group consisting of Aspergillus niger, Aspergillus nidulans, and Aspergillus oryzae;
the pectinase enzyme is derived from organisms selected from the group consisting of Aspergillus Niger, Aspergillus awamori, Aspergillus oryzae, Penicillium expansum, Penicillium restrictum, Trichoderma viride, Mucor piriformis, Yarrowia lipolytica, Penicillium janthinellum, Tetracoccosporium sp., Penicillium chrysogenum, Saccharomyces fragilis, Saccharomyces thermantitonum, Torulopsis kefyr, Candida pseudotropicalis var, lactosa, Candida pseudotropicalis, Saccharomyces sp, Cryptococcus sp., Aureobasidium pullulans, Rhodotorula dairenensis, Kluyveromyces marxianus, Geotrichum klebahnii, Wickerhanomyces anomalus, Hanseniaspora sp., Saccharomyces cerevisiae, Rhodotorula dairenensis, Candida zemplinina, Metschnikowia sp., Aureobasidium pullulans, Cryptococcus saitoi, Pseudomonas fluorescens, Bacillus sp., Pseudomonas sp., Micrococcus sp., Bacillus licheniformis, and Brevibacillus borstelensis; and/or
the hemicellulase is derived from saprophytic microbes, and optionally, wherein the saprophytic microbes comprise members of the Bacillus or Paenibacillus genera.

10. The composition of claim 1, wherein the enzyme blend comprises PGPR at a concentration of at least 1×10⁴ to 1×10¹⁰ colony forming units/milliliter (CFU/mL); and/or
wherein the enzyme blend comprises PGPF at an average concentration of about 1×10⁸ CFU/mL.

11. The composition of claim 1, wherein the PGPR comprise bacteria selected from the group consisting of Azospirillum, Actinobacter, Alcaligenes, Bacillus, Burkholderia, Buttiauxella, Enterobacter, Klebsiella, Kluyvera, Pseudomonas, Rahnella, Ralstonia, Rhizobium, Serratia, Stenotrophomonas, Paenibacillus, Lysinibacillus, and a combination thereof, and optionally, wherein the PGPR comprise Azospirillum and/or Bacillus, and optionally, wherein the PGPR comprise Bacillus subtilis.

12. The composition of claim 1, wherein the PGPF comprise fungi selected from the group consisting of Aspergillus, Fusarium, Penicillium, Phoma, Trichoderma, and a combination thereof, and optionally wherein the PGPF comprise Aspergillus, and optionally wherein the PGPF comprise Aspergillus oryzae.

13. The composition of claim 1, wherein the composition is in the form of a solid or liquid, and optionally, wherein the solid is in the form of a powder, a tablet, a capsule, or a gel.

14. A method for promoting plant health or plant growth, or for improving the root health of a plant, wherein the method comprises administering an effective amount of a composition of claim 1 to a plant.

15. The method of claim 14, wherein the composition is administered to the root of the plant, seeds of the plant, leaves of the plant, or soil surrounding the plant.

16. The method of claim 14, wherein the composition is applied in the form of a liquid composition, and optionally wherein the liquid composition is prepared by dissolving a solid form of the composition with water.

17. The method of claim 15, wherein the composition is administered to the plant by dusting using a strainer.

18. The method of claim 14, wherein the method comprises blending the composition into the soil used for growing the plant.
